(19) United States
(12) Patent Application Publication
(10) Pub. No.: US 2009/0037337 A1
(43) Pub. Date: Feb. 5, 2009

(54) Software Licensing and Enforcement System

(76) Inventors: Ahmad Baitalmal, Renton, WA (US); Daniel J. Kolke, North Bend, WA (US); Jon K. Collette, Normandy Park, WA (US); Casey Tompkins, Woodinville, WA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/182,800

(22) Filed: Jul. 30, 2008

Related U.S. Application Data
(63) Continuation-in-part of application No. 12/102,854, filed on Apr. 14, 2008.
(60) Provisional application No. 60/962,877, filed on Jul. 31, 2007.

(51) Int. Cl. G06Q 99/00

(52) U.S. Cl. 705/59

(57) ABSTRACT

In an embodiment, a computer implemented method is described. The method is performed at one or more servers, hosting a marketplace application. A software application is received from a vendor for distribution. License terms are generated in response to a selection by the vendor from options provided by the marketplace application. The license terms are associated with the software application. The software application is made available for distribution through the marketplace application, in accordance with the license terms.

### RELATED APPLICATIONS

This application claims the benefit of and priority to U.S. Provisional Patent Application Ser. No. 60/962,877 filed on Jul. 31, 2007, the disclosure of which is hereby incorporated by reference in its entirety. This application is a continuation-in-part of U.S. patent application Ser. No. 12/102,854, “System And Method For Resolving Conflicts Between An Offline Web-Based Application And An Online Web-Based Application” filed on Apr. 14, 2008, which application is incorporated by reference herein in its entirety.

This application is related to U.S. patent application Ser. No. 12/102,848, “System And Method For Synchronizing An Offline Web-Based Application With An Online Web-Based Application” filed on Apr. 14, 2008, which application is incorporated by reference herein in its entirety. This application is related to U.S. patent application Ser. No. 12/102,842, “System And Method For Running A Web-Based Application While Offline” filed on Apr. 14, 2008, which application is incorporated by reference herein in its entirety. This application is related to U.S. patent application Ser. No. ______, “System and Method for Synchronizing Applications” filed on the same date as this application, (Attorney Docket Number 069904-5004), which application is incorporated by reference herein in its entirety. This application is related to U.S. patent application Ser. No. ______, “Framework for Synchronizing Applications” filed on the same date as this application, (Attorney Docket Number 069904-5005), which application is incorporated by reference herein in its entirety. This application is related to U.S. patent application Ser. No. ______, “Software Marketplace and Distribution System” filed on the same date as this application, (Attorney Docket Number 069904-5006), which application is incorporated by reference herein in its entirety.

### TECHNICAL FIELD

The disclosed embodiments relate generally to licensing and enforcement of software applications.

### BACKGROUND

It is often difficult for developers or vendors of software applications, particularly small software applications, to economically market and license their applications. Furthermore, it is often difficult to enforce a license for a small software application, because it may not be cost effective to pursue a violator of the license. It would be desirable to have a system for marketing, licensing and enforcing of software applications that permits a software developer or vendor to concentrate on creating software applications without the overhead of managing the business aspects of marketing and licensing.

### SUMMARY

An embodiment of the present application relates to a marketplace for software applications where, once licensed, the software applications are hosted at a user account.

The present application describes some embodiments of a software marketplace whereby software vendors can easily upload and license software applications and receive revenue in return. Among other advantages, this frees software vendors from the need to manage financial and legal issues associated with licensing software applications to large numbers of users. In one embodiment, the software marketplace is associated with a software platform provider (in one example, Etelos) and the software vendors develop software applications for this software platform. This arrangement benefits both the software vendor (who can concentrate on writing applications and receiving revenue for them) and the software platform provider (who has a large number of developers supporting their software platform.

This arrangement is particularly attractive to vendors of small software applications, where the revenue per licensed application is small, and the number of licensees is high. It may not be cost effective or time effective for the software vendor to engage with large numbers of small payments and licensees, particularly when the licensees may be spread around geographically, in different time zones, use different currencies, etc. By combining ease of use, tight integration, and transparent billing and licensing for the vendors' software applications, the software platform provider can provide an attractive service for its customers

As the number of software vendors supporting the software platform increases, the software vendors may provide custom application development to customers of the software platform. In some embodiments, the software platform provider can monitor this process and ensure quality. In some embodiments, customers of the software platform may place jobs (i.e., custom software specifications) out for bid, where developers bid on the work. A software customer may specify a bid based on a combination of cost, quality, delivery time, and other factors.

Software vendors are commonly concerned about the overhead of licensing their software applications, and about enforcing their software licenses. Some embodiments enable software vendors to specify a set of license terms (e.g., commonly used license types such as open source, proprietary, executable only, source code license, etc.) for a software application, and prevent licensees of the software application from misusing the software application outside the terms of the license.

Some embodiments provide a method for detecting changes made to a first data set in a plurality of data sets, and synchronizing at least a first subset of the changes to a data framework that facilitates data synchronization between the plurality of data sets.

In some embodiments, at least a second subset of the synchronized changes from the data framework to a second data set in the plurality of data sets is synchronized.

In some embodiments, at least a third subset of the synchronized changes from the data framework to a second data framework is synchronized.

Some embodiments provide a computer readable storage medium storing one or more programs configured for execution by a computer, the one or more programs including instructions for detecting changes made to a first data set in a plurality of data sets, and synchronizing at least a first subset of the changes to a data framework that facilitates data synchronization between the plurality of data sets.

Some embodiments provide a system including one or more processors, memory, and one or more programs stored in the memory, the one or more programs comprising instructions to: detect changes made to a first data set in a plurality of data sets; and synchronize at least a first subset of the changes to a data framework that facilitates data synchronization between the plurality of data sets.

Some embodiments provide a method for identifying a first data set in a plurality of data sets that is to be synchronized with a data framework, determining a mapping between one or more data fields in a data structure for the first data set and one or more data fields in a data structure for the data framework, and generating synchronization rules for the first data set based on the determined mapping.

Some embodiments provide a computer readable storage medium storing one or more programs configured for execution by a computer, the one or more programs including instructions for identifying a first data set in a plurality of data sets that is to be synchronized with a data framework, determining a mapping between one or more data fields in a data structure for the first data set and one or more data fields in a data structure for the data framework, and generating synchronization rules for the first data set based on the determined mapping.

Some embodiments provide a system including one or more processors, memory, and one or more programs stored in the memory, the one or more programs comprising instructions to: identify a first data set in a plurality of data sets that is to be synchronized with a data framework, determine a mapping between one or more data fields in a data structure for the first data set and one or more data fields in a data structure for the data framework, and generate synchronization rules for the first data set based on the determined mapping.

Some embodiments provide a method for detecting changes made to a first data set for a first web-based application in an account, identifying at least a second data set for a second web-based application in the account, wherein the second data set includes at least a subset of the data included in the first data set, and applying synchronization rules to synchronize the second data set with the first data set.

Some embodiments provide a computer readable storage medium storing one or more programs configured for execution by a computer, the one or more programs including instructions for detecting changes made to a first data set for a first web-based application in an account, identifying at least a second data set for a second web-based application in the account, wherein the second data set includes at least a subset of the data included in the first data set, and applying synchronization rules to synchronize the second data set with the first data set.

Some embodiments provide a system including one or more processors, memory, and one or more programs stored in the memory, the one or more programs comprising instructions to: detect changes made to a first data set for a first web-based application in an account, identify at least a second data set for a second web-based application in the account, wherein the second data set includes at least a subset of the data included in the first data set, and apply synchronization rules to synchronize the second data set with the first data set.

Some embodiments provide a computer system including one or more processors, memory, and one or more programs and data structures stored in the memory, the one or more programs and data structures including: an application data structure configured to store data and program files for a web-based application, an account data structure configured to store one or more instances of the application data structure for an account, wherein an instance of the application data structure corresponds to an instance of a web-based application, and a synchronization module configured to synchronize data between web-based applications within an account based on synchronization rules.

Some embodiments provide a computer readable storage medium storing one or more programs and data structures configured for execution by a computer, the one or more data structures including: an application data structure configured to store data and program files for a web-based application, and an account data structure configured to store one or more instances of the application data structure for an account, wherein an instance of the application data structure corresponds to an instance of a web-based application. The one or more programs include instructions for synchronizing data between web-based applications within an account based on synchronization rules.

In accordance with some embodiments, a computer-implemented method is performed at a system. The computer-implemented method includes at one or more servers hosting a marketplace application: receiving from a vendor a software application for distribution; associating license terms with the software application; making the software application available for distribution through the marketplace application; and deploying the software application to one or more user accounts on one or more hosting servers, in accordance with the license terms.

In accordance with some embodiments, a computer-implemented method is performed at a system. The computer-implemented method includes at one or more servers hosting a marketplace application: receiving from a vendor a software application for distribution; generating license terms in response to a selection by the vendor from options provided by the marketplace application; associating the license terms with the software application; and making the software application available for distribution through the marketplace application, in accordance with the license terms.

In accordance with some embodiments, a computer-implemented method is performed at a system. The computer-implemented method includes at one or more servers hosting a marketplace application, in response to a request from a syndicated server to distribute a software application from the marketplace: identifying one or more user accounts associated with the request; verifying that the one or more user accounts has permission to use the software application; and deploying the software application to the one or more user accounts, in accordance with license terms associated with the software application.

In accordance with some embodiments, a computer-implemented method is performed at a system. The computer-implemented method includes at one or more servers hosting a marketplace application: making a software application available for distribution through the marketplace application; receiving a user request to license the software application; and providing the software application for deployment to one or more user accounts, hosted on one or more servers.

In accordance with some embodiments, a system for distributing software applications is described. The system comprises one or more processors, memory, and one or more programs stored in the memory. The one or more programs comprise instructions for implementing: a program module configured to provide a software application for distribution in response to an access request from a user; a program module configured to receive and deploy the software application from the marketplace module to an account on one or more servers; and a program module configured to provide at least one or more user accounts, from which the user accesses the software application.

In accordance with some embodiments, a server system comprises one or more processors, memory, and one or more programs stored in the memory. The one or more programs comprise instructions for at one or more servers hosting a marketplace application: receiving from a vendor a software application for distribution; associating license terms with the software application; making the software application available for distribution through the marketplace application; and deploying the software application to one or more user accounts on one or more hosting servers, in accordance with the license terms.

In accordance with some embodiments, a computer readable storage medium stores one or more programs configured for execution by a computer. The one or more programs comprise instructions to, at one or more servers hosting a marketplace application: receive from a vendor a software application for distribution; associate license terms with the software application; make the software application available for distribution through the marketplace application; and deploy the software application to one or more user accounts on one or more hosting servers, in accordance with the license terms.

In accordance with some embodiments, a server system comprises one or more processors, memory, and one or more programs stored in the memory. The one or more programs comprise instructions for, at one or more servers hosting a marketplace application: receiving from a vendor a software application for distribution; generating license terms in response to a selection by the vendor from options provided by the marketplace application; associating the license terms with the software application; and making the software application available for distribution through the marketplace application, in accordance with the license terms.

In accordance with some embodiments, a computer readable storage medium stores one or more programs configured for execution by a computer. The one or more programs comprise instructions for, at one or more servers hosting a marketplace application: receiving from a vendor a software application for distribution; generating license terms in response to a selection by the vendor from options provided by the marketplace application; associating the license terms with the software application; and making the software application available for distribution through the marketplace application, in accordance with the license terms.

In accordance with some embodiments, a server system comprises one or more processors, memory, and one or more programs stored in the memory. The one or more programs comprise instructions for, at one or more marketplace servers hosting a marketplace application, in response to a request from a syndicated server to distribute a software application from the marketplace: identifying one or more user accounts associated with the request; verifying that the one or more user accounts has permission to use the software application; and deploying the software application to the one or more user accounts, in accordance with license terms associated with the software application.

In accordance with some embodiments, a computer readable storage medium stores one or more programs configured for execution by a computer. The one or more programs comprise instructions for, at one or more marketplace servers hosting a marketplace application, in response to a request from a syndicated server to distribute a software application from the marketplace: identifying one or more user accounts associated with the request; verifying that the one or more user accounts has permission to use the software application; and deploying the software application to the one or more user accounts, in accordance with license terms associated with the software application.

In accordance with some embodiments, a server system comprises one or more processors, memory, and one or more programs stored in the memory. The one or more programs comprise instructions for at one or more servers hosting a marketplace application: making a software application available for distribution through the marketplace application; receiving a user request to license the software application; and providing the software application for deployment to one or more user accounts, hosted on one or more servers.

In accordance with some embodiments, a computer readable storage medium stores one or more programs configured for execution by a computer. The one or more programs comprise instructions for at one or more servers hosting a marketplace application: making a software application available for distribution through the marketplace application; receiving a user request to license the software application; and providing the software application for deployment to one or more user accounts, hosted on one or more servers.

### BRIEF DESCRIPTION OF THE DRAWINGS

FIG. 1 presents a block diagram of a network, according to embodiments of the present invention.

FIG. 2 presents a block diagram of a network, according to embodiments of the present invention.

FIG. 3 presents a block diagram of an application database, according to embodiments of the present invention.

FIG. 4 presents a block diagram of a user database, according to embodiments of the present invention.

FIG. 5 presents a block diagram of a synchronization engine on an application server, according to embodiments of the present invention.

FIG. 6 presents a block diagram of a synchronization engine on a client computer system, according to embodiments of the present invention.

FIG. 7 presents a block diagram of an application server, according to embodiments of the present invention.

FIG. 8 presents a block diagram of a client, according to embodiments of the present invention.

FIG. 9 presents a block diagram illustrating exemplary group memberships for users for a given web-based application, according to embodiments of the present invention.

FIG. 10 presents a block diagram of an exemplary AOP framework that provides offline access to a web-based application, according to embodiments of the present invention.

FIG. 11 illustrates an exemplary process of using an AOP framework to run a web-based application while offline, according to embodiments of the present invention.

FIG. 12 presents a block diagram of an exemplary process of installing an instance of an AOP framework on a client computer system, according to embodiments of the present invention.

FIG. 13 illustrates an exemplary process of installing an instance of an AOP framework on a client computer system, according to embodiments of the present invention.

FIG. 14 presents a block diagram of an exemplary process of initializing an AOP account on a client computer system, according to embodiments of the present invention.

FIG. 15 illustrates an exemplary process of initializing an AOP account on a client computer system, according to embodiments of the present invention.

FIG. 16 presents a block diagram of an exemplary process of installing a web-based application on a client computer system, according to embodiments of the present invention.

FIG. 17 illustrates an exemplary process of installing a web-based application on a client computer system, according to embodiments of the present invention.

FIG. 18 presents a block diagram of an exemplary process of performing an initial data synchronization for a web-based application on a client computer system, according to embodiments of the present invention.

FIG. 19 illustrates an exemplary process of performing an initial data synchronization for a web-based application on a client computer system, according to embodiments of the present invention.

FIG. 20 presents a block diagram of an exemplary process of using the AOP framework on a client computer system, according to embodiments of the present invention.

FIG. 21 illustrates an exemplary process of using the AOP framework on a client computer system, according to embodiments of the present invention.

FIG. 22 presents a block diagram of an exemplary process for a client computer system determining how to access a web-based application, according to embodiments of the present invention.

FIG. 23 illustrates an exemplary process for a client computer system determining how to access a web-based application, according to embodiments of the present invention.

FIG. 24 presents a block diagram of an exemplary process for synchronizing a web-based application on a client computer system with a web-based application on an application server, according to embodiments of the present invention.

FIG. 25 illustrates an exemplary process for synchronizing a web-based application on a client computer system with a web-based application on an application server, according to embodiments of the present invention.

FIG. 26 presents a block diagram of an exemplary process for synchronizing a web-based application on a client computer system with a web-based application on an application server, according to embodiments of the present invention.

FIG. 27A illustrates an exemplary process for synchronizing a web-based application on a client computer system with a web-based application on an application server, according to embodiments of the present invention.

FIG. 27B continues the process illustrated in FIG. 27A, according to embodiments of the present invention.

FIG. 27C continues the process illustrated in FIG. 27B, according to embodiments of the present invention.

FIG. 27D continues the process illustrated in FIG. 27C, according to embodiments of the present invention.

FIG. 27E continues the process illustrated in FIG. 27D, according to embodiments of the present invention.

FIG. 27F continues the process illustrated in FIG. 27E, according to embodiments of the present invention.

FIG. 28 presents a block diagram of an exemplary process for resolving conflicts for web-based applications that use auto-incrementing identifiers, according to embodiments of the present invention.

FIG. 29 illustrates an exemplary process for resolving conflicts for web-based applications that use auto-incrementing identifiers, according to embodiments of the present invention.

FIG. 30 presents a flowchart of an exemplary process for providing access to a web-based application while offline, according to embodiments of the present invention.

FIG. 31 presents a flowchart of an exemplary process for synchronizing a web-based application on a client computer system with a web-based application on an application server, according to embodiments of the present invention.

FIG. 32 presents a flowchart of an exemplary process for synchronizing a web-based application on a client computer system with a web-based application on an application server, according to embodiments of the present invention.

FIG. 33 presents a flowchart of an exemplary process for resolving conflicts between a web-based application on a client computer system and a web-based application on an application server, according to embodiments of the present invention.

FIG. 34 presents a flowchart of an exemplary process for resolving conflicts between a web-based application on a client computer system and a web-based application on an application server which uses automatically incrementing identifiers for database records, according to embodiments of the present invention.

FIG. 35 presents a flowchart of an exemplary process for providing access to a web-based application while offline, according to embodiments of the present invention.

FIG. 36 presents a block diagram illustrating an exemplary user interface for creating synchronization rules, according to embodiments of the present invention.

FIG. 37 presents a block diagram illustrating an exemplary user interface for generating auto-incrementing identifiers, according to embodiments of the present invention.

FIG. 38 presents a block diagram illustrating an exemplary process for creating synchronization rules, according to embodiments of the present invention.

FIG. 39 presents a flowchart of an exemplary process for creating synchronization rules, according to embodiments of the present invention.

FIG. 40 presents a block diagram of an exemplary foreign key mapping, according to embodiments of the present invention.

FIG. 41 presents a flowchart of an exemplary process for creating a foreign key mapping, according to embodiments of the present invention.

FIG. 44 is a block diagram illustrating deploying applications to a user account, according to some embodiments.

FIG. 45 is a block diagram illustrating managing licenses in a multi-tenancy environment, according to some embodiments.

FIG. 46 is a block diagram illustrating a web application marketplace and hosting infrastructure, according to some embodiments.

FIG. 47 is a flow diagram illustrating a process for selecting and deploying a software application in a user account, according to some embodiments.

FIG. 48 is a block diagram illustrating a marketplace server and hosting infrastructure, according to some embodiments.

FIG. 49 is a block diagram illustrating licensing options in a software distribution marketplace, according to some embodiments.

FIG. 50 is a block diagram illustrating dynamic billing in a software distribution marketplace, according to some embodiments.

FIG. 51 is a block diagram illustrating an application manager and repository in a software distribution marketplace, according to some embodiments.

FIG. 52 is a block diagram illustrating syndicated deployment across a network in a software distribution marketplace, according to some embodiments.

FIG. 53 is a block diagram illustrating a packager in a software distribution marketplace, according to some embodiments.

FIG. 54 is a block diagram illustrating an alternative embodiment of a packager in a software distribution marketplace, according to some embodiments.

FIG. 55 is a block diagram illustrating an alternative embodiment of a packager in a software distribution marketplace, according to some embodiments.

FIG. 56 is a block diagram illustrating licensing a software application in a software distribution marketplace, according to some embodiments.

FIG. 57 is a block diagram illustrating providing security for software applications, deployed to a user account, in a software distribution marketplace, according to some embodiments.

FIG. 58 is a block diagram illustrating multiple logons to a software application in a software distribution marketplace, according to some embodiments.

FIG. 59 is a block diagram illustrating a user access control interface, in a software distribution marketplace, according to some embodiments.

FIG. 60 is a block diagram illustrating a user access control interface, in a software distribution marketplace, according to some embodiments.

FIG. 61 is a system block diagram illustrating a server hosting a software marketplace and licensing system, according to some embodiments.

FIG. 62 is a system block diagram illustrating a client interfacing with a software marketplace and licensing system, according to some embodiments.

FIG. 63 is a block diagram illustrating an exemplary application framework, according to some embodiments.

FIG. 64A is a block diagram illustrating exemplary components of an account, according to some embodiments.

FIG. 64B is a flow diagram of an exemplary process for creating an account and installing applications into the account, according to some embodiments.

FIG. 65 is a block diagram of a server and a client, according to some embodiments.

FIG. 66 is a flow diagram of an exemplary process for synchronizing applications, according to some embodiments.

FIG. 67 is a block diagram illustrating an exemplary process for synchronizing applications, according to some embodiments.

FIG. 68 is a block diagram illustrating an exemplary process for handling parent-child relationships during a synchronization process, according to some embodiments.

FIG. 69 is a flow diagram of an exemplary process for translating owner IDs, according to some embodiments.

FIG. 70 is a block diagram illustrating an exemplary process for merging users between applications, according to some embodiments.

FIG. 71 is a flow diagram of an exemplary process for merging users between applications, according to some embodiments.

FIG. 72 presents a block diagram of an exemplary server, according to some embodiments.

FIG. 73 presents a block diagram of an exemplary client computer system, according to some embodiments.

FIG. 74 presents a block diagram illustrating an exemplary application synchronization module, according to some embodiments.

FIG. 75 presents exemplary synchronization data structures, according to some embodiments.

FIG. 76 is a flow diagram of an exemplary process for synchronizing applications, according to some embodiments.

FIG. 77 is a flow diagram of an exemplary process for generating synchronization rules that are used to synchronize applications, according to some embodiments.

FIG. 78 is a flow diagram of an exemplary process for synchronizing applications, according to some embodiments.

FIG. 79 presents exemplary synchronization rules data structures, according to some embodiments.

FIG. 80 is a flow diagram of a process for distributing a software application, according to some embodiments.

FIG. 81 is a flow diagram of a process for distributing a software application, according to some embodiments.

FIG. 82 is a flow diagram of a process for licensing a software application, according to some embodiments.

FIG. 83 is a flow diagram of a process for distributing a software application, according to some embodiments.

FIG. 84 is a flow diagram of a process for syndicated deployment of a software application, according to some embodiments.

FIG. 85 is a flow diagram of a process for licensing and receiving payment for a software application, according to some embodiments.

FIG. 101 is an exemplary screenshot 10100 of an account user management interface.

FIG. 102 is an exemplary screenshot 10200 of an application packager.

FIG. 103 is an exemplary screenshot 10300 of an application packager.

FIG. 104 is an exemplary screenshot 10400 of an application packager.

FIG. 105 is an exemplary screenshot 10500 of an application packager.

FIG. 106 is an exemplary screenshot 10600 of an application packager.

FIG. 107 is exemplary screenshot 10700 of an application packager.

FIG. 108 is an exemplary screenshot 10800 of an application packager.

FIG. 109 is an exemplary screenshot 10900 of an application packager.

FIG. 110 is an exemplary screenshot 11000 of an application packager.

FIG. 111 is an exemplary screenshot 11100 of an application packager.

FIG. 112 is an exemplary screenshot 11200 of an application packager.

FIG. 113 is an exemplary screenshot 11300 of an application packager.

FIG. 114 is an exemplary screenshot 11400 of an account information details screen.

FIG. 115 is an exemplary screenshot 11500 of a development environment.

FIG. 116 is an exemplary screenshot 11600 of an application packager.

FIG. 117 is an exemplary screenshot 11700 of an AOP sync rules manager.

FIG. 118 is an exemplary screenshot 11800 of an AOP sync rules manager.

FIG. 119 is an exemplary screenshot 11900 of an AOP sync rules manager.

FIG. 120 is an exemplary screenshot 12000 of an AOP sync rules manager.

FIG. 121 is an exemplary screenshot 12100 of an AOP sync rules manager.

FIG. 122 is an exemplary screenshot 12200 of an integration application group manager.

FIG. 123 is an exemplary screenshot 12300 of a sync rules manager.

FIG. 124 is an exemplary screenshot 12400 of a sync rules manager.

FIG. 125 is an exemplary screenshot 12500 of a sync rules manager.

FIG. 126 is an exemplary screenshot 12600 of a sync rules manager.

FIG. 127 is an exemplary screenshot 12700 of a sync rules manager.

FIG. 128 is an exemplary screenshot 12800 of a sync rules manager.

FIG. 129 is an exemplary screenshot 12900 of a support page.

FIG. 130 is an exemplary screenshot 13000 of a product/service basic information page.

FIG. 131 is an exemplary screenshot 13100 of a staging application page.

FIG. 132 is an exemplary screenshot 13200 of an edit licensing page.

FIG. 133 is an exemplary screenshot 13300 of a setup marketing information page.

FIG. 134 is an exemplary screenshot 13400 of a setup marketing full page.

FIG. 135 is an exemplary screenshot 13500 of a setup features full page.

FIG. 136 is an exemplary screenshot 13600 of a product demo page.

FIG. 137 is an exemplary screenshot 13700 of an “Add a Blog” feed page.

FIG. 138 is an exemplary screenshot 13800 of a setup frequently asked questions (FAQs) page.

FIG. 139 is an exemplary screenshot 13900 of a setup getting started application page.

FIG. 140 is an exemplary screenshot 14000 of a support page.

FIG. 141 is an exemplary screenshot 14100 of an “About us” page.

FIG. 142 is an exemplary screenshot 14200 of a product upgrade page.

FIG. 143 is an exemplary screenshot 14300 of a “my store style” page.

FIG. 144 is an exemplary screenshot 14400 of a pricing grid and purchase/license link setup page.

FIG. 145 is an exemplary screenshot 14500 of a web services “Post Data” setup page.

FIG. 146 is an exemplary screenshot 14600 of a support page.

FIG. 147 is an exemplary screenshot 14700 of a support page.

FIG. 148 is an exemplary screenshot 14800 of a support page.

FIG. 149 is an exemplary screenshot 14900 of a support page.

FIG. 150 is an exemplary screenshot 15000 of a store product list.

FIG. 151 is an exemplary screenshot 15100 of a store listing report.

FIG. 152 is an exemplary screenshot 15200 of a store listing report.

FIG. 153 is a screenshot of an exemplary screenshot 15300 of a transactions report.

FIG. 154 is an exemplary screenshot 15400 of a support page.

FIG. 155 is an exemplary screenshot 15500 of a marketplace page.

FIG. 156 is an exemplary screenshot 15600 of a hosting and development environment.

FIG. 157 is an exemplary screenshot 15700 of a marketplace page.

FIG. 158 is an exemplary screenshot 15800 of a licensing page.

FIG. 159 is an exemplary screenshot 15900 of a support page.

FIG. 160 is an exemplary screenshot 16000 of a shopping cart page.

FIG. 161 is an exemplary screenshot 16100 of a CRM test listing page.

FIG. 162 is an exemplary screenshot 16200 of a developer toolkit page.

FIG. 163 is an exemplary screenshot 16300 of a support page.

FIG. 164 is an exemplary screen shot 16400 from the bottom portion of the screenshot 16300.

FIG. 165 is an exemplary screenshot 16500 of a support page.

FIG. 166 is an exemplary screenshot 16600 of an installation page.

FIG. 167 is an exemplary screenshot 16700 of an installation processing page.

FIG. 168 is an exemplary screenshot 16800 of an installation processing page.

FIG. 169 is an exemplary screenshot 16900 of a support page.

FIG. 170 is an exemplary screenshot 17000 of a support page.

FIG. 171 is an exemplary screenshot 17100 of a marketplace page.

FIG. 172 is an exemplary screenshot 17200 of a marketplace page.

FIG. 173 is an exemplary screenshot 17300 of a support page.

FIG. 174 is an exemplary screenshot 17400 of a support page.

FIG. 175 is an exemplary screenshot 17500 of a support page.

FIG. 176 is an exemplary screenshot 17600 of a support page.

FIG. 177 is an exemplary screenshot 17700 of a support page.

FIG. 178 is an exemplary screenshot 17800 of a support page.

FIG. 179 is an exemplary screenshot 17900 of a support page.

FIG. 180 is an exemplary screenshot 18000 of a support page.

FIG. 181 is an exemplary screenshot 18100 of a support page.

FIG. 182 is an exemplary screenshot 18200 of a marketplace homepage.

FIG. 183 is an exemplary screenshot 18300 of a marketplace page.

FIG. 184 is an exemplary screenshot 18400 of a marketplace page.

FIG. 185 is an exemplary screenshot 18500 of a marketplace page.

FIG. 186 is an exemplary screenshot 18600 of a marketplace page.

FIG. 187 is an exemplary screenshot 18700 of a marketplace page.

FIG. 188 is an exemplary screenshot 18800 of a marketplace page.

FIG. 189 is an exemplary screenshot 18900 of a marketplace page.

Like reference numerals refer to corresponding parts throughout the drawings.

### DESCRIPTION OF EMBODIMENTS

### Definitions

A Remote Procedure Call (RPC) is a programming interface that allows one program to use the services of another program in a remote machine. The calling program sends a message and data to the remote program, which is executed, and results are passed back to the calling program. Note that RPC refers to XML RPC.

A virtual host (vhost) is a server that includes multiple web sites, each with its own domain name. A <virtualhost> . . . </virtualhost> is an Apache HTTP server directive (instruction) that maps domain names to different directories (and other instructions) on the filesystem. vhosts can be used to define the boundaries of an application. Each web-based application in an account on the client computer system must have at least one virtual host in Apache. Note that there can be more than one vhost, all pointing to the same shared directory/config. Also note that other web servers have similar functions as the Apache virtualhost directive.

Vmap is a virtual database query map. A vmap is a variable map, or a field map. It maps variables (columns, fields) in one database to variables (columns, fields) in another DB.

LAMP is a solution stack of software that is used to run dynamic web sites. The LAMP solution stack typically comprises open source software. The LAMP stack can refer to a suite of software that includes LINUX, Apache HTTP server, MySQL and/or PostgreSQL, Perl, Python, Ruby, Ruby on Rails, Apache Tomcat, and/or PHP.

A solution stack is a set of software subsystems or components that are required to deliver a specified solution (e.g., product or service).

A web application or a web-based application is an application that can be accessed through the web over a network (e.g., the Internet, etc.). Web-based applications typically generate dynamic content. Dynamic content is content that can be generated when a request is received from a user. For example, a user may request scores for one or more sporting events. These scores can be retrieved and a page listing the scores can be displayed to the user. Alternatively, dynamic content can be periodically generated and cached. When a user requests the dynamic content, the cached version is displayed to the user. Web-based applications do not require distribution because they are typically hosted on an application server. Users who desire to use a web-based application can use a browser to access the application server hosting the web-based application. A client-server model requires a specialized client program that serves as a user interface to the server and that must be installed on each computer system that is to access the server application. Any upgrades to the server application typically require an update to the client application. In contrast, web-based applications use a browser engine, such as found in a web browser engine, as an interface to the application server. In general, each page delivered to the browser is a static document; however, the static document is typically composed of a number of dynamic elements that are embedded into the document prior to being delivered to the browser. Web-based applications are typically structured as a three-tier application with a browser engine at the first tier, an engine that can process dynamic content (e.g., scripting languages, etc.) in the second tier, and a database in the third tier.

### Overview

Presently, in order to receive the full functionality of a web-based application, a client computer system must be able to communicate with an application server hosting the web-based application. Although some features of a web-based application may be available while the client computer system is not connected to an application server hosting the web-based application, other features of the application server may not function properly or may not function at all if the client computer system is not connected to the application server. For example, consider a user who wants to update a contact in a web-based address book. Updating a contact in a web-based address book typically requires updating data records in a database or some other mechanism for storing and managing data (e.g., files). Typically, the database is part of the application server or accessible to the application server through a network connection. Thus, in order to update a contact in the web-based address book, the client computer system for the user must be connected to the application server hosting the web-based address book so that the update to the contact can be made to in the database.

Thus, in some embodiments, a client computer system is loaded with a framework that allows the client computer system to access web-based applications locally without requiring a network connection to an application server hosting the web-based application. This framework is referred to as the “Applications on a Plane” (AOP) framework in this specification. This framework is useful for at least traveling salespeople, drivers, business travelers (e.g., on airplanes), etc. In these embodiments, while working on the application locally, data can be added, modified, and changed without the need to be connected to the application server hosting the web-based application. The AOP framework tracks the changes and when the network connection between the client computer system and the application server is reestablished, the changes can be synchronized between the client computer system and the application server.

In some embodiments, the AOP framework can include an application server and an account management system. In some embodiments, the application server is the Etelos Application Server (EAS). In some embodiments, the account management system is the Etelos Management System (EMS). This specification may use the terms EAS and EMS in the generic sense to refer to an application server and an account management system, respectively.

In some embodiments, AOP framework installations can be split into two steps: installation of an open source stack (e.g., Apache HTTP server, PHP, PostgreSQL, MySQL, Python, etc.) and installation of the AOP framework (e.g., the EAS and EMS installation). Other software stacks can be used. For example, WAMP (Windows, Apache HTTP server, MySQL, PHP) and/or LAPP (Linux, Apache HTTP server, PostgreSQL, PHP).

In some embodiments, AOP synchronization is managed at two levels. A user-based synchronization enables the user to synchronize information that only the user is allowed to see based upon a set of user-based synchronization rules. A group administrative synchronization synchronizes all changes in the web-based application for a user that a user is allowed to see because of group administrative permissions.

In some embodiments, the AOP framework allows existing web-based applications to support offline use on a client computer system (e.g., without a connection to an application server that hosts the web-based application) without changing the architecture and code for the web-based application. For example, if a developer builds a web-based application based on the Linux, Apache HTTP server, MySQL, and PHP (LAMP) web development environment, the web-based application can be used in the AOP framework with little or no code changes. A developer can then use an administrative tool to create rules for how the web-based application is to be synchronized with client computer systems that have made changes to the web-based application while offline. Note that in prior art systems, a developer must re-architect (e.g., changing the data model) and/or recode the web-based application to be able to run on a client computer system without a network connection to an application server.

In some embodiments, the AOP framework assigns a local domain extension to a universal resource locator (URL) for a web-based application so that a user can access the web-based application on the client computer system instead of on the application server. In doing so, a user can choose when to access the web-based application locally and when to access the web-based application on the application server. For example, the local domain extension can be an “.aop” suffix that is added to the end of the URL. If the URL is http://appl.com, the modified URL is http://appl.com.aop. If a user wants to run the web-based application on the AOP framework on a client computer system, the user can access the web-based application by entering the local URL (e.g., http://appl.com.aop). Note that the “.aop” suffix is one example of a suffix that can be appended to a URL. Any other suffix can be appended to a URL. Alternatively, the URL can be modified in other ways (e.g., completely rewriting the URL, etc.) that can indicate local access is required. In some embodiments, an entry in a hosts file is added to map the URL with the appended suffix to the local client computer system. In other embodiments, an entry in a domain naming service is added to map the URL with the appended suffix to the local client computer system.

In some embodiments, a suffix is not appended to the URL. In these embodiments, the URL itself is used to direct the browser to the local web server on the client computer system. In these embodiments, an entry in the hosts file or in a DNS server on the client computer system associates the URL with the client computer system. Note that since a client computer system starts its search for an IP address associated with the URL on the client computer system, if an IP address is found in the hosts file or a local DNS server on the client computer system, the client computer system uses this IP address regardless as to whether or not another IP address (e.g., the real IP address exists).

Allowing users to make changes to web-based applications while disconnected from an application server hosting the web-based application creates several problems including synchronization of data between the client computer system and the application server. As long as the client computer system is connected to the application server, the two systems can remain synchronized with each other by periodically communicating with each other (e.g., through polling or through triggers). However, offline use of web-based applications can cause data conflicts because users can be creating, modifying, and deleting records on different instances of the web-based application. This problem is compounded by the fact that most web-based applications use automatically incrementing database identifiers to provide a unique identifier for a given database record. For example, for a user table, the user ID column may use an automatically incrementing user ID generator. When a new user is added to the user table, the database determines the next unique user ID from the automatically incrementing user ID generator. Since, each instance of the web-based application includes the automatically incrementing user ID generator that increments the next user ID independently of the other instances of the web-based application, it is possible that the user IDs between all of the instances of the web-based application are not unique. Thus, in some embodiments, the AOP framework provides a synchronization technique that can solve the above-described problems. The synchronization technique can be separate from the web-based application so that the code for the web-based application does not need to be modified. Not modifying the code is advantageous for at least the reason that rearchitecting and recoding web-based applications can be a burdensome and time-consuming process.

Most applications that are designed for the web are designed to run on a single large piece of infrastructure with shared resources. This technique allows a “software as a service” (SaaS) provider to scale the infrastructure as needed. Since many users (e.g., companies) may be using the same database separated only by differences in primary keys, control to applications and databases are set so that security is not compromised. These security models are difficult to port to existing systems that allow use of web-based applications while disconnected from an application server. However, the AOP framework solves these problems as described below. In some embodiments, the AOP framework enables users to see only their own data and not see data from other users. However, if a user is a part of an administrative group, the administrative user can see data for other users over which the administrative user has administrative rights.

In some embodiments, the AOP platform provides mechanisms for distribution of web-based applications through a marketplace. These mechanism can facilitate billing services (e.g., for purchases, subscriptions, and other licenses) and user management.

### AOP

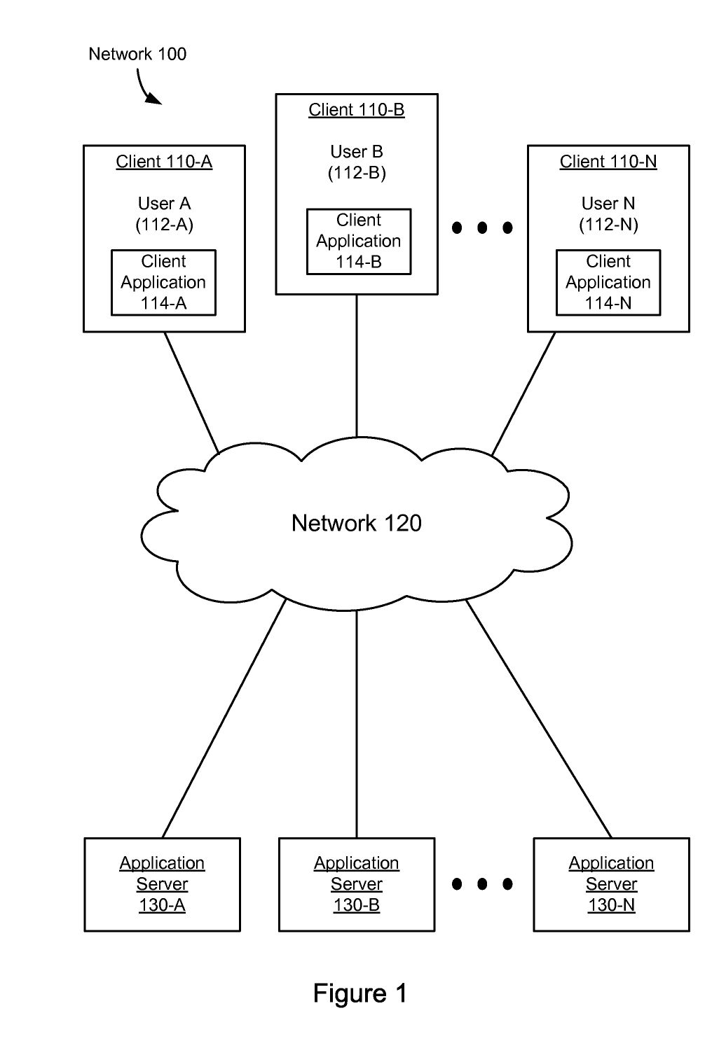

FIG. 1 presents a block diagram of network 100, according to embodiments of the present invention. Network 100 includes clients 110-A to 110-N and application servers 130-A to 130-N. Clients 110-A to clients 110-N and application servers 130-A to 130-N are connected to each other through network 120. Network 120 can include, but is not limited to, a local area network (LAN), a wide area network (WAN), the Internet, an intranet, a wireless network, a mobile network, a combination of networks, or any type of network now known or later developed. Clients 110-A to 110-N can not only communicate with application servers 130-A to 130-N through network 120, but can also communicate with each other through network 120. Similarly, application servers 130-A to 130-N can communicate with each other through network 120.

In some embodiments, application servers 130-A to 130-N include one or more web-based applications. In some embodiments, a web-based application is an application that is hosted on an application server and that can be accessed by clients that are connected to the application server through a network. Although a web-based application may have a set of functionality that can be used without a network connection to the application server hosting the web-based application, a web-based application typically has another set of functionality that cannot be used by a client computer system unless the client computer system is connected to the application server hosting the web-based application. For example, the set of functionality that requires a network connection to the application server can include functionality that requires access to data stored in a database for the web-based application.

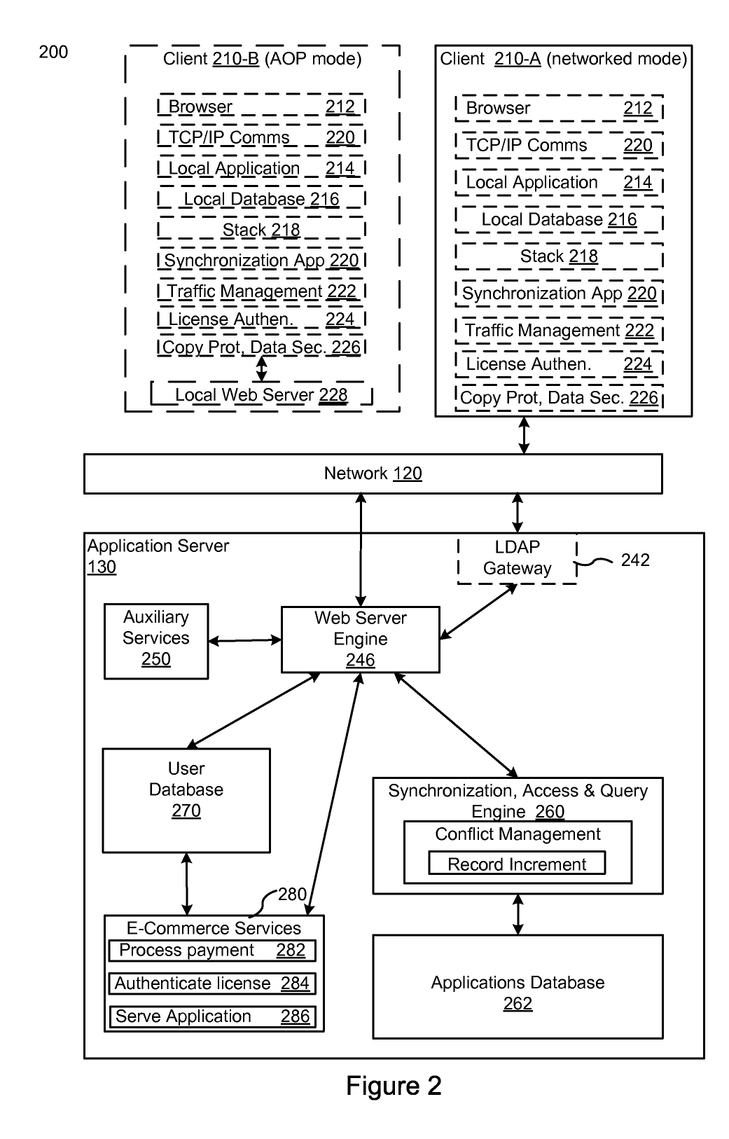

FIG. 2 presents a block diagram of network 200, according to embodiments of the present invention. Network 200 includes clients 210-A and 210-B, network 120, and application server 130. Clients 210-A and 210-B may correspond to any one of clients 110-A to 110-N illustrated in FIG. 1. Application server 130 may correspond to any one of the application servers 130-A to 130-N illustrated in FIG. 1.

Clients 210-A and 210-B include browser 212, TCP/IP communications module 220, local application 214, local database 216, stack 218, synchronization application 220, traffic management module 222, license authentication module 224, copy protection and data security module 226. Browser 212 can include any application that can access data and/or services on a remote computer system through a network (e.g., network 120). In some embodiments, browser 212 is a web browser. TCP/IP communications module 220 provides procedures and routines that allow clients 210-A and 210-B to communicate with other computer system through network 120 using the TCP/IP protocol.

Local application 214 can include any application that can be run on a client. In some embodiments, local application 214 is an instance of a web-based application that is hosted on an application server (e.g., application server 130).

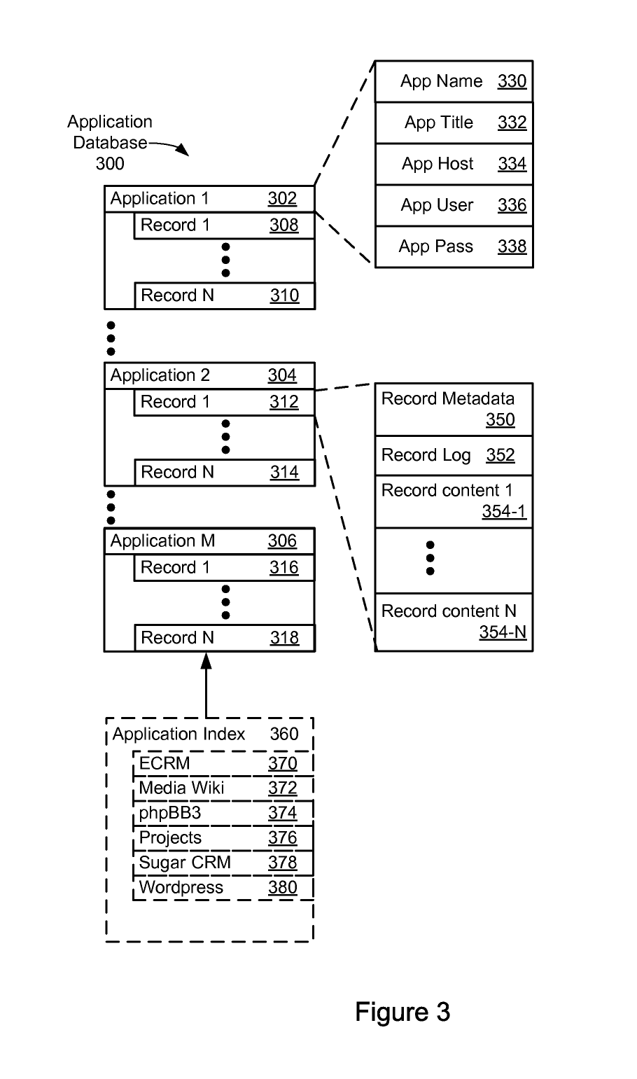

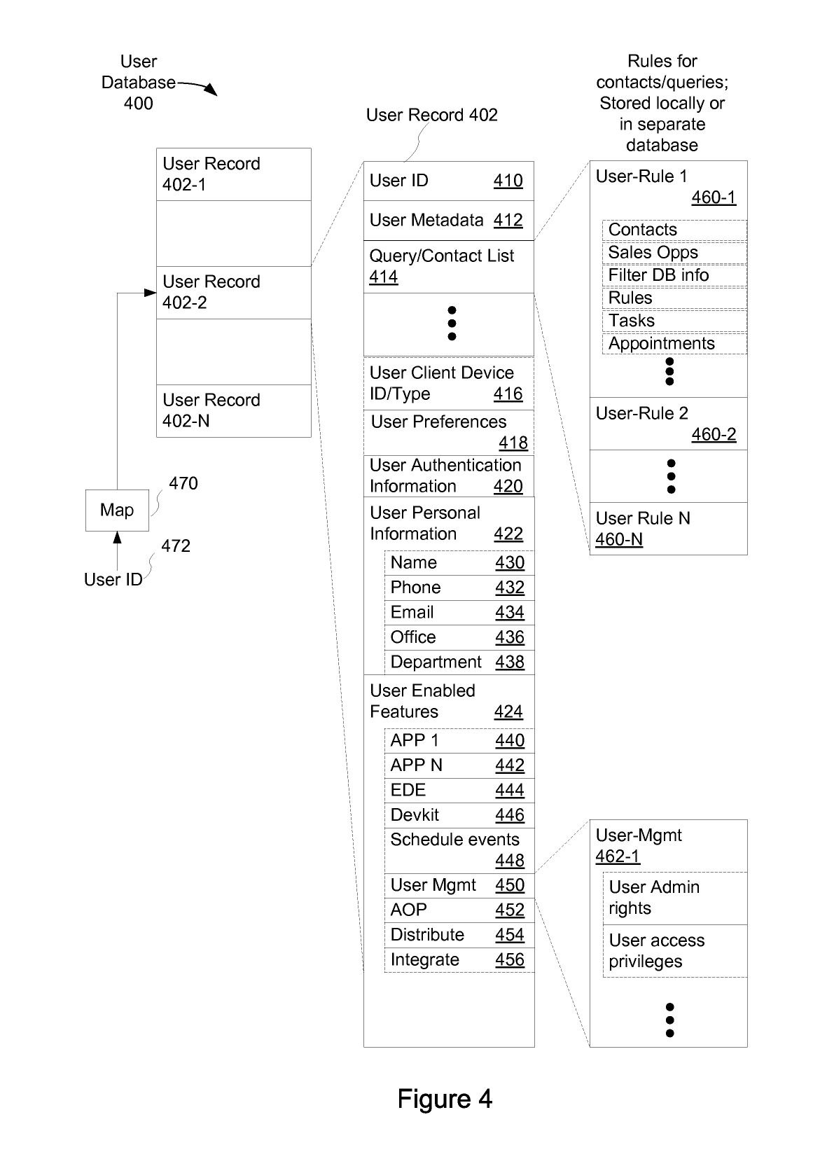

Local database 216 can include a database that can be used by local application 214. For example, local database 216 can include, but is not limited to, MySQL, PostgreSQL, ORACLE, etc. In some embodiments, local database 216 includes a user database and an application database. The user database is described in more detail below with reference to FIG. 4. The application database is described in more detail below with reference to FIG. 3.

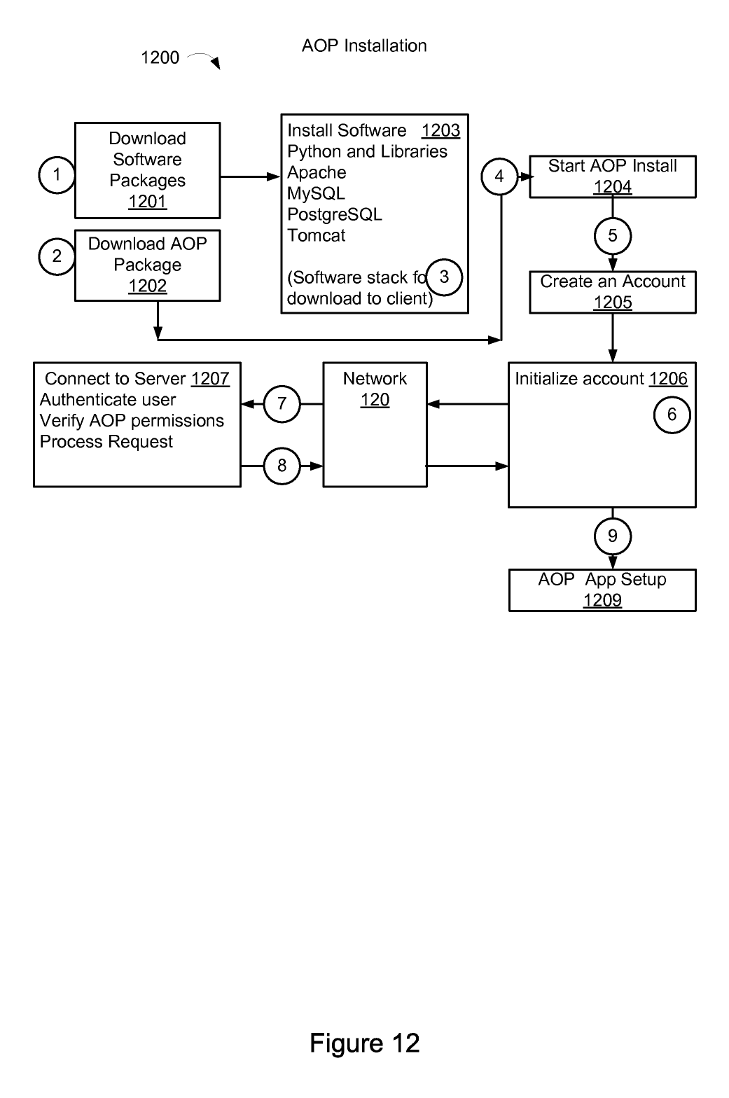

Stack 218 can include a number of software packages that enable a web-based application to run on a client. In some embodiments, the software packages can include, but are not limited to, a web server (e.g., Apache HTTP Server), a database (e.g., MySQL, PostgreSQL, ORACLE), application servers (e.g., Apache Tomcat), scripting languages (e.g., Python, Ruby, Ruby on Rails, etc.), and libraries. In some embodiments, stack 218 includes open source software (OSS) packages. In some embodiments, the OSS packages include Apache HTTP server, MySQL, PostgreSQL, Apache Tomcat, Python, and libraries. Stack 218 is described in more detail below with reference to FIG. 12.

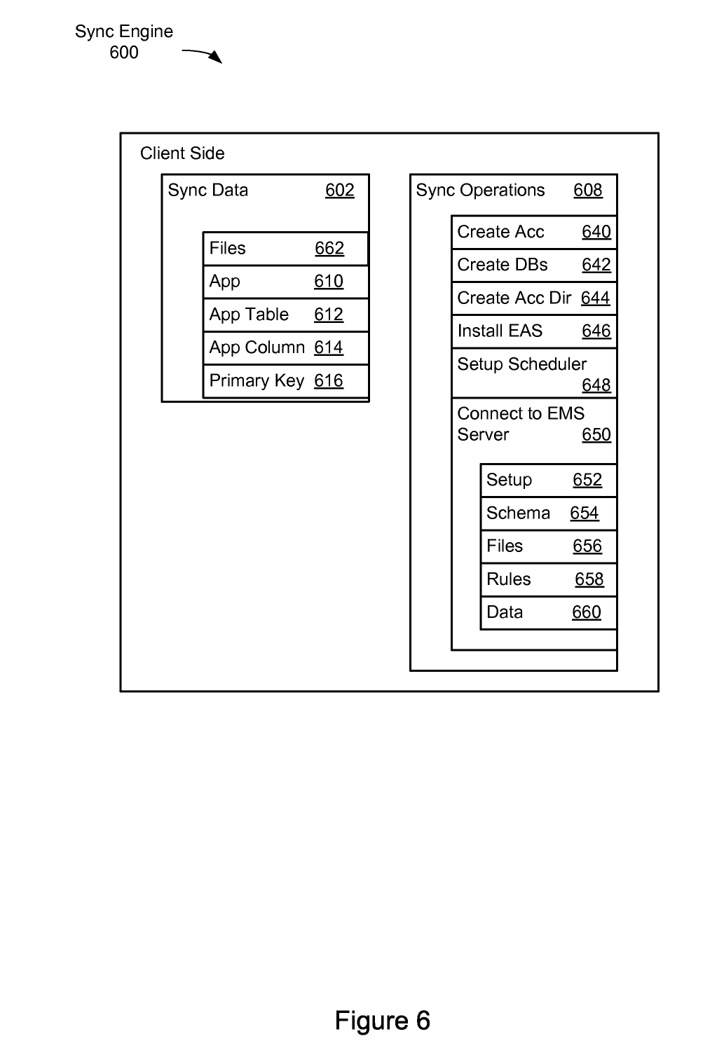

Synchronization application 220 can synchronize a web-based application that is running on a client (e.g., clients 210-B) with a corresponding web-based application running on an application server (e.g., application server 130). Synchronization application 220 is described in more detail below with reference to FIGS. 6 and 23-28.

Traffic management module 222 can manage network traffic between the client and other computer systems. For example, if a user using client 210-A enters a universal resource locator (URL) into browser 212, traffic management module determines an Internet protocol (IP) address for the URL. In some embodiments, traffic management module 222 first looks at a hosts file for client 210-A. The hosts file can map URLs to IP addresses. In some embodiments, for web-based application that are installed on client 210-A, the hosts file can include an entry that associates an IP address for client 210-A (e.g., 127.0.0.1) with the URL. If an entry for the URL exists in the hosts file, traffic management module returns the IP address associated with the URL. If an entry for the URL does not exist in the hosts file, traffic management module 222 can query a dynamic naming service (DNS) server to determine an IP address for the URL. The DNS server may be on client 210-A or may be on a remote DNS server. Note that if a network connection to a remote DNS server does not exist, the client computer system may resort to using the local hosts file and/or the local DNS server to resolve IP addresses. If an entry for the URL is found in a DNS server, traffic management module 222 returns the IP address associated with the URL. If an IP address associated with the URL is not found, an error message can be returned.

License authentication module 224 can be used to verify whether a given user or a given client can use a web-based application loaded on the given client. Copy protection and data security module 226 can protect data that is located in local database 216 and/or local application 214 from being accessed by unauthorized users. For example, copy protection and data security module 226 can protect data by using access control mechanisms to restrict access to data. Alternatively, copy protection and data security module 226 can protect data by encrypting the data. Copy protection and data security module 226 can also work with license authentication module 224 to prevent users that have expired licenses from accessing data stored in local database 216.

As illustrated in FIG. 2, client 210-B is operating in an AOP mode whereas client 210-A is operating in a networked mode. In a networked mode, a user on client 210-A can access a web-based application on application server 130 through network 120. In contrast, a user on client 210-B does not have a connection to application server 130, and thus cannot access functionality for a web-based application that requires a network connection to application server 130. However, since client 210-B has the AOP framework installed, client 210-B can operate in an AOP mode where the full functionality of web-based application (including functionality that normally requires a network connection to application server 130) is available to the user. In some embodiments, a local web server 228 runs web-based application locally. In some embodiments, local web server 228 can be part of stack 218. Note that client 210-A can also include local web server 228. If client 210-A loses a connection to network 120, client 210-A can load the AOP framework and use a local web server to run the web-based application locally until the network connection is restored.

Application server 130 can include one or more of: lightweight directory access protocol (LDAP) gateway 242, web server engine 246, auxiliary services 250, synchronization, access and query engine 260, applications database 262, user database 270, and ecommerce services 280. LDAP gateway 242 can provide directory services to clients through network 120. Note that LDAP gateway 242 is optional in some embodiments.

Web server engine 246 can respond to requests for static web pages, dynamically generated web pages, and web-based applications. These requests can come from clients (e.g., 210-A and 210-B) or from other application servers. In some embodiments, web server engine 246 is an open source web server (e.g., Apache HTTP server). Web server engine 246 can access LDAP gateway 242, auxiliary services 250, user database 270, synchronization, access, and query engine 260, and e-commerce services 280.

Auxiliary services 250 can include, but are not limited to: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and FreeType (font utilities library).

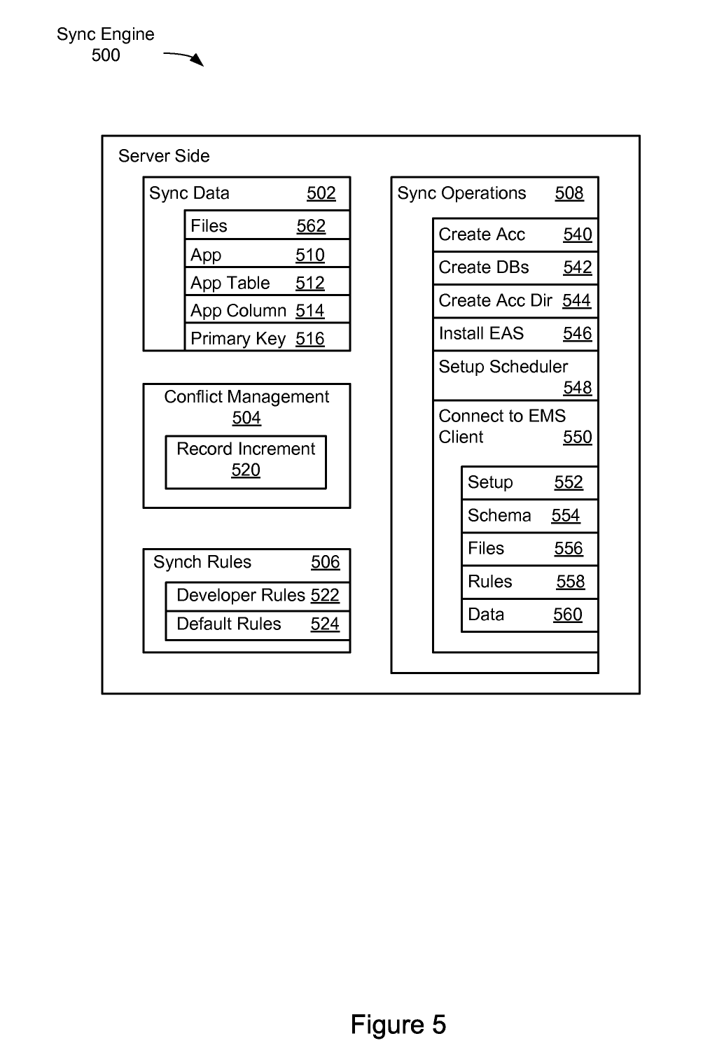

Synchronization, access, and query engine 260 can synchronize data and files between a web-based application hosted on application server 130 and a corresponding web-based application hosted on a client (e.g., clients 210-A and 210-B). Synchronization, access, and query engine 260 can include rules for conflict management and techniques for handling automatically incrementing record identifiers in a database for web-based applications. Synchronization, access, and query engine 260 can access applications database 262, which can include information about web-based applications available on the application server and can include data for the web-based applications. Synchronization, access, and query engine 260 is described in more detail below with reference to FIGS. 5 and 23-28 below. Applications database 262 is described in more detail below with reference to FIG. 3 below.

User database 270 can include information about users. In some embodiments, user database 270 can be used to track users that are allowed to access web-based applications on application server 130. User database 270 is described in more detail below with reference to FIG. 4.

E-commerce services 280 can provide payment and order fulfillment services. In some embodiments, e-commerce services 280 includes process payment module 282, authenticate license module 284, and serve application module 286. Process payment module 282 can process payments for goods and services. For example, process payment module can authorize payments by credit card, debit cards, electronic funds transfers, or other payment mechanisms (e.g., credits, prepaid tokens, etc.). Authenticate license module 284 can verify that a user has a valid license for a specified service and/or web-based application. E-commerce services 280 can access user database 270 to determine license information and/or payment information. Serve application module 286 can serve applications to a user after a product or service has been purchased or after a license has been verified.

FIG. 3 presents a block diagram of application database 300, according to embodiments of the present invention. Application database 300 includes records 302 to 306 for application 1 to application M, respectively. In some embodiments, applications 1 to application M are web-based applications hosted on an application server. Note that in general there can be any number of applications stored in applications database 300. Each application can have a number of records associated with the application.

Record 302 for application 1 can include information about an application hosted on an application server. For example, record 302 can include, but is not limited to, application name 330, application title 332, application host 334, application user 336, and application password 338. Application name 330 can be a name for the application. Application title 332 can be a title for the application. Application host 334 can be a URL and/or an IP address that is associated with the application on the application server. Application user 336 can be the user or group of users who can manage the application. Application password 338 can be a password for accessing the management features for the application on the application server. Records 304 to 306 for application 2 to application M, respectively, are similar to record 302 for application 1.

Record 1 312 for application 2 can include metadata and content for application 2. For example, record 1 312 can include, but is not limited to, record metadata 350, record log 352, and record content 1 354-1 to record content N 354-N. Record metadata 350 can include information about a given record. For example, the metadata can include, but is not limited to, the date and time the record was created, the user that created the record, and/or the IP address of the user who created the record. Record log 352 can include a log for record 312. For example, record log 352 can be used when synchronizing application 2 between the application server and a client computer system. Record content 1 354-1 to record content N 354-N can include content for record 1 312. In some embodiments, record 1 312 to record N 314 can be in the same table within application database 300. In other embodiments, record 1 312 to record N 316 are in different tables within application database 300 or in other databases linked to application database 300. The other records 308-310 and 314-318 are similar to record 312.

Application index 360 is an index to the applications available in application database 300 (e.g., applications 1, 2, . . . M). For example, applications index can include exemplary applications such as Etelos CRM (ECRM) 370, Media Wiki 372, phpBB3 374, Projects 376, Sugar CRM 378, and/or Wordpress 380.

In some embodiments, each application hosted on an application server is stored in a separate database. These separate databases can be located on the application server or on remote database servers.

Note that the discussion above is one example of an application database. The information included in the application database can include more or fewer records than what are illustrated in FIG. 3.

FIG. 4 presents a block diagram of user database 400, according to embodiments of the present invention. User database 400 includes a number of user records 402-1 to 402-N. User database 400 also includes map 470 that can map user IDs to user records. For example, as illustrated in FIG. 4, map 470 maps user ID 472 to user record 402-2.

User records 402-1 and 402-N are similar to user record 402-2. Thus, the description of user record 402-2 below applies to user records 402-1 and 402-N. User record 402-2 includes, but is not limited to, user ID 410, user metadata 412, query/contact list 414, user client device ID/type 416, user preferences 418, user authentication information 420, user personal information 422, and user enabled features 424. In some embodiments, user ID 410 can be a unique identifier for a user within user database 400. In other embodiments, user ID 410 can be a unique identifier for a user across a specified set of databases (e.g., all or a subset of the database) in the AOP framework. User metadata 412 can include metadata information about the user record. For example, the metadata information can include, but is not limited to, a date and time when the user record was created, a user who created the user record, the IP address of the user who created the user record, etc.

Query/contact list 414 can include queries that are used to retrieve contact records for a user (e.g., user-rule 1 460-1 to user-rule 460-N). The user rules can also be used to retrieve contact information, sales opportunities, filter database information, rules, tasks, appointments, and other contact-related information. For a given contact within query/contact list 414, information related to the contact can be stored in the contact records for the contact. For example, the information can include contact information for the contact (e.g., name, phone number, fax number, address, email address, etc.), action items due to the contact, a last interaction with the contact, etc.

User client device ID/type 416 can store information about the type or IDs of computer devices that the user has used to access applications on the application server. For example, user client device ID/type 416 can indicate that a user used a laptop and a PDA to access applications on the application server. This information can then be used to generate a response that is substantially optimized for the computer device that the user is using to access the application.

User preferences 418 can include preferences for the user. These preferences can be used when generating responses for the user. For example, the preferences can include, font types and sizes, color schemes, etc. User authentication information 420 can be used to authenticate a user. For example, the authentication information can be a username/password combination for the user or can be a digital certificate for the user.

User personal information 422 includes, but is not limited to, name 430, phone number 432 (e.g., home, work, mobile, pager, fax, etc.), email addresses 434, office information 436 (e.g., company name, office address, phone number, fax number, etc.), and/or department 438.

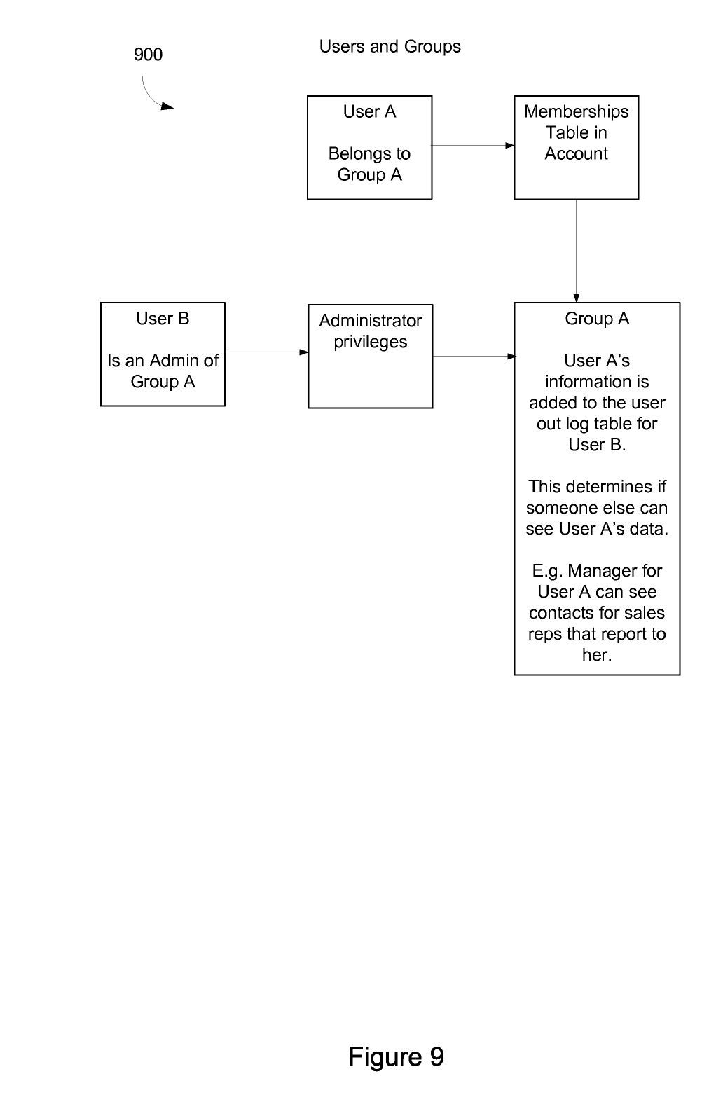

User enabled features 424 includes a list of features on the application server that have been enabled for the user. In some embodiments, user enabled features 424 are determined by the license (e.g., subscription, free, purchased, etc.) granted to the user. In some embodiments, user enabled features 424 are determined by the features that were purchased by the user. In some embodiments, user enabled features 424 are determined by the web-based applications that are available on an application server. Exemplary user enabled features 424 can include, but are not limited to, Application 1 440, Application N 442, EDE 444, Devkit 446, Schedule events 448, user management 450, AOP framework 452, distribute 454, and integrate 456. User management 450 includes a list of rights and privileges for a user. For example, user management 462-1 can include, but is not limited to, administrative rights and access privileges for the user associated with user record 402-2. In some embodiments, these rights and privileges can be determined based on the applications available for the user and/or user enabled features 424. Note that user admin rights and access privileges are described in more detail below with reference to FIG. 9.

Note that the information in the user records can be located within one or more tables of user database 400 and/or in other associated databases. Also note that the discussion above is one example of a user database. The information included in the user database can include more or fewer records than what are illustrated in FIG. 4.

In some embodiments, user database 400 is a distributed database. In some embodiments, user databases 400 can be located on the application server or on remote database servers.

FIG. 5 presents a block diagram of synchronization engine 500 on an application server, according to embodiments of the present invention. Synchronization engine 500 includes a synchronization data module 502, a conflict management module 504, synchronization rules 506, and synchronization operations 508.

Synchronization data module 502 includes data used by synchronization engine 500 to synchronize a web-based application on a client computer system with a web-based application on the application server. As illustrated in FIG. 5, synchronization data module 502 includes files 562, application 510, application table 512, application column 514, and primary key 516.

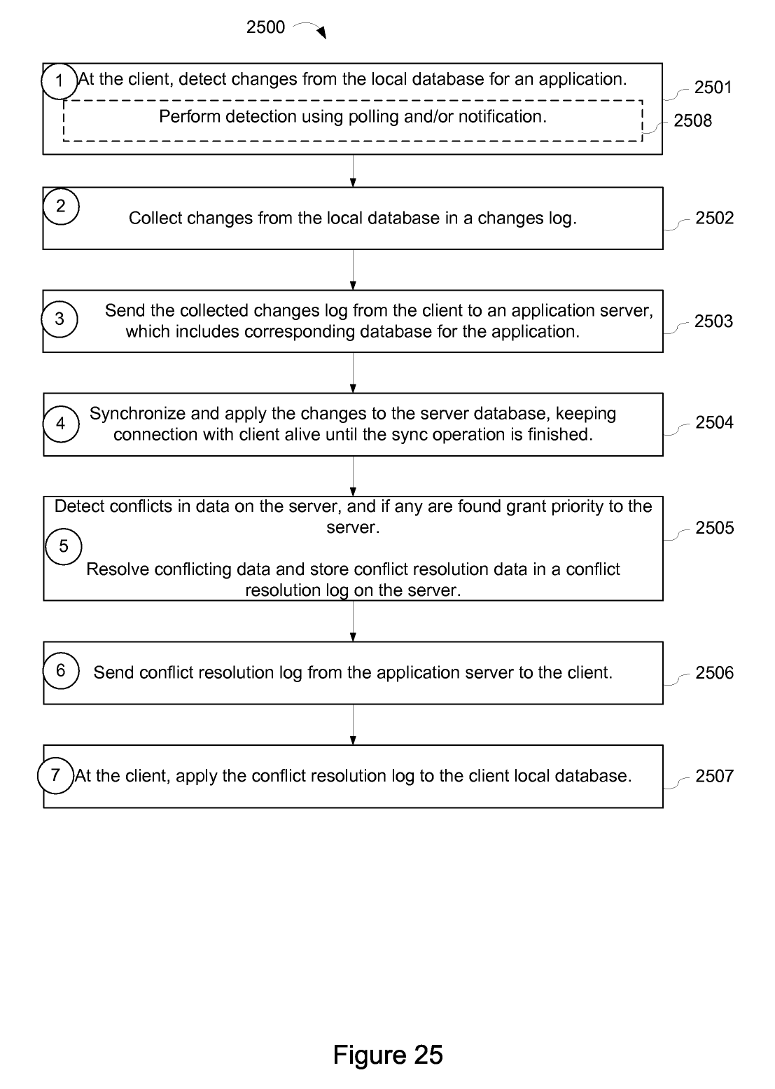

Conflict management module 504 resolves conflicts between the application server and client computer systems. These conflicts can arise when client computer systems operate web-based applications while not connected to the application server. For example, if a web-based application uses an automatically incrementing identifier for database records, client computer systems that are not connected to the application server can unknowingly use the same identifiers as the application server for different data resulting in data conflicts. Thus, in some embodiments, a record increment module 520 is provided to resolve conflicts for web-based application that use automatically incrementing identifiers for database records. Conflict management module 504 and record increment module 520 are described in more detail below with reference to FIGS. 25-28 below.

Synchronization rules 506 are rules used by synchronization engine 500 to determine how to synchronize records between a client computer system and an application server. These rules can include developer specified rules 522 and default rules 524.

Synchronization operations module 508 includes, but is not limited to, create accounts module 540, create databases module 542, create account directories module 544, install EAS module 546, setup scheduler module 548, and connect to EMS client 550. Create accounts module 540 can be used to create accounts for web-based applications. Create databases module 542 can be used to create the databases for web-based applications and the AOP framework. Create account directories 544 can be used to create the directory structure of web-based applications. Install EAS module 546 can be used to install an application server that can be used to serve web-based applications to clients. In some embodiments, the application server module is the Etelos Application Server (EAS) module. Setup schedule module 548 can setup a synchronization schedule between the application server and client computer systems.

Connect to EMS client module 550 can be used to connect an application server with the EMS module on a client computer system. Connect to EMS client module 550 can send data to an EMS module on the client computer system to synchronize the web-based application between the application server and the client computer system. The data can include, but is not limited to, setup data 552, schema 554, files 556, rules 558, and/or data 560.

FIG. 6 presents a block diagram of synchronization engine 600 on a client computer system, according to embodiments of the present invention. The modules in synchronization engine 600 perform similar functions as the modules in synchronization engine 500. For example, synchronization data module 602 generally corresponds to synchronization data module 502 and synchronization operations 608 generally corresponds to synchronization operations 508. As a result, the discussion above for synchronization engine 600 is not repeated.

In some embodiments, the file structures for a web-based application in the application server and the client computer system are similar.

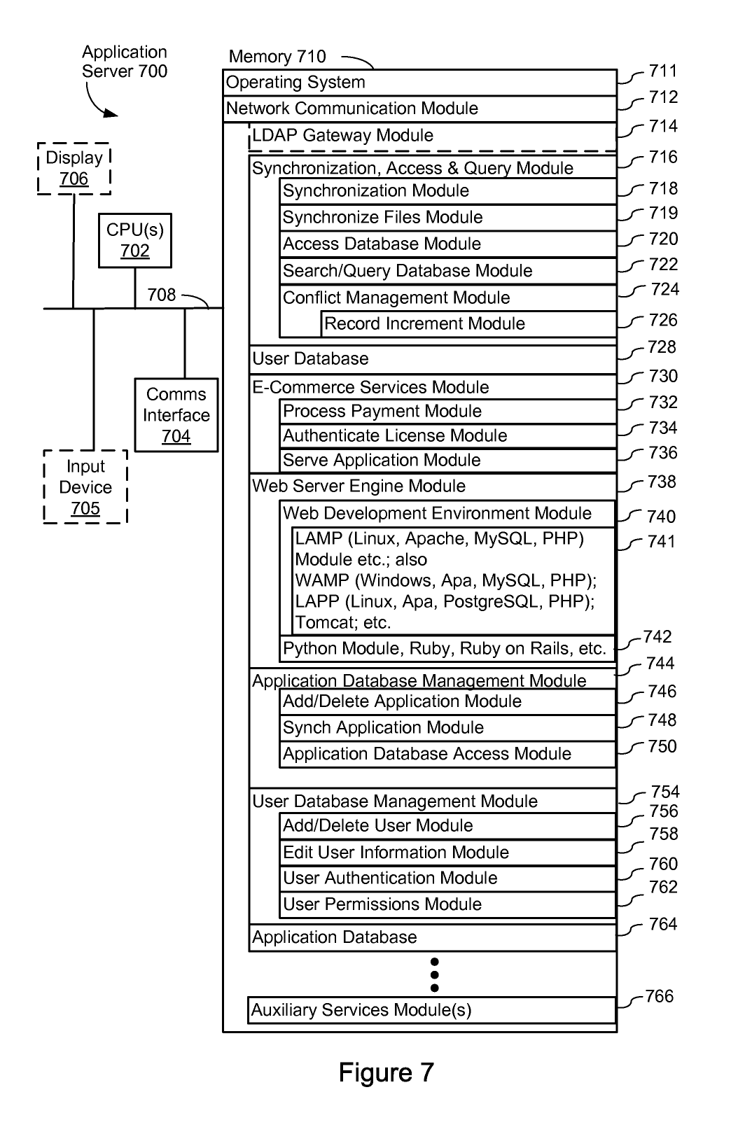

FIG. 7 presents a block diagram of application server 700, according to embodiments of the present invention. The application server 700 generally includes one or more processing units (CPU's) 702, one or more network or other communications interfaces 704, memory 710, and one or more communication buses 708 for interconnecting these components. The communication buses 708 may include circuitry (sometimes called a chipset) that interconnects and controls communications between system components. The application server 700 may optionally include a display 706 and one or more input devices 705 (e.g., keyboard, mouse, trackpoint, etc.). Memory 710 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 710 may optionally include one or more storage devices remotely located from the CPU(s) 702. Memory 710, or alternately the non-volatile memory device(s) within memory 710, comprises a computer readable storage medium. In some embodiments, memory 710 stores the following programs, modules and data structures, or a subset thereof: operating system 711, network communication module 712, LDAP gateway module 714 (optional), synchronization, access and query module 716, user database 728, e-commerce services module 730, web server engine module 738, application database management module 744, user database management module 754, application database 764, and/or auxiliary services modules 766.

Operating system 711 includes procedures for handling various basic system services and for performing hardware dependent tasks. Network communication module 712 can be used for connecting the application server 700 to other computers via the one or more communication network interfaces 704 (wired or wireless) and one or more communication networks, such as the Internet, other wide area networks, local area networks, metropolitan area networks, and so on. LDAP gateway module 714 can provides directory services for application server 700 and other computer systems. In some embodiments, LDAP gateway module 714 is optional.

Synchronization, access, and query module 716 can provides synchronization procedures to synchronize a web-based application on a client computer system with a web-based application on an application server. Synchronization, access, and query module 716 includes one or more of synchronization module 718, synchronization files module 719, access database module 720, query database module 722, and/or conflict management module 724. Synchronization module 718 can perform synchronization operations between a client computer system and application server 700. Synchronization files module 719 synchronizes files between the client computer system and application server 700. Access database module 720 performs read (e.g., select operations) and write operations (e.g., insert, update, and delete operations) on databases. Query database module 722 performs queries in the databases and returns results of the query. Conflict management module 724 resolves conflicts between application server 700 and client computer systems. Conflict management module 724 can include record increment module 726, which can handle conflicts that arise from automatically incrementing identifiers for database records.

User database 728 includes user information as described above with reference to FIGS. 2 and 4. Application database 764 includes application data as described above with reference to FIGS. 2 and 3.

E-commerce services module 730 can provide electronic commerce services. E-commerce services module 730 includes one or more of process payment module 732, authenticate license module 734, serve application module 736. E-commerce services module 730 is described in more detail above with reference to FIG. 2.

Web server engine module 738 can serve web pages to client computer system or other application servers. In some embodiments, web server engine module 738 includes web development environment module 740, which provides software and tools to build and serve web-based applications. In some embodiments, web development environment module 740 is LAMP module 741, which includes the LINUX operating system, Apache HTTP server, the MySQL database management system, and the PHP scripting language.

The components of LAMP module 741 can be substituted for other compatible technologies. In general, LAMP module 741 includes an operating system, a web server, a database, and support for a scripting language. For example, LAMP module 741 can include WAMP (Windows, Apache HTTP, MySQL, PHP) and/or LAPP (Linux, Apache HTTP, PostgreSQL, PHP). LAMP module 741 can also include Apache Tomcat. In some embodiments, web server engine module 734 includes a Python module 742 that supports the Python scripting language. Optionally, Python module 742 can also support Ruby, Ruby on rails, and/or any other languages.

Application database management module 744 provides an interface to manage and access an applications database for web-based applications that are hosted on application server 700. Application database management module 744 can include an add/delete application module 746, a synchronize application module 748, and an application access module 750. Add/delete application module 746 allows for the addition or deletion of web-based application records in application database 764 on application server 700. Synchronize application module 748 synchronizes applications database 764 with an application database on a client computer system. Application access module 750 determines whether a user is allowed to access a given application within application server 700.

User database management module 754 provides an interface to manage and access a user database for web-based applications that are hosted on application server 700. Users database management module 754 can include an add/delete user module 756, an edit user information module 758, a user authentication module 760, and/or a user permissions module 762. Add/delete user module 756 allows for the addition or deletion of users in user database 728 on application server 700. Edit user information module 758 allows for the editing of user information in user database 728. User authentication module 760 authenticates users by checking user credentials stored in user database 728 (e.g., by checking a username and password for a user, or a digital certificate). User permissions module 762 determines whether a user is allowed to access specified resources and/or applications within application server 700.

Auxiliary services module(s) 766 includes, but is not limited to: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and FreeType (font utilities library).

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 710 may store a subset of the modules and data structures identified above. Furthermore, memory 710 may store additional modules and data structures not described above.

Although FIG. 7 shows an “application server,” FIG. 7 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 7 could be implemented on single servers and single items could be implemented by one or more servers. The actual number of servers used to implement an application server and how features are allocated among them will vary from one implementation to another, and may depend in part on the amount of data traffic that the system must handle during peak usage periods as well as during average usage periods.

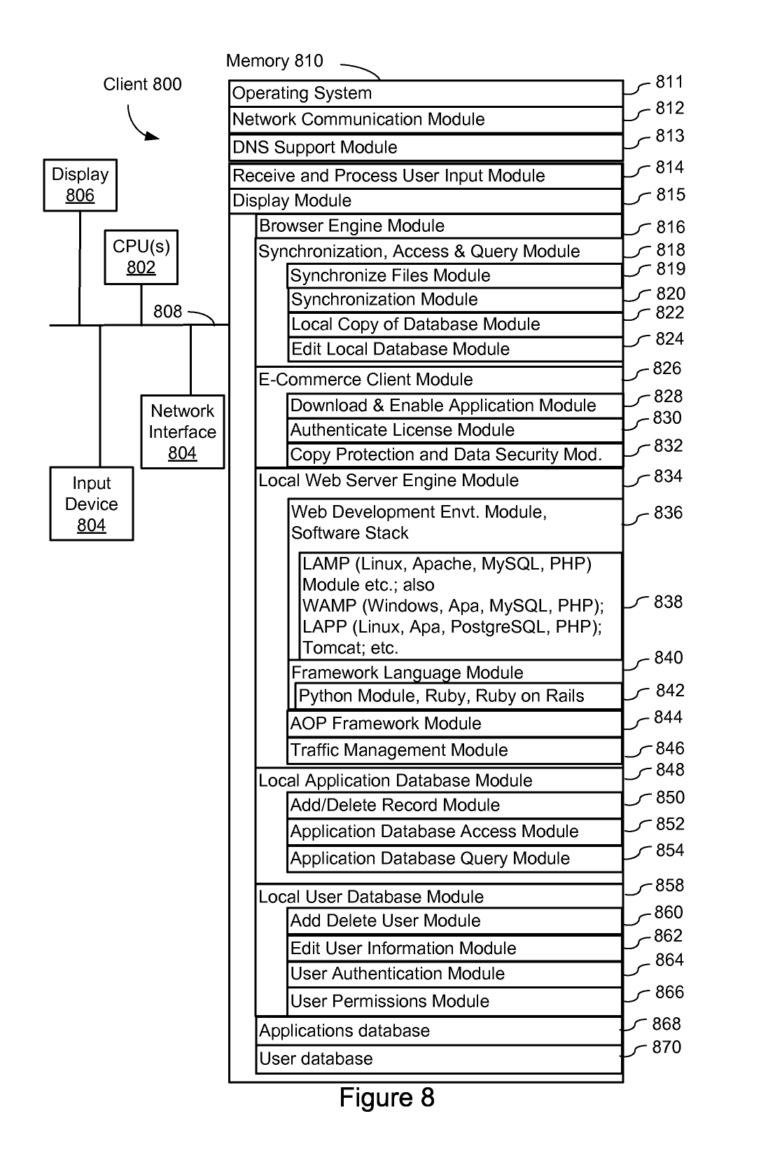

FIG. 8 presents a block diagram of client 800, according to embodiments of the present invention. The client 800 generally includes one or more processing units (CPU's) 802, one or more network or other communications interfaces 804, memory 810, and one or more communication buses 808 for interconnecting these components. The communication buses 808 may include circuitry (sometimes called a chipset) that interconnects and controls communications between system components. The client 800 includes a display 806 and one or more input devices 805 (e.g., keyboard, mouse, trackpoint, etc.). Memory 810 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 810 may optionally include one or more storage devices remotely located from the CPU(s) 802. Memory 810, or alternately the non-volatile memory device(s) within memory 810, comprises a computer readable storage medium. In some embodiments, memory 810 stores the following programs, modules and data structures, or a subset thereof: operating system 811, network communication module 812, DNS support module 813, receive and process user input module 814, display module 815, browser engine module 816, synchronization, access and query module 818, e-commerce client module 826, local web server engine module 834, local application database module 848, local user database management module 858, application database 868, and/or user database 870.

Operating system 811 includes procedures for handling various basic system services and for performing hardware dependent tasks. Network communication module 812 can be used for connecting the client 800 to other computers via the one or more communication network interfaces 804 (wired or wireless) and one or more communication networks, such as the Internet, other wide area networks, local area networks, metropolitan area networks, and so on. DNS support module 813 provides DNS services for client 800. Receive and process user input module 814 receives and processes user inputs received from input devices 805. Display module 815 displays a user interfaces for applications running on client 800. Browser engine module 816 can include any application with a rendering engine that can access data and/or services on a local or a remote computer system and render the results so that a user can view the data and/or interact with the services. In some embodiments, browser engine module 816 is a web browser.

Synchronization, access, and query module 818 can provides synchronization procedures to synchronize a web-based application on a client computer system with a web-based application on an application server. Synchronization, access, and query module 818 includes one or more of synchronize files module 819, synchronization module 820, local copy of database module 822, and edit local database module 824. Synchronization module 820 can perform synchronization operations between client 800 and an application server. Local copy of database module 822 makes a local copy of databases located on an application server. Edit local database module 824 provides an interface to edit the local copy of the databases.

E-commerce client module 826 can provide electronic commerce services that enable use of web-based applications on client 800. E-commerce client module 826 includes one or more of download and enable application module 828, authenticate license module 830, and/or copy protection and data security module 832. Download and enable application module downloads and enables web-based applications from an application server. Authenticate license module 830 determines whether the license for a web-based application is valid. If so, a user is allowed to access the web-based application. Otherwise, a user is prevented from accessing the web-based application. Copy protection and data security module 832 can protect data that is located in local databases (e.g., an application database or a user database) from being accessed by unauthorized users. Copy protection and data security module 832 can work with authenticate license module 830 to prevent users that have expired licenses from accessing data stored in local databases.

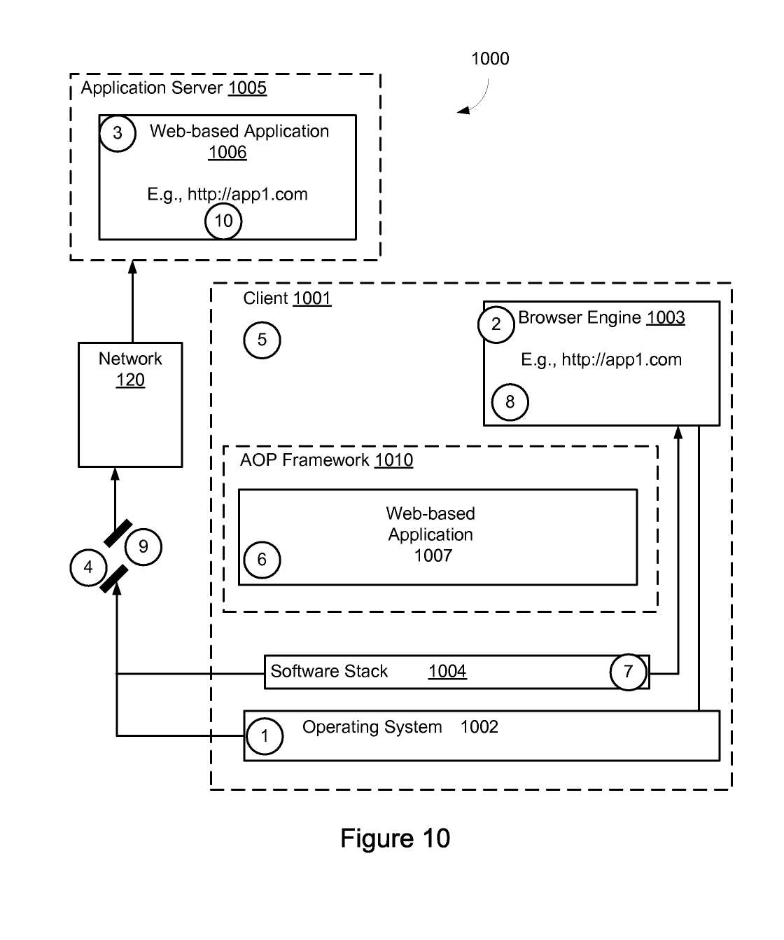

Local web server engine module 834 can serve web pages to client 800 or to other computer systems. In some embodiments, local web server engine module 834 includes web development environment module 836, framework language module 840, AOP framework module 844, and/or traffic management module 846. Web development environment module 836 provides software and tools to build and serve web-based applications. In some embodiments, web development environment module 840 includes a number of open source software (OSS) packages. Thus, web development environment module is sometimes referred to as a software stack. In some embodiments, web development environment module 836 includes LAMP module 838, which includes the LINUX operating system, Apache HTTP server, MySQL database management system, and support for the PHP scripting language and Apache Tomcat. The components of LAMP module 838 can be substituted for other compatible technologies (e.g., WAMP, LAPP, etc.). In general, LAMP module 838 includes an operating system, a web server, a database, and support for a scripting language. Framework language module 840 provides support for one or more programming languages used to implement the AOP framework. In some embodiments, framework language module 840 includes python module 842 which supports the Python, Ruby, and/or Ruby on Rails scripting language. AOP framework module 844 provides data structures and procedures for running web-based applications on a client computer system (e.g., client 800). AOP framework module 844 is described in more detail below with reference to FIGS. 10-28. Traffic management module 846 manages network traffic between client 800 and other computer systems. Traffic management module 846 is described in more detail above with reference to FIG. 2.

Local application database management module 848 provides an interface to manage and access applications database 868 for web-based applications that are hosted on client 800. Local application database management module 848 can include an add/delete record module 850, an application database access module 852, and/or an application database query module 854. Add/delete record module 850 allows for the addition or deletion of web-based application records in application database 868. Application database access module 852 performs reads and writes into application database 868. For example, application database access module 852 can process requests for retrieving data, adding records, deleting records, and editing records. Application database query module 854 performs queries on and returns results from application database 868.

Local user database management module 858 provides an interface to manage and access user database 870 for web-based applications that are hosted on client 800. Local user database management module 858 can include an add/delete user module 860, an edit user information module 862, a user authentication module 864, and/or a user permissions module 866. Add/delete user module 860 allows for the addition or deletion of users in user database 870. Edit user information module 862 allows for the editing of user information in users database 868. User authentication module 864 authenticates users by checking user credentials stored in user database 870 (e.g., by checking a username and password for a user, or a digital certificate). User permissions module 866 determines whether a user is allowed to access specified resources and/or applications within client 800.

Auxiliary services module(s) 864 includes, but is not limited to: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and/or FreeType (font utilities library).

Application database 868 is described in more detail above with reference to FIGS. 2 and 3 above. User database 870 is described in more detail above with reference to FIGS. 2 and 4 above.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 810 may store a subset of the modules and data structures identified above. Furthermore, memory 810 may store additional modules and data structures not described above.

### AOP Framework

FIG. 10 presents a block diagram 1000 of exemplary AOP framework 100 which provides offline access to web-based application 1006, according to embodiments of the present invention. In some embodiments, client computer system 1001 is coupled to application server 1005 through network 120. Network 120 can include, but is not limited to, a local area network (LAN), a wide area network (WAN), the Internet, a mobile network, and/or a wireless network. Client computer system 1001 includes operating system 1002, browser 1003, and AOP framework 1010. As illustrated in FIG. 1, AOP framework 1010 includes software stack 1004 and web-based application 1007. Software stack 1004 may be comprised of open source software, commercial software, or a combination of both. Note that the details of AOP framework 1010 are described in more detail below with reference to FIGS. 10B-28 below. Application server 1005 includes web-based application 1006.

Consider a user who wants to access web-based application 1006 located on application server 1005. For example, the URL for the web-based application can be http://appl.com. The user can use browser engine 1003 on client computer system 1001 to access the URL http://appl.com. When client computer system 1001 has a network connection with application server 1005, application server 1005 can activate web-based application 1006 to respond to the request from browser engine 1003.

On a client computer system without AOP framework 1010, the user can only access the full functionality of web-based application 1006 when there is a network connection between the client computer system and application server 1005. However, since client computer system 1001 includes AOP framework 100, the user can access the full or substantially the full functionality of web-based application 1006 when there is no network connection between client computer system 1001 and the application server 1005. As illustrated in FIG. 1, AOP framework 1010 includes web-based application 1007, which is a local instance of web-based application 1006. Software stack 1004 provides the software required to execute web-based application 1006 on client computer system 1001. In some embodiments, Software stack 1004 is the same set of software used on application server 1005 to run web-based application 1006.

When client computer system 1001 does not have a network connection with application server 1005, AOP framework 1010 can allow the user to continue having access to the functionality of web-based application 1006 by activating web-based application 1007 on client computer system 1001. Note that the loss of a network connection with application server can result from the user manually disconnecting the network connection (e.g., through software or hardware) or can be a result of external factors (e.g., power outages, network outages, etc.). In some embodiments, AOP framework 1010 automatically activates web-based application 1007 when the network connection to application server 1005 no longer exists. In other embodiments, after the network connection to application server 1005 no longer exists, AOP framework 1010 waits for the user to indicate that web-based application 1007 should be activated.

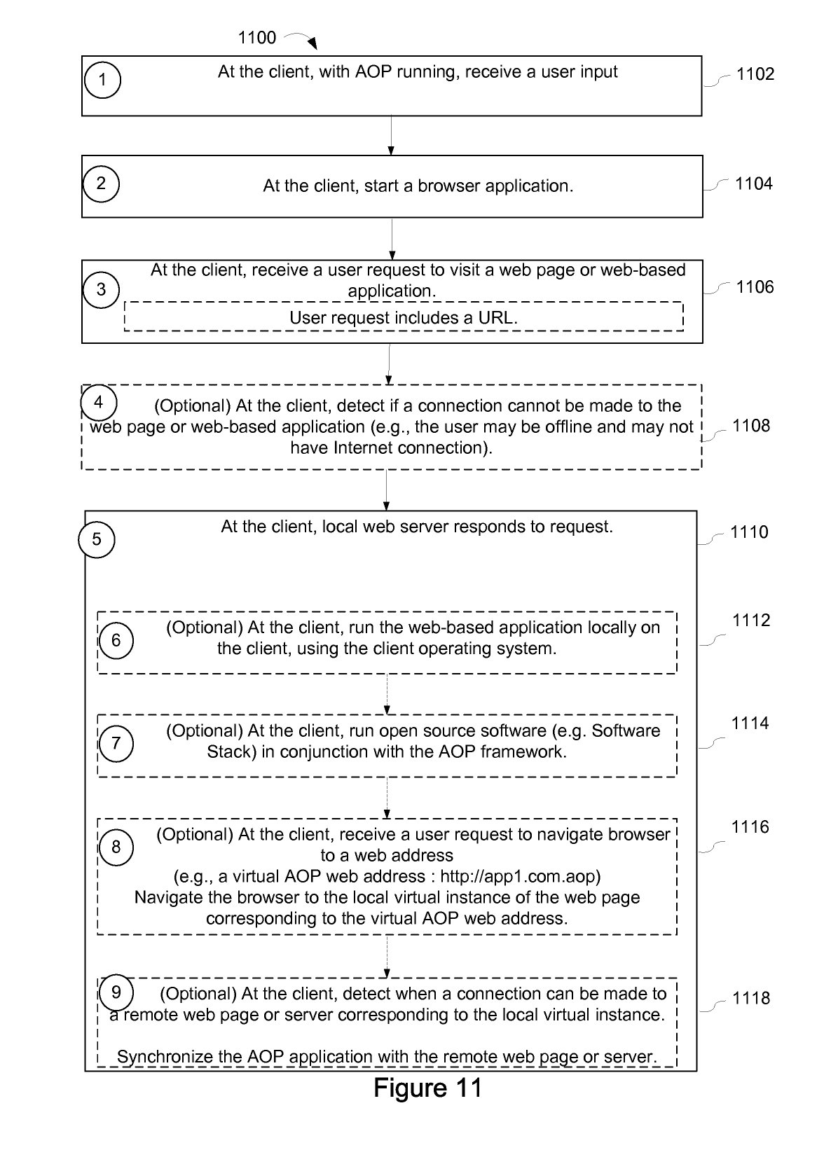

FIG. 11 illustrates an exemplary process 1100 of using AOP framework 1010 to run web-based application 1006 while offline, according to embodiments of the present invention. Note that FIG. 11 corresponds to the block diagram in FIG. 10. The process begins when client computer system 1001 receives an input from a user (1102). Client computer system 1001 starts a browser application (1104). Client 1001 then receives a user request to visit a web page or an application (1106). The user request can include a URL. Optionally, client computer system 1001 then detects if a connection cannot be made to the web page or the application (1108). For example, the user may be offline and may not have an Internet connection. If the connection cannot be made, then a web server on client computer system 1001 responds to the request (1110). Client computer system 1001 can then perform one or more of the optional steps 1112-1118. Client computer system 1001 can run the application locally using the client's operating system (1112). Client computer system 1001 can run the software in conjunction with the AOP framework (1114). Client computer system 1001 can receive a user request to navigate the browser to a web address (e.g., a URL). For example, the URL can be http://appl.com.aop. Note that the extension “.aop” can be replaced with any other extension. AOP framework 1010 can then respond to the request for the specified URL and activates web-based application 1007 to respond to the request. Client computer system 1001 can then detect when a connection can be made to a remote web page or a server corresponding to the local virtual instance (e.g., application server 1005) (1118). When the network connection between client computer system 1001 and application server 1005 is reestablished, any changes made in web-based application 1007 on client computer system 1001 can be synchronized with web-based application 1006 on application server 1005. In some embodiments, client computer system 1001 is synchronized with application server 1005 using Network 120.

In some embodiments, the AOP framework modifies the operating system's network hosts file so that application domains ending with a specified domain suffix are treated as local domains served by a local web server. For example, if the specified domain suffix is “.aop”, an application may have the universal resource locator (URL) “appl.com.aop”. In some embodiments, the local web server is on the same client computer system as the client computer system running the AOP framework. For example, if the AOP framework is running on a laptop, the laptop may also include a local web server.

In some embodiments, when a user attempts to use a browser to access an application that has the specified domain suffix, the request is handled by a local web server and control is delegated to the application associated with the domain name on the client computer system.

In some embodiments, the AOP framework supports web application development languages including, but not limited to, PHP, Python, Ruby, and/or Ruby on Rails.

In some embodiments, the AOP framework determines all local changes made to applications on the client computer system and synchronizes these changes with the application server. In some embodiments, the synchronization is performed on a predetermined frequency. In other embodiments, the synchronization is performed on demand.

### AOP Installation

The AOP framework enables web-based applications to run locally without requiring a network connection to an application server hosting the web-based application. As a result, some embodiments install software packages on a client computer system. These software packages can include, but are not limited to a web server (e.g., Apache HTTP Server), a database (e.g., MySQL, PostgreSQL), application servers (e.g., Apache Tomcat), scripting languages (e.g., Python), and libraries. In some embodiments, the software package includes Apache HTTP server, MySQL, PostgreSQL, Apache Tomcat, Python, and libraries. In other embodiments, the software packages are included in the package for the AOP framework.

FIG. 12 presents a block diagram 1200 of an exemplary process of installing an instance of an AOP framework on a client computer system, according to embodiments of the present invention. The installation process includes downloading OSS packages (1201) and an AOP package (1202), installing the software packages (1203), installing the AOP package (1204), creating an account (1205), initializing an account (1206), connecting to the application server (1207), downloading application files from the application server (e.g., using RPC and SVN through Network 120), and setting up an AOP application on the client computer system (1209).

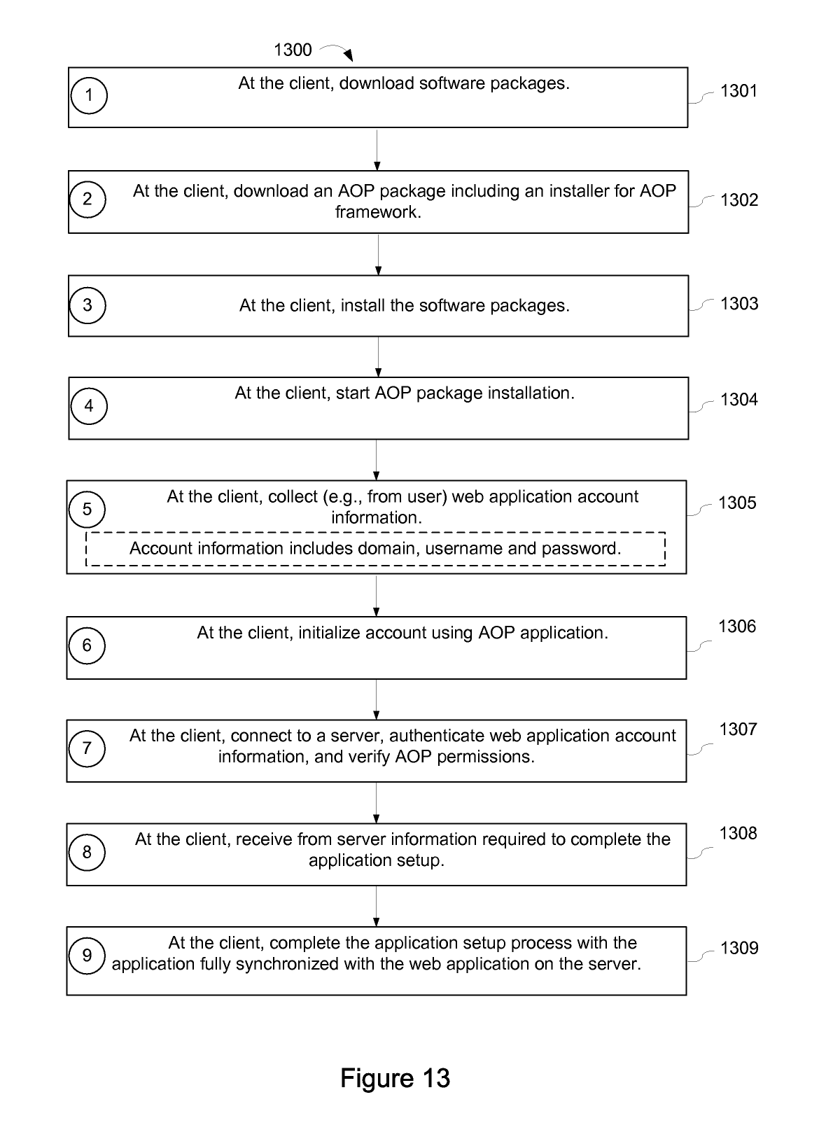

FIG. 13 illustrates an exemplary process 1300 of installing an instance of an AOP framework on a client computer system, according to embodiments of the present invention. Note that FIG. 13 corresponds to the block diagram in FIG. 12. The process begins when a user downloads software packages (1301). The software packages can be included in a single compressed file. The user also downloads the AOP framework package (1302). The AOP framework package can be included in a compressed file. In some embodiments, the AOP framework package includes an installation utility.

The user then installs the software packages on the client computer system (1303). If the software packages are already installed on the client computer system, the software packages are not reinstalled. In some embodiments, if the software packages are already installed on the client computer system, the versions of the software packages installed on the client computer system are determined. The software packages are either updated or not updated based on the determined versions. For example, if a minor software version update occurred for a software package installed on the client computer system, the minor software version update may not be applied. In some embodiments, if the software packages are already installed on the client computer system, the software packages may periodically check for updates and apply the updates according to a set of rules. For example, the set of rules can specify that certain software packages can be updated without user intervention whereas others require specified instructions from users and/or the developers of the web-based application. After the software packages are installed, the user starts the AOP package installation process (1304). The AOP package installation process installs the AOP framework. During the installation process, the user enters account information about web-based applications that the user desires to use (1305). For example, the account information can include one or more of universal resource locator (URL) for the web-based application, a username, and a password.

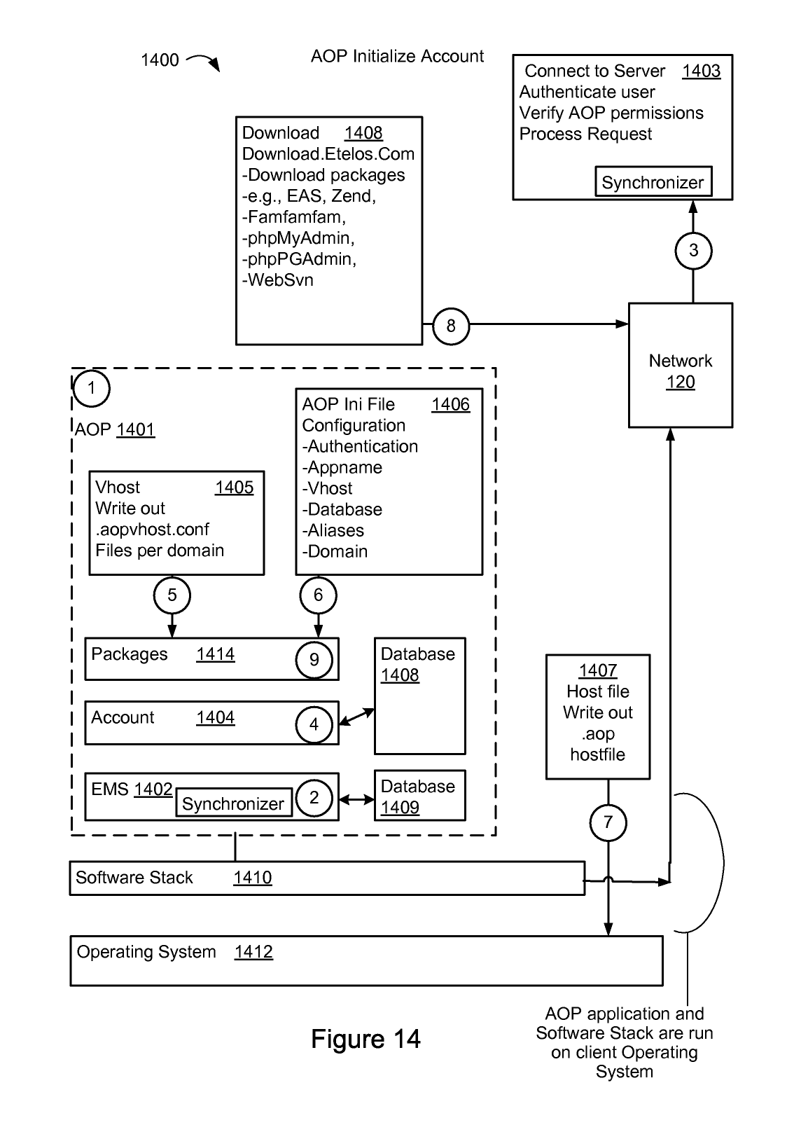

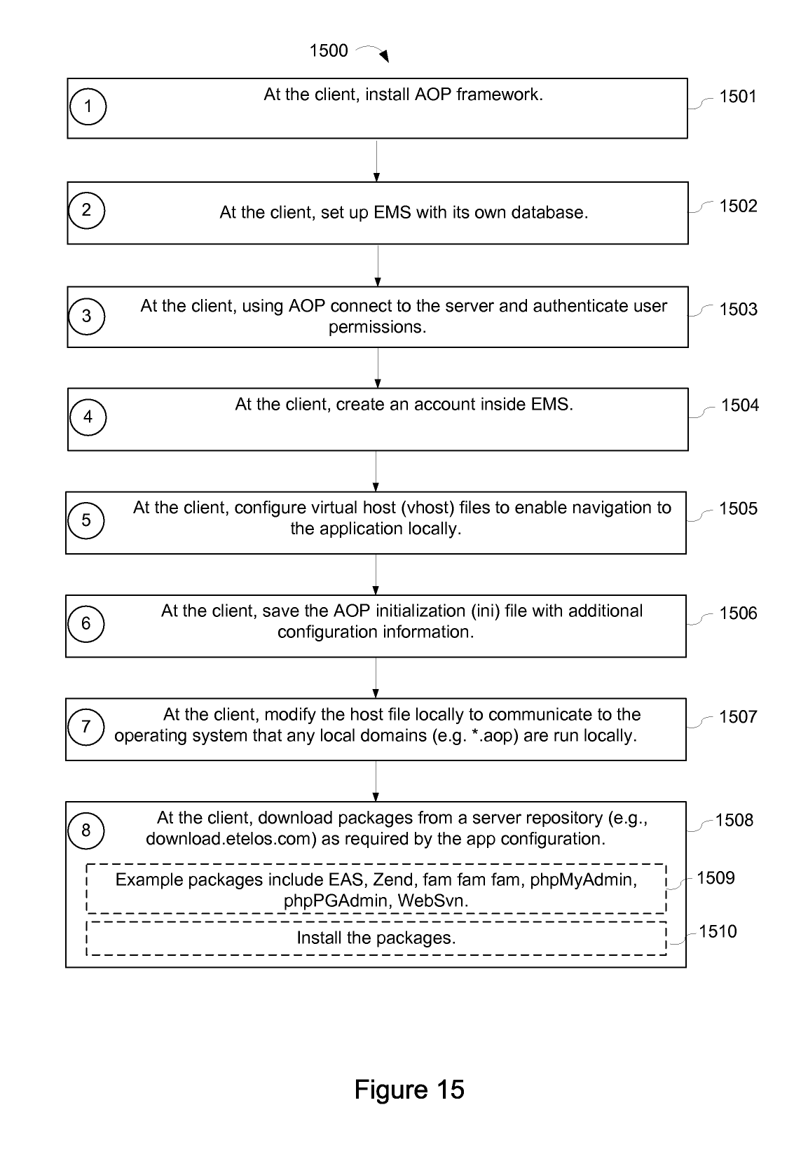

The AOP framework then initializes the account (1306). The account initialization operation is described in more detail with reference to FIGS. 14-15 below.

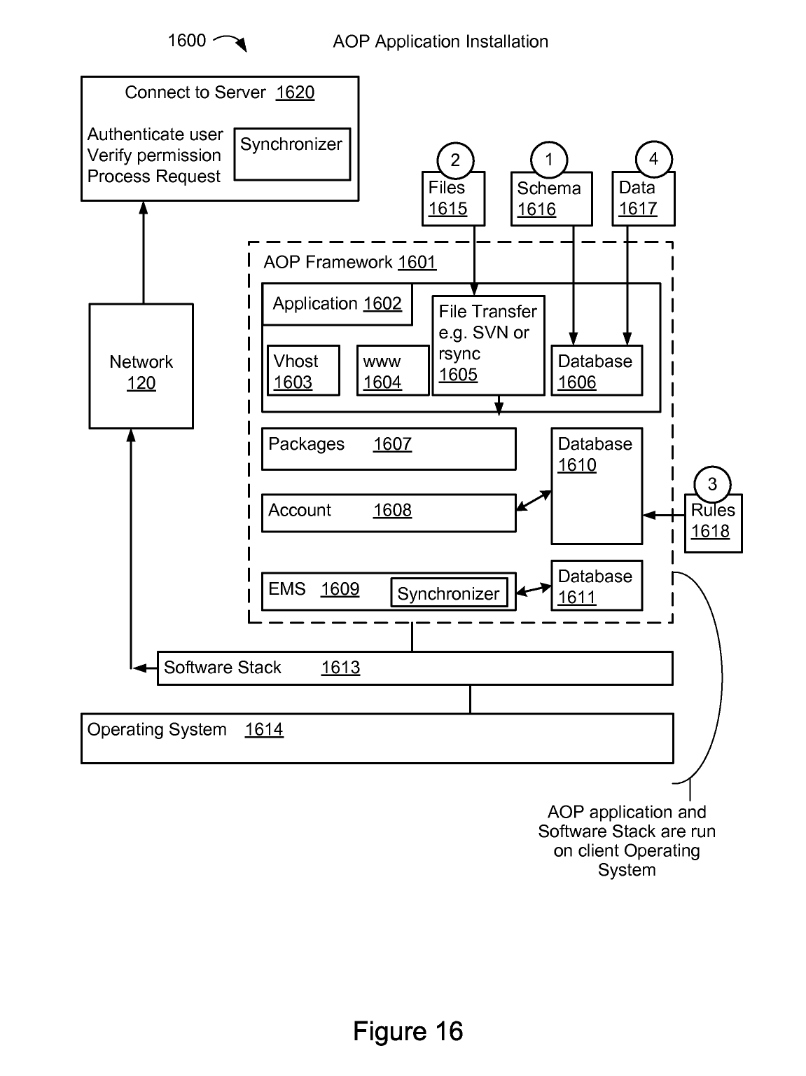

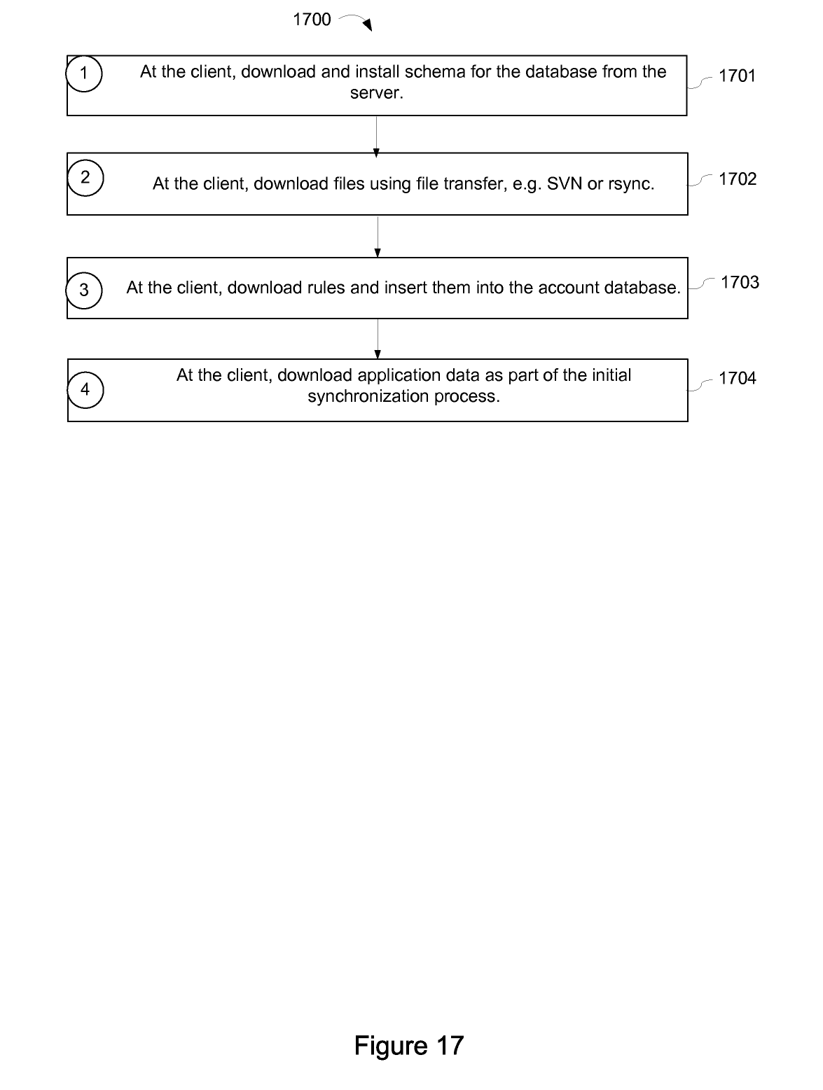

After the account is initialized, the client computer system connects to the application server so that the application server can authenticate the user and verify AOP permissions (1307). After the user has been verified, the application server transfers information required to complete the installation of the web-based application on the client computer system (1308). For example, the application server can transfer files and data for the web-based application to the client computer system. The client computer system then installs up the web-based application (1309). Step 1309 is described in more detail below with reference to FIGS. 16-17.

### AOP Initialize Account

FIG. 14 presents a block diagram 1400 of an exemplary process of initializing an AOP account on a client computer system, according to embodiments of the present invention. FIG. 14 includes AOP application 1401, vhost file 1405, AOP initialization file 1406, database 1408-1409, packages 1414, account 1404, EMS 1402, software stack 1410, operating system 1412, host file 1407, download 1408, connect to server 1403, and Network 120.

FIG. 15 illustrates an exemplary process 1500 of initializing an AOP account on a client computer system, according to embodiments of the present invention. Note that FIG. 15 corresponds to the block diagram in FIG. 14. The AOP framework is installed on the client computer system (1501). After the AOP framework has been installed on the client computer system, a database for an account management system is installed (1502). In some embodiments, the account management system is the Etelos Management System (EMS). The term EMS is used below to describe a generic account management system. The AOP framework connects to the application server and authenticates user permissions (1503). If the user is authenticated, an account is created in the account management system (1504).

The local web server instance within the AOP framework is configured to enable navigation to the web-based application that is installed on the client computer system (1505). In some embodiments, a virtual hosts (vhost) file is configured to map a specified URL to a location for the web-based application on client computer system. For example, the vhost file can map http://appl.com.aop to /web/appl. As noted above, the “.aop” suffix can be any suffix.

An AOP initialization file that includes additional configuration information is saved (1506). The specified URL is then associated with the client computer system (1507). In some embodiments, an entry is added to a hosts file on the client computer system. The entry can be used to redirect a request for the specified URL to the client computer system. In other embodiments, an entry is added to a dynamic naming service (DNS) server on the client computer system. The entry can be used to redirect a request for the specified URL to the client computer system.

Packages that are required by the web-based application are then downloaded from a package repository onto the client computer system (1508). These packages can include packages such as EAS, Zend, fam fam fam, phpMyAdmin, etc (1509). The packages are then installed (1510).

The account is initialized and the system will move onto application installation.

### Web-Based Application Installation

FIG. 16 presents a block diagram 1600 of an exemplary process of installing a web-based application on a client computer system, according to embodiments of the present invention. FIG. 16 includes AOP framework 1601, software stack 1613, operating system 1614, files 1615, schema 1616, data 1617, rules 1618, Network 120, and connect to server 1620. AOP Framework 1601 includes application 1602, packages 1607, account 1608, EMS 1609, and databases 1610-1611. Application 1602 includes vhost 1603, web files 1604, file transfer 1605 (e.g., SVN, rsync, etc.), and database 1606.

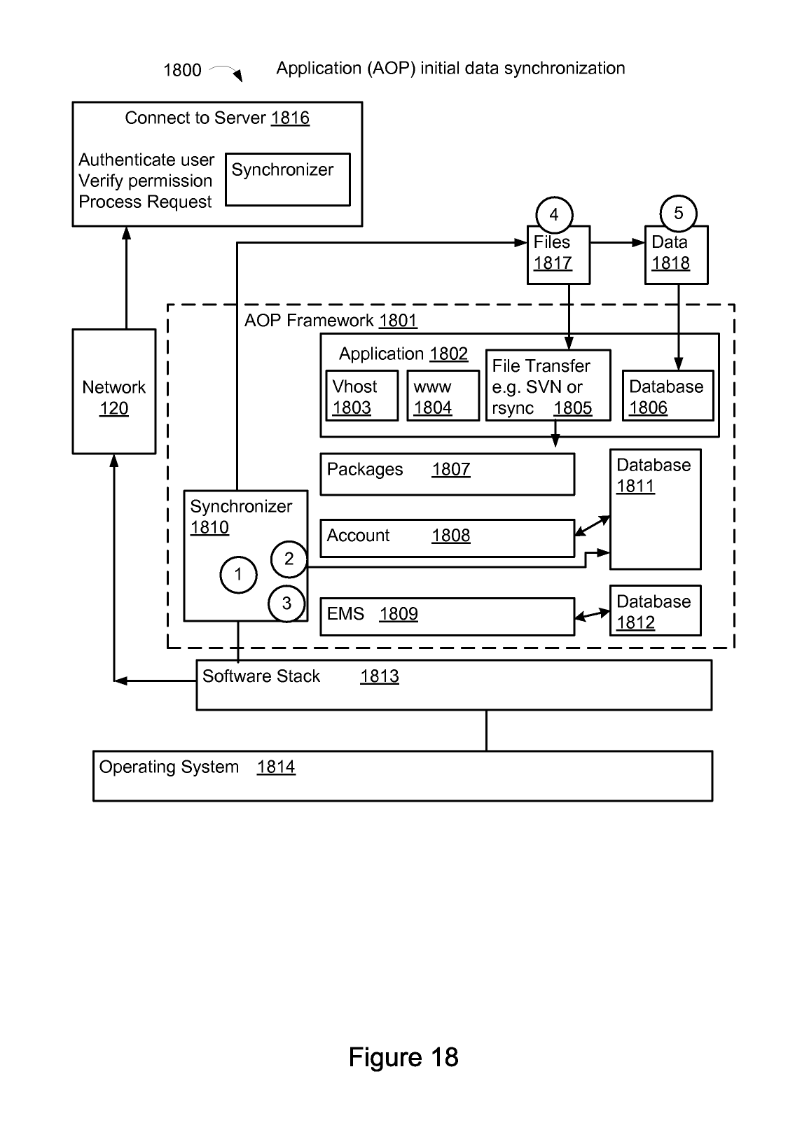

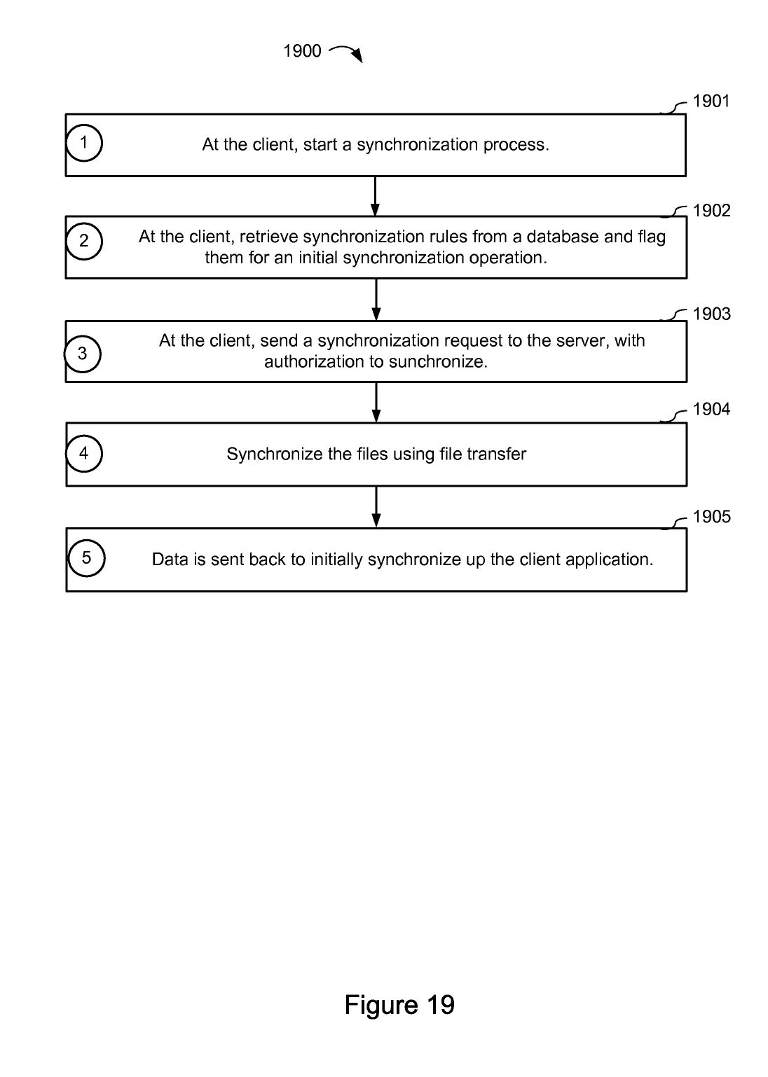

FIG. 17 illustrates an exemplary process 1700 of installing a web-based application on a client computer system, according to embodiments of the present invention. Note that FIG. 17 corresponds to the block diagram in FIG. 16. The client computer system downloads and installs the schema of the database for the web-based application from the application server (1701). The client computer system also downloads the files required by the web-based application (1702). For example, the files can be downloaded using Subversion (SVN), which is a version control system, and/or rsync. The client computer system then downloads synchronization rules and inserts the rules into the database for the account management system (1703). Next, the client computer system downloads application data as part of the initial synchronization process (1704). Step 1704 is described in more detail below with reference to FIGS. 18-19.

### Initial Data Synchronization

FIG. 18 presents a block diagram 1800 of an exemplary process of performing an initial data synchronization for a web-based application on a client computer system, according to embodiments of the present invention. FIG. 18 includes AOP framework 1801, software stack 1813, operating system 1814, files 1817, data 1818, Network 120, and connect to server 1816. AOP Framework 1801 includes application 1802, packages 1807, account 1808, EMS 1809, synchronizer 1810, and databases 1811-1812. Application 1802 includes vhost 1803, web files 1804, file transfer 1805 (e.g., SVN, rsync, and other file transfer tools), and database 1806.

FIG. 19 illustrates an exemplary process 1900 of performing an initial data synchronization for a web-based application on a client computer system, according to embodiments of the present invention. Note that FIG. 19 corresponds to the block diagram in FIG. 18. The initial data sync can be a large and time consuming process because all data records for the web-based application on the application server are synchronized with the web-based application on the client computer system. The synchronization rules processing can be more simple because a new installation typically does not have conflicting data between the application server and the client computer system.

The process begins when a synchronization engine within the AOP framework on the client computer system starts an initial data synchronization process (1901). The synchronizer then retrieves initial data synchronization rules from the database (1902). The synchronizer sends a request to the application server to synchronize with the application server (1903). This request can include user authentication information. Once the user is authenticated, the client computer system synchronizes files for the web-based application using a file transfer utility (1904). For example, the file transfer utility can include Subversion (SNV), rsync, etc. The application server then sends data records to the client computer system (1905). In some embodiments, the data records include all data records for the web-based application.

### Using an the AOP Framework

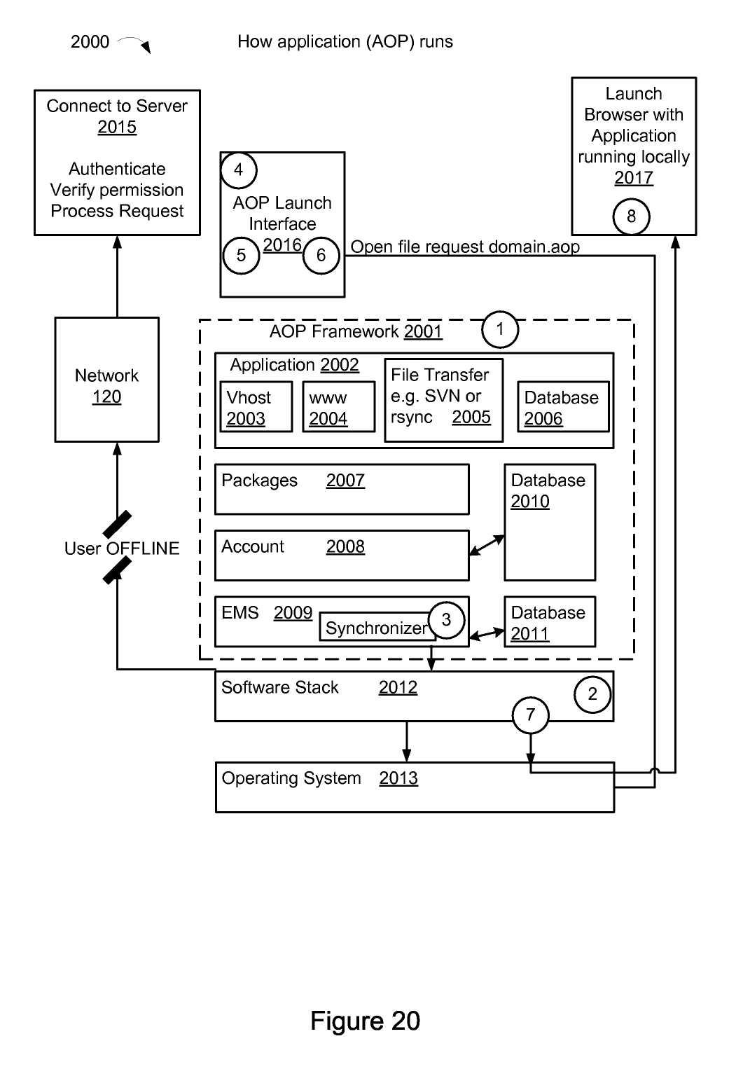

FIG. 20 presents a block diagram 2000 of an exemplary process of using the AOP framework on a client computer system, according to embodiments of the present invention. FIG. 20 includes AOP framework 2001, software stack 2012, operating system 2013, Network 120, connect to server 2015, AOP launch interface 2016, launch browser with application running locally 2017. AOP Framework 2001 includes application 2002, packages 2007, account 2008, EMS 2009, and databases 2010-2011. Application 2002 includes vhost 2003, web files 2004, file transfer 2005 (e.g., SVN, rsycn, and other file transfer tools), and database 2006.

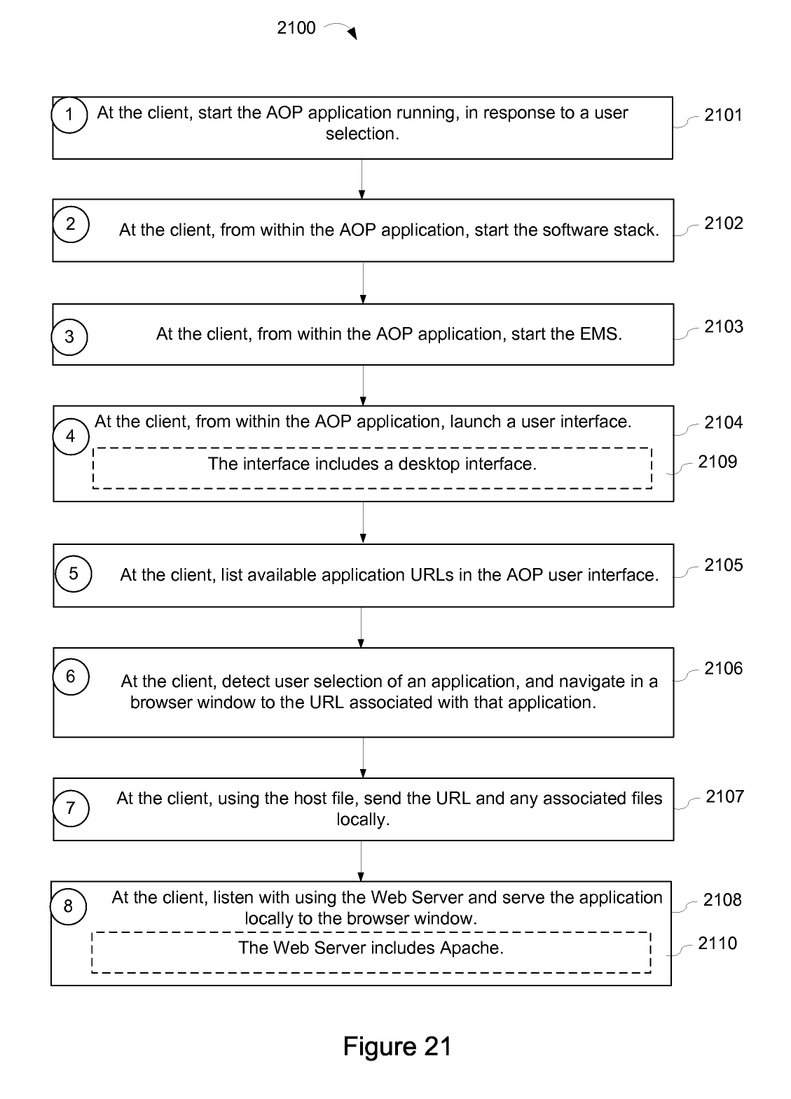

FIG. 21 illustrates an exemplary process 2100 of using the AOP framework on a client computer system, according to embodiments of the present invention. Note that FIG. 21 corresponds to the block diagram in FIG. 20. The AOP framework allows a user to use web-based applications on a client computer system regardless of whether the client computer system is connected to an application server that hosts the web-based application. In order to use web-based applications on the client computer system without a connection to the application server, the AOP framework must be running. A user on a client computer system executes the AOP framework on the client computer system (2101). The AOP framework loads the software stack (2102) and the EMS (2103). The AOP framework then loads a user interface (2104) and web-based applications that are available on the client computer system (2105). In some embodiments, the user interface can include a desktop interface (2109). A user can then select a web-based application to use. This selection is detected and causes the browser to navigate to the URL associated with the selected application (2106). The AOP framework causes the client computer system to be directed to a web server running on the client computer system (2107). For example, an entry in a hosts file or an entry in a DNS server on the client computer system can be used to direct the client computer system to the web server running on the client computer system. The web server on the client computer system listens for connections and responds to a connection request by serving the requested web-based application (2108). In some embodiments, the web server includes Apache HTTP server (2110).

A user that is using a web-based application on the application server can later lose a network connection to the application server. In some embodiments, if the client computer system is running the AOP framework, the user can continue using the web-based application without the network connection to the application server. In these embodiments, the AOP framework can seamlessly continue providing the services required by the web-based application so that the user does not know that the network connection to the application server is lost. After the network connection to the application server is restored, any changes made on the client computer system and the application server can be synchronized with each other.

In some cases, a network connection may be slow or unreliable. Thus, in some embodiments, a user can use a web-based application from the client computer system regardless of whether a network connection to the application server exists or not. In these embodiments, the AOP framework periodically synchronizes changes made on the application server and the client computer system with each other. In doing so, a poor user experience that could result from a low-quality or intermittent network connection can be reduced or eliminated.

In some embodiments, a web browser is used to access the web-based application.

### Client Computer System

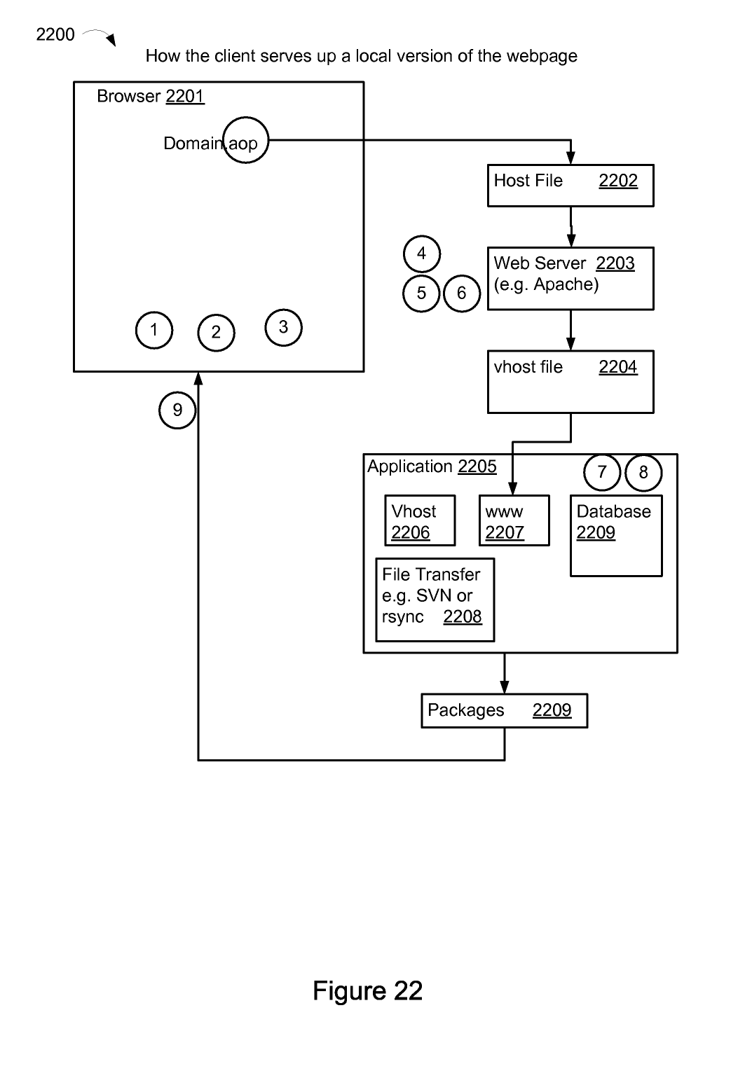

When a user requests a web-based application by entering a URL into a browser, the client computer system determines how to access the web-based application. FIG. 22 presents a block diagram 2200 of an exemplary process for a client computer system determining how to access a web-based application, according to embodiments of the present invention. FIG. 22 includes browser 2201, host file 2202, web server 2203, vhost file 2204, application 2205, and packages 2209. Application 2005 includes vhost 2206, web files 2207, file transfer 2208 (e.g., SVN, rsycn, and other file transfer tools), and database 2209.

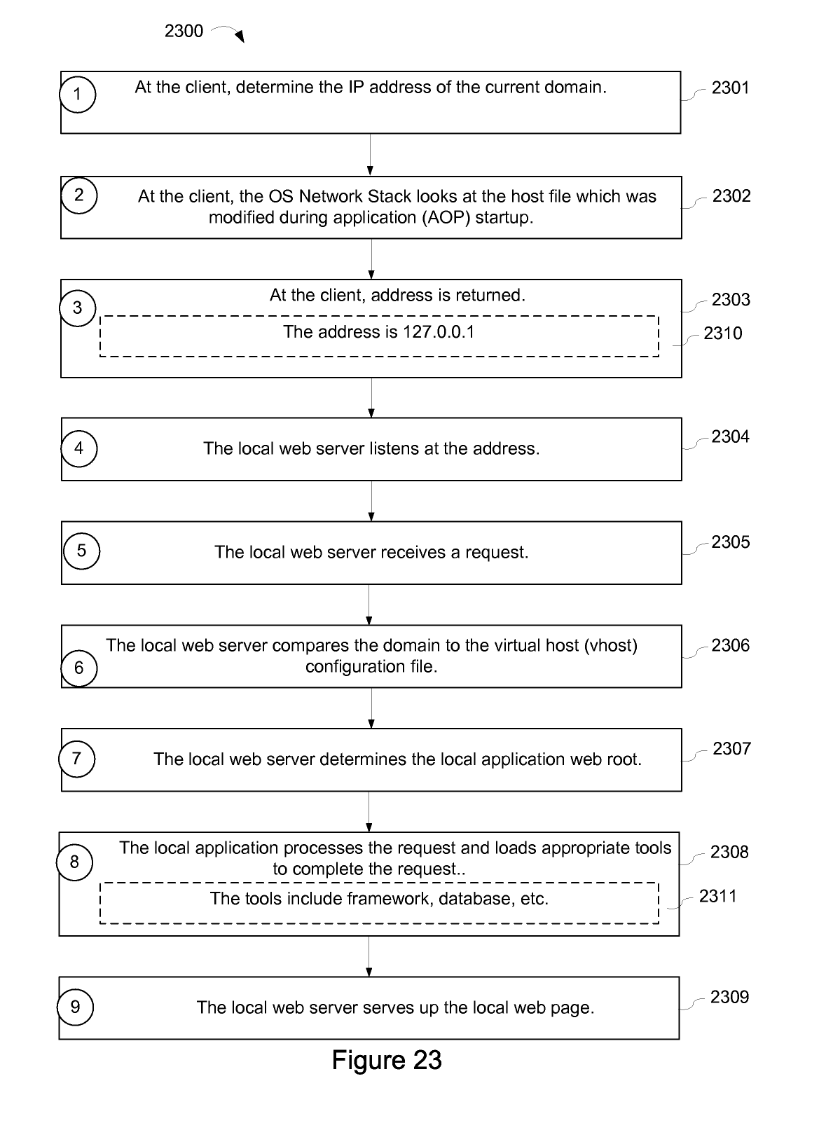

FIG. 23 illustrates an exemplary process 2300 for a client computer system determining how to access a web-based application, according to embodiments of the present invention. FIG. 23 corresponds to the block diagram in FIG. 22. The client computer system first determines an IP address associated with the URL (2301). In some embodiments, the URL includes a domain suffix “.aop”. The client computer system first checks a local hosts file to determine whether the URL is included in an entry in the hosts file (2302). If the URL is not included in an entry in the hosts file, the client computer system checks one or more DNS servers to locate the IP address associated with the URL. If the URL is included in an entry in the hosts file, the client computer system retrieves the IP address for the URL (2303). The IP address for the web-based application is set to an address associated with the client computer system (e.g., 127.0.0.1) (2310). In some embodiments, the IP address associated with the URL for web-based applications is set to an address associated with the client computer system each time the AOP framework is started on the client computer system. In other embodiments, the IP address associated with the URL for web-based applications is set to an address associated with the client computer system when the web-based application is installed on the client computer system.

The web browser is then directed to the IP address associated with the client computer system on which the web server on the client computer system listens (2304). The local web server receives the request (2305) and compares the requested URL to a virtual host (vhost) configuration file (2306) to determine where the files for the web-based application are located on the client computer system (2307) (e.g., the local application web root). The web-based application and tools required to complete the request are loaded (2308). In some embodiments, the tools include the AOP framework, database, etc (2311). The web server then returns a web page with the results of the request (2309).

### AOP Synchronization

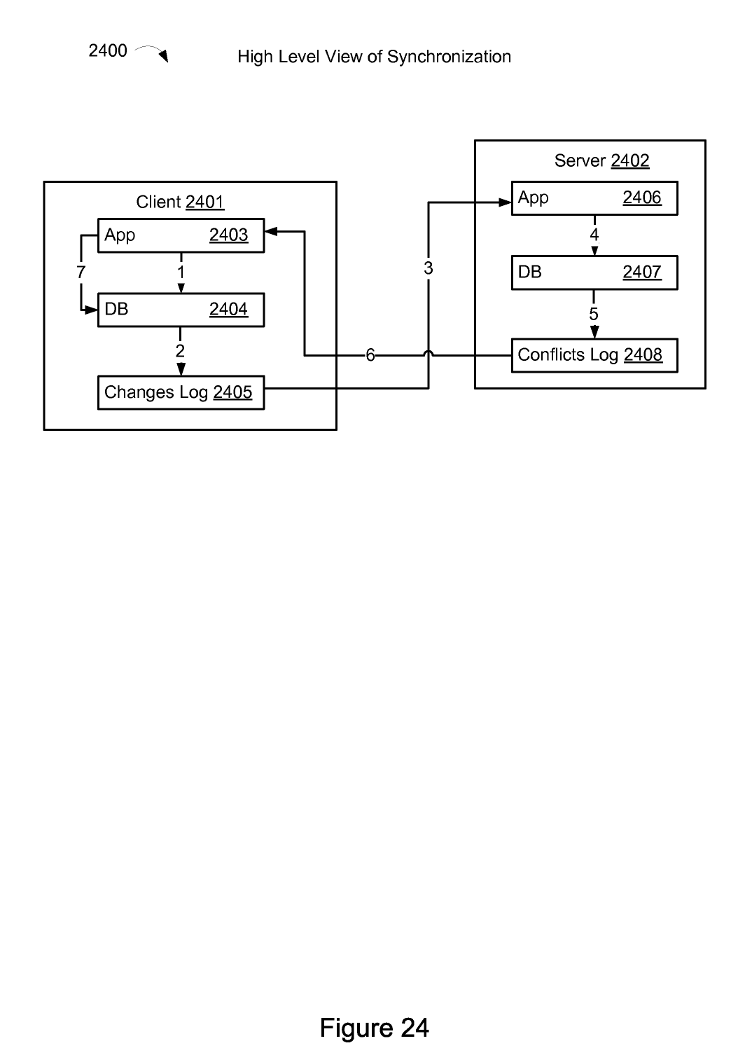

FIG. 24 presents a block diagram 2400 of an exemplary process for synchronizing a web-based application 2403 on a client computer system 2401 with a web-based application 2406 on an application server 2402, according to embodiments of the present invention. As illustrated in FIG. 24, client computer system 2401 includes web-based application 2403, database 2404, and changes log 2405. Application server 2402 includes web-based application 2406, database 2407, and conflicts log 2408. Web-based application 2403 corresponds to web-based application 2406. Similarly, database 2404 corresponds to database 2407.

FIG. 25 illustrates an exemplary process 2500 for synchronizing a web-based application on a client computer system with a web-based application on an application server, according to embodiments of the present invention. FIG. 25 corresponds to the block diagram in FIG. 24. A synchronization process (or a synchronizer module) on the client computer system detects changes in a database 2404 for the client computer system 2401 (2501). In some embodiments, the synchronization process periodically polls database 2404 to determine whether changes have been made (2508). In other embodiments, the synchronization process listens for notification messages which are sent when database 2404 has been changed (2508).

The synchronization process then collects all the changes from database 2404 into a changes log 2405 (2502). The changes are sent to application server 2402 (2503). A synchronization process (or synchronization module) on the application server applies the changes received from the client computer system 2401 to database 2407 (2504). In some embodiments, the connection between client computer system 2401 and application server 2402 is kept alive until the synchronization process is completed.

If conflicts exist between the changes made on client computer system 2401 and application server 2402, the data on the server “wins” (2505). The conflicting data is resolved at application server 2402 and conflict resolution data is collected in a conflict resolution log 2408.

The synchronization process on application server 2402 then sends the conflict resolution log 2408 to client computer system 2401 (2506). The conflict resolution log is applied to database 2407 on client computer system 2401 (2507). Both client computer system 2401 and application server 2402 are synchronized at this point.

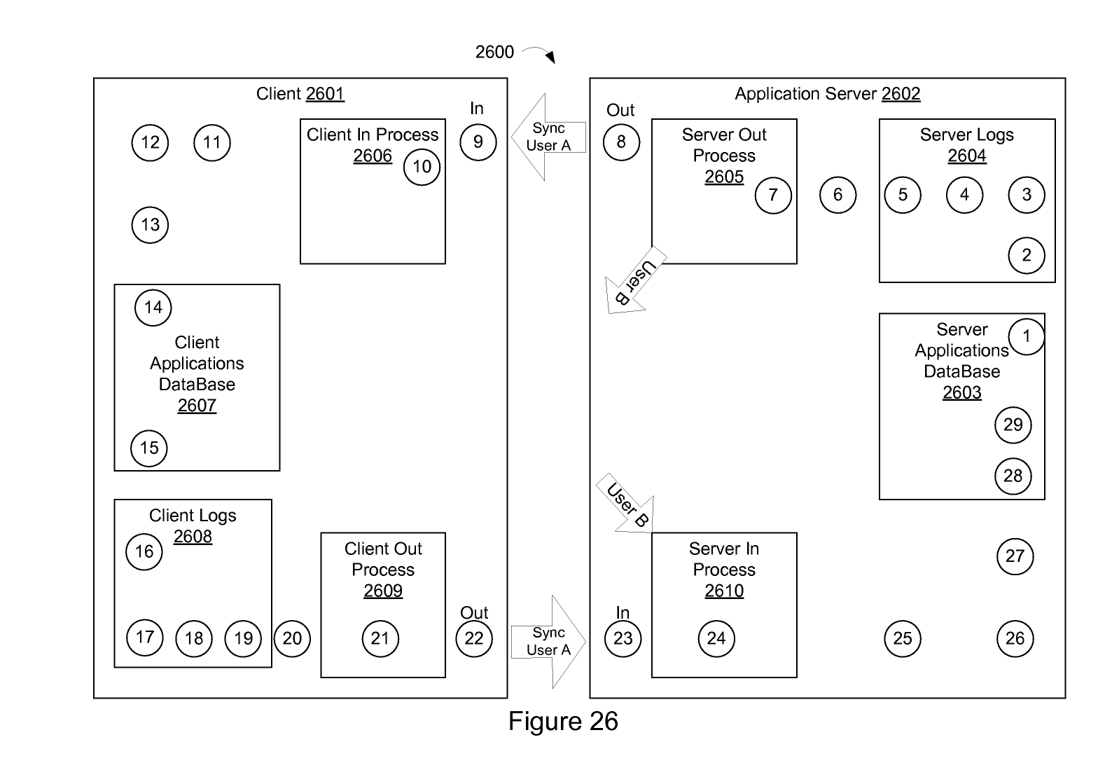

FIG. 26 presents a block diagram 2600 of an exemplary process for synchronizing a web-based application on a client computer system 2601 with a web-based application on an application server 2602, according to embodiments of the present invention. FIG. 26 includes client 2601 and server 2602. Client 2601 includes client in process 2606, client applications database 2607, client logs 2608, and client out process 2609. Application server 2602 includes server applications database 2603, server logs 2604, server out process 2605, and server in process 2610.

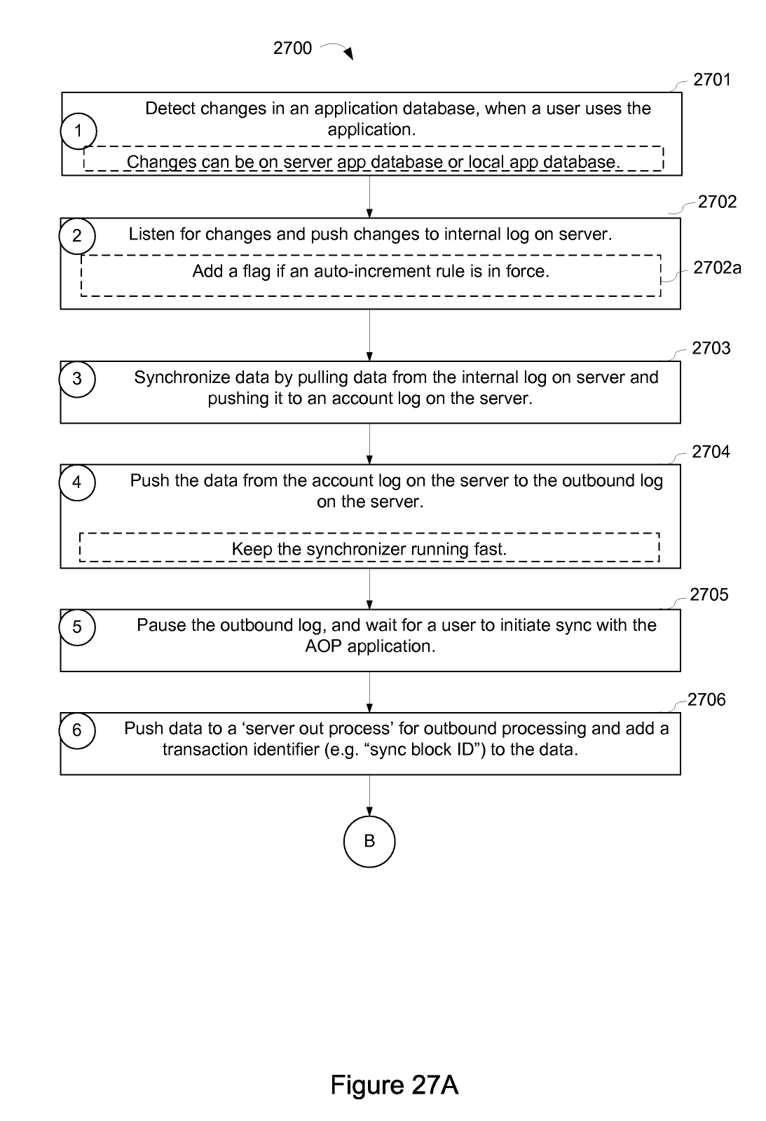

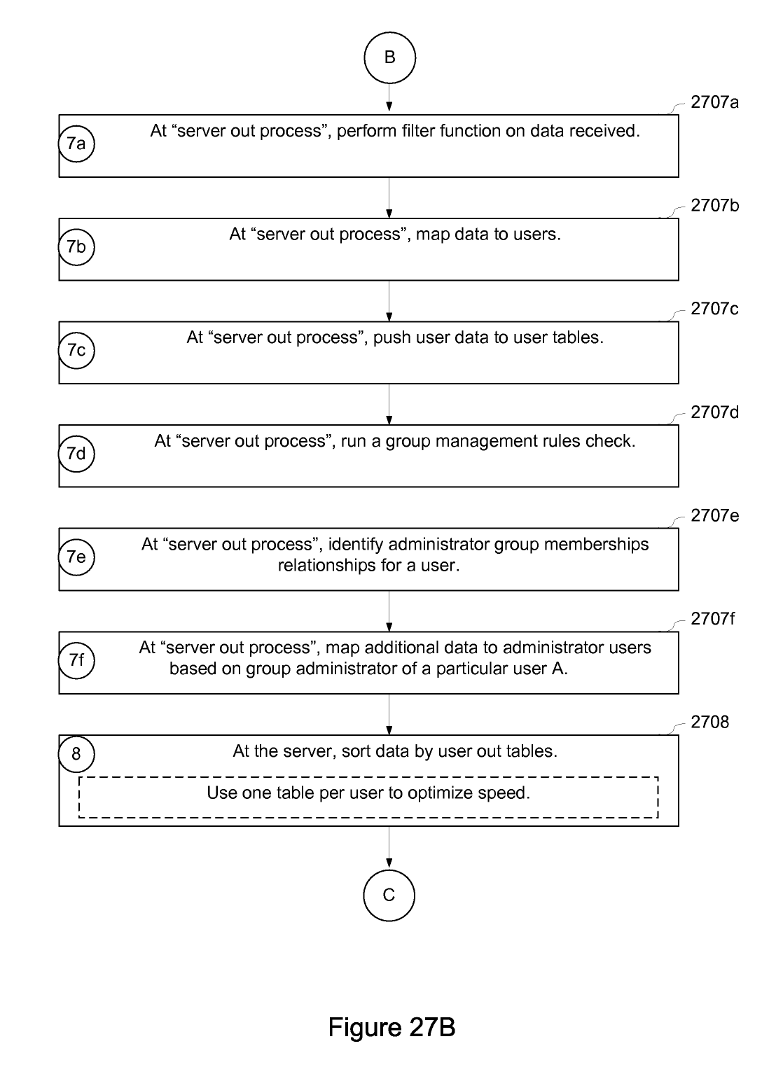

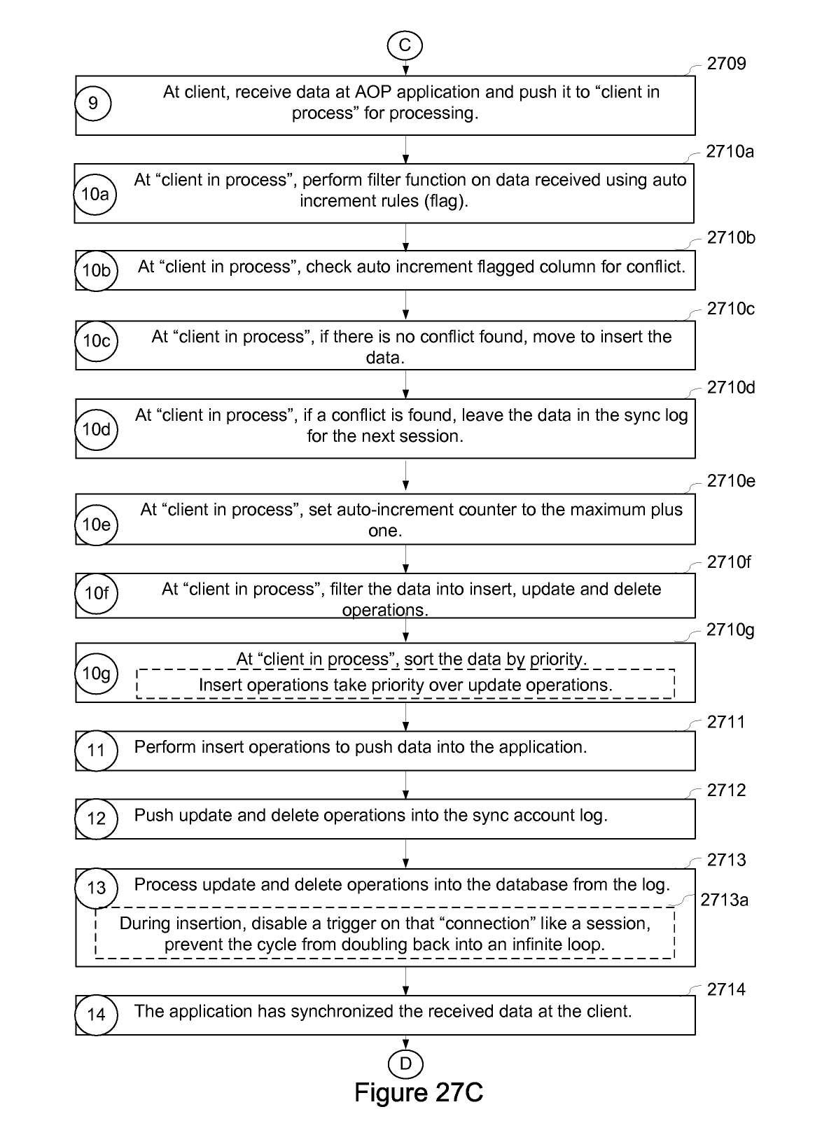

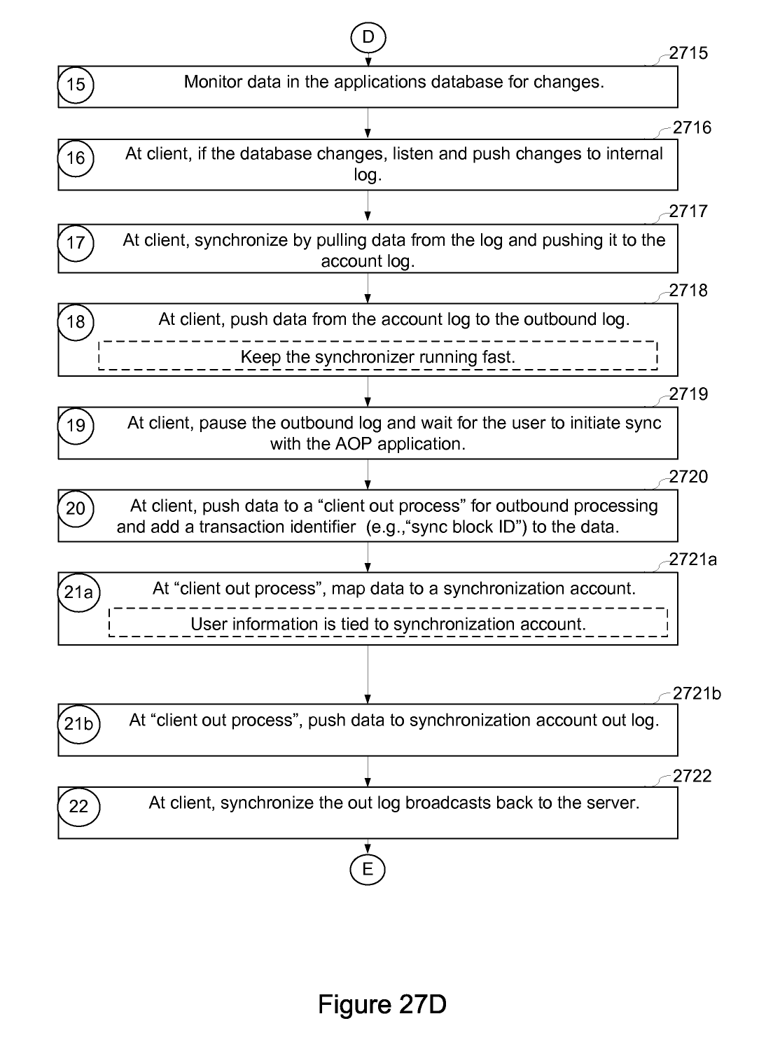

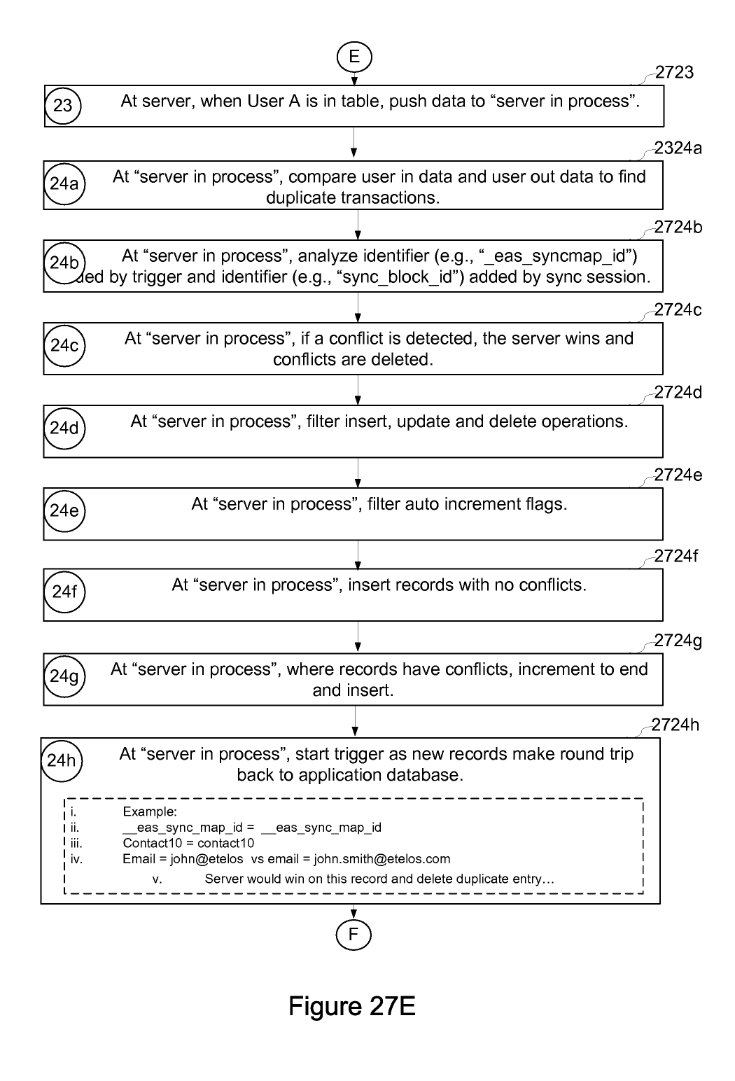

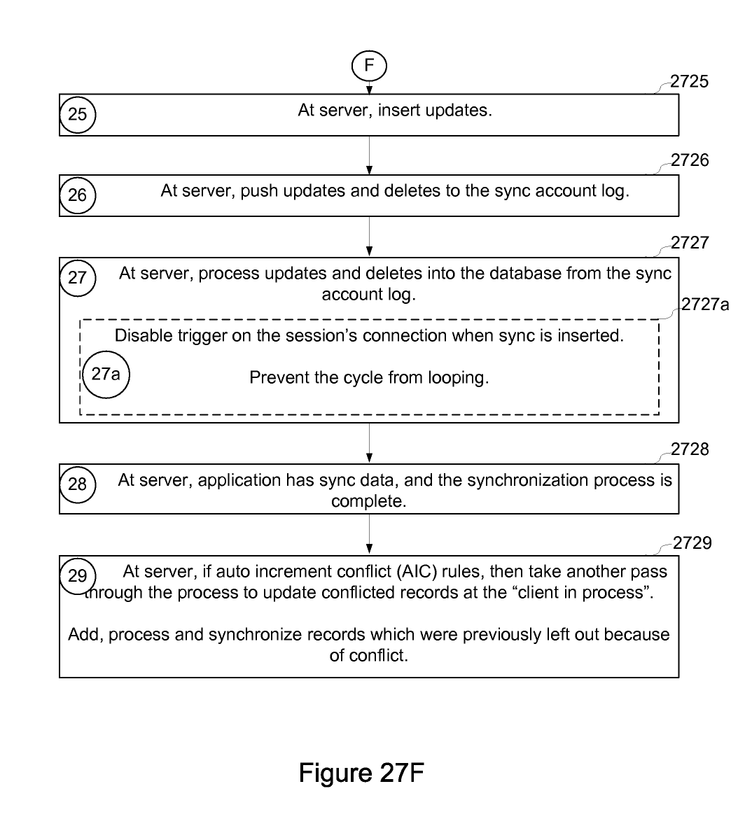

FIGS. 27A-27F illustrate an exemplary process 2700 for synchronizing a web-based application on a client computer system 2601 with a web-based application on an application server 2602, according to embodiments of the present invention. FIG. 27 corresponds to the block diagram in FIG. 26. A user makes changes to the web-based application on application server 2602 (2701). For example, the user can make changes to a database for a web-based application by adding new records or modifying existing records in the database.

Database triggers watch for changes in database 2603 and note these changes in an internal log (2702). In some embodiments, if a rule type is “auto-increment,” then a flag is added to the log (2730). A synchronization process on application server 2602 then pulls data from the internal log and sends the data to an account log (2703). The data in the account log is then sent to an outbound log (2704). The outbound log is used to speed up the synchronization process because the outbound log can become large and slow to process. The synchronization process then waits for a user to initialize a synchronization operation with the application server (2705).

Once a synchronization operation is started, the data is sent to server out process 2605 for outbound processing (2706). In some embodiments, a transaction id called “sync block ID” is added to the data. The server out process performs several operations (2707), which can include, but are not limited to: applying filters, mapping data to users, sending user data to user tables, running group management rule checks, identifying administrative group memberships relationships for users, and/or mapping additional data to admin users based on a group admin of user A. The data is then sorted by users (2708). In some embodiments, the data is separated into separate “user out” tables, wherein each user has a “user out” table. In doing so, the speed of the synchronization can be optimized.

Client computer system 2601 receives the data and sends the data to client in process 2606 for processing (2709). Client in process 2606 performs a number of operations (2710), including, but not limited to, filtering Auto Increment Rules (flag), checking auto increment (AI) flagged column for conflict, marking data as “insert” if there are no conflicts, marking data in the sync log as “leave” (which are processed in the next session) if there are conflicts (see 2724), setting an auto-increment counter to max+1, filtering data into inserts, updates and deletes, and/or sorting priorities (e.g., inserts before updates).

The synchronization process then inserts data that is marked as “insert” into client applications database 2607 for the web-based application (2711). The synchronization process then sends data that is marked as “update” or “delete” to a sync account log (2712). The updates and deletes in the sync account log are then processed by client applications database 2607 (2713). In some embodiments, when the synchronization process inserts data, the synchronization process disables triggers within a synchronization session to prevent doubling back into an infinite loop (2713a). The web-based application on client computer system 2601 is now synchronized with the web-based application on application server 2602 (2714).

A user using web-based application on client computer system 2601 changes data in client applications database 2607 for the web-based application (2715). Database triggers watch for changes in client applications database 2607 and notes these changes in an internal log (2716). A synchronization process on client computer system 2601 then pulls data from the internal log and sends the data to an account log (2717). The data in the account log is then sent to an outbound log (2718). The outbound log is used to speed up the synchronization process because the outbound log can become large and slow to process. The synchronization process then waits for a user to initialize a synchronization operation with the application server (2719).

Once a synchronization operation is started, the data is sent to client out process 2609 for outbound processing (2720). In some embodiments, a transaction id called “sync block ID” is added to the data. Client out process 2609 performs several operations (2721), including, but not limited to, mapping data to sync account (user info is tied to sync acct) and/or pushing data to the sync account out log. Sync account out log is broadcast to application server 2601 (2722).

In some embodiments, every user has a table associated with the user (e.g., “in-table”), which is used for inbound processing. User in-tables (e.g., user A in-table, user B in-table) are pushed to server in process 2610 (2723). Server in process 2610 performs a number of operations (2724), including, but not limited to, comparing data—user out and user in—duplicate transactions, based on _eas_syncmap_id (added by trigger) and “sync_block_id” added by sync session, server wins—so server deletes conflicts, filtering inserts from updates and deletes, filtering auto increment flags, inserting records with no conflict, and/or inserting records with conflicts at the next unused record. Several examples of conflicting records include: _eas_sync_map_id=_eas_sync_map_id, Contact10=contact10, and Email=john@etelos vs. email=john.smith@etelos.com.

Data records that are marked as “insert” are inserted (2725). Data records that are marked as “update” or “delete” are sent to a sync account log (2726). The updates and deletes in the sync account log are then processed by server applications database 2603 (2727). In some embodiments, when the synchronization process inserts data, the synchronization process disables triggers this synchronization session to prevent doubling back into an infinite loop (2732). The web-based application on application server 2602 is now synchronized with the web-based application on client computer system 2601 (2728).

If the automatic incrementing rules detect a conflict between application server 2602 and client computer system 2601, another pass is taken through the process to update conflicted records (2729). During this process, records that were previously left out because of conflicts are synchronized.

In some embodiments, the synchronization process can be used to synchronize between different types of database management systems (DMBSs). In some embodiments, the synchronization process can be used to synchronize between the same type of DBMSs. In some embodiments, the changes are synchronized directly with a DBMS associated with the web-based application. In all of these embodiments, database drivers are used to perform the synchronization between the DBMSs. The database drivers can handle the translations of data between different types of DBMSs as well as determining what changes occurred since the last synchronization process.

In some embodiments, the synchronization process synchronizes directly with the file structures associated with the web-based applications. In these embodiments, a file synchronization utility such as SVN or rsync can be used to synchronize the file structures.

### Auto Increment Conflict Resolution

Some web-based applications use automatically incrementing identifiers in a database when a new record is added to the database. In these web-based applications, conflicts can arise if multiple instances of the web-based application (e.g., on the application server, on multiple client computer systems, etc.) are all inserting new data records into a database for that instance of the web-based application. Thus, some embodiments provide a technique to resolve conflicts for web-based application that use auto-increment identifiers.

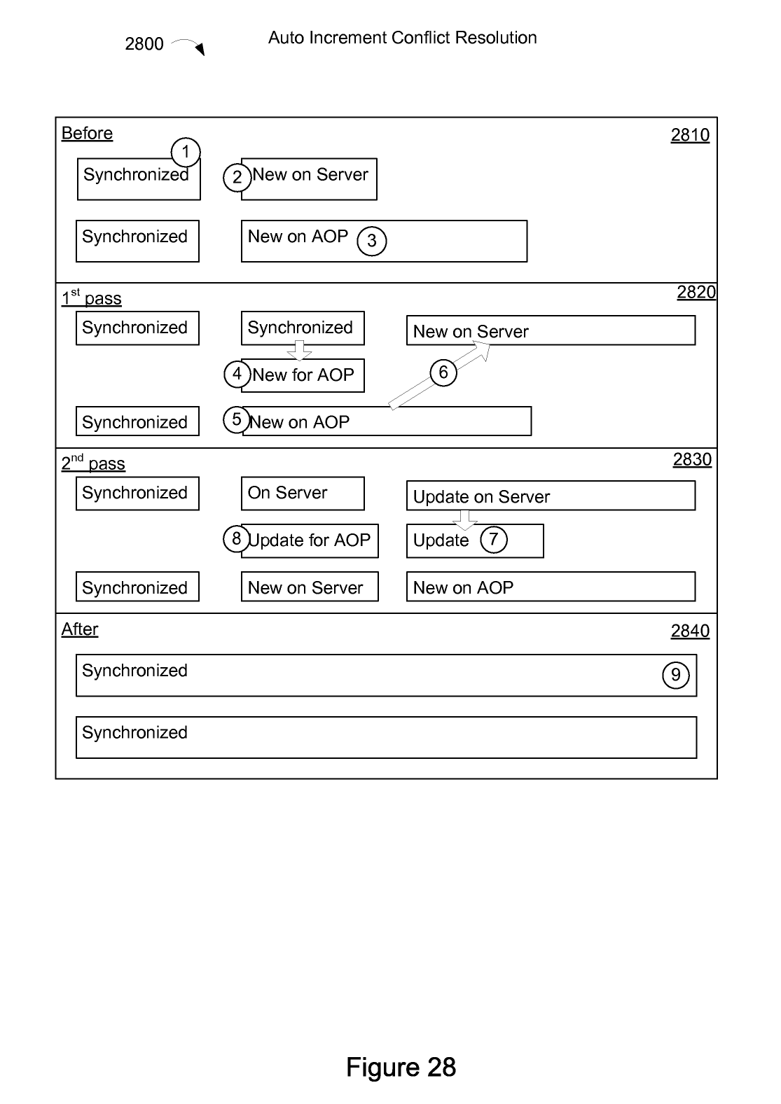

FIG. 28 presents a block diagram 2800 of an exemplary process for resolving conflicts for web-based applications that use auto-incrementing identifiers, according to embodiments of the present invention. FIG. 28 illustrates the state of data on an application server and a client computer system at several points in time (e.g., before synchronization, after a first pass of synchronization, after a second pass of synchronization, and after synchronization is complete).

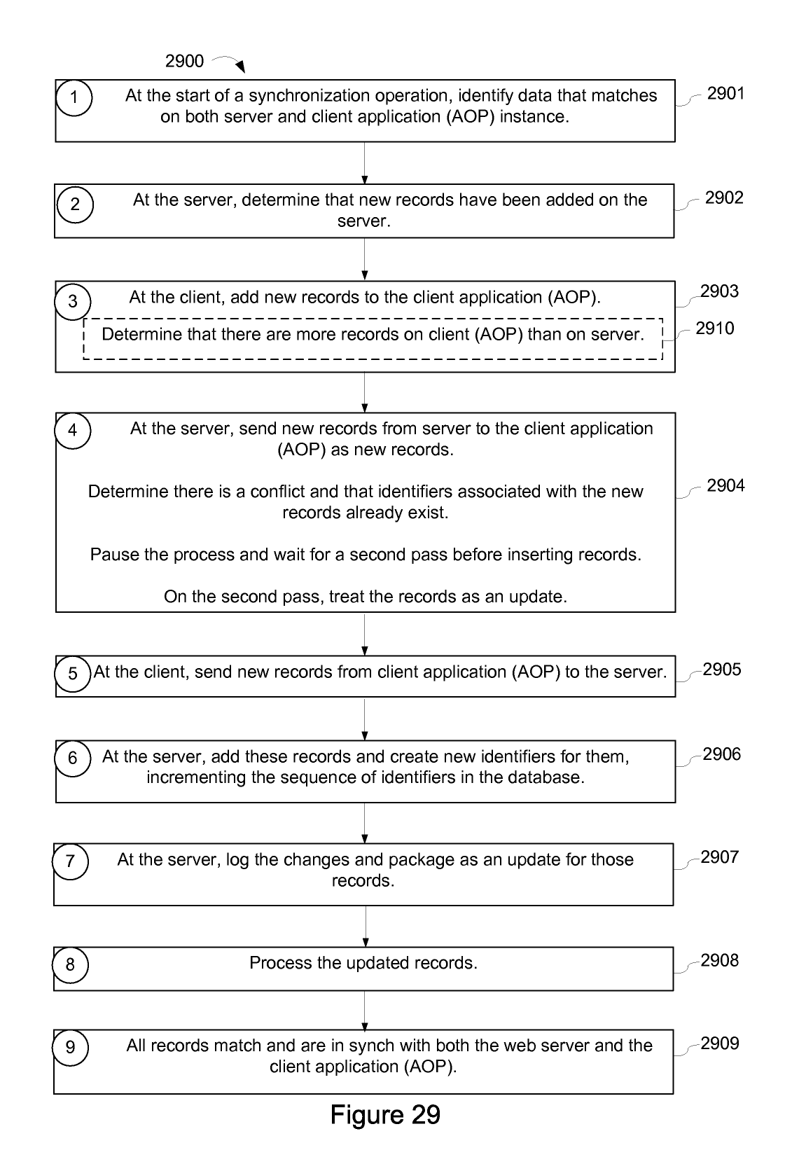

FIG. 29 illustrates an exemplary process 2900 for resolving conflicts for web-based applications that use auto-incrementing identifiers, according to embodiments of the present invention. FIG. 29 corresponds to the block diagram in FIG. 28. As illustrated in FIG. 29, both the application server and the client computer system have added new records into their respective databases for the web-based application. The application server and the client computer system also have records that are already synchronized. Note that in FIG. 29, the identifiers increase from left to right. Thus, the new records on the application server and the client computer system include a number of records that use the same identifiers, resulting in conflicts.

At the start of a synchronization operation, the data that is already synchronized on both the application server and the client computer system (e.g., the AOP instance) is identified (2901). The application server then determines that new records have been added to the application server since the last synchronization with the client computer system (2902). The client computer system determines that new records have been added to the client computer system since the last synchronization with the application server (2903).

The conflict resolution process begins when the application server sends its new records to the client computer system (2904). Since there is a conflict between the identifiers used in the application server and the client computer system, the conflict resolution process waits for a second pass before inserting the new records received from the application server. On the second pass, the new records from the application server are treated as an update.

The client computer system sends its new records to the application server (2905). The application server assigns new identifiers for these records and inserts these records into the database for the web-based application (2906). The application server can assign the new identifiers for these records by using the automatically incrementing identifiers in the database. The application server then generates an update log that includes the changes for these records (2907). The application server sends the update log to the client computer system which then processes updates from that result from these records and from the new records received from the application server at step 2804 (2908). The records in both databases are now synchronized (2909).

### Users and Groups

FIG. 9 presents a block diagram illustrating exemplary group memberships for users for a given web-based application, according to embodiments of the present invention. As illustrated in FIG. 9, user A is a member of group A. This membership can be managed through a memberships table. User B is a member of a group of administrators that are administrators of group A. This administrator membership can be managed through an admin table. In some embodiments, changes to user A's information are also added to a user out log table for user B. Thus, user B can see changes that user A has made. For example, a sales manager can view contacts for sales representatives that report to the sales manager.

In some embodiments, a group sync app group filter is used to indicate whether the web-based application supports group memberships. These rules can be setup in the account database for the web-based application. The filter can include information such as a data table (e.g., a contacts table), a membership table (e.g., the membership table), and a group table (e.g., groups). This can be a one time setup that a developer of a web-based application does to configure the web-based application to synchronize with the AOP framework. In some embodiments, the filter is setup when the developer ports the application to the AOP framework environment.

In some embodiments, the group filter sets flags in database triggers to send memberships data with a log entry so that the AOP framework knows what to use to filter in the server out process. In other words, the group filter is used to indicate which table includes user information, whether there is a membership table for linking users to groups, and the table that keeps track of groups.

### Rules Setup

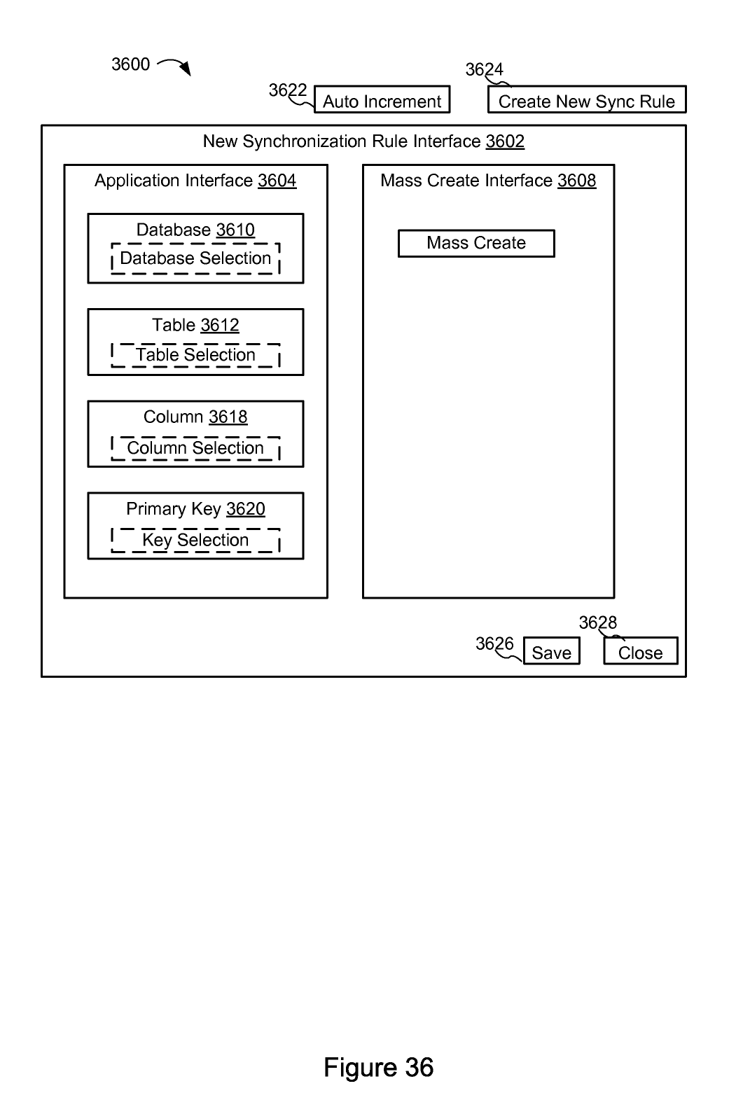

FIG. 36 presents a block diagram 3600 illustrating an exemplary user interface 3600 for creating synchronization rules, according to embodiments of the present invention. User interface 3600 includes one or more of: new synchronization rule interface 3602, auto increment function 3622, and/or create new sync rule function 3624. New synchronization rule interface 3602 includes one or more of: application interface 3604, mass create interface 3608, save function 3626, and/or close function 3628.

Application interface 3604 includes one or more of database function 3610, table function 3612, column function 3618, and/or primary key function 3620. Database function 3610 allows a user to select available databases. Table function 3612 allows a user to select tables within the available databases. Column function 3618 allows a user to select columns within the tables. Primary key function 3620 allows a user to select primary keys for the tables. Using these functions, a user can specify synchronization rules on one or more of the database level, the table level, the column level, and the primary key level.

Mass create interface 3608 includes a mass create function which allows a user to automatically create sync rules for the AOP framework at every match for a specified level. For example, a user can use the mass create function to create sync rules for all database tables.

Auto increment function 3622 allows a user to specify which columns on a given table use automatically incrementing identifiers. Create new sync rule 3624 creates the new synchronization rule specified by the user in user interface 3600. Save function 3626 saves the new rule whereas close function 3628 closes user interface 3600.

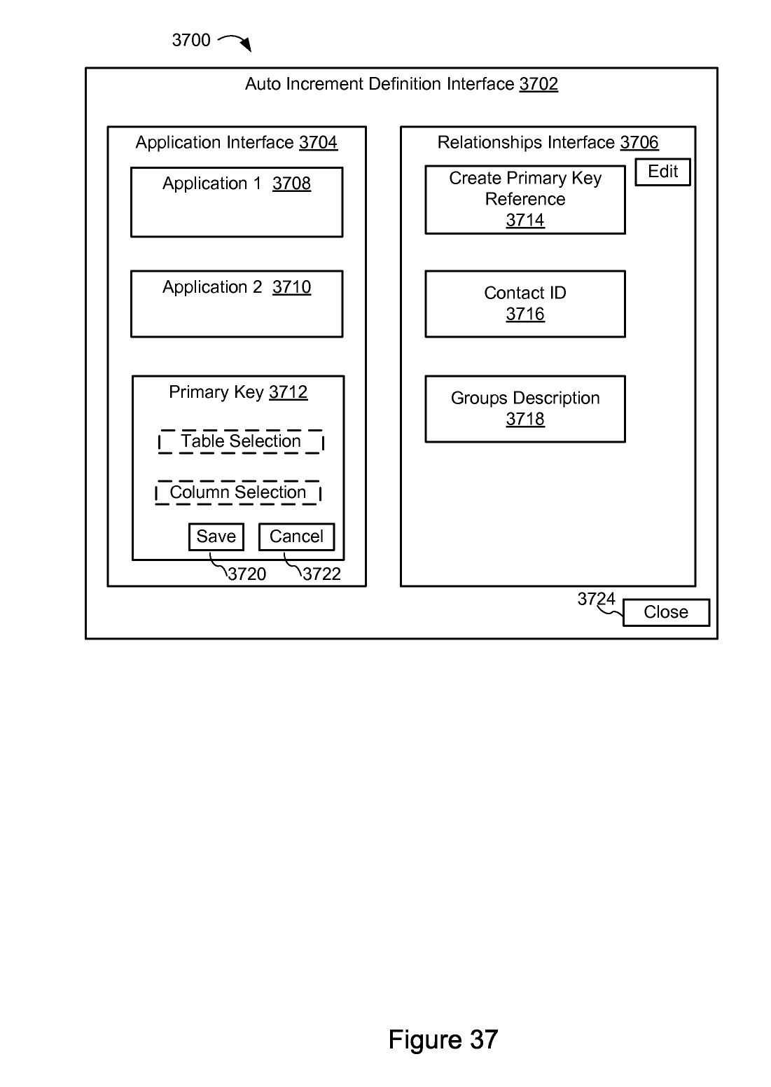

FIG. 37 presents a block diagram 3700 illustrating an exemplary user interface 3700 for generating auto-incrementing identifiers, according to embodiments of the present invention. User interface 3700 includes auto increment definition interface 3702, which includes one or more of application interface 3704, relationships interface 3706, and/or close function 3724. Application interface 3704 includes one or more of application 1 3708, application 2 3710, and/or primary key 3712. Primary key 3712 includes one or more of a table selection function, a column selection function, save function 3720, and/or cancel function 3722. Relationships interface 3706 includes one or more of create primary key reference function 3714, contact ID function 3716, groups description function 3718, and an edit function.

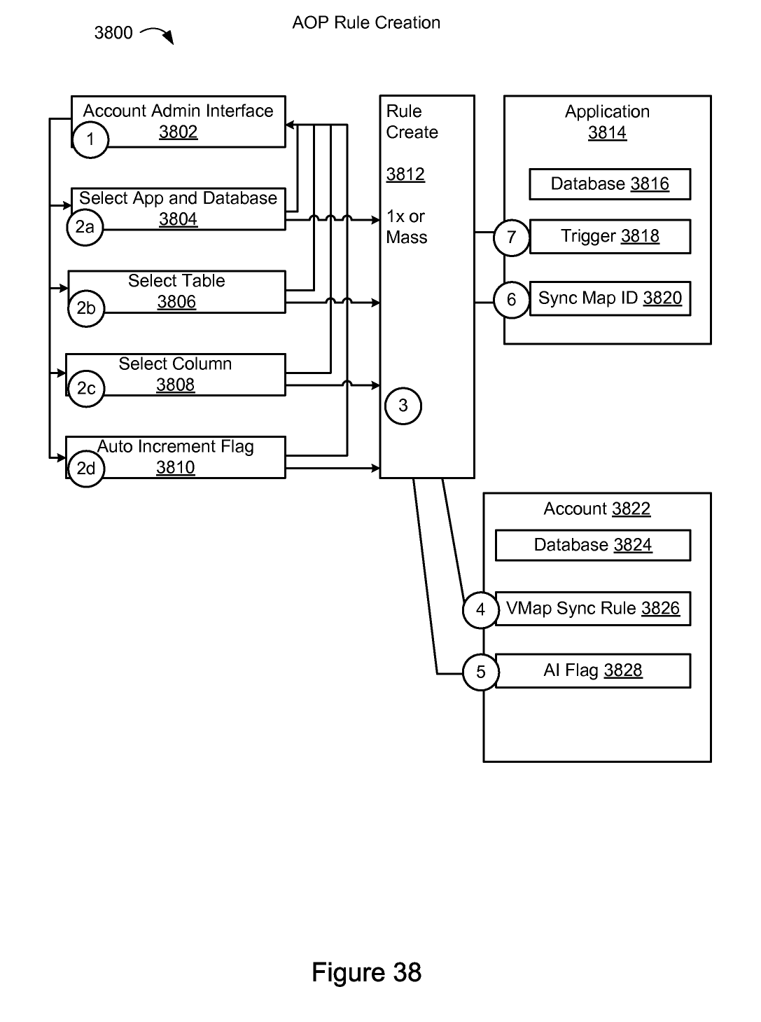

FIG. 38 presents a block diagram 3800 illustrating an exemplary process for creating synchronization rules, according to embodiments of the present invention. FIG. 38 includes one or more of account admin interface 3802, select application and database 3804, select table 3806, select column 3808, auto increment flag 3810, rule create 3812, application 3814, and/or account 3822. Application 3814 include one or more of database 3816, trigger 3818, and/or sync map ID 3820. Account 3822 includes one or more of database 3824, vmap sync rule 3826, and AI flag 3828.

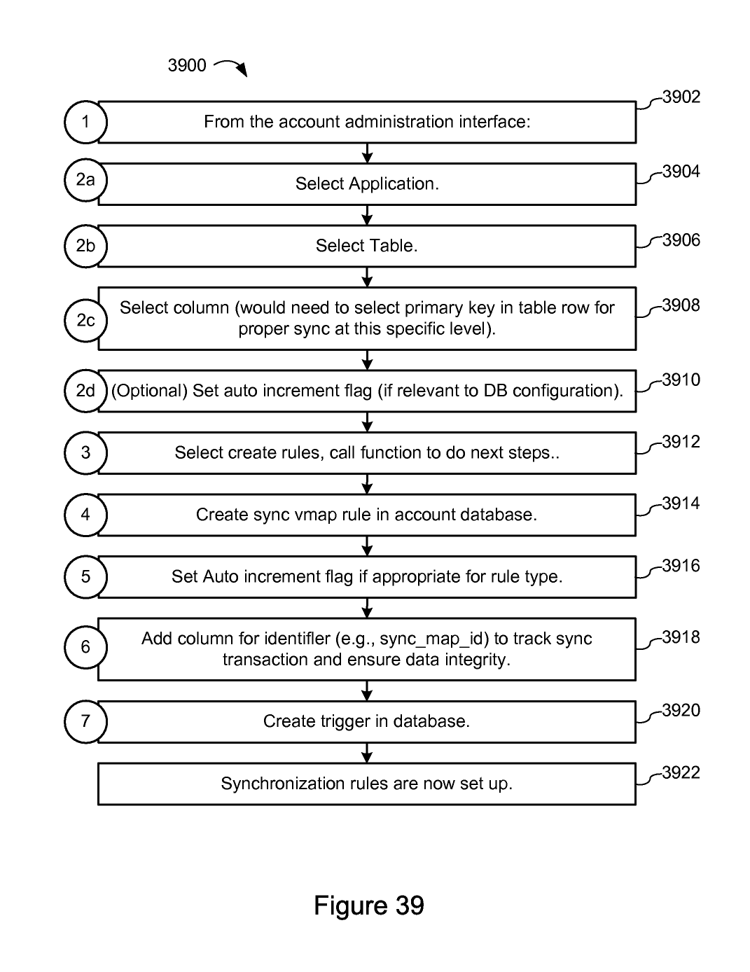

FIG. 39 presents a flowchart of an exemplary process 3900 for creating synchronization rules, according to embodiments of the present invention. FIG. 39 corresponds to the block diagram in FIG. 38. From the account admin interface (3902), a user can perform the following operations: selecting an application (which inherently selects the associated databases) (3904), selecting a table (3906), selecting a column (which can involve selecting a primary key in a table row for proper synchronization at this specific level) (3908), and/or optionally setting an auto increment flag (e.g., if relevant to the database configuration) (3910). After the user performs one or more of the previous options, the user can select a create rules function (3912), which calls functions to perform one or more of steps 3914-3922. Alternatively, the user can refine the rules by using the account admin interface to specify more rules.

After selecting the create rules function, a rules generator creates a sync vmap rule in the account database (3914). The rules generator sets an auto increment flag if appropriate for rule type (e.g., if the database table uses an auto incrementing primary key column) (3916). The rules generator adds a column for a sync_map_id, which tracks sync transactions and ensures data integrity (3918). The rules generator creates a trigger in the database (3920). The synchronization rules are now setup at step 3922. Note that a user can also select a “mass create” at one or more levels (e.g., all tables, specific tables, specific columns, etc.) in the process from now on that can automatically create sync rules for the AOP framework at every match at that level.

### Foreign Key Mapping

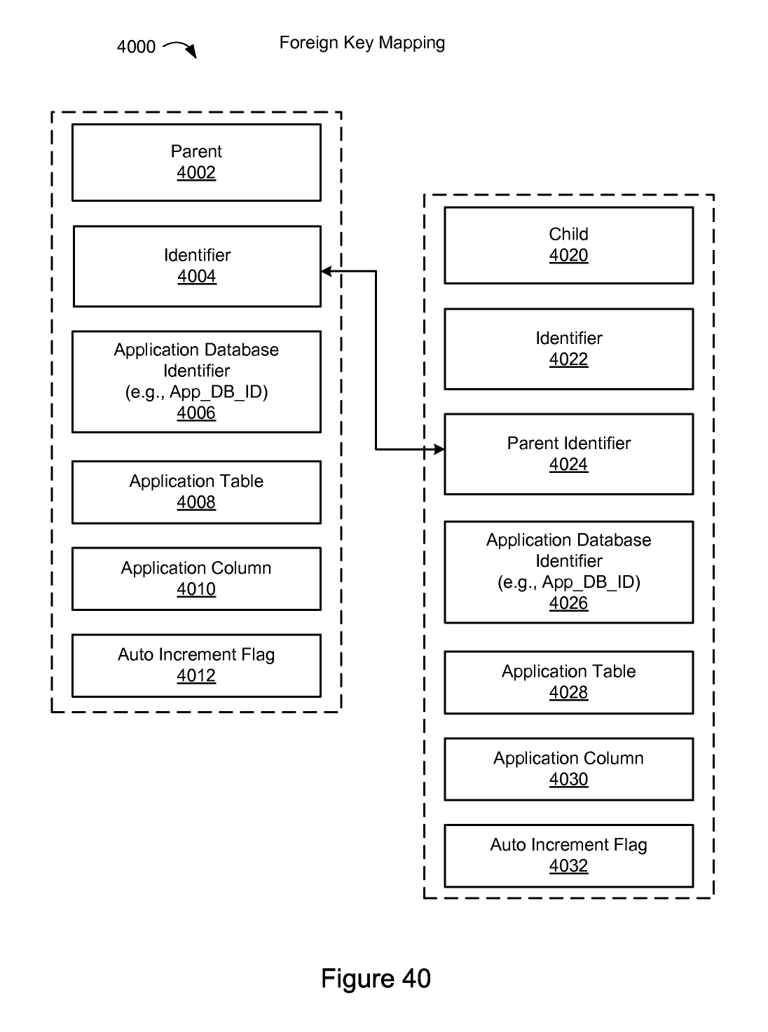

Foreign key mappings specify the relationships between a parent table and a child table. These mappings are used during the synchronization and conflict resolution processes. FIG. 40 presents a block diagram 4000 of an exemplary foreign key mapping, according to embodiments of the present invention. The foreign key mapping includes parent 4002 and child 4020. Parent 4002 includes one or more of identifier 4004, application database identifier (e.g., App_DB_ID) 4006, application table 4008, application column 4010, and auto increment flag 4012. Child 4020 includes one or more of identifier 4022, parent identifier 4024, application database identifier (e.g., App_DB_ID) 4026, application table 4028, application column 4030, and auto increment flag 4032. Parent identifier 4024 for child 4020 corresponds to identifier 4004 for parent 4002.

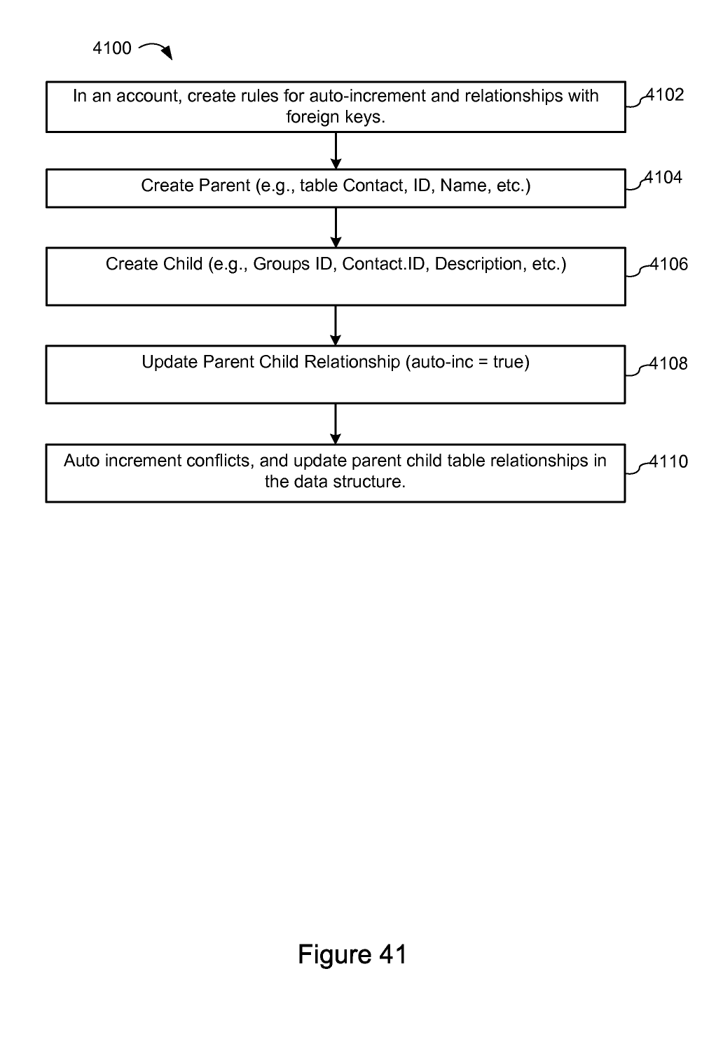

FIG. 41 presents a flowchart of an exemplary process 4100 for creating a foreign key mapping, according to embodiments of the present invention. In an account, rules for auto increment and relationships with foreign keys are created (4102). A parent is created (e.g., table Contact, ID, Name, etc.) (4104). A child is created (e.g., Groups ID, Contact.ID, Description, etc.) (4106). The parent-child relationship is updated (auto-inc=true) (4108). Auto increment any conflicts that may arise and updated parent-child table relationships in the data structure (4110).

### Summary of AOP

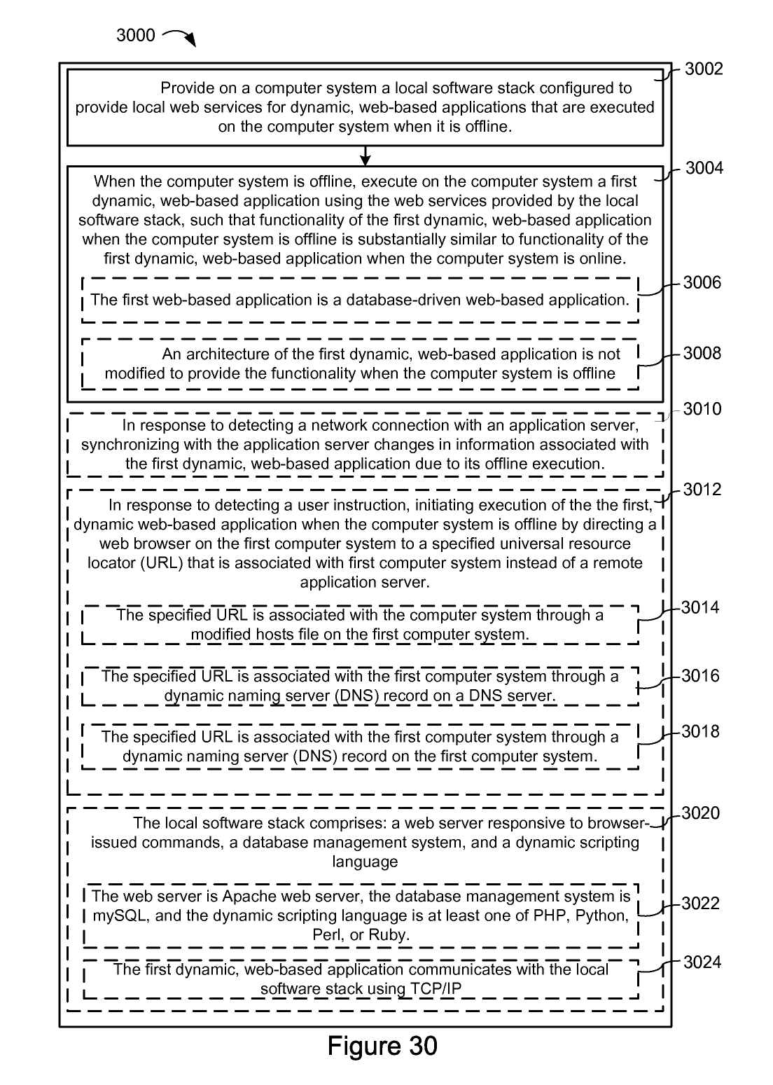

FIG. 30 presents a flowchart of an exemplary process 3000 for providing access to a web-based application while offline, according to embodiments of the present invention. The process begins by providing on a computer system a local software stack configured to provide local web services for dynamic, web-based applications that are executed on the computer system when it is offline (3002). When the computer system is offline, the computer system executes a first dynamic, web-based application using the web services provided by the local software stack, such that functionality of the first dynamic, web-based application when the computer system is offline is substantially similar to functionality of the first dynamic, web-based application when the computer system is online (3004). In some embodiments, the first web-based application is a database-driven web-based application (3006). In some embodiments, the architecture of the first dynamic, web-based application is not modified to provide the functionality when the computer system is offline (3008).

In some embodiments, in response to detecting a network connection with an application server, the computer system synchronizes with the application server changes in information associated with the first dynamic, web-based application due to its offline execution (3010).

In some embodiments, a user of the computer system initiates execution of the first, dynamic web-based application when the computer system is offline by directing a web browser on the first computer system to a specified universal resource locator (URL) that is associated with the computer system instead of a remote application server (3012). The specified URL can be associated with the computer system through a modified hosts file on the first computer system (3014). Moreover, the specified URL can be associated with the computer system through a modified hosts file on the first computer system (3016). Furthermore, the specified URL can be associated with the first computer system through a dynamic naming server (DNS) record on the first computer system (3018).

In some embodiments, the local software stack comprises: a web server responsive to browser-issued commands, a database management system, and a dynamic scripting language (3020). In some embodiments, the web server is Apache web server, the database management system is mySQL, and the dynamic scripting language is at least one of PHP, Python, Perl, or Ruby (3022). In some embodiments, the first dynamic, web-based application communicates with the local software stack using TCP/IP (3024).

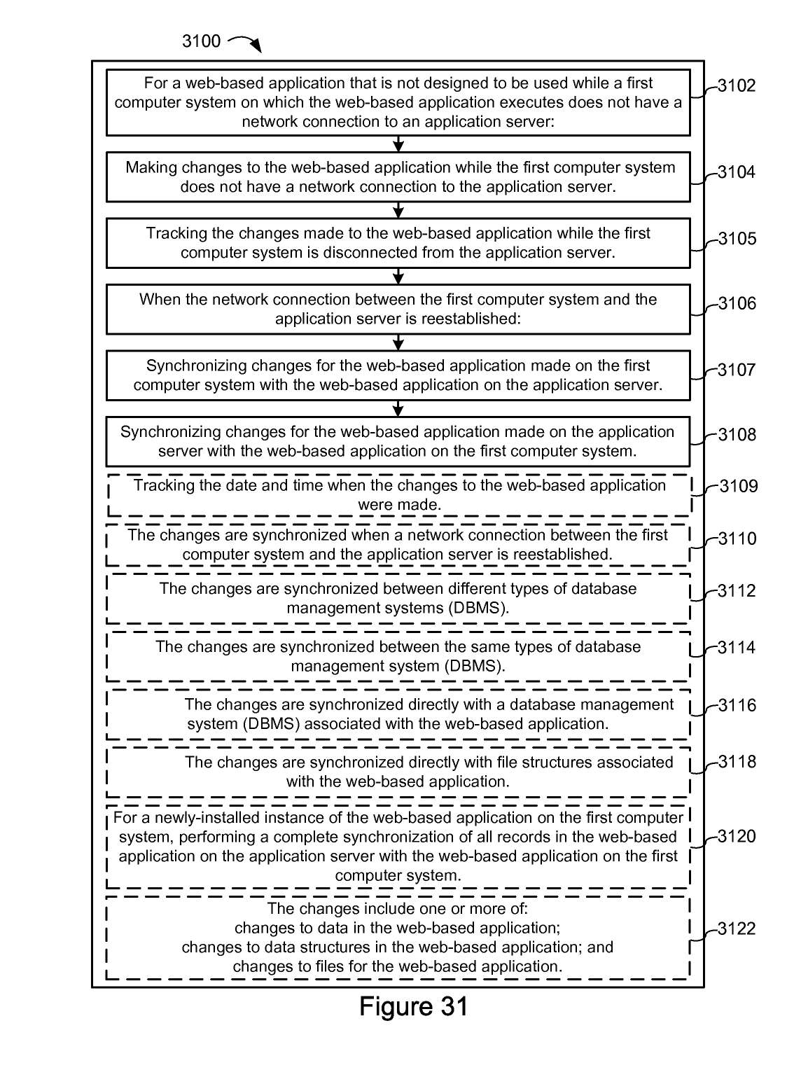

FIG. 31 presents a flowchart of an exemplary process 3100 for synchronizing a web-based application on a client computer system with a web-based application on an application server, according to embodiments of the present invention. For a web-based application that is not designed to be used while a first computer system on which the web-based application executes does not have a network connection to an application server (3102), changes are made to the web-based application while the first computer system does not have a network connection to the application server (3104). The changes made to the web-based application while the first computer system is disconnected from the application server are tracked (3105). When the network connection between the first computer system and the application server is reestablished (3106), the changes are synchronized for the web-based application made on the first computer system with the web-based application on the application server (3107). The changes are synchronized for the web-based application on the application server with the web-based application on the first computer system (3108).

In some embodiments, the date and time when the changes to the web-based application were made are tracked (3109). In some embodiments, the changes are synchronized when a network connection between the first computer system and the application server is reestablished (3110). In some embodiments, the changes are synchronized between different types of database management systems (DBMS) (3112). In some embodiments, the changes are synchronized between the same types of database management system (DBMS) (3114). In some embodiments, the changes are synchronized directly with a database management system (DBMS) associated with the web-based application (3116). In some embodiments, the changes are synchronized directly with file structures associated with the web-based application (3118). In some embodiments, for a newly-installed instance of the web-based application on the first computer system, the method further comprises performing a complete synchronization of all records in the web-based application on the application server with the web-based application on the first computer system (3120). In some embodiments, the changes include one or more of: changes to data in the web-based application; changes to data structures in the web-based application; and/or changes to files for the web-based application (3122).

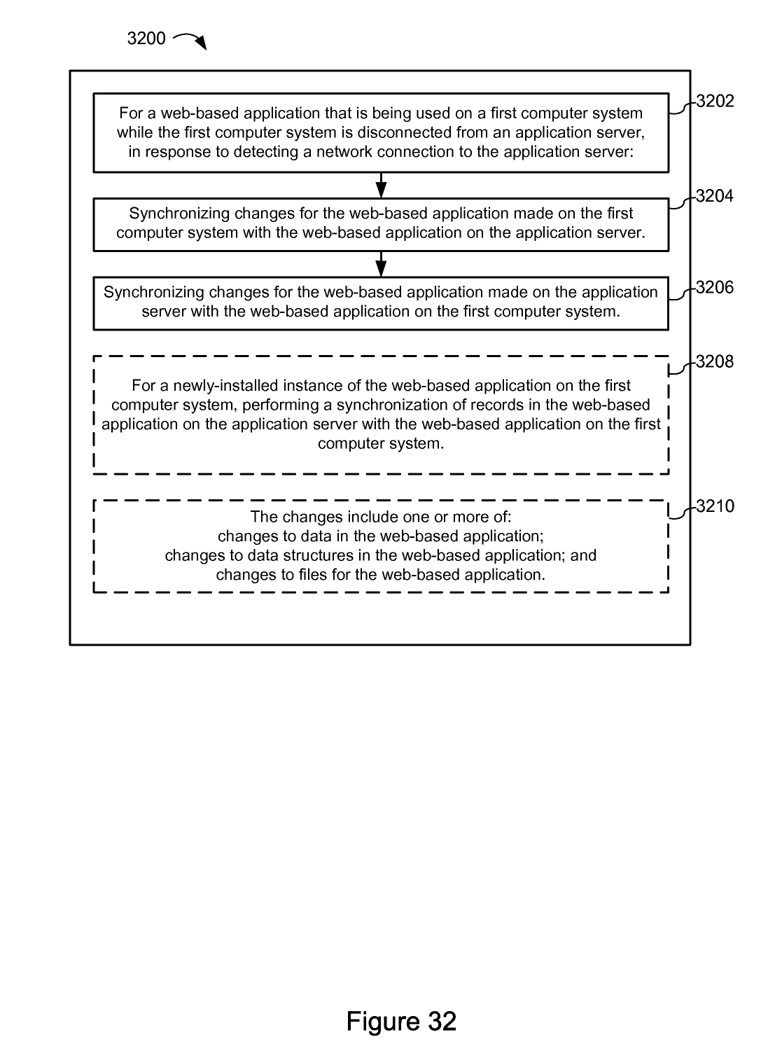

FIG. 32 presents a flowchart of an exemplary process 3200 for providing synchronizing a web-based application on a client computer system with a web-based application on an application server, according to embodiments of the present invention. For a web-based application that is being used on a first computer system while the first computer system is disconnected from an application server, in response to detecting a network connection to the application server (3202), changes made for the web-based application on the first computer system are synchronized with the web-based application on the application server (3204). The changes made for the web-based application on the application server are also synchronized with the web-based application on the first computer system (3206).

In some embodiments, for a newly-installed instance of the web-based application on the first computer system, a synchronization of records is performed in the web-based application on the application server with the web-based application on the first computer system (3208).

In some embodiments, the changes include one or more of: changes to data in the web-based application; changes to data structures in the web-based application; and/or changes to files for the web-based application (3210).

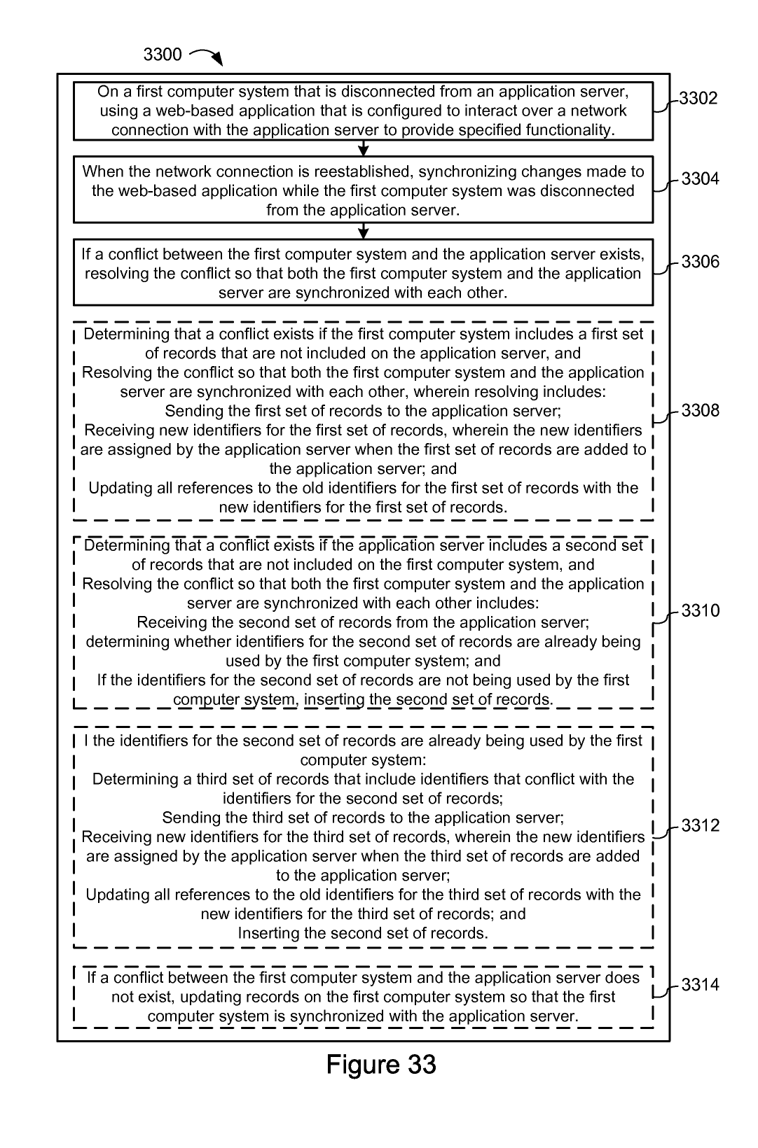

FIG. 33 presents a flowchart of an exemplary process 3300 for resolving conflicts between a web-based application on a client computer system and a web-based application on an application server, according to embodiments of the present invention. On a first computer system that is disconnected from an application server, a web-based application that is configured to interact over a network connection with the application server to provide specified functionality is used (3302). When the network connection is reestablished, changes made to the web-based application while the first computer system was disconnected from the application server are synchronized (3304). If a conflict between the first computer system and the application server exists, the conflicts are resolved so that both the first computer system and the application server are synchronized with each other (3306).

In some embodiments, a conflict exists if the first computer system includes a first set of records that are not included on the application server, and wherein resolving the conflict so that both the first computer system and the application server are synchronized with each other involves: sending the first set of records to the application server; receiving new identifiers for the first set of records, wherein the new identifiers are assigned by the application server when the first set of records are added to the application server; and updating all references to the old identifiers for the first set of records with the new identifiers for the first set of records (3308).

In some embodiments, a conflict exists if the application server includes a second set of records that are not included on the first computer system, and wherein resolving the conflict so that both the first computer system and the application server are synchronized with each other involves: receiving the second set of records from the application server; determining whether identifiers for the second set of records are already being used by the first computer system; and/or if the identifiers for the second set of records are not being used by the first computer system, inserting the second set of records (3310).

In some embodiments, if the identifiers for the second set of records are already being used by the first computer system, the following operations are performed: determining a third set of records that include identifiers that conflict with the identifiers for the second set of records; sending the third set of records to the application server; receiving new identifiers for the third set of records, wherein the new identifiers are assigned by the application server when the third set of records are added to the application server; updating all references to the old identifiers for the third set of records with the new identifiers for the third set of records; and inserting the second set of records (3312).

In some embodiments, if a conflict between the first computer system and the application server does not exist, records are updated on the first computer system so that the first computer system is synchronized with the application server (3314).

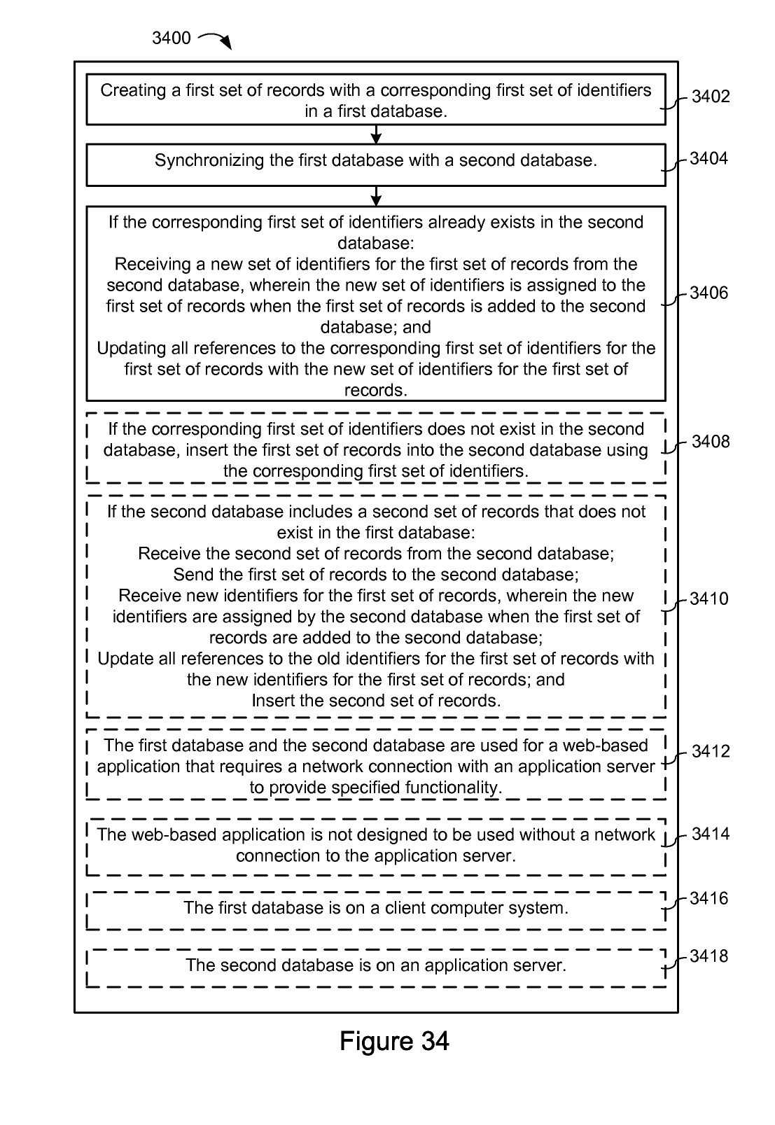

FIG. 34 presents a flowchart of an exemplary process 3400 for resolving conflicts between a web-based application on a client computer system and a web-based application on an application server that use automatically incrementing identifiers for database records, according to embodiments of the present invention. A first set of records are created with a corresponding first set of identifiers in a first database (3402). The first database is synchronized with a second database (3404). If the corresponding first set of identifiers already exists in the second database, a new set of identifiers is received for the first set of records from the second database, wherein the new set of identifiers is assigned to the first set of records when the first set of records is added to the second database, and all references to the corresponding first set of identifiers is updated for the first set of records with the new set of identifiers for the first set of records (3406).

In some embodiments, if the corresponding first set of identifiers does not exist in the second database, the first set of records is inserted into the second database using the corresponding first set of identifiers (3408).

In some embodiments, if the second database includes a second set of records that does not exist in the first database, the following operations are performed: receiving the second set of records from the second database; sending the first set of records to the second database; receiving new identifiers for the first set of records, wherein the new identifiers are assigned by the second database when the first set of records are added to the second database; updating all references to the old identifiers for the first set of records with the new identifiers for the first set of records; and inserting the second set of records (3410).

In some embodiments, the first database and the second database are used for a web-based application that requires a network connection with an application server to provide specified functionality (3412). In some embodiments, the web-based application was not designed to be used without a network connection to the application server (3414). In some embodiments, the first database is on a client computer system (3416). In some embodiments, the second database is on an application server (3418).

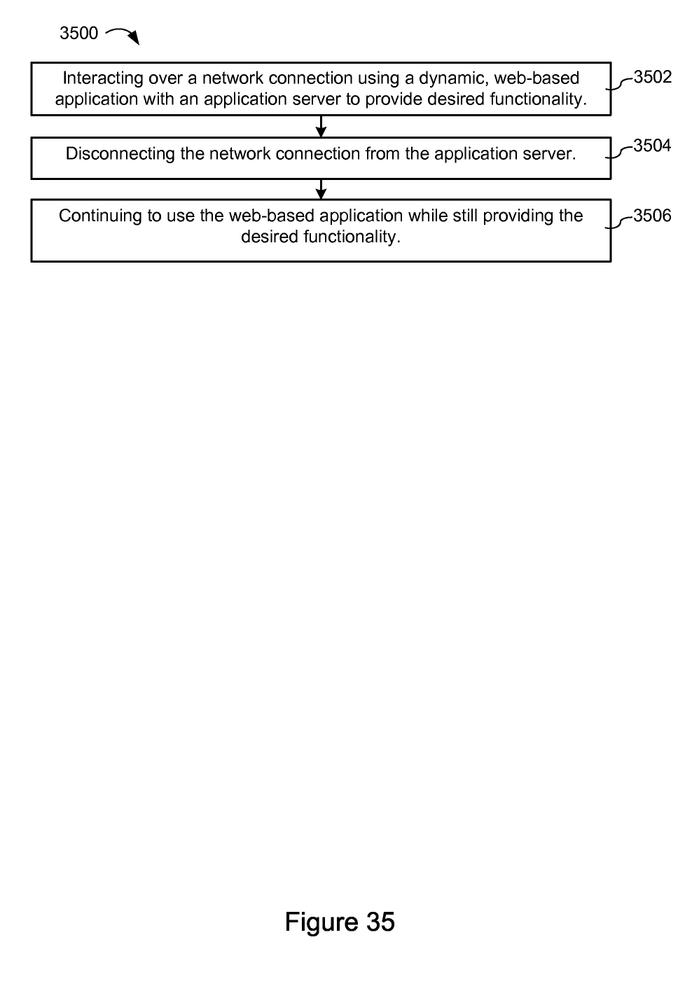

FIG. 35 presents a flowchart of an exemplary process 3500 for providing access to a web-based application while offline, according to embodiments of the present invention. A dynamic, web-based application configured to interact over a network connection with an application server to provide desired functionality is used (3502). The network connection is disconnected from the application server (3504). The web-based application continues to be used while still providing the desired functionality (3506).

In some embodiments, the dynamic, web-based application is a database-driven web-based application. In some embodiments, the architecture of the dynamic, web-based application is not modified to provide functionality when the computer system is offline. In some embodiments, in response to detecting a network connection with an application server, changes in information associated with the dynamic, web-based application due to its offline execution are synchronized with the application server. In some embodiments, a user of the computer system initiates execution of the dynamic, web-based application when the computer system is offline by directing a browser on the first computer system to a specified universal resource locator (URL) that is associated with the computer system instead of a remote application server.

Marketplace and Licensing

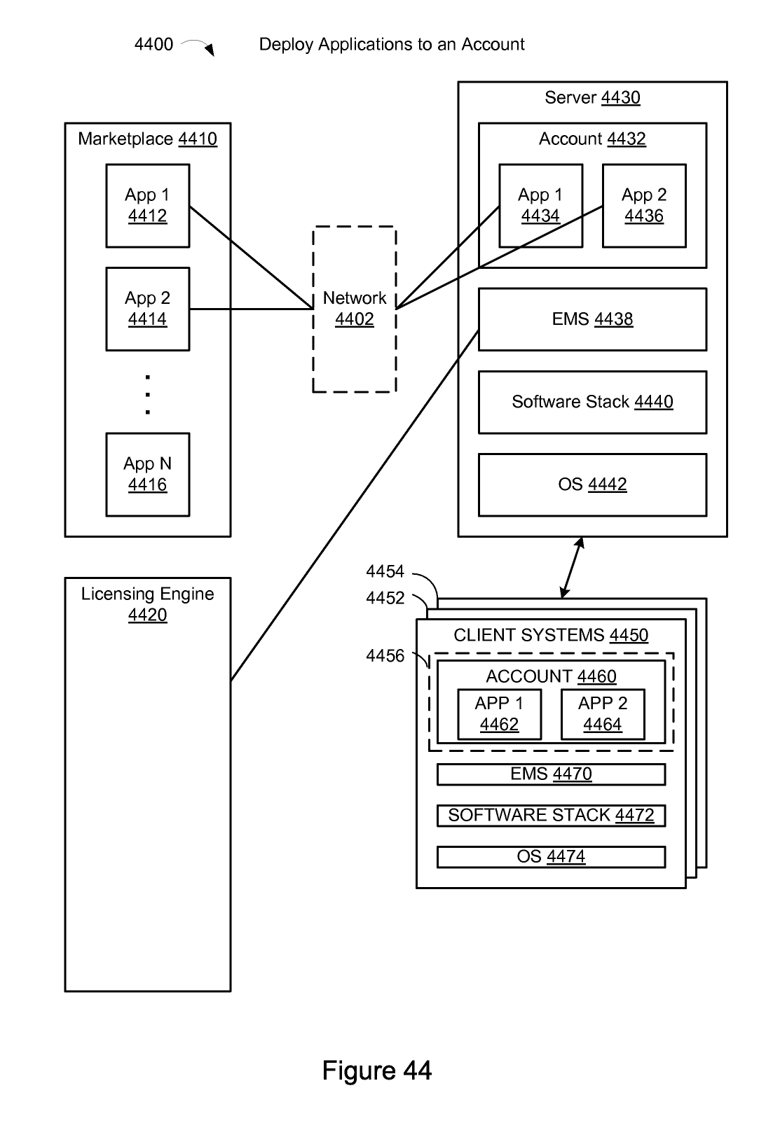

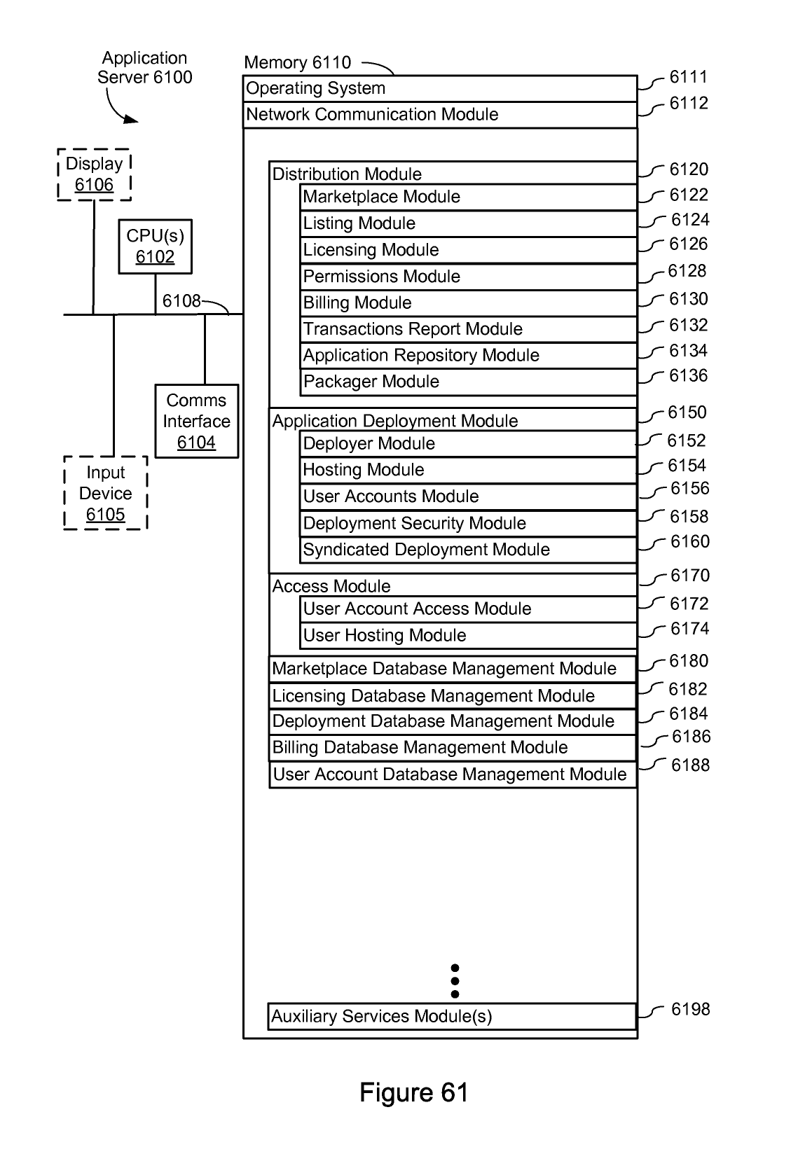

FIG. 44 is a high-level block diagram 4400 of a software marketplace, illustrating deployment of applications to a user account. A marketplace server 4410 makes available for distribution a plurality of software applications 4412, 4414, 4416. A licensing engine 4420 associates licensing terms with the software applications. In some embodiments, the licensing engine 4420 is part of the marketplace 4410. In some embodiments, the marketplace server is executed by a marketplace module 6122 (FIG. 61).

One or more software applications (e.g., application 4412 and application 4414) are deployed to an account 4432 hosted at a hosting infrastructure server 4430. An account is a data structure associated with a user, maintained on a server (e.g., the hosting infrastructure server 4430), where the account data structure includes information regarding which software applications are licensed to the user. In some embodiments the account may include license files, keys, etc. associated with one or more software applications. In some embodiments, applications licensed by a user are configurable to cross-synchronize, i.e. to synchronize data between the applications associated with the user. In some embodiments, the user associated with a user account could be an individual or an organization.

In some embodiments, the hosting infrastructure server is executed by a hosting module 6154 (FIG. 61). In some embodiments, the deployment is across a network 4402, e.g., where the hosting infrastructure server is located separately from the marketplace server 4410. Deployment means the software application is associated with the user account, such that the user associated with the user account is permitted to access the software application. In some embodiments, one or more files relating to the software application are provided to the user account as part of the deployment.

In some embodiments, the hosting infrastructure server 4430 and the marketplace server 4410 are logical servers on one physical system, for example application sever 6100 (FIG. 61). The deployment is performed in accordance with the licensing terms, provided by licensing engine 4420, in some embodiments executed by licensing module 6126 (FIG. 61). In some embodiments, the licensing engine controls the deployment of and access to software applications, and enforces license terms provided by the software vendor. In some embodiments, the licensing module provides the software code or executables to operate the licensing engine. The hosting infrastructure server 4430 includes an account management system (EMS) 4438 for managing the accounts 4432, executed by user accounts module 6156 (FIG. 61). A user account allows a user (person licensed to use software applications provided by the marketplace) to authenticate to system services. The user account also provides a user with the opportunity to be authorized to access deployed software applications. Users may need to identify themselves for the purposes of accounting, security, logging and resource management. In some embodiments, a user identifies him or herself using an account identifier and a username, and in some embodiments the user also has a password.

A software stack 4440 and operating system 4442 provide the software architecture to support the account framework and application execution. In some embodiments, the network 4402 is the Internet or an intranet or local connection between the marketplace 4410 and server 4340.

One or more client systems 4450, 4452, 4454 access the hosting infrastructure server 4430 to execute the applications. In some embodiments, the client systems correspond to application client 6200. In some embodiments, one or more of applications 4434, 4436 are executed at the server 4430, and results are displayed to the client through a client application or browser, executed by client/browser display module 6215. In some embodiments, applications are run in a local mode (e.g., AOP mode as described earlier) where a client hosts and executes applications 4462 and 4464 associated with an account 4460, corresponding to applications 4434 and 4436 hosted at hosting infrastructure server 4430. An account management system (EMS) 4470 manages the accounts at the client, in some embodiments executed by user account access module 6272. A client-side software stack 4472 and operating system 4474 provide the software architecture to support the account framework and application execution on the client.

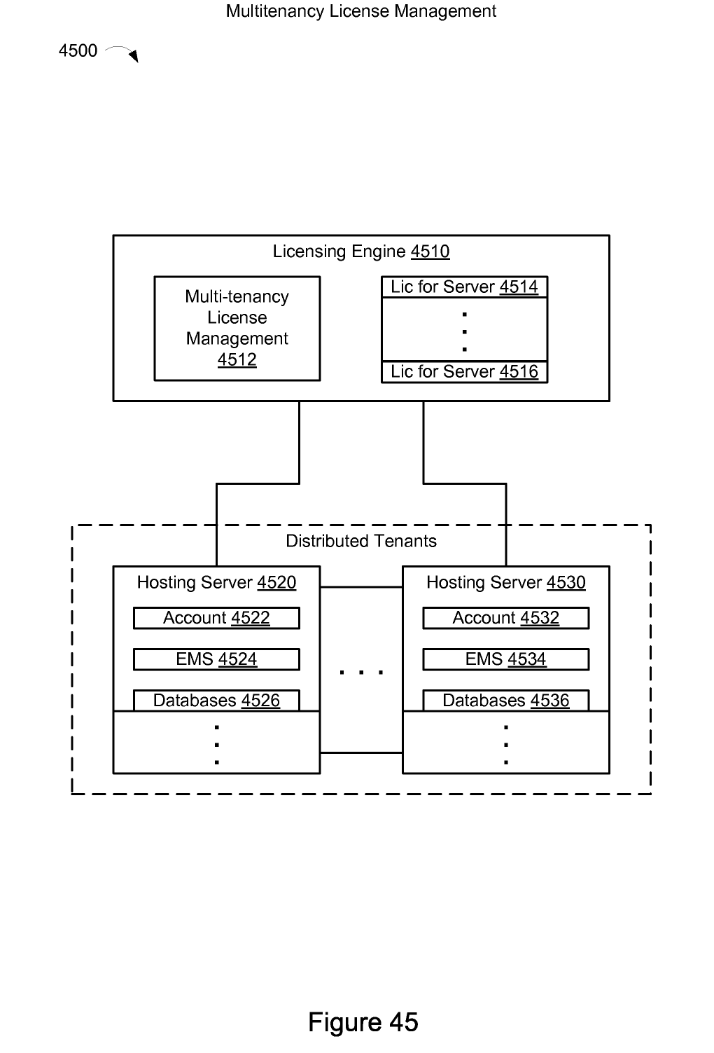

FIG. 45 illustrates a block diagram 4500 of a software marketplace illustrating management of licenses in a multi-tenancy environment. A multi-tenancy environment is one which allows multiple customers or users to access a shared data model. In some embodiments, the software marketplace includes a licensing engine 4510, executed by licensing module 6126, to control licensing for hosted infrastructure servers (e.g., 4520, 4530). A hosted infrastructure server is one that hosts user accounts, and in some embodiments software applications associated with those user accounts. In some embodiments, the hosted infrastructure server may exist as a logical server on the same physical hardware as the marketplace server. In some embodiments, the hosted infrastructure server may be physically separate from the marketplace server. A multi-tenant license management engine 4512 generates and manages licenses (e.g., 4514, 4516) for deployment and execution of software applications on hosted infrastructure servers. The licenses are generated in response to a selection by a software vendor from options provided by the marketplace application. The license terms are associated with a software application. Software applications are deployed to the hosting infrastructure servers in accordance with the licenses (4514, 4516).

In some embodiments, hosted infrastructure servers 4520, 4530 are distributed tenants in a multi-tenant licensing system. In a distributed tenant architecture, each user runs its applications in a distributed-computing environment. In some embodiments, the hosted infrastructure servers 4520, 4530 are logical servers on one or more physical servers. The hosted servers include an account (4522, 4532) into which applications are installed, and account management system (EMS) (4524, 4534) for managing the accounts, and databases (4526, 4536) for supporting the hosted infrastructure.

In some embodiments, the databases 4536 can include relational database management systems such as PostgreSQL, MySQL, and optionally Oracle, Microsoft SQL, or any other Open Database Connectivity (ODBC) interfacing database may be used.

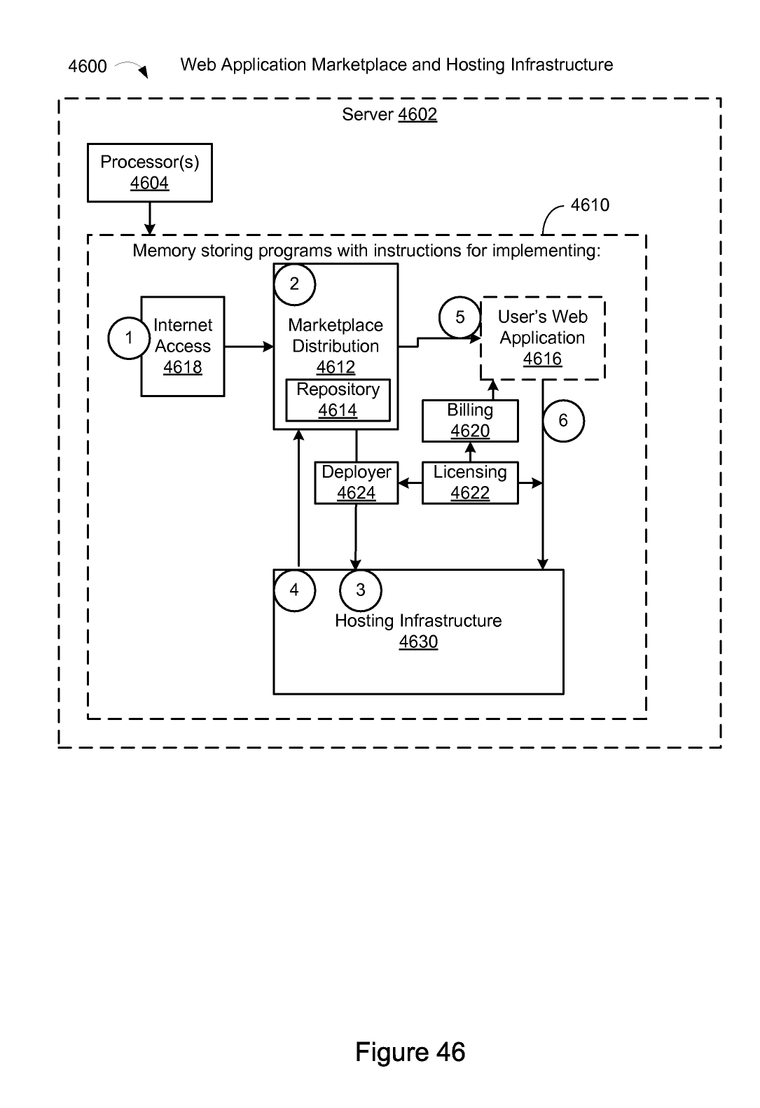

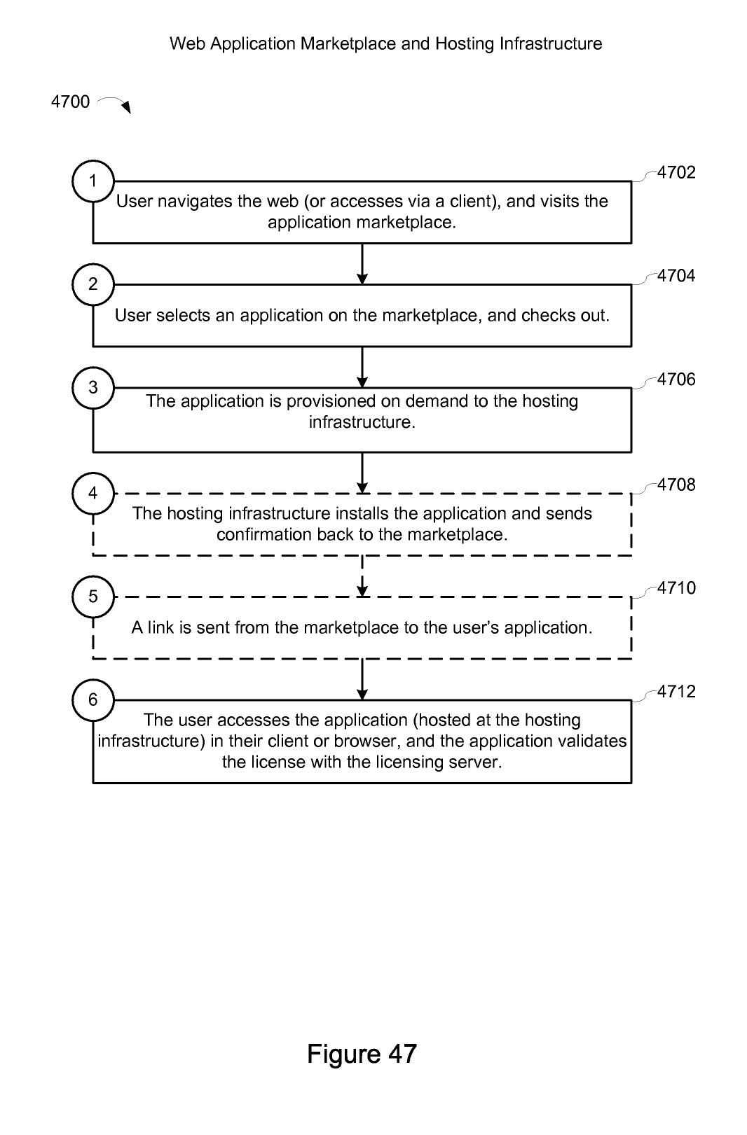

FIG. 46 illustrates a server system 4600 for a web application marketplace and hosting infrastructure. One or more servers 4602 hosts the marketplace application. The one or more servers include one or more processors 4604. The processors include memory 4610 storing instructions for implementing the marketplace application. In some embodiments, the circled numbers of FIG. 46 correspond to steps shown in the flow diagram of FIG. 47.

A marketplace application 4612 (executed in some embodiments by marketplace module 6122, FIG. 61) receives from a vendor a software application for distribution. The vendor can include a developer, coder, broker, or licensee with right to resell software. In some embodiments, the marketplace receives the application via an Internet (including in some embodiments a world wide web) connection 4618. License terms 4622 are associated with the software application by a licensing module 6126 (FIG. 61). The associating may include storing a license selection in a license manager, with a link/pointer to the account storing the respective software application. The software application is made available for distribution through the marketplace application, executed in some embodiments by the distribution module 6120 (FIG. 61). Making the software application available for distribution can include displaying (via a listing manager) a summary of the software application, price, license terms, and a platform(s) or framework (s) on which the software application operates, in a catalog of software applications hosted by the marketplace application. The distribution may be initiated through the marketplace app, but the distribution and deployment process do not have to take place through the marketplace application.

Throughout this application, displaying means that the server sends data for display to a client associated with the user. Prior to display, the data for display may be formatted by the server prior to sending to the client associated with the user, or may be formatted by the client after receiving the data, or may include a combination of these operations.

In some embodiments, the marketplace application presents a description of the license terms to a user, via the user's web application or client 4616. This presenting may be performed by the listing module 6122 (FIG. 61). The description can be a full or brief description (e.g., open source, proprietary, source code, object file, repackaging, etc.) or an icon indicating a license type associated with the software application.

In response to a user selection of one or more software applications from the marketplace 4612, the software application is deployed by deployer 4624 to one or more user accounts on one or more hosting servers 4630. In some embodiments, a deployment confirmation is sent back to the marketplace 4612. The hosting servers 4630 may be provided by the marketplace operator, or may be provided by the user. The hosting servers 4630 may be physical servers, or virtual servers. The deployment is performed in accordance with the license terms, executed by application deployment module 6150 (FIG. 61). In some embodiments, the deploying is associated with a billing operation 4620. In some embodiments, the one or more user accounts are accounts associated with the user who made the request to deploy the software application. Deploying includes at least one of the following: downloading the software application to the one or more user accounts, and/or enabling a flag associated with the software application in the one or more user accounts, enabling a license for the software application to the one or more user accounts, where the application itself stays stored at the marketplace server.

In some embodiments, a software vendor provides a license key to the marketplace application, whereby the marketplace application or a related application deploys/provisions the license key to a user account, and makes an API call to the software vendor at or after the time that the software application is licensed by the user. An application programming interface (API) is a set of declarations of the functions (or procedures) that an operating system, library or service provides to support requests made by computer programs. In some embodiments, the purpose of the API call is to inform the software vendor that a particular user or account has licensed the software application, which version is licensed, etc. In some embodiments, this information is beneficial to the software vendor when responding to technical support requests from the user.

In some embodiments, a software vendor may provide a license key associated with the software application to the marketplace application, and the license key is deployed to an account associated with a licensee. In some embodiments, the deployed license key enables the account to access or execute the software application. In some embodiments, the purpose of the license key is to enforce licensing terms.

In some embodiments, a software vendor may provide a license key update to the marketplace application, and the license key update is deployed to an account associated with a licensee, where the license key update modifies an already installed license key. In some embodiments, this modification includes extending or shortening a period of time during which the account may access the software application. In some embodiments, this modification includes adding or removing features that the account may access in the software application. When the application is deployed to an account associated with a user, in some embodiments confirmation is provided to the user, and then the user can access and run the application deployed at hosting infrastructure 4630.

In some embodiments, the hosting infrastructure servers are physically separate from the marketplace servers hosting the marketplace application. In some embodiments, the deploying of a software application is performed in response to a user request to deploy the software application. In some embodiments, the marketplace application determines a user account type, and based on the user account type, prepares to deploy (via the deployer) a software application to the user account.

In some embodiments, distribution to a user through the marketplace application 4612 is performed through a website (e.g., 4618) associated with the marketplace application. In some embodiments, distribution to a user through the marketplace application includes distribution through a client associated with the marketplace application 4612, where the client accesses the marketplace through a secure connection.

In some embodiments, the software application is packaged, executed in some embodiments by packager module 6136, FIG. 61, for distribution via the marketplace application 4612 hosted by the one or more servers 4602. The packaging can include one or more of parsing code for the software application, performing quality control for the software application, testing the software, packaging the software application for distribution, and packaging an update to the software application or packaging an update to the licensing of an application. In some embodiments, the packaged software application is stored in an application repository 4614.

In some embodiments, software applications are presented, described and made available at the marketplace application by a listing manager, executed by listing module 6124, FIG. 61. The listing manager performs one or more of storing listings (sale details for software applications), storing technical articles and information, and storing support resources (help, customer support, etc.). The listing manager may also provide one or more of a search function, a list of most popular software applications, a package deal for licensing a suite of software applications, a customer review, and other related functions. In some embodiments, the listing manager includes a store listing for licensing the software application. In some embodiments, the marketplace application stores, or stores links to, technical support for the software application. This technical support includes application notes, instructional articles, datasheets, frequently asked questions (FAQs), etc.

FIG. 47 illustrates a flowchart 4700 of operations for selecting and deploying a software application in a user account. A user navigates (1) the web (or accesses via a client), and visits the application marketplace (4702). The user selects an application from the marketplace (2), and checks out (4704). The application is provisioned (3) (or deployed) on demand to the hosting infrastructure (4706). In some embodiments, the hosting infrastructure installs the application and sends confirmation (4) back to the marketplace (4708). In some embodiments, a link is sent (5) from the marketplace to the user's application (4710). The user accesses the application (6) and the application validates the license with the licensing server (hosted at the hosting infrastructure) via their client or browser (4712).

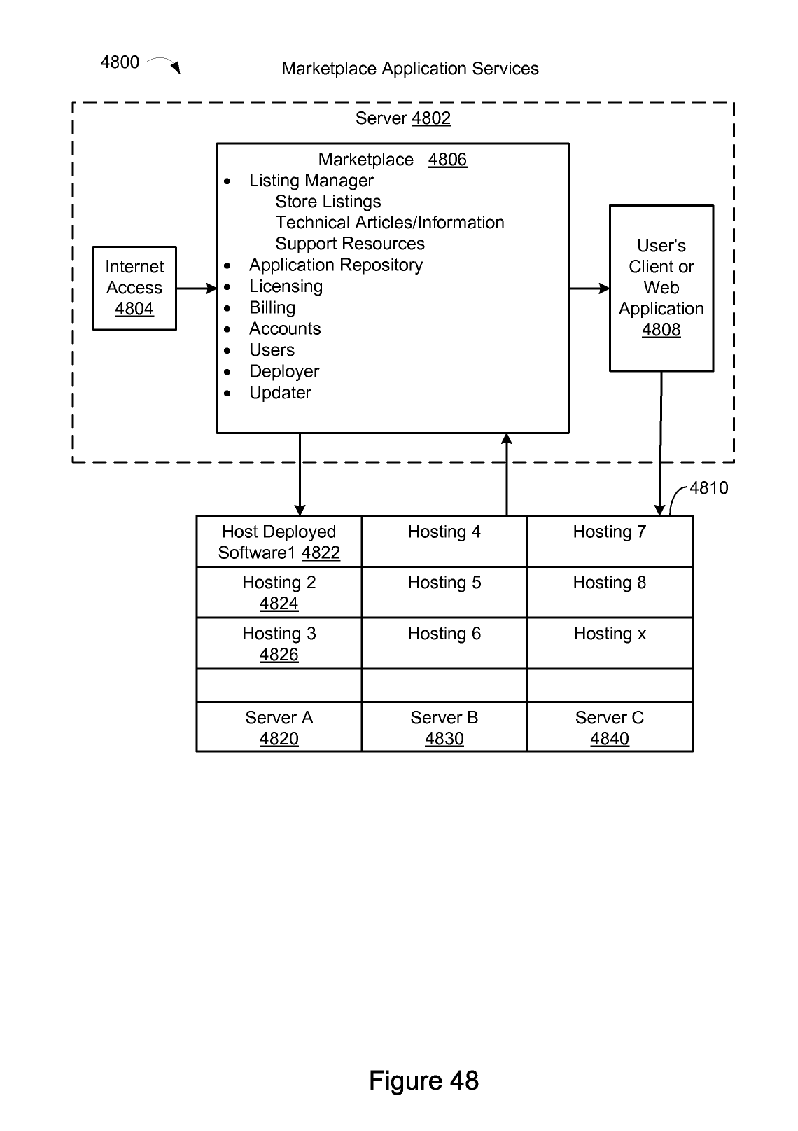

FIG. 48 illustrates a system 4800 including a marketplace server 4802 and a hosting infrastructure 4810. The hosting infrastructure includes one or more hosting servers 4820, 4830, 4840. The one or more hosting servers include one or more deployed software applications 4822, 4824, 4826.

A user accesses a marketplace 4806 via a web connection or client 4804. The user selects and checks out a software application, as described. The software application is hosted at the one or more hosting servers, e.g., deployed software application 4822, at server 4820. The user accesses the deployed software through a client or web connection 4808, as described. Each server may host one or more software applications associated with one or more user accounts. The servers may be physical servers or logical servers operating in one or more groups on a physical server. User accounts are managed by user accounts module 6156 (FIG. 61).

In some embodiments, deploying an application (in some embodiments executed by or under the control of a deployer module 6152, FIG. 61) includes downloading the software application to the one or more user accounts. User account access is managed by user account access module 6172 (FIG. 61). In some embodiments, deploying an application includes activating a flag associated with the software application in the one or more user accounts that indicates when the application is available to a user associated with the account. In some embodiments, the flag enables the software application for the user. In some embodiments, deploying an application includes activating a license for the software application in the one or more user accounts, which activation renders the software application available to a user associated with the corresponding account. In some embodiments, deploying an application includes providing the software application for hosting by a user on hosting servers associated with the user, the hosting executed by user hosting module 6174 (FIG. 61).

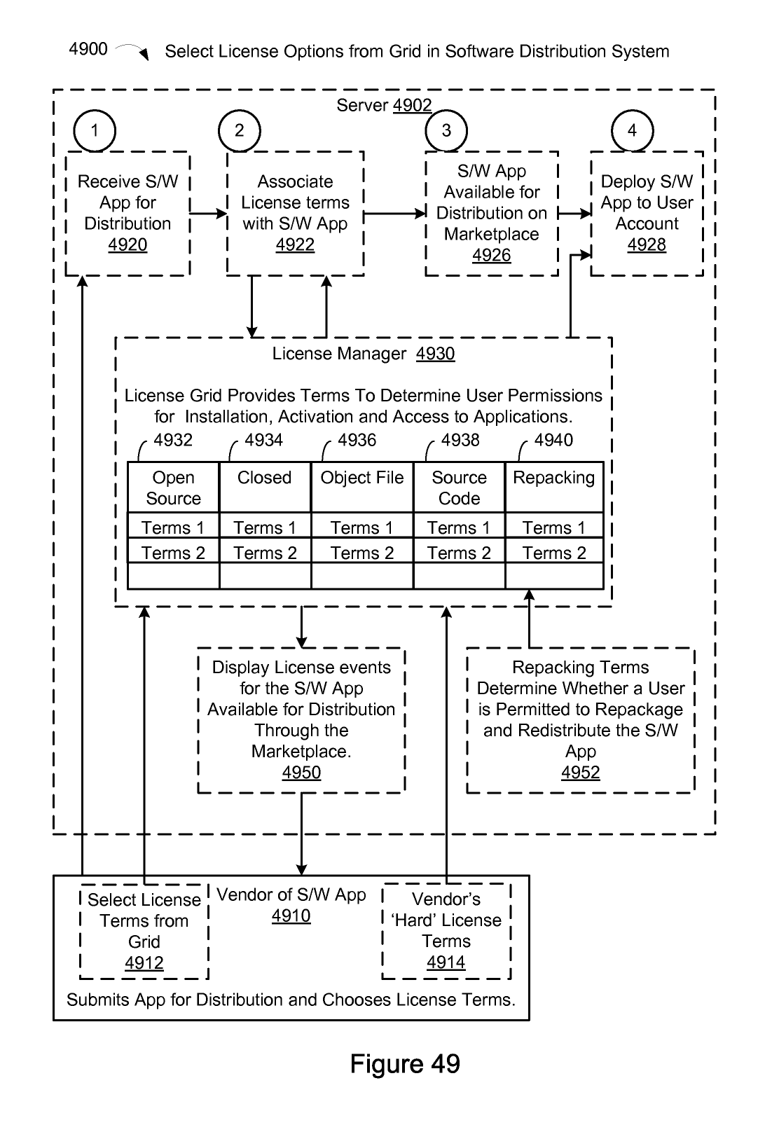

FIG. 49 illustrates a server system 4900 for selecting license options in a software distribution marketplace. This figure shows operations at the server, under control of the licensing manager, where a vendor may associate one or more license terms with its software application. The server system includes one or more servers 4902, hosting a marketplace application. The server system is configured to receive from a vendor 4910 a software application for distribution 4920. The server system includes a licensing manager 4930 and is configured to perform under control of the license manager 4930 a number of operations 4920-4928 related to software vendor selection of license terms associated with the software application.

License manager 4930 is configured to generate license terms in response to a selection by the vendor from options provided by the marketplace application. The license terms are associated 4922 with the software application. In some embodiments, the license terms are stored in a licensing manager.

The server is configured to make the software application available for distribution (4926) through the marketplace application, in accordance with the license terms.

In some embodiments, the software application is deployed 4928 to one or more user accounts on one or more hosting servers, in accordance with the license terms. Deploying an application in accordance with the license terms means that conditions specified by the software vendor in the license terms (e.g., source code is to be hidden from the licensee) are enforced when deploying and when granting access to the software application. In some embodiments, a deployer enables or disables functions or options within the deployed software application, where this enabling or disabling is determined by the license terms provided by the software vendor.

In some embodiments, the deploying is in response to a payment associated with the one or more user accounts.

In some embodiments, the license terms are selected by a vendor 4910 of the software application. In some embodiments, the license terms are selected from a grid 4912 or set of options provided by the marketplace application. In some embodiments, the license terms include at least one of one or more open source licenses 4932, closed licenses 4934, object file licenses 4936, source code licenses 4938, and repacking licenses 4940. An open source license 4932 may provide typical license terms for open source software, e.g., a GNU license or BSD license, where the application source code is available under terms that allow for modification and redistribution without having to pay the original author. A closed license 4934 (also known as a proprietary license) is one that does not allow access to source code. An object file license 4936 is one that allows a user to execute the software application, but not to access any source code or object files. The source code license 4938 is on that allows a user to access the source code of the licensed software application, including making changes to the source code, but only allows distribution of binary code. In some embodiments, a repacking license 4940 determines whether a user of the software application is permitted to repackage and redistribute the software application, in accordance with repacking terms 4952. In some embodiments, the repacking license has an associated royalty. In some embodiments, the royalty is one selected from a wholesale royalty, a retail royalty, or a flat fee. In some embodiments, the vendor may upload its own term sheet(s) for its software applications, and this term sheet is provided with the software application.

In some embodiments, the license terms may address (limit or permit) redeployment of software to a user within the same organization as the licensing user. This might be the case where a system administrator licenses a software application, customizes it for her organization, and then redistributes the customized software to users within her organization. In some embodiments, the license terms may allow redeployment to the whole marketplace. This might be the case where a developer can license a first software application, write more code to add value to it, and resell the enhanced software application to the marketplace. In this situation, a licensee could be required to remit a royalty to the vendor of the first software application or to the marketplace administrator, or to some combination thereof.

In some embodiments, the license manager 4930 determines user permissions for installation, activation, and access to features of applications. In some embodiments, the license options provided by the marketplace application include an option to use license terms 4914 supplied by the vendor. These vendor-supplied terms 4914 may be considered as ‘hard’ terms (i.e., a fixed termsheet provided by the software vendor, rather than terms generated by the marketplace application in response to selections of terms by the user), since they are not generated by the license manager in response to a selection from the standard license options.

In some embodiments, the license manager 4930 includes a transaction reporter 4950 (executed in some embodiments by transactions report module 6132, FIG. 61) to display licensing events for a respective software application made available for distribution through the marketplace application. In some embodiments, this transaction reporter shows transactions going through the marketplace for a respective software application, including installation status, user check-in status, payment status etc. In some embodiments, the transaction reporter displays the licensing events to a respective vendor associated with the respective software application.

In some embodiments, a price associated with the software application is stored at a licensing manager separately from the software application. In some embodiments, the price is dynamically adjusted by the licensing manager in response to a selection by the software vendor, or by the marketplace administrator, or by usage metrics triggers embedded in the software application itself. In some embodiments, an adjustment to the price is provided to the marketplace, which updates pricing information to charge the adjusted price for licensed software applications.

In some embodiments, at least one selected from the group consisting of access duration, features, and price, is dynamically adjusted by the licensing manager in response to a selection by the software vendor, or by the marketplace administrator. The access duration includes a trial period for the software application, or other promotional offers. The features includes access to features (including new or premium features) within the software application. The price is the price associated with the licensed software application of features thereof. Vendors can also choose, bandwidth allowed, disk space, users, record table max limits and/or if ads are displayed in the application, among other things.

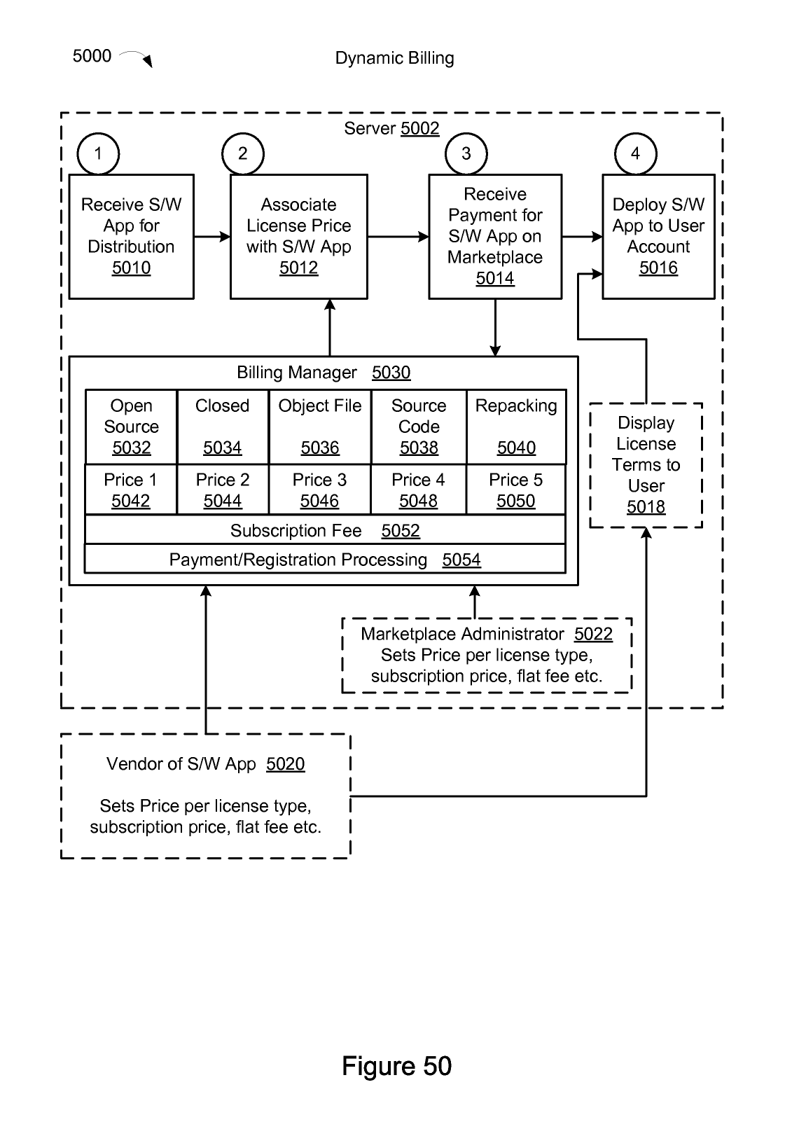

FIG. 50 illustrates a server system 5000 for performing dynamic billing in a software distribution marketplace. This figure shows operations at the server, under control of the billing manager, where a vendor may associate one or more prices with its software application. The server system includes a billing manager 5030, and is configured to perform under control of the billing manager 5030 a number of operations (including 5010-5016, indicated on FIG. 50 as circled numbers 1 to 4) related to user selection of license terms associated with the software application.

The server system includes one or more servers 5002, hosting a marketplace application 4806 (FIG. 48) and a billing manager 5030. The server system is configured to receive from a vendor a software application for distribution 5010, and store it in an application repository, executed by application repository module 6134 (FIG. 61). The system is configured to associate a licensing price (stored in the billing manager 5030) with the software application 5012, where the license price is controlled by billing manager 5030, executed by billing module 6130 (FIG. 61). The licensing management is executed by licensing module 6126 (FIG. 61). The vendor of the software application provides a price per license 5020, which may be stored by the server at the billing manager 5030. This price per license may be changed dynamically (i.e. changed ‘on the fly’) by the vendor 5020 or by an administrator 5022 of the software distribution marketplace. The billing manager 5030 updates the prices associated with each license type (if more than one) for a software application.

In some embodiments, a first price 5042 is associated with an open source license 5032, a second price 5044 is associated with a closed license 5034, a third price 5046 is associated with an object file 5036, a fourth price 5048 is associated with a source code license 5038, and a fifth price 5050 is associated with a repacking license 5040. In some embodiments, there are more or fewer prices associated with one or more of the license types. In some embodiments, a subscription or ‘flat fee’ price 5052 is supported by the billing manager. In some embodiments, the server 5002 receives a payment 5014 for licensing the software application. In some embodiments, the billing manager supports payment processing (for paid licenses). In some embodiments, the billing manager supports registration (where no payment required for a license) 5054.

During the licensing process, (e.g., before a user pays to license a software application), license terms associated with the software application, or a link to those license terms, are displayed 5018 to the user. In some embodiments, the license terms are provided to the user before executing the software application. In some embodiments, the license terms are provided as click-wrap license terms. The server is configured to deploy 5016 the licensed software application to an account associated with the user.

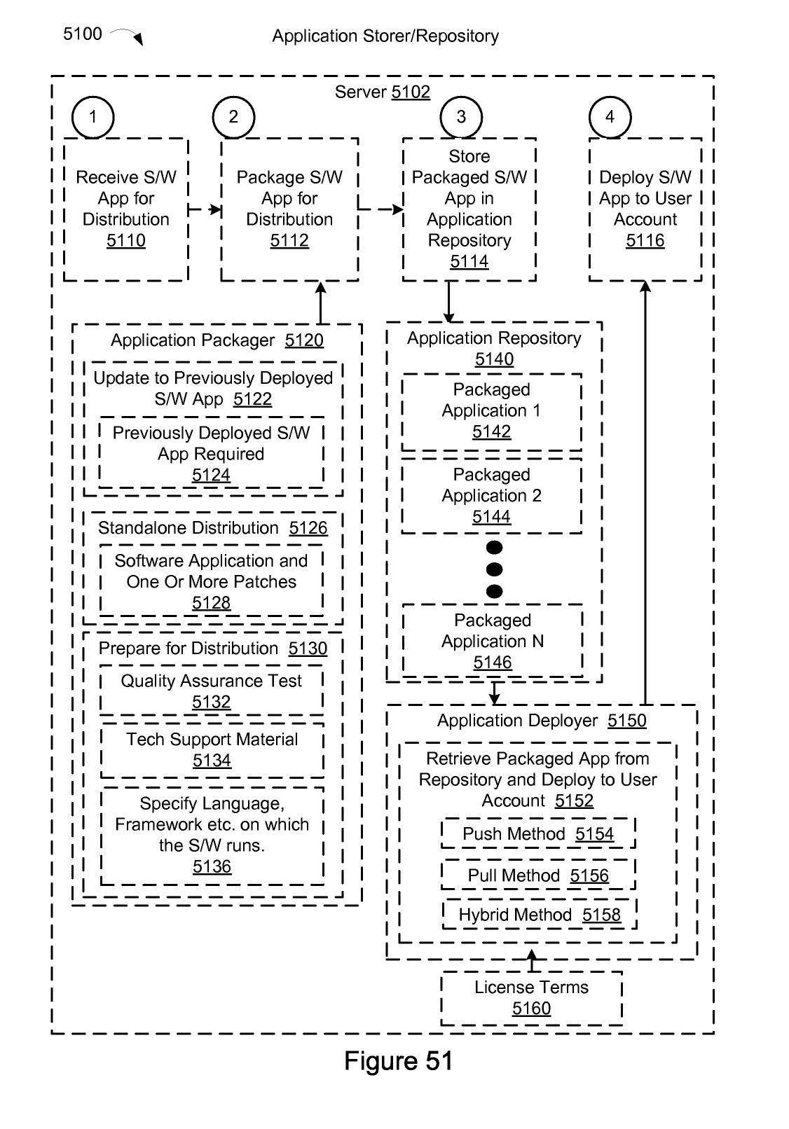

FIG. 51 illustrates a server system 5100 for managing an application repository and deployer in a software distribution marketplace. This figure shows operations at the server, under control of the application repository and/or deployer, where software applications provided by a software vendor may be deployed to a user account associated with a user. Server 5102 is configured to receive a software application from a software vendor for distribution 5110. An application packager 5120 (executed in some embodiments by a packager module 6136, FIG. 61) packages 5112 the software application for distribution. An application deployer 5150 deploys the software application to a user account 5116. The packaged application is stored 5114 in an application repository. In some embodiments, the application deployer serves as a gateway between the user account and the application repository 5140.

In some embodiments, the server 5102 hosts the deployed software application for one or more user accounts. The hosting includes executing the deployed software on behalf of the associated users. In some embodiments, the software application is hosted at a server separate from the server 5102.

In some embodiments, the application packager 5120 prepares updates 5122 to previously deployed software applications 5214. In some embodiments, this preparation included one or more of testing the software application for functionality and/or performance to ensure quality, providing technical support material (e.g., a manual, product application notes, etc.), and specifying a language and framework associated with the software application.

In some embodiments, the previously deployed function 5124 is required for the update 5122 to operate. Such an update is sometimes referred to as a ‘mini application’ and may include plugins or add-on features that can be bought from the store. In some embodiments, the ‘mini application’ may include updates to the applications.

In some embodiments, the application packager 5120 prepares updates to standalone distributions 5126. A standalone distribution is one that does not require a previously deployed function to operate. In some embodiments, the standalone distribution includes a software application and one or more patches to the software application 5128.

In some embodiments, the application packager 5120 prepares applications or updates for distribution 5130 by performing a quality assurance test 5132. This test may be automatic or may involve some human input. The application packager 5120 includes technical support material 5134 with the packaged application (e.g., a readme file). The application packager 5120 may include instructions to specify what language, framework, database, supporting packages and libraries, or operating system the software application is compatible with 5136.

In some embodiments, the application repository 5140 stores a plurality of packaged applications 5142, 5144, to 5146. These packaged applications are those applications that are ready for distribution and deployment to a user account.

In some embodiments, the application deployer 5150 retrieves a packaged application from the repository 5140 if it does not exist in a local cache and then deploys it to a user account (5152, 5116). The deployer can deploy an application by a push method 5154 (where a user does not have any choice about whether or not to receive the deployed update or application), by a pull method 5156 (where the user chooses to retrieve the deployed update), or by a hybrid method 5158 (which may be a combination of the push and pull methods, or another method). The application deployer performs deployment in accordance with license terms 5160.

In some embodiments, the application deployer 5150 generates a new user account compatible with the software application and deploys the software application to the new user account. The account type can include one or more of operating system, language, or framework associated with the user account.

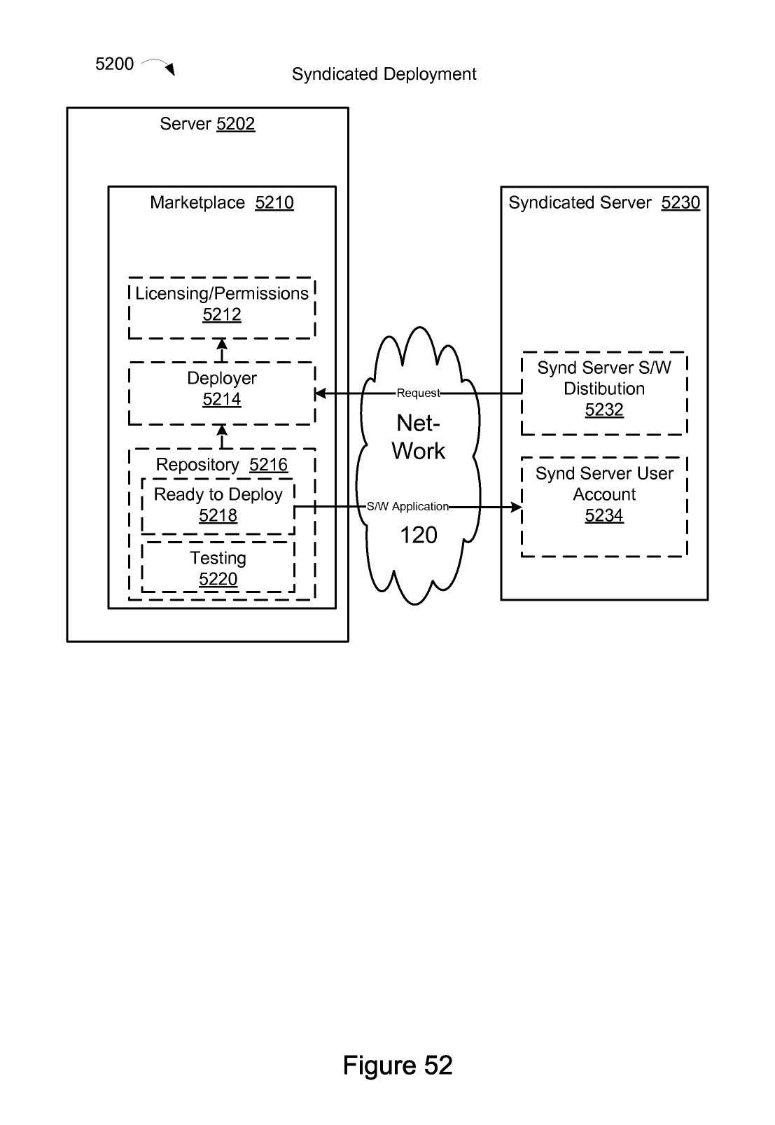

FIG. 52 illustrates a server system 5200 for performing syndicated deployment of a software application across a network, executed by syndicated deployment module 6160 (FIG. 61). Server 5202 is configured to receive a request from syndicated server 5230, across a network 120, as described. In some embodiments, the request is received at marketplace 5210, including at deployer 5214. The server identifies one or more user accounts associated with the request. The server (including deployer 5214) checks licensing terms and permissions 5212, to determine if the syndicated server, including syndicated server software distribution 5232 and syndicated server user accounts 5234, have permission to receive the deployed software application, and if the syndicated deployment is in accordance with the license terms.

In some embodiments, deploying an application includes providing through an application deployer, across a network to one or more user accounts, a software application stored at the application repository. The deployer accesses repository 5216 and retrieves an application ready to deploy 5218. This application is deployed to syndicated server user account 5234, in accordance with the license terms.

In some embodiments, deploying an application includes presenting the software application for deployment to a user or to a syndicated server associated with the user. In these embodiments, the syndicated server deploys the presented software application into a user account associated with the syndicated server. A syndicated server is a server that is logically separate from the marketplace server. In some embodiments, the syndicated server is also physically separate from the marketplace server and is controlled by someone other than the controller of the marketplace and hosting servers. In some embodiments, the syndicated server primarily provides services other than the licensing of software applications in a marketplace. In some embodiments, the syndicated server offers to its users the ability to license software applications from the marketplace by providing its users with an interface (in some embodiments, implemented using an API) by which to browse and/or license software applications from the marketplace. In some embodiments, a licensed application is deployed to an account associated with the user, hosted by or under the control of the syndicated server.

In some embodiments, the software application is made available for distribution through the syndicated server. In this embodiment, the syndicated server acts as a marketplace front for the software application, and the application is licensed by a user through the syndicated server.

In some embodiments, deploying an application includes selecting one of a plurality of software applications, compatible with the one or more user accounts, from the application repository. The selected software application is deployed to an account associated with the user, hosted by the hosting infrastructure server.

In some embodiments, the application repository stores software applications in any one or more of a number of states, including at least one state of a ready to deploy state, an undergoing quality assurance state (undergoing testing 5220), a ready to submit for quality assurance state, and an unfinished state. The ready to deploy state means that the software application is fully tested and is ready for licensing to a user. Only software applications in the ready to deploy state can be listed on the marketplace and licensed to a user, and thus only software applications in this state can generate revenue. The undergoing quality assurance state means that the software application is being tested and verified for quality, and is not yet ready for licensing to a user. The ready to submit for quality assurance state means that the software application code is written, but testing and quality assurance has not yet been performed on it. The unfinished state means that the software application is still in development.

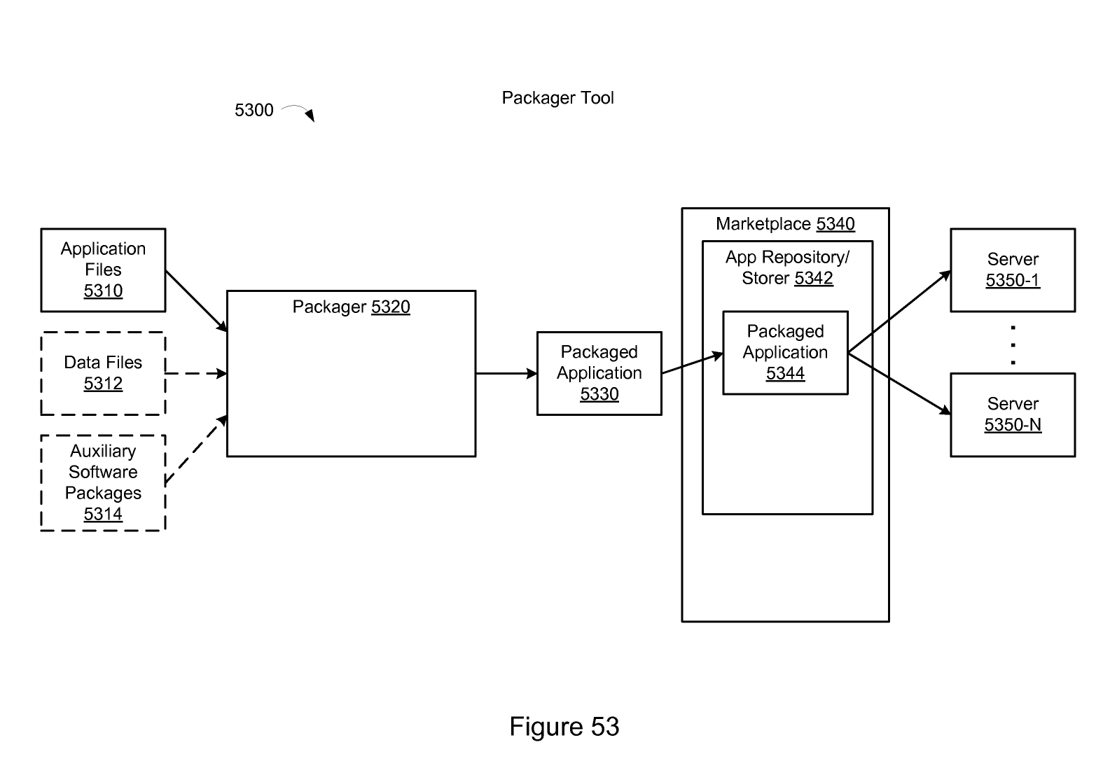

FIG. 53 illustrates an embodiment of a server system 5300 for packaging software applications for distribution to a user account. The system 5300 includes a packager 5320, executed in some embodiments by a packager module 6136 (FIG. 61).

The packager receives as input software application files 5310, and prepares them for deployment. In some embodiments, the packager also receives data files, local install scripts 5312 and auxiliary software packages 5314 associated with the software application files 5310. The packager prepares one or more of the files 5310, 5312 and 5314, and generates a packaged application 5330, which is stored in application repository 5342 associated with marketplace application 5340. Upon licensing by one or more users 1 to N, the packaged application 5344 is deployed to one or more accounts 1 to N associated with the users 1 to N, on hosting application servers 5350-1 to 5350-N. This deploying is performed by the application deployer.

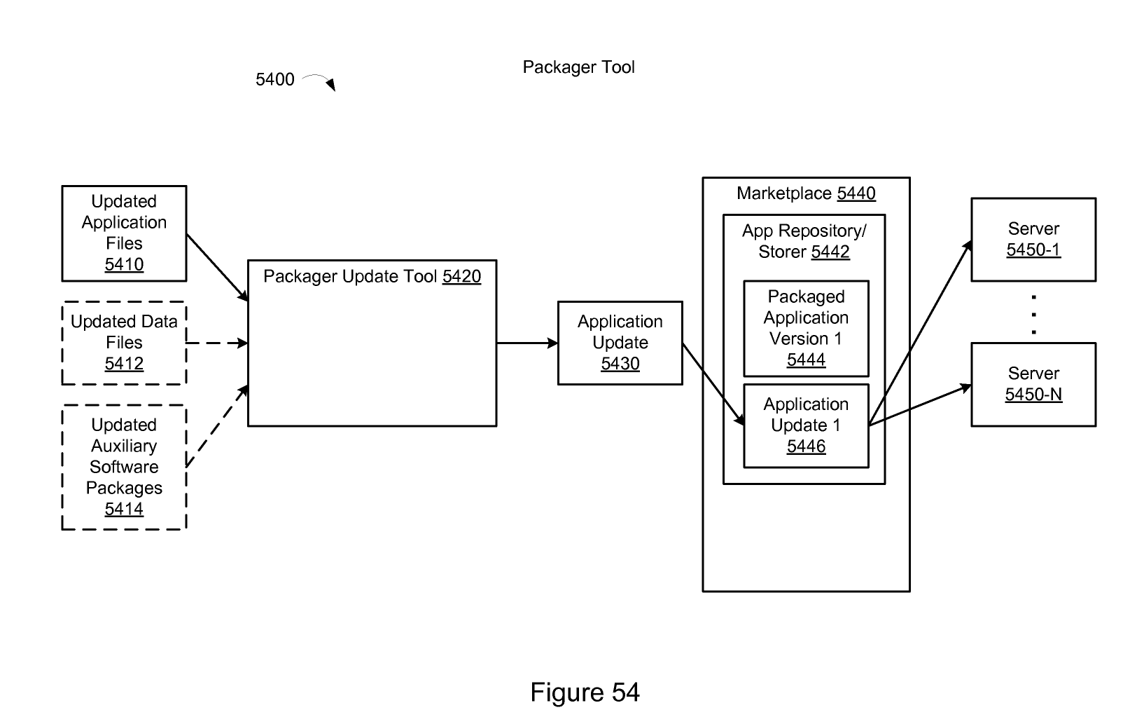

FIG. 54 illustrates an alternate embodiment of a server system 5400 for packaging updates to software applications for distribution to a user account. The system 5400 includes a packager update tool 5420, which in some embodiments is executed by the packager module 6136 (FIG. 61).

The packager receives as input updated software application files 5410, updated data files, local install scripts 5412, and updated auxiliary software packages 5414 prepares them for deployment, and generates an updated (patched) application 5430. In some embodiments, the updated application (patch) 5446 is stored in the application repository 5442 associated with marketplace application 5440, for deployment to one or more servers 5450-1 to 5450-N. The updated application (patch) is deployed to servers that already have the original packaged application (e.g., version 1) 5444 installed.

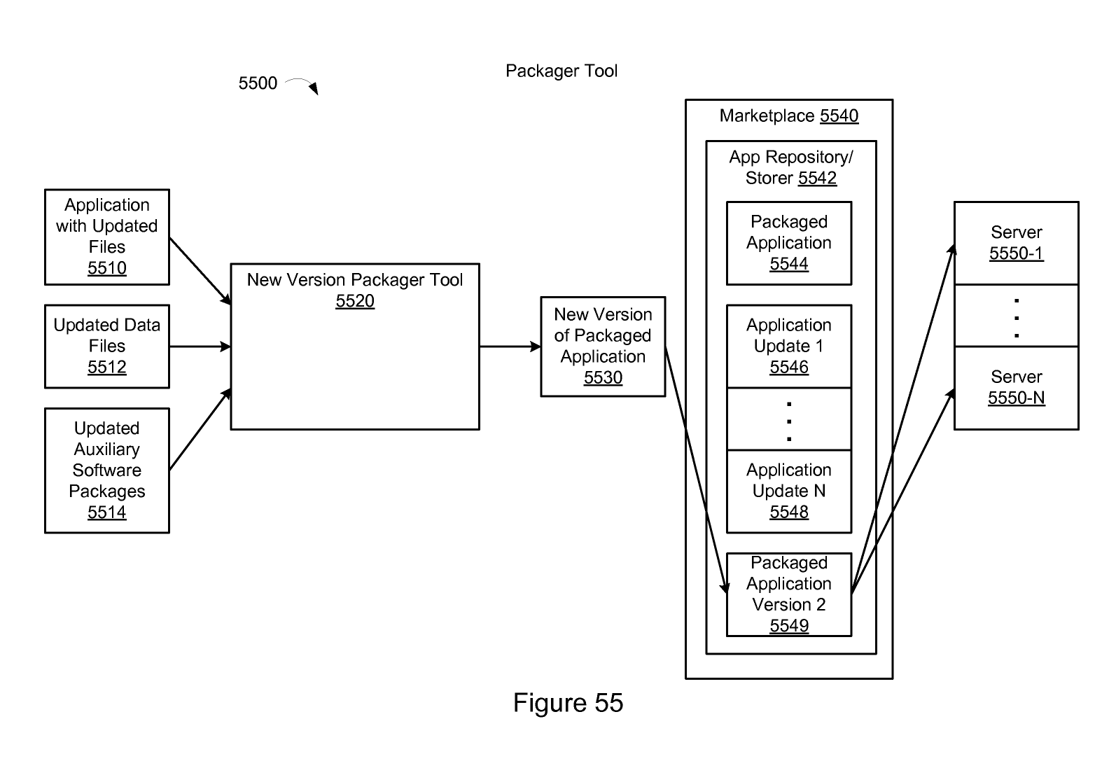

FIG. 55 illustrates an alternate embodiment of a server system 5500 for packaging updates together with software applications for distribution to a user account. System 5500 includes packager 5520, executed by packager module 6136 (FIG. 61). Packager 5520 packages both software applications and updates files for the software applications separately or together for distribution.

The packager receives as input software application files 5510, updated data files 5512, and updated auxiliary software packages 5514; prepares them for deployment either together or separately; and generates a packaged new version of an application 5530. In some embodiments, a packaged new version of an application is stored in the application repository 5542 associated with the marketplace application 5440, for deployment to one or more servers 5550-1 to 5550-N. The packaged new version of the application 5549 is deployed by the application deployer to one or more user accounts associated with hosting infrastructure servers. In some embodiments, the application repository 5542 stores the original packaged application 5544, and updates 5546 to 5548 to the packaged application. In some embodiments, when the packaged new version of the application 5549 is placed in the application repository 5542, the older version 5544, and updates 5546 to 5548, may be removed from the application repository.

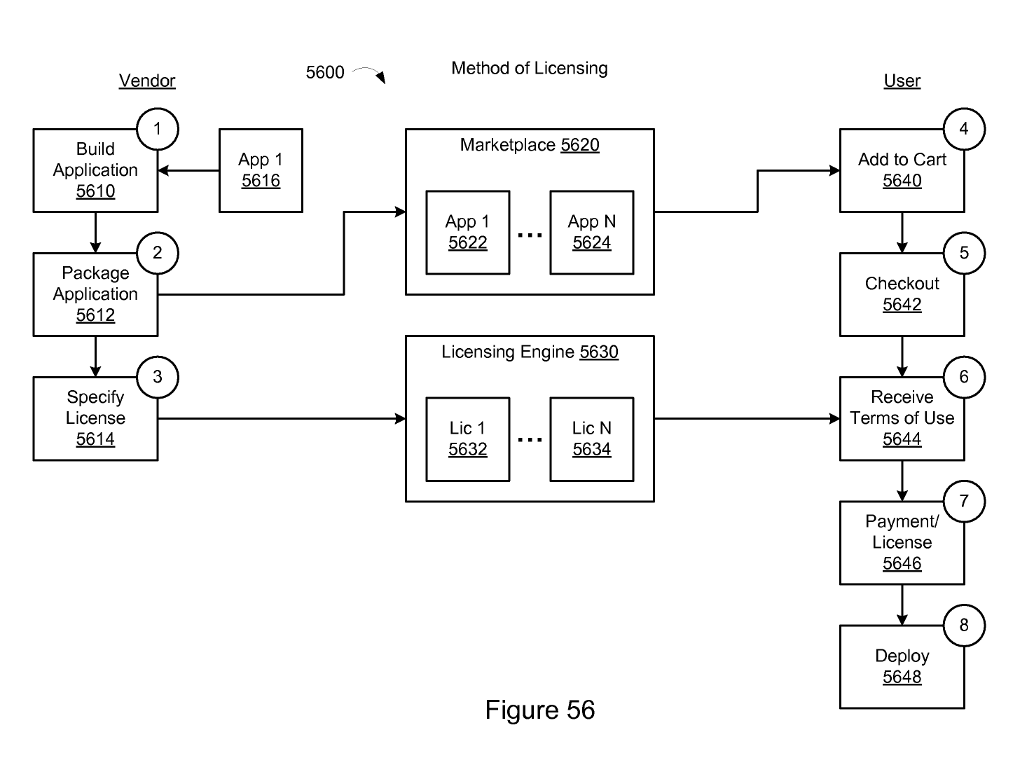

FIG. 56 illustrates a method 5600 of licensing a software application from a marketplace, for deployment to a user account associated with a user, hosted at a hosting infrastructure server. In this scenario, the licensing process includes receiving a selection from the user for a software application from the marketplace and adding the application to a cart associated with the user, receiving the user's request to check out the cart and thereby the user's request to license the software application, providing the user with terms of use associated with the software application, and receiving the user's agreement to the terms of use (in some embodiments, receiving a payment from the user). In some embodiments, upon licensing of the software application by the user, the software application is deployed to an account associated with the user.

At one or more servers hosting a marketplace application 5620, one or more software applications 5622 to 5624 are made available for distribution through the marketplace application. The marketplace server receives a user request to license the software application. The marketplace server provides the software application for deployment 5648 to one or more user accounts, hosted on the one or more servers, or hosted at a hosting infrastructure server, as described regarding FIG. 44.

In some embodiments, providing the software application for deployment includes providing the software application across a network for deployment at one or more servers associated with the user, hosting the one or more user accounts.

In some embodiments, the user request includes a selection by the user to add the software application to a cart 5640 associated with the user, and to check out 5642 the cart.

In some embodiments, prior to deploying or prior to receiving the user request, the marketplace server presents a description of license terms of use associated with the software application to the user 5644.

In some embodiments, the license terms are specified by a vendor 5614 associated with the software application. The license terms may be specified before the software application is presented for deployment, or the license terms may be specified following deployment. In some embodiments, the license terms may evolve after deployment. In some embodiments, specifying the license terms includes selecting (by the vendor) the license terms 5614 from a plurality of options provided by a licensing engine 5630 associated with the one or more servers hosting a marketplace application. In some embodiments, the licenses are stored 5632, 5634 at the licensing engine 5630. In some embodiments, the licensing engine 5630 validates that the user request to license the software application complies with the license terms.

In some embodiments, the request to license the software application includes a payment 5646 (e.g., credit card or debit card payment, or bank transfer). In some embodiments, the request may be associated with a prospective future payment (trial period). The prospective future payment may include receiving a credit card number, but not billing the credit card until some time in the future.e. g., at the expiration of the trial period.

In some embodiments, prior to presenting an application for deployment, the vendor builds 5610 and packages 5612 the software application 5616. In some embodiments, the software application is a web-based software application, executed at one or more servers.

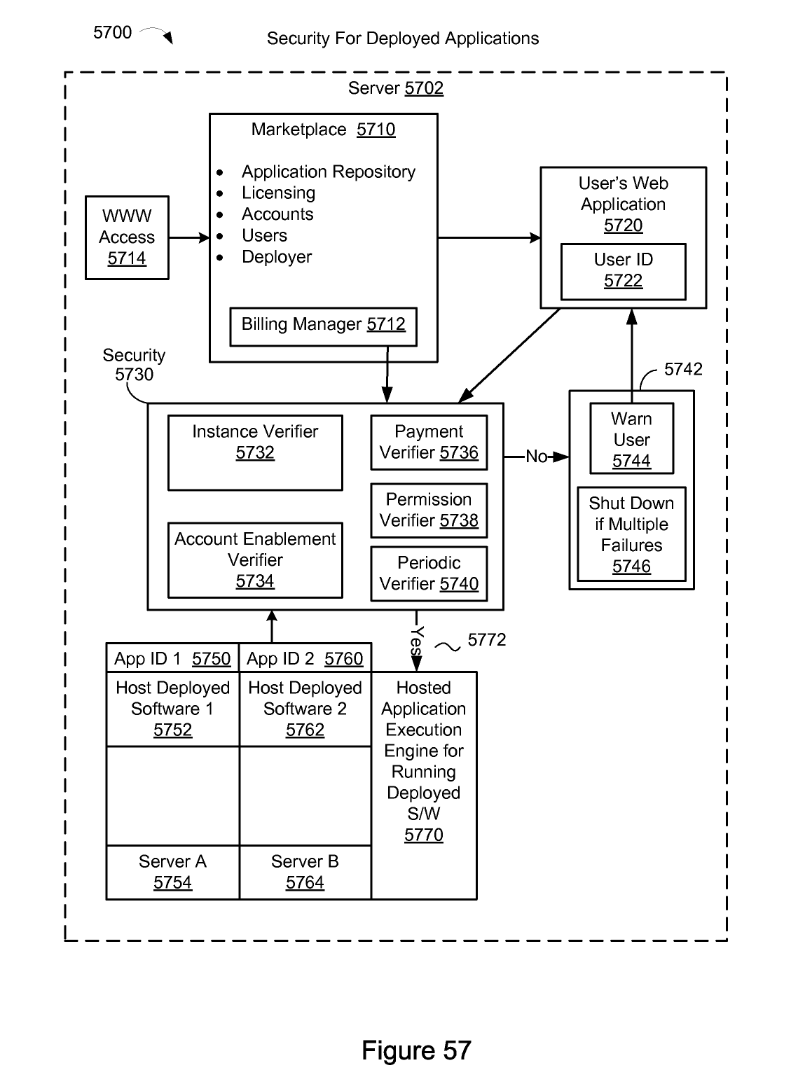

FIG. 57 illustrates a system 5700 for providing security for software applications, deployed to a user account. One or more servers 5702 hosts a marketplace application 5710. The marketplace application includes a billing manager 5712. The marketplace application is accessed by a web connection or client 5714. The deployed application is accessed by a user's web application 5720, having an associated user identifier 5722.

The server 5702 includes a security application 5730, executed by deployment security module 6158 (FIG. 61). In some embodiments, the security application 5730 verifies that only a licensed set of features and/or number of copies of a deployed software application is running at a time 5732. These requirements may be provided by the software vendor via the licensing manager (described in FIG. 49).

In some embodiments, the security application 5730 includes a payment verifier 5736 to compare a user identifier 5722 associated with the one or more user accounts and an application id (e.g. 5750, 5760) associated with the deployed application against the billing manager 5712 to verify that a valid payment has been recorded. In some embodiments, this verification is performed prior to executing the deployed application. The security application verifies that both the user and application are associated with a valid transaction before allowing a user to execute the software application.

In some embodiments, the security application 5730 includes a permission verifier 5738 to verify that the one or more user accounts have permission to execute the deployed application, and in the event of a verification failure, to warn the user. The user account permissions are executed by permissions module 6128 (FIG. 61). In some embodiments, the security application 5730 includes periodic verifier 5740 to periodically (e.g., daily, weekly, monthly etc.) repeat one or more of the verification steps described. Following one or more verification failures, a shutdown application 5742 warns the user 5744, and/or prevents 5746 (in the event of multiple failures) the one or more user accounts from executing the deployed application. The plurality of failures includes factors such as the number of failures, the period of time over which failures occur, IP addresses from which attempted logons to the application are made, etc. In some embodiments, the shutdown application 5742 prevents access by the user to data stored at the one or more servers, upon determining that the one or more user accounts has been disabled. The user access is executed by access module 6170 (FIG. 61). The account enablement verifier 5734 verifies that a user account has permission to access the deployed software applications (e.g., 5752, 5762). In some embodiments, the user permission/access is made available to the application vendor through the licensing API to enable custom messaging and actions by the vendor. Making available means that a list of privileges or permissions associated with a the user is provided to the software application vendor so the vendor can understand what terms the user has agreed to when licensing the software. This can assist the software vendor in resolving a user's problems. In some embodiments, when a user is denied access, the user is redirected to the vendors marketplace storefront listing to resolve the issue.

In some embodiments, the security application 5730 includes instance verifier 5732 to check for multiple instances of the software application being simultaneously executed by the one or more user accounts. In some embodiments, for some software applications (e.g., AOP) multiple logons to a user account are permitted, but only one logon may use (execute) a software application associated with the user account at a time. As an example, a user can stay logged into her account at work, but go home and access the account from her home PC. Since she is using her work PC to execute applications while she is at home, she may execute a software application while logged into her account from her home PC.

If the security application 5730 determines that the user account is authorized to access a deployed software application, a confirmation 5772 is provided to a hosted application execution engine 5770 for running deployed software. This engine executes one or more of the hosted deployed software applications 5752, 5762, hosted on one or more servers 5754, 5764.

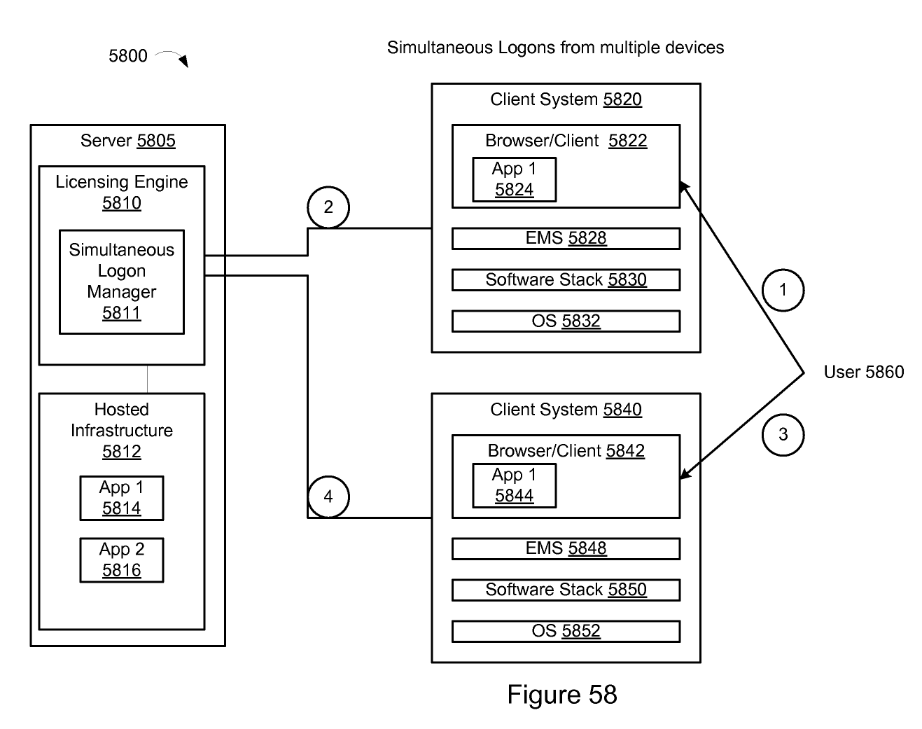

FIG. 58 illustrates a system 5800 for allowing multiple logons by a user 5860 to a software application, deployed to a user account. In an example, a user may require multiple logons if he logged onto the software application from his work computer, and left work and traveled home forgetting to log out. If the user wants to access the software application from his home computer (while still logged on from work, having forgotten to log out) then the user may log in from home (thus creating a simultaneous logon situation). In another example, a user may be logged on to the software application from his desk computer, and while in a meeting at another location, may want to access the software application using a handheld device (thus creating a simultaneous logon situation). One or more servers 5805 hosts a licensing engine 5180. The licensing engine includes a simultaneous logon manager 5811, executed by user account access module 6172 (FIG. 61). In some embodiments, the one or more servers 5805 also host a first 5814 and a second 5186 deployed software applications, where a user has licenses to the first and second deployed applications.

A first client system 5820 (e.g., an office PC) executes a browser 5822 in which a first instance 5824 of first software application 5814 is open and logged in. The first client system also includes an account management system (EMS) 5828, a software stack 5830, and an operating system (OS) stack 5832. A second client system 5840 (e.g., a home PC) executes a browser 5842, in which a second instance 5844 of first software application 5814 is open and logged in. The second client system also includes an account management system (EMS) 5848, a software stack 5850, and an OS stack 5852.

When a client 5820 attempts to access a deployed application 5814 (associated with a user account), the licensing engine 5810 and logon manager 5811 determine if the client 5820 has permission to access the application, and also determine if another client is accessing that application, associated with the user account. In some embodiments, the logon manager 5811 will only permit (depending on the license terms specified by the software vendor via the licensing manager, described in FIG. 49) a single logon to an application associated with a user account at a time. In some embodiments, the logon manager 5811 will permit a plurality of logons (e.g., by clients 5820 and 5840) to an application associated with a user account, if the licensing terms so permit. In some embodiments, the login manager 5811 will permit multiple logons, as long as only one client system is operating the application at a time. Operating means providing input to the application and/or receiving information from the application.

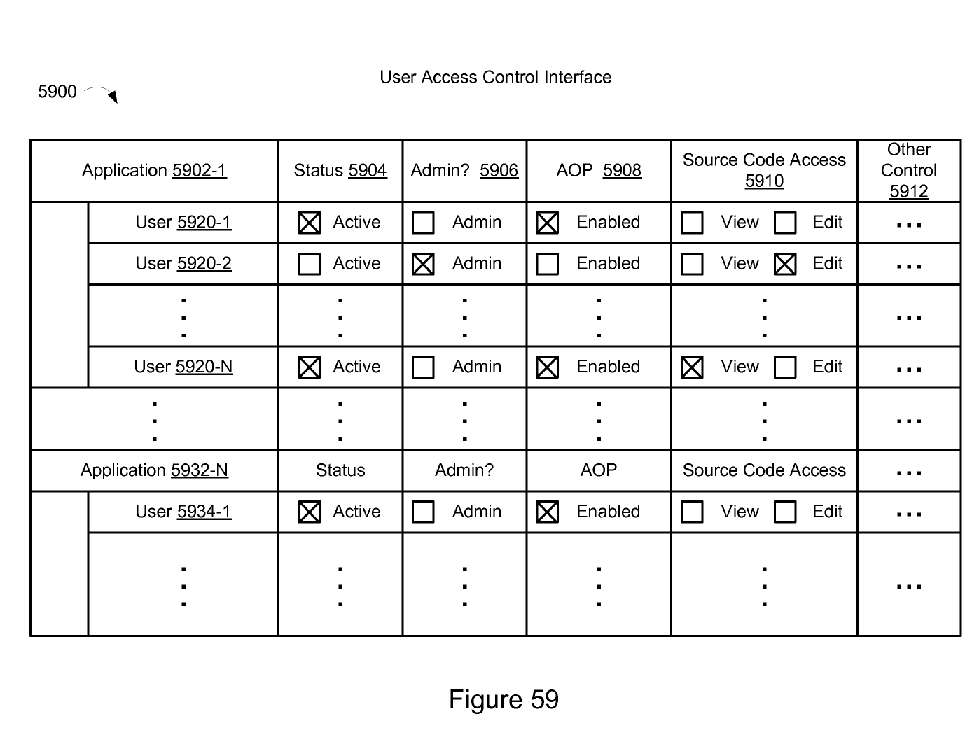

FIG. 59 illustrates an exemplary user access control interface 5900 for controlling user access to a software application, deployed to a user account. This figure shows operations at the marketplace server, under control of the licensing manager, where a system administrator (or in some embodiments, a vendor) may view and/or change license terms associated with the software application and associated with users of those applications. This is useful because it gives the administrator a ‘birds eye’ view of licensing permissions and activity within the system.

A plurality of applications 5902-1 to 5932-N are shown on the left hand column. Associated with each application is one or more users 5920-1 to 5920-N, and 5934-1. For each user, a status indicator 5904 determines if the user is active (i.e., using) that particular application. An administrator status 5906 determines if the user has administrator privileges. An AOP status 5908 indicates if a user has permission to run an application offline. A source code access status 5910 determines whether a user is allowed to view or edit source code associated with an application. By changing the status buttons or indicators, an administrator or vendor can change the permissions associated with an application or with a user. Other control 5912 determines if a user can access other features, in accordance with a particular embodiment.

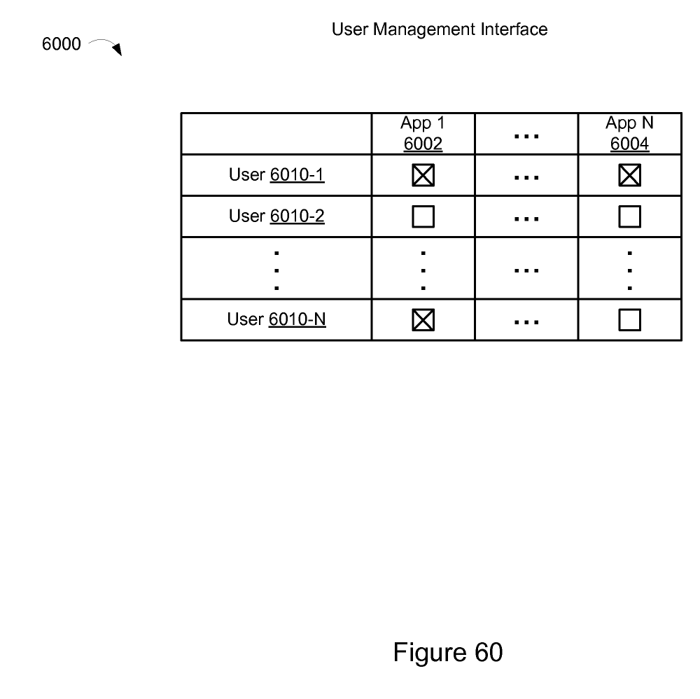

FIG. 60 illustrates an exemplary user access control interface 6000 for controlling user access to a software application, deployed to a user account. One or more software applications 6002 through 6004 are shown. For each software application, one or more users 6010-1, 6010-2 through 6010-N may access the software application, where this access is controlled by this interface.

FIG. 61 is a block diagram illustrating a server system 6100 configured to host a software marketplace and licensing system. The system 6100 generally includes one or more processing units (CPU's) 6102, one or more network or other communications interfaces 6104, memory 6110, and one or more communication buses 6108 for interconnecting these components. The communication buses 6108 may include circuitry (sometimes called a chipset) that interconnects and controls communications between system components. The system 6100 may optionally include a user interface, for instance a display 6106 and input device (e.g., a keyboard and/or mouse) 6105. Memory 6110 may include high speed random access memory such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 6110 may include mass storage that is remotely located from the central processing unit(s) 6102.

Memory 6110, or alternately the non-volatile memory device(s) within memory 6110, comprises a computer readable storage medium. In some embodiments, memory 6110 stores the following programs, modules and data structures, or a subset thereof:
an operating system 6111 that includes procedures for handling various basic system services and for performing hardware dependent tasks;
a network communication module 6112 that is used for connecting the server 6100 to other computers via the one or more communication network interfaces 6104 (wired or wireless) and one or more communication networks, such as the Internet, other wide area networks, local area networks, metropolitan area networks, and so on;
a distribution module 6120 that is used to market and distribute software applications to users of the software marketplace and licensing system;
a marketplace module 6122 that provides an electronic marketplace where software vendors can display, and users can select, software applications for licensing;
a listing module 6124 that is used to generate and display software application products within an electronic marketplace;
a licensing module 6126 that controls the distribution of software applications, with license terms selected or provided by a software vendor;
In some embodiments, a permissions module 6128 that enforces license terms during deployment;
a billing module 6130 that receives and processes payment from a user associated with a licensed software application;
a transaction report module 6132 for reporting on distribution and licensing activity taking place within the marketplace;
an application repository module 6134 for storing and managing software applications ready for distribution;
a packaging module 6136 for preparing software applications and updates for distribution;
a deployment module 6150, for managing deployment of software applications to a user account, and managing hosting of the software application;
a deployer module 6152 (in some embodiments part of the deployment module 6150) for deploying a software application to a hosted user account, or to a user-controlled server for hosting the account;
a hosting module 6154 for hosting the software application in a hosted user account and for executing the software application;
a user account module 6156 for managing user accounts, permissions and access;
a security module 6158 for managing deployment and ensuring that a software application is deployed in accordance with license terms, to authorized users, at authorized servers;
a syndicated deployment module 6160 for performing syndicated deployment (in some embodiments, across a network) in response to a request from a syndicated server;
an access module 6170 for controlling access to deployed applications and to the marketplace;
a user account access module 6172 (in some embodiments, part of user account module 6156 or access module 6170) for controlling user access to hosted applications;
a user hosting module 6174 (in some embodiments, part of a hosting module 6154) for hosting the deployed software application at a server controlled by the user;
a marketplace database management module 6180 for managing a marketplace database;
a licensing database management module 6182 for managing a licensing database;
a deployment database management module 6184 for managing a deployment database;
a billing database management module 6186 for managing a billing database; and
a user account database management module 6188 for managing a user account database.

In some embodiments, the database management modules 6180, 6182, 6184, 6186, 6188 can be separate or combined into one or more groups.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 6110 may store a subset of the modules and data structures identified above. Furthermore, memory 6110 stores additional modules and data structures not described above.

Although FIG. 61 shows a server system for software application distribution, FIG. 61 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 61 could be implemented on single servers or single items could be implemented by one or more servers. The actual number of servers used to implement a software application distribution system and the way in which features are allocated among them will vary from one implementation to another, and may depend in part on the amount of data traffic that the system must handle during peak usage periods as well as during average usage periods.

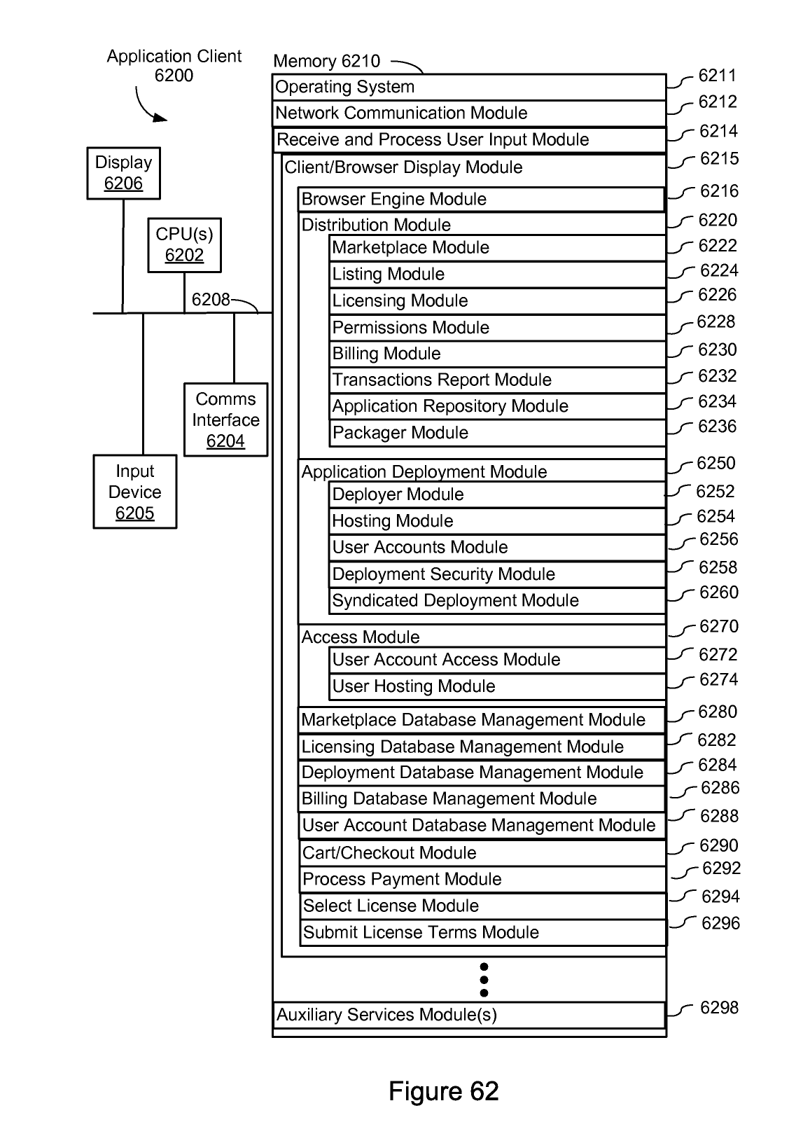

FIG. 62 illustrates a block diagram of a client system 6200 for accessing a software marketplace and licensing system, hosted at one or more servers. The client system 6200 generally includes one or more processing units (CPU's) 6202, one or more network or other communications interfaces 6204, memory 6210, and one or more communication buses 6208 for interconnecting these components. The communication buses 6208 may include circuitry (sometimes called a chipset) that interconnects and controls communications between system components. The system 6200 also includes a user interface, for instance a display 6206 and input device (e.g., a keyboard and mouse) 6205. Memory 6210 may include high speed random access memory such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 6210 may include mass storage that is remotely located from the central processing unit(s) 6202.

Memory 6210, or alternately the non-volatile memory device(s) within memory 6210, comprises a computer readable storage medium. In some embodiments, memory 6210 stores the following programs, modules and data structures, or a subset thereof:
an operating system 6211 that includes procedures for handling various basic system services and for performing hardware dependent tasks;
a network communication module 6212 that is used for connecting the client 6200 to a server hosting software applications, via the one or more communication network interfaces 6104 (wired or wireless) and one or more communication networks, such as the Internet, other wide area networks, local area networks, metropolitan area networks, and so on;
a receive and process user input module 6214 for receiving input from input device(s) 6205, such as a keyboard and mouse, and interpreting that input to control a client/browser;
a client/browser module 6215 (including browser engine module 6216) for providing a window by which a user accesses the hosted software application, and through which the user (or in some embodiments an administrator) manages the hosted software application;
accessible through the client/browser module 6215: a distribution module 6220, application deployment module 6250 and access module 6270, each with constituent modules, and database management modules 6280 through 6288, corresponding to modules in FIG. 61 as described earlier;
accessible through the client/browser module 6215: a cart checkout/module 6290 for allowing a user to place a software application in the cart, and checking out the cart to license the software application;
accessible through the client/browser module 6215: a process payment module 6292 for processing a payment associated with the licensed software application;
accessible through the client/browser module 6215: a select license module 6294 for selecting a license associated with a software application, prior to licensing the application;
accessible through the client/browser module 6215: a submit license terms module 6296 for a vendor to select license terms associated with the software application, or to submit custom license terms provided by the vendor (e.g., a text file); and
auxiliary services module(s) 6298 for providing other features or services associated with the client.

Flowcharts for Marketplace and Licensing

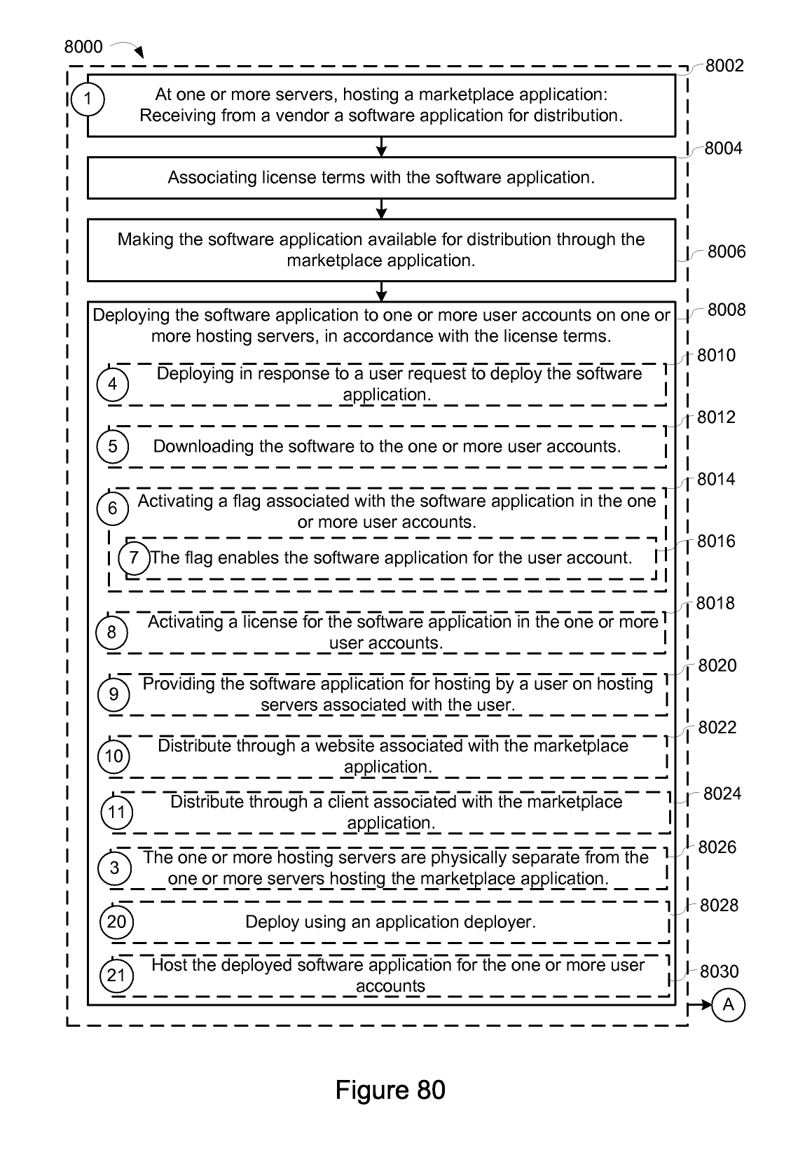

FIG. 80 is a flowchart representing a server method 8000 for distributing a software application, according to certain embodiments of the invention. Server method 8000 may be governed by instructions that are stored in a computer readable storage medium and that are executed by one or more processors of one or more servers. Each of the operations shown in FIG. 80 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

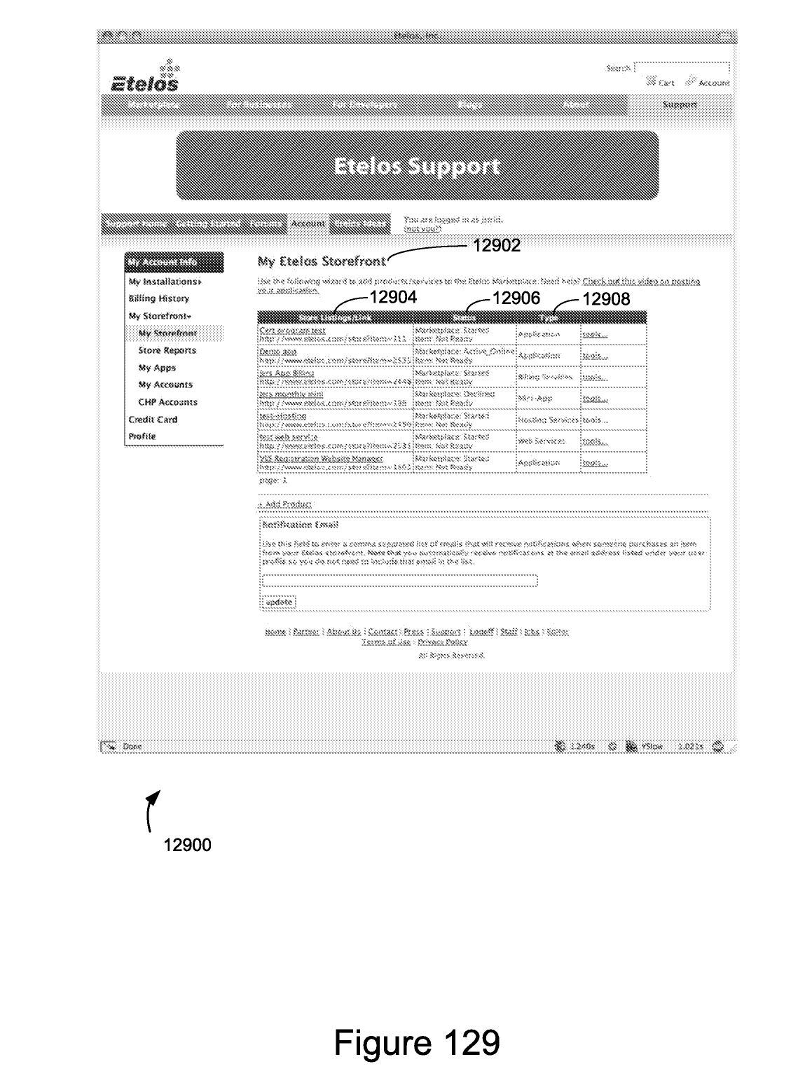

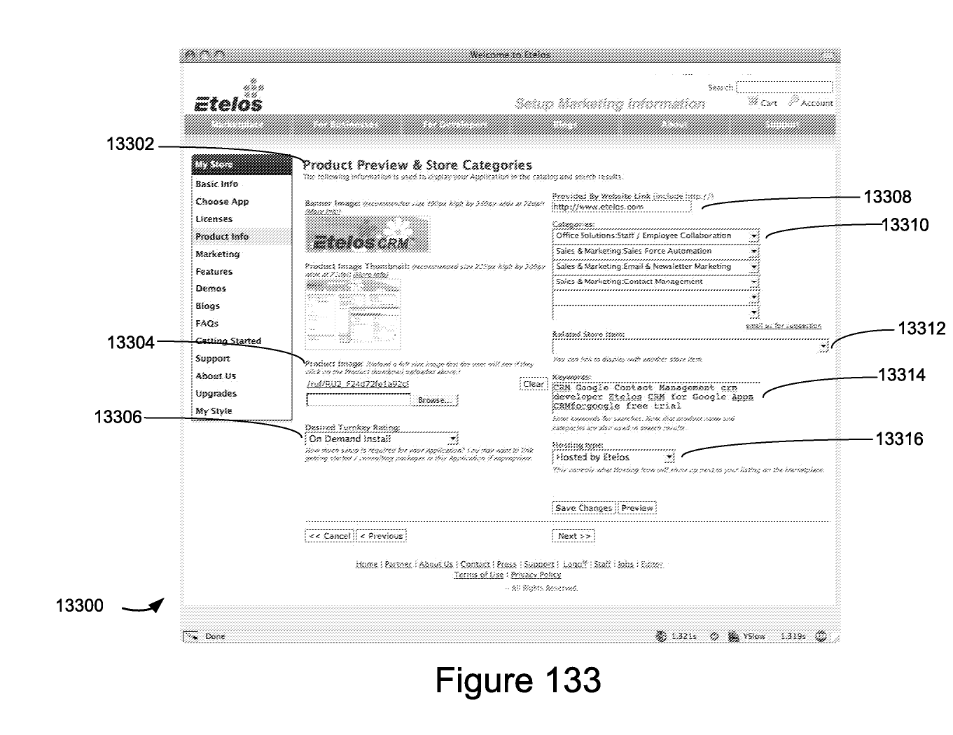

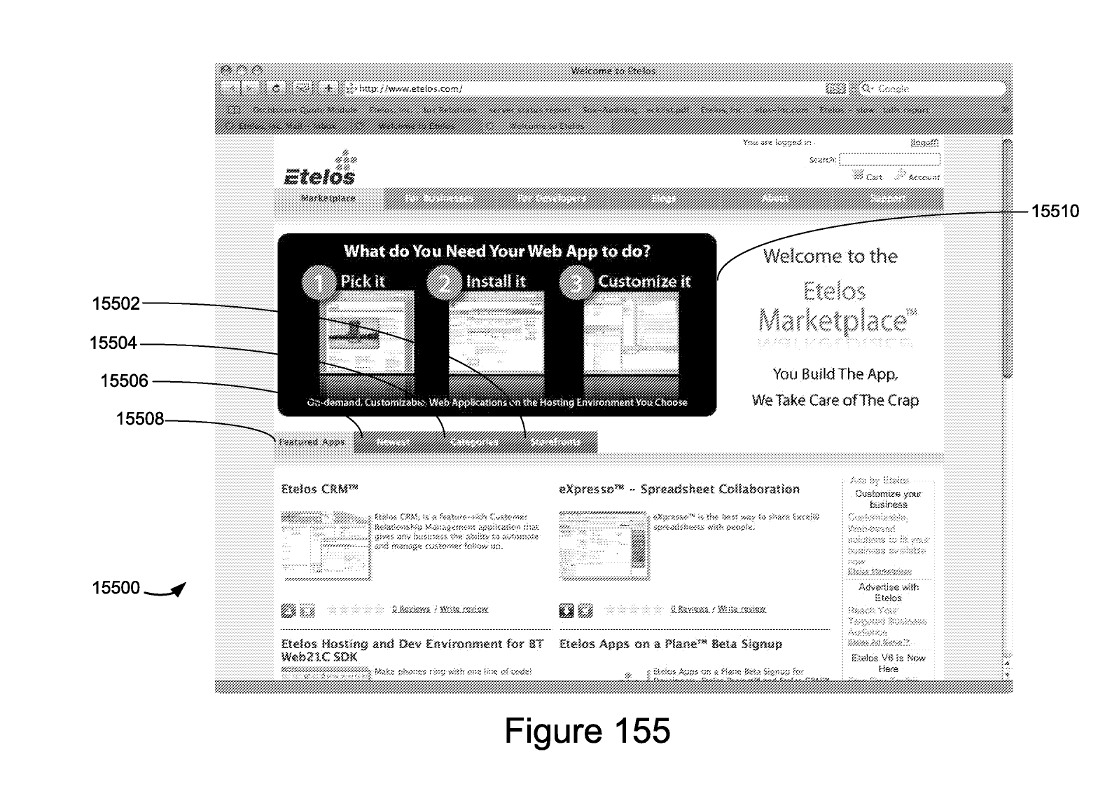

At one or more servers hosting a marketplace application (e.g., FIG. 129, marketplace storefront; FIG. 155, user marketplace), a software application is received from a vendor for distribution (8002). License terms (e.g., FIG. 133, license terms) are associated with the software application (8004). In some embodiments, the license terms are received from the vendor of the software application, and are stored in a database (e.g., by licensing database management module 6182, FIG. 61) with a pointer to the vendor's software application. Associated means that when the software application is selected for licensing by a user, the vendor license terms corresponding to that vendor's software application are used during licensing and distribution of the software application. In some embodiments, a vendor may have different sets of license terms per software application.

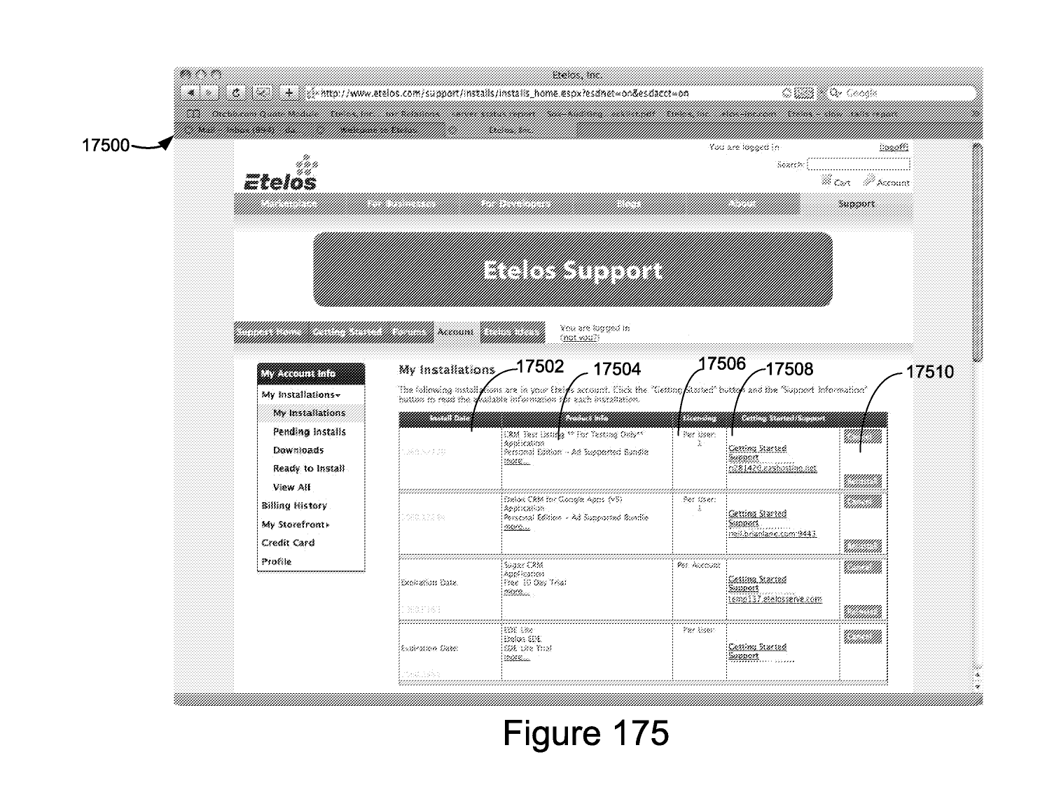

The software application is made available for distribution (e.g., FIGS. 129, 155) through the marketplace application (8006). The software application is deployed (e.g., FIG. 175, “My Installations”) to one or more user accounts on one or more hosting servers, in accordance with the license terms.

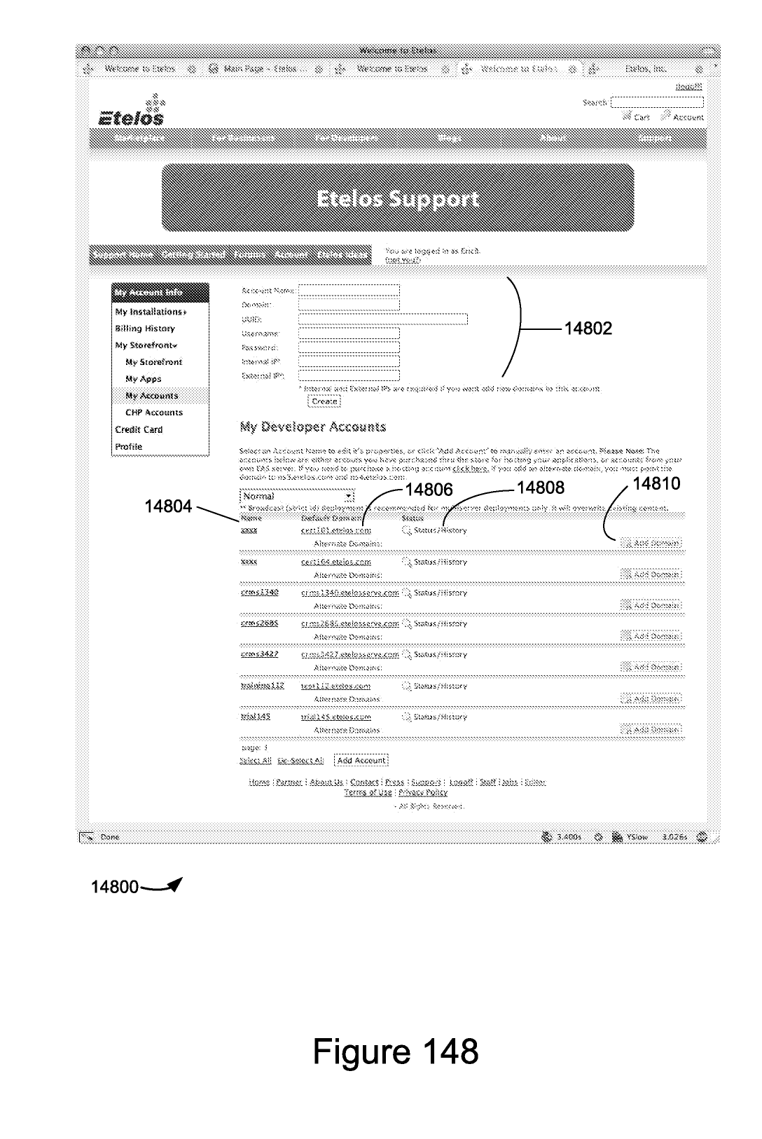

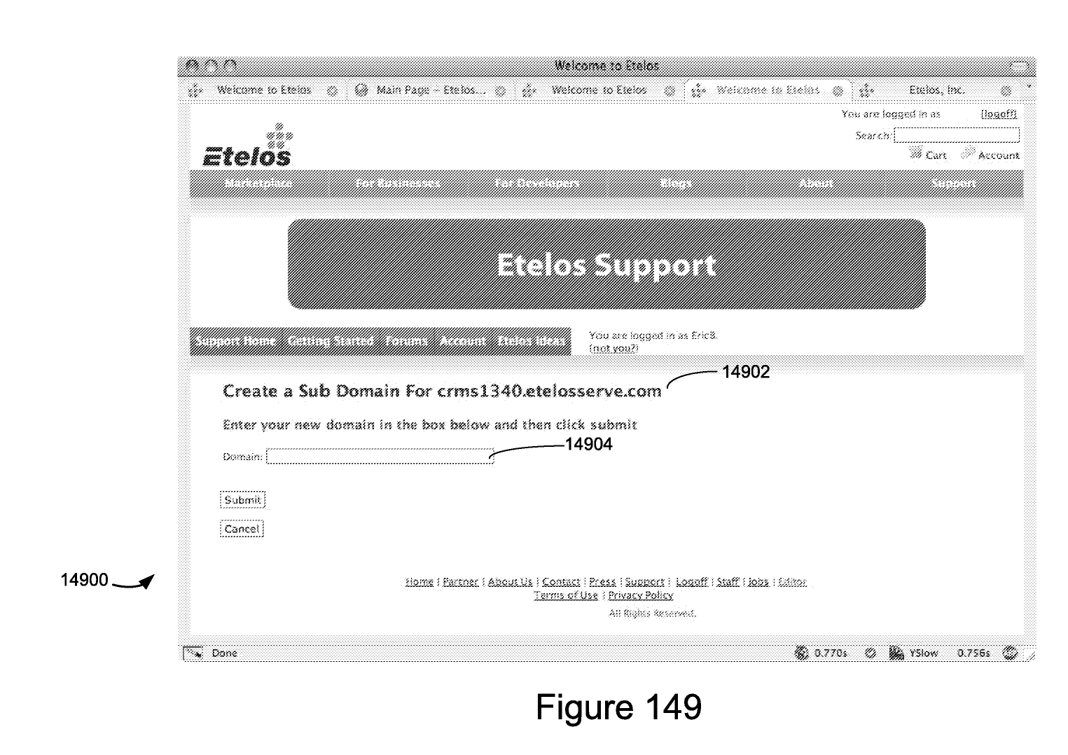

In some embodiments, the one or more hosting servers (e.g., FIG. 148, developer hosting accounts; FIG. 149 hosting sub-domains) are physically separate from the one or more servers hosting the marketplace application (8026).

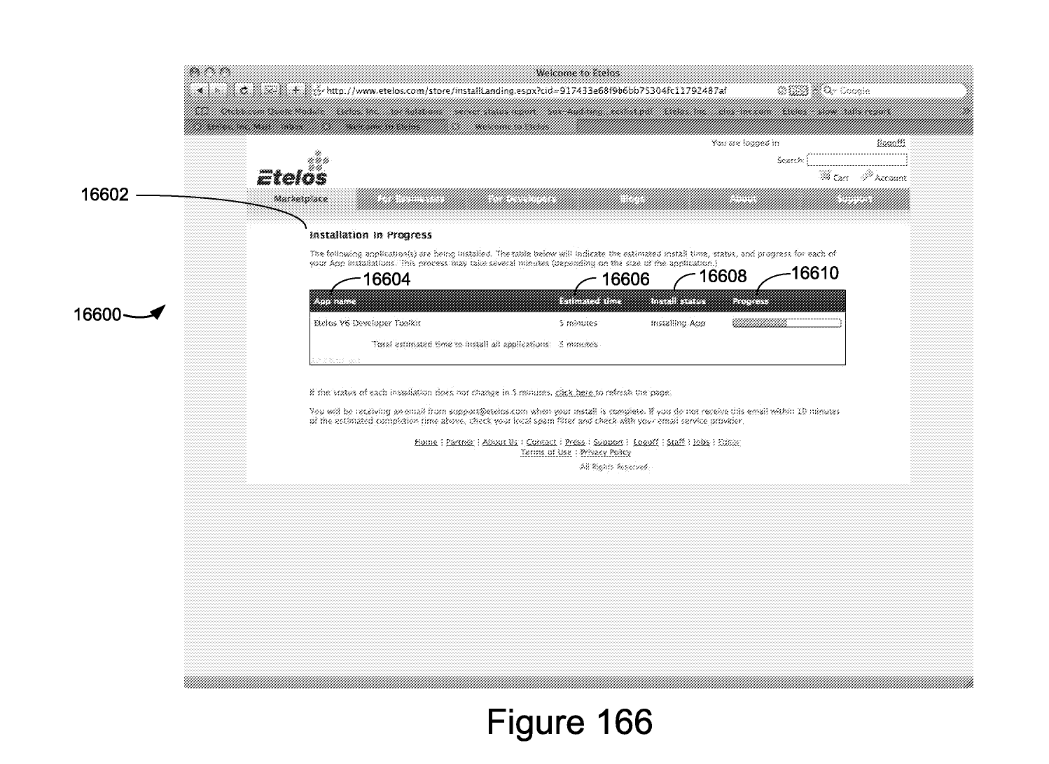

In some embodiments, the deploying is performed after a user request (e.g., FIGS. 166, 167, 168, download and install) to deploy the software application (8101). In some embodiments, the deploying includes downloading the software to one or more user accounts (8012). In some embodiments, deploying includes activating a flag associated with the software application in the one or more user accounts (8014). In some embodiments, the flag enables the software application for the user account (8016). In some embodiments, the deploying includes activating a license for the software application in the one or more user accounts (8018).

In some embodiments, the deploying includes providing the software application for hosting by a user on hosting servers (e.g., FIG. 148 developer hosting account, FIG. 149 sub-domains associated with an account) associated with the user (8020).

In some embodiments, distribution to a user through the marketplace application includes through a website (e.g., FIG. 155, marketplace storefront) associated with the marketplace application (8022). In some embodiments, distribution to a user through the marketplace application includes distribution through a client associated with the marketplace application (8024).

In some embodiments, the deploying is performed (e.g., FIG. 175, “My Installations”) by an application deployer (8028), such as the application deployer described in FIG. 51, and/or the application deployer module 6152 (FIG. 61).

In some embodiments, the deployed software application is hosted for the one or more user accounts (8030).

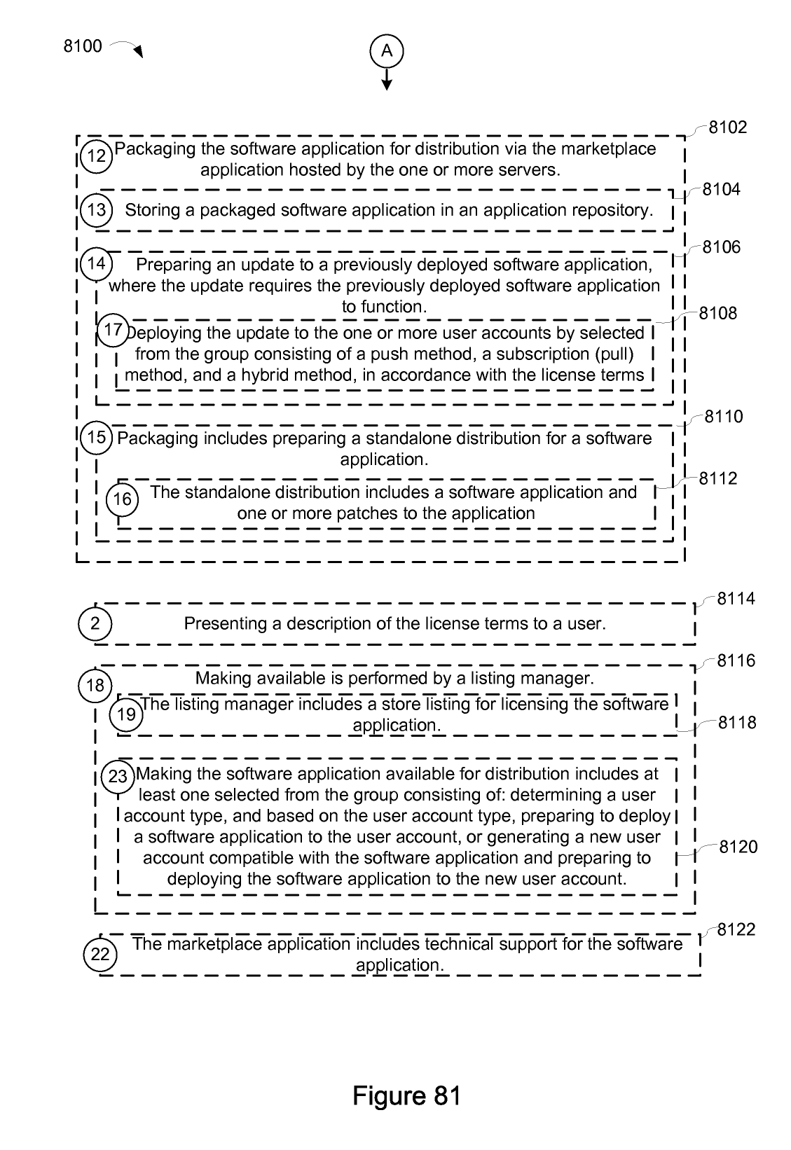

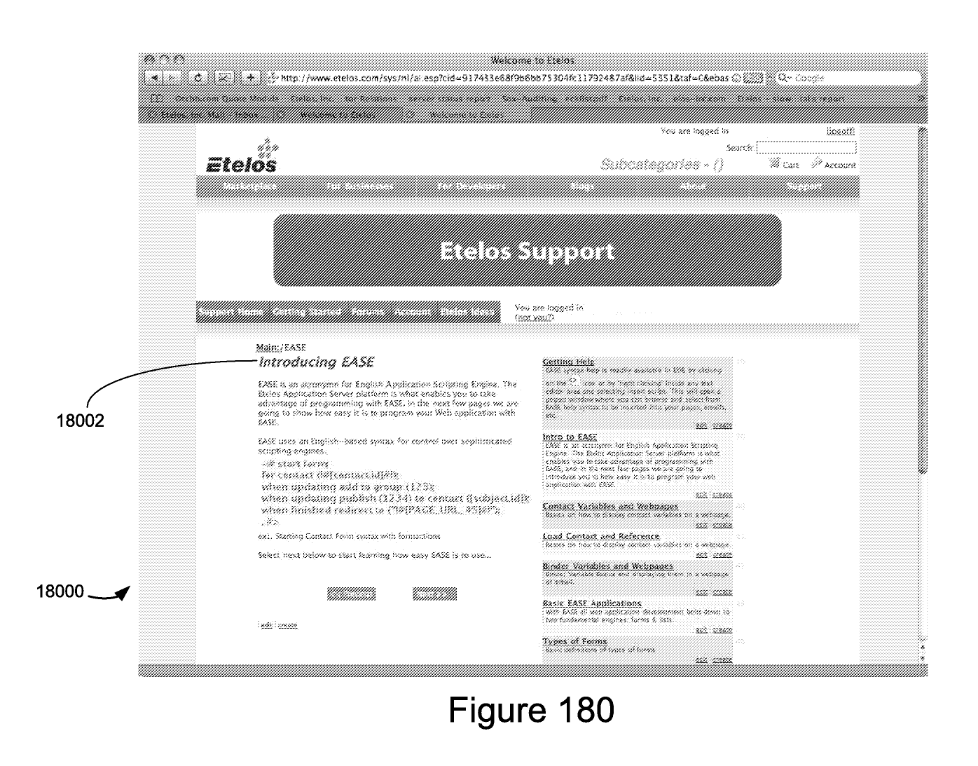

FIG. 81 is a flowchart 8100 continuing the server method 8000 of FIG. 180.

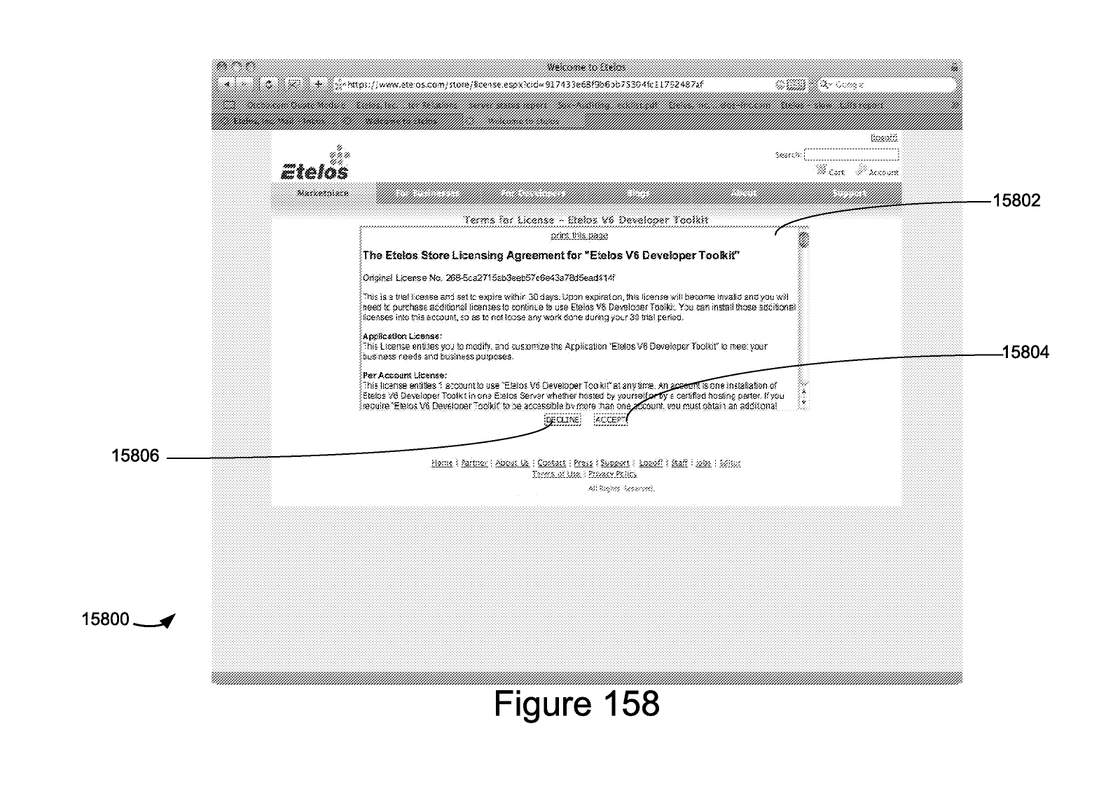

In some embodiments, a description of the license terms (e.g., FIG. 158, accept terms) is presented to a user (FIG. 81, 8114).

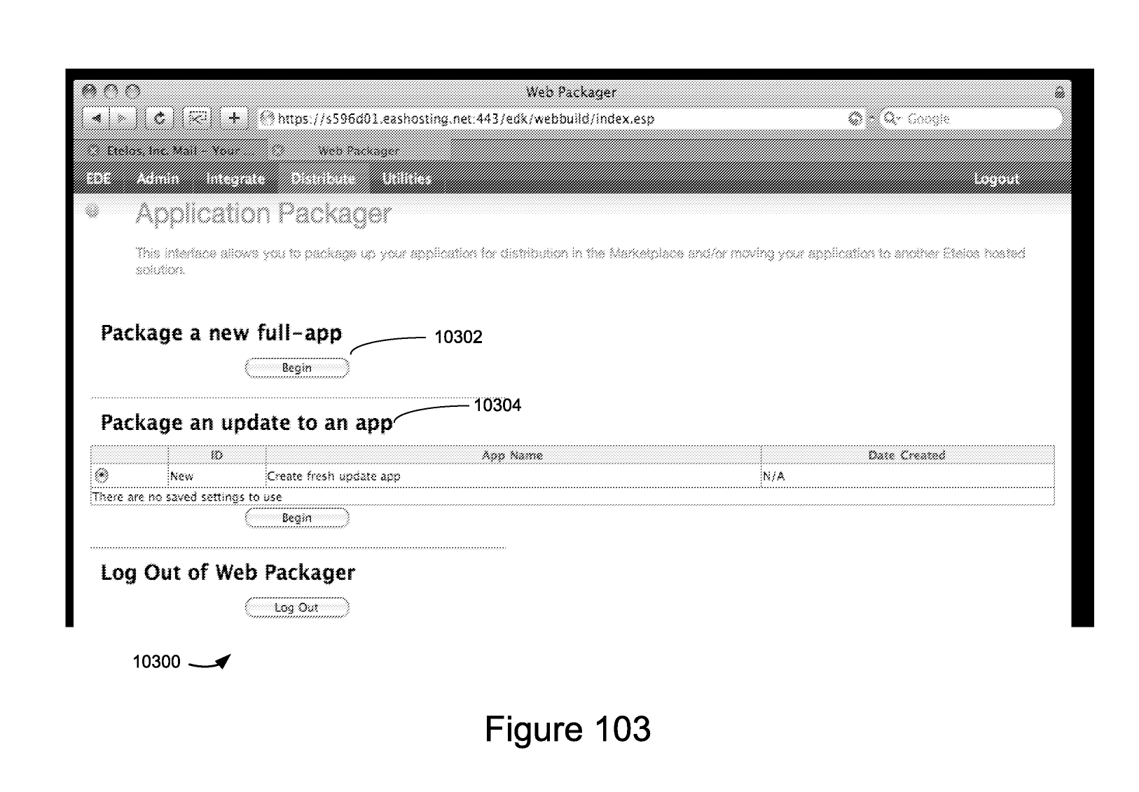

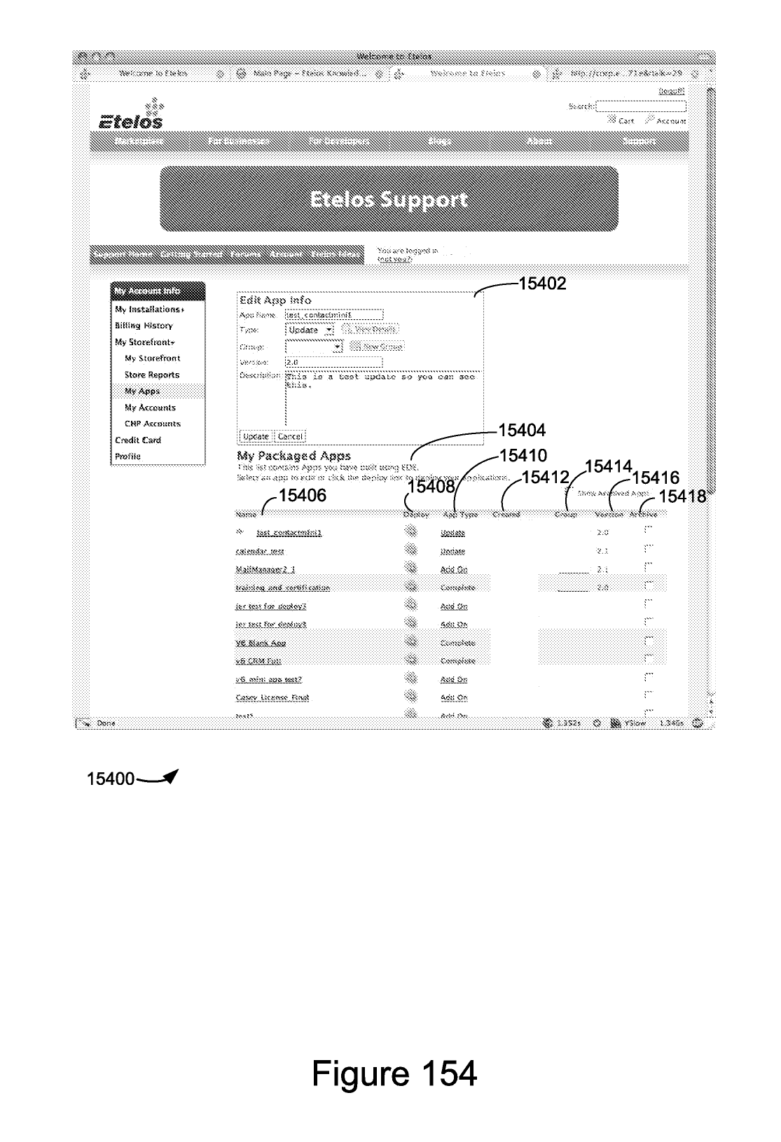

In some embodiments, the software application is packaged (e.g., FIG. 154, 173, My Packaged Applications) for distribution via the marketplace application hosted by the one or more servers (8102). In some embodiments, a packaged software application is stored in an application repository (8104). In some embodiments, the packaging includes preparing an update (e.g., FIG. 103, update 10304) to a previously deployed software application, where the update requires the previously deployed software application to function (8106). This scenario might be where a patch update (set of fixes to a previously deployed application) is deployed. A patch generally requires the earlier deployed application to function, since the patch only changes a small portion of the deployed application, and thus the patch is not a standalone application.

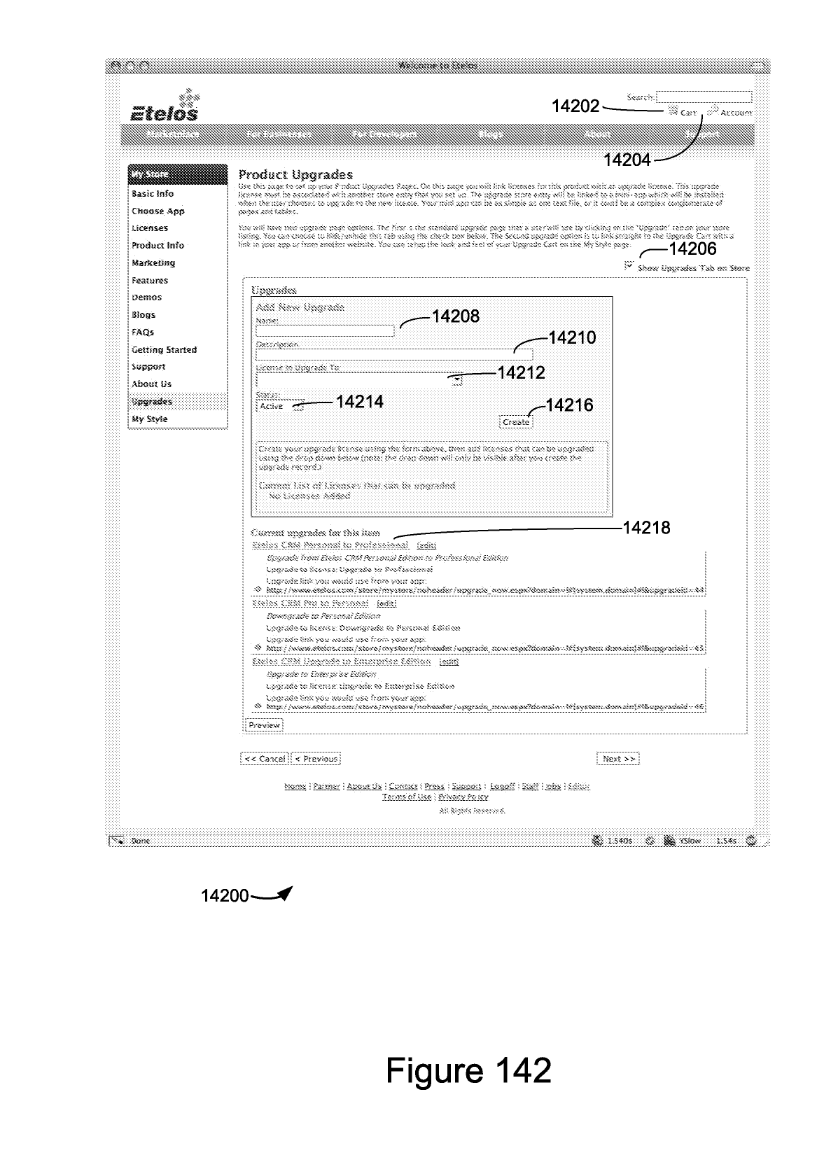

In some embodiments, the packaging includes preparing a standalone distribution (e.g., FIG. 103, update 10302) for a software application (8110). In some embodiments, the standalone distribution includes a software application and one or more patches to the application (8112). In some embodiments, the update is deployed to the one or more user accounts selected from the group consisting of (e.g., FIG. 142, Product Upgrade) a push method, a subscription (pull) method, and a hybrid method, in accordance with the license terms (8108).

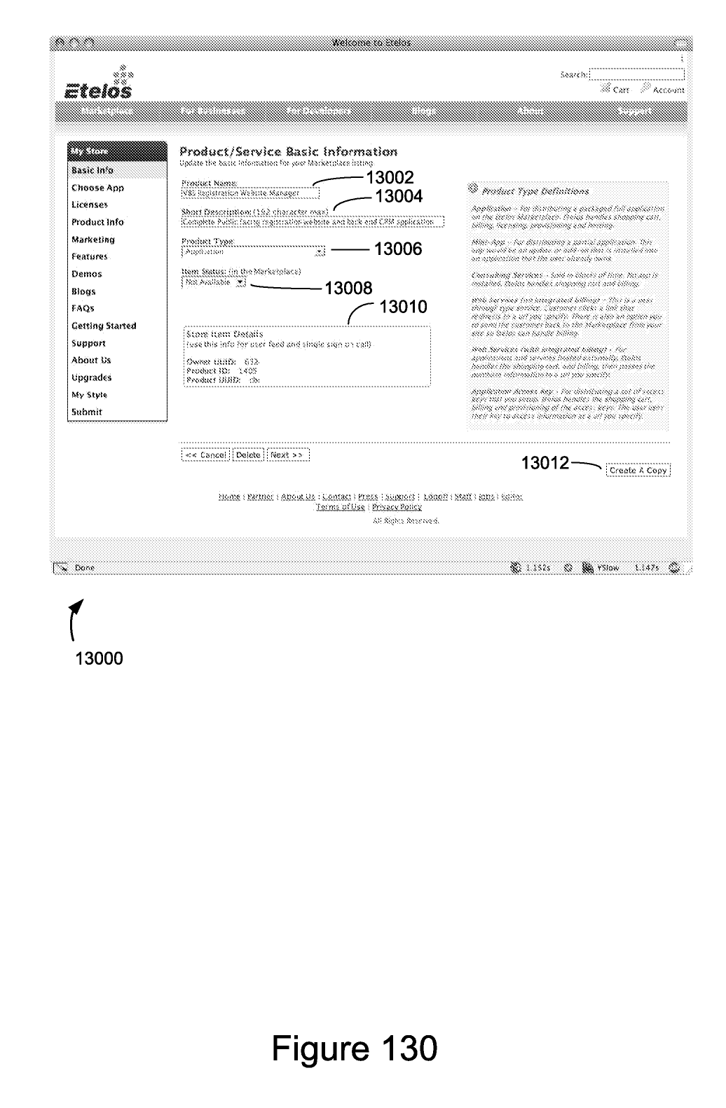

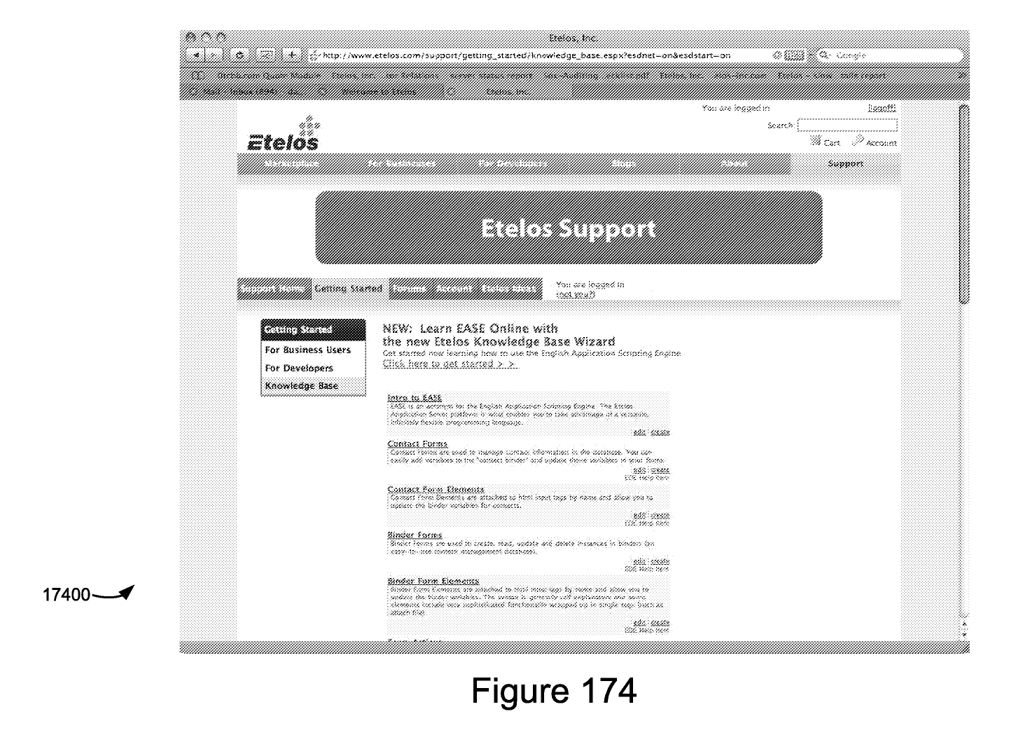

In some embodiments, the making available (e.g., FIG. 130, Product/Service Basic Information) is performed by a listing manager (8116), executed by listing module 6124 (FIG. 61). In some embodiments, the listing manager includes a store listing (e.g., FIGS. 130-153, store listing details/setup, FIG. 155 storefront) for licensing the software application (8118). In some embodiments, the marketplace application includes technical support (e.g., FIGS. 174, 177-181, support and knowledge base) for the software application (8122). By making available, the listing manager performs one or more of storing and presenting software application listings (sale details for software applications), storing technical articles and information, and storing support resources (help, customer support, etc.). The listing manager may also provide one or more of a search function, a list of most popular software applications, a package deal for licensing a suite of software applications, a customer review, and other related functions.

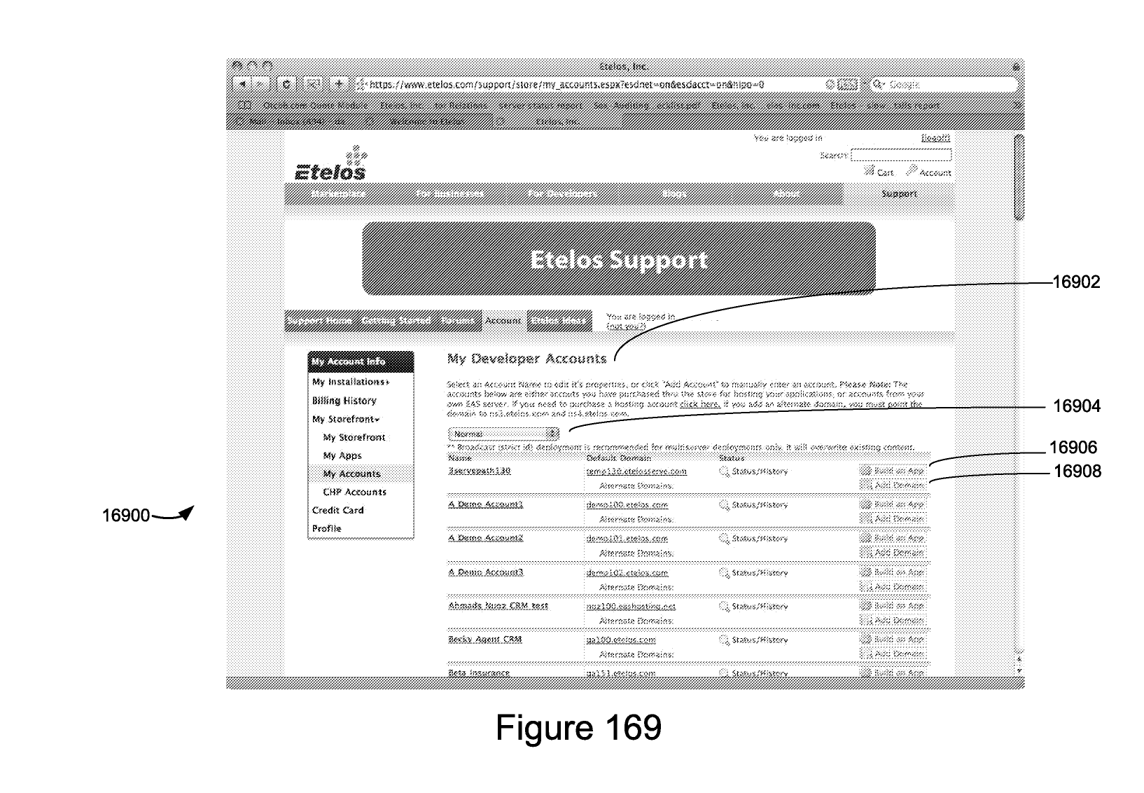

In some embodiments, making the software application available for distribution can be done by determining a user account type, and based on the user account type, preparing to deploy a software application to the user account, or generating a new user account (e.g., FIG. 169, developer accounts) compatible with the software application and preparing to deploy the software application to the new user account (8120).

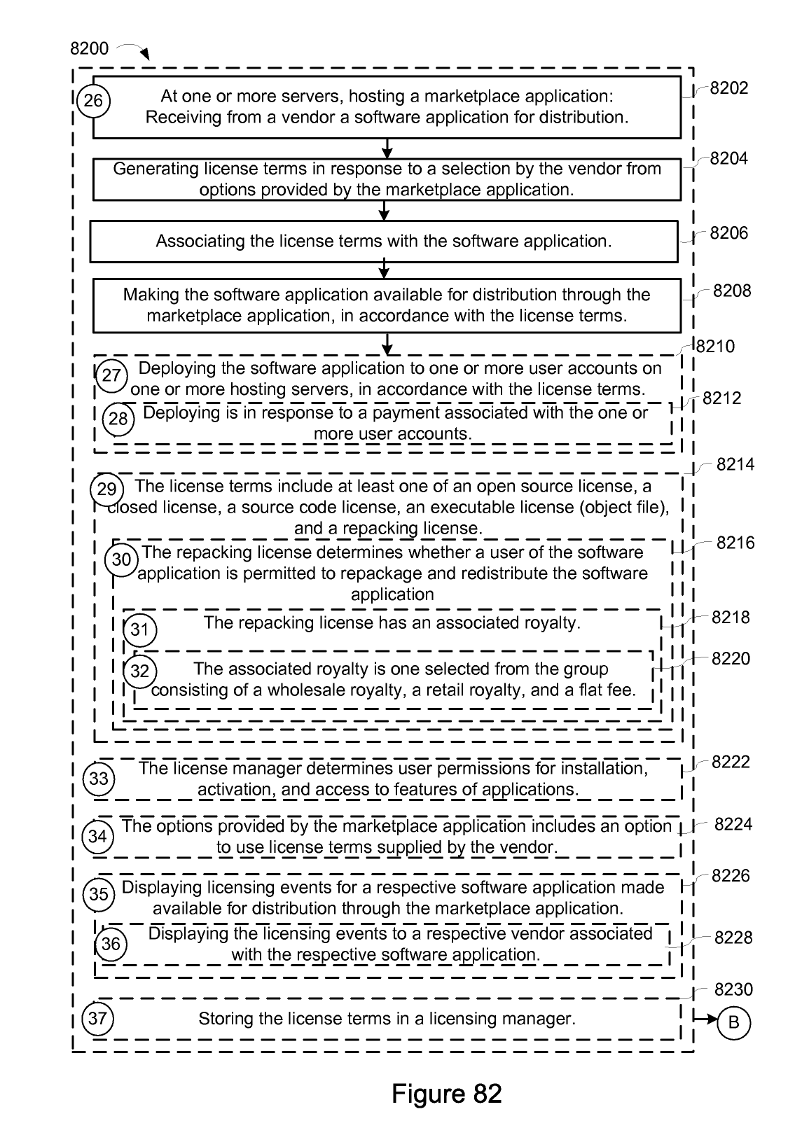

FIG. 82 is a flowchart representing a server method 8200 for licensing a software application, according to certain embodiments of the invention. The server method 8200 may be executed by licensing module 6126 (FIG. 61) and as described earlier with regard to FIG. 49.

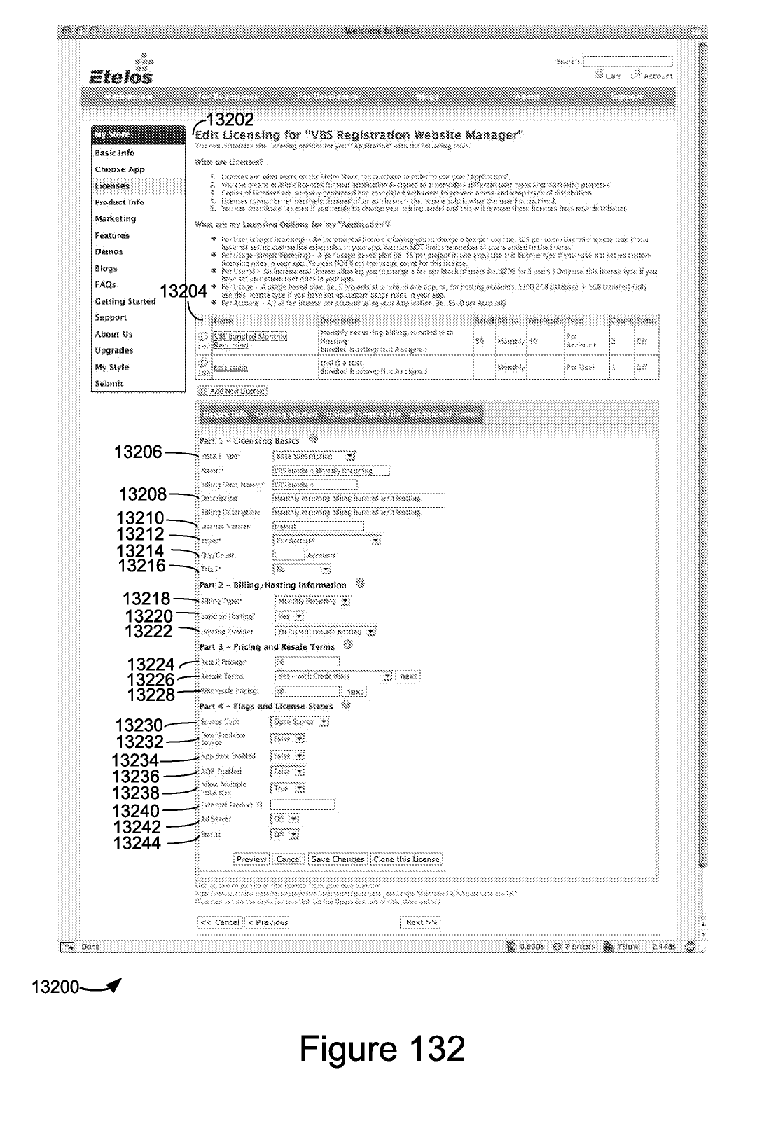

At one or more servers, hosting a marketplace application, a software application is received from a vendor for distribution (8202). License terms (e.g., FIG. 132, license selection) are generated (8204) in response to a selection by the vendor from options provided by the marketplace application. The license terms are associated with the software application (8206). The software application is made available for distribution through the marketplace application (e.g. FIG. 155, storefront), in accordance with the license terms (8208).

In some embodiments, the software application is deployed (e.g., FIG. 175, My Installations) to one or more user accounts on one or more hosting servers, in accordance with the license terms (8210). For example, the license terms can influence an application in the following way. Deploying an application in accordance with the license terms means that conditions specified by the software vendor in the license terms (e.g., source code is to be hidden from the licensee) are enforced when deploying and when granting access to the software application. In some embodiments, a deployer enables or disables functions or options within the deployed software application, where this enabling or disabling is determined by the license terms provided by the software vendor.

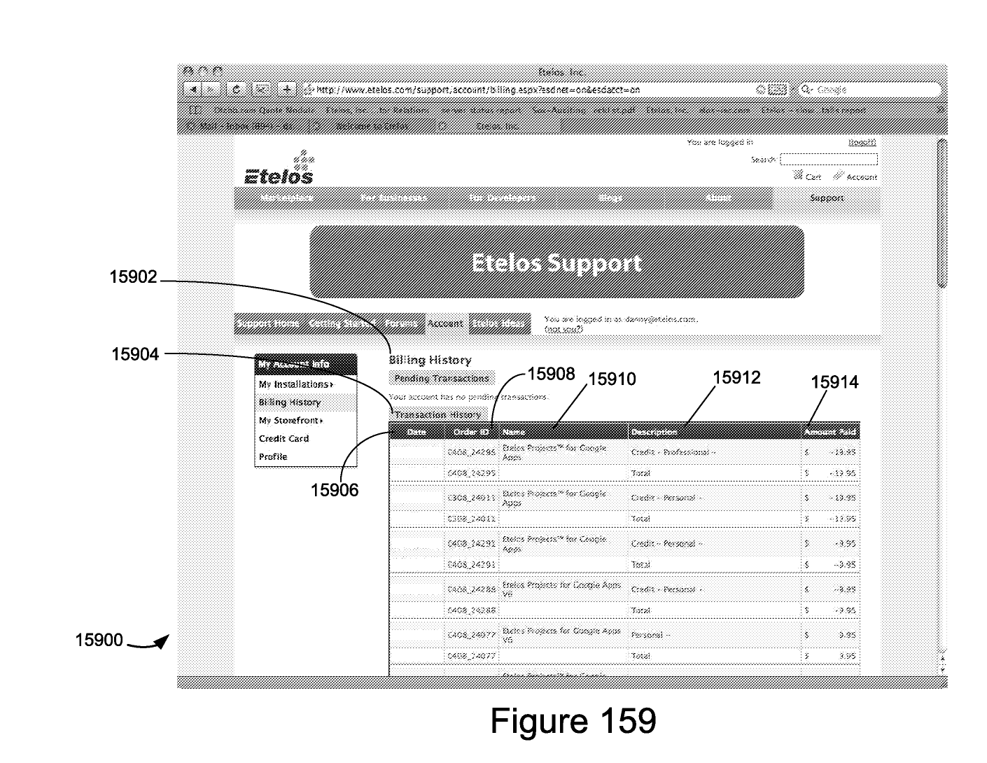

In some embodiments, the deploying is in response to a payment (e.g., FIG. 159, billing history) associated with the one or more user accounts (8212).

In some embodiments, license terms include at least one of (e.g., FIG. 132, part four) an open source license, a closed license, a source code license, an executable (object file) license, and a repacking license (8214). In some embodiments, the repacking license (e.g., FIG. 132, part three) determines whether a user of the software application is permitted to repackage and redistribute the software application (8216). In some embodiments, the repacking license has an associated royalty (8218). In some embodiments, the associated royalty is one selected from the group consisting of a wholesale royalty, a retail royalty, and a flat fee (8220). In some embodiments, the license manager determines user permissions (e.g., FIG. 132, part four) for installation, activation, and access to features of applications (8222). In some embodiments, the options provided by the marketplace application includes an option to use license terms supplied by the vendor (8224).

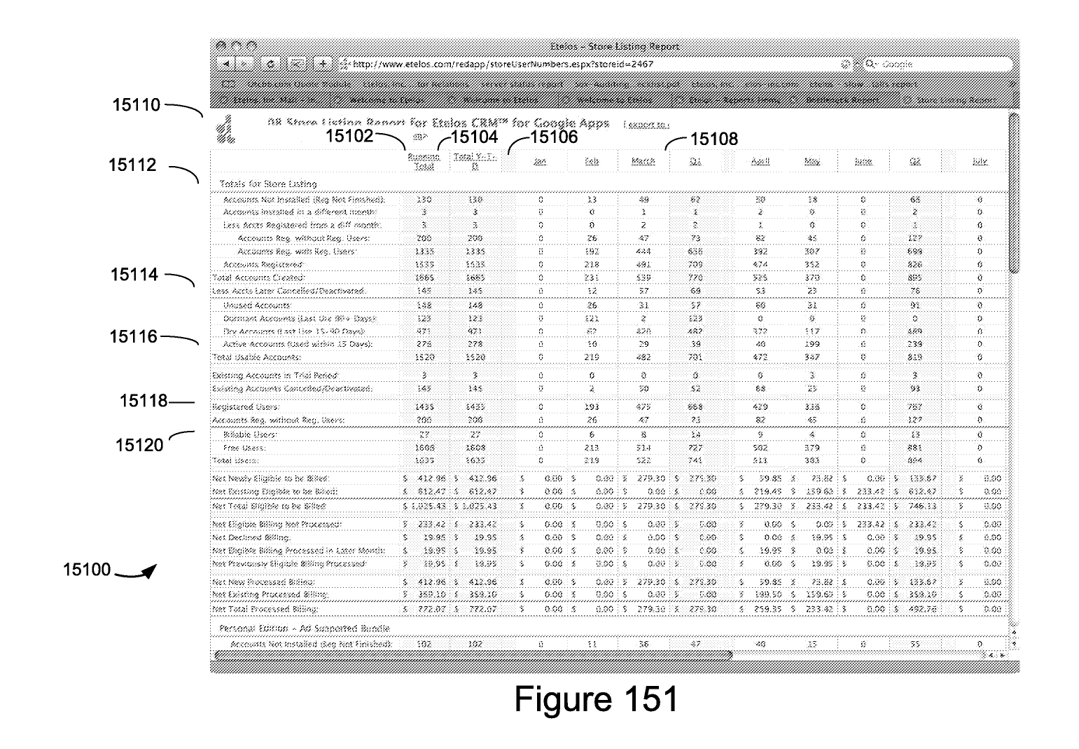

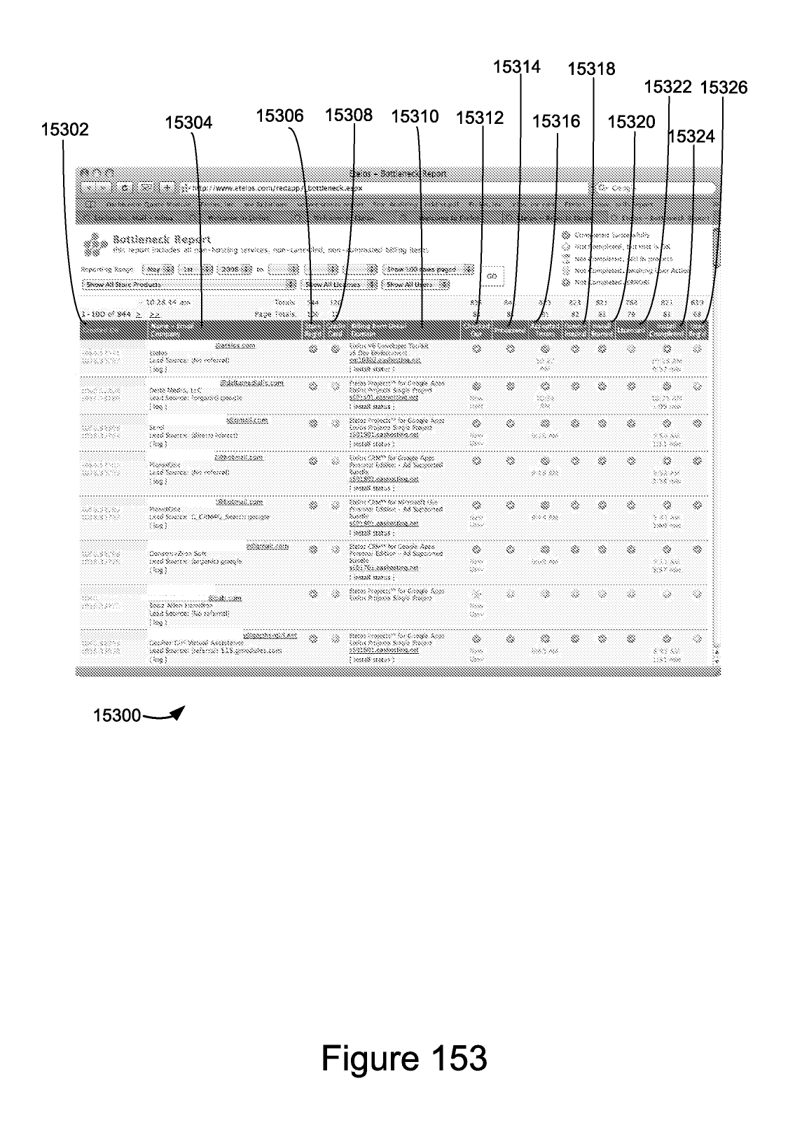

In some embodiments, licensing events (e.g., FIG. 153, transaction report) for a respective software application are made available for distribution through the marketplace application (8226). In some embodiments, the license events are displayed (e.g., FIG. 151, store report) to a respective vendor associated with the respective software application (8228). In some embodiments, the license terms are stored in a licensing manager (8230).

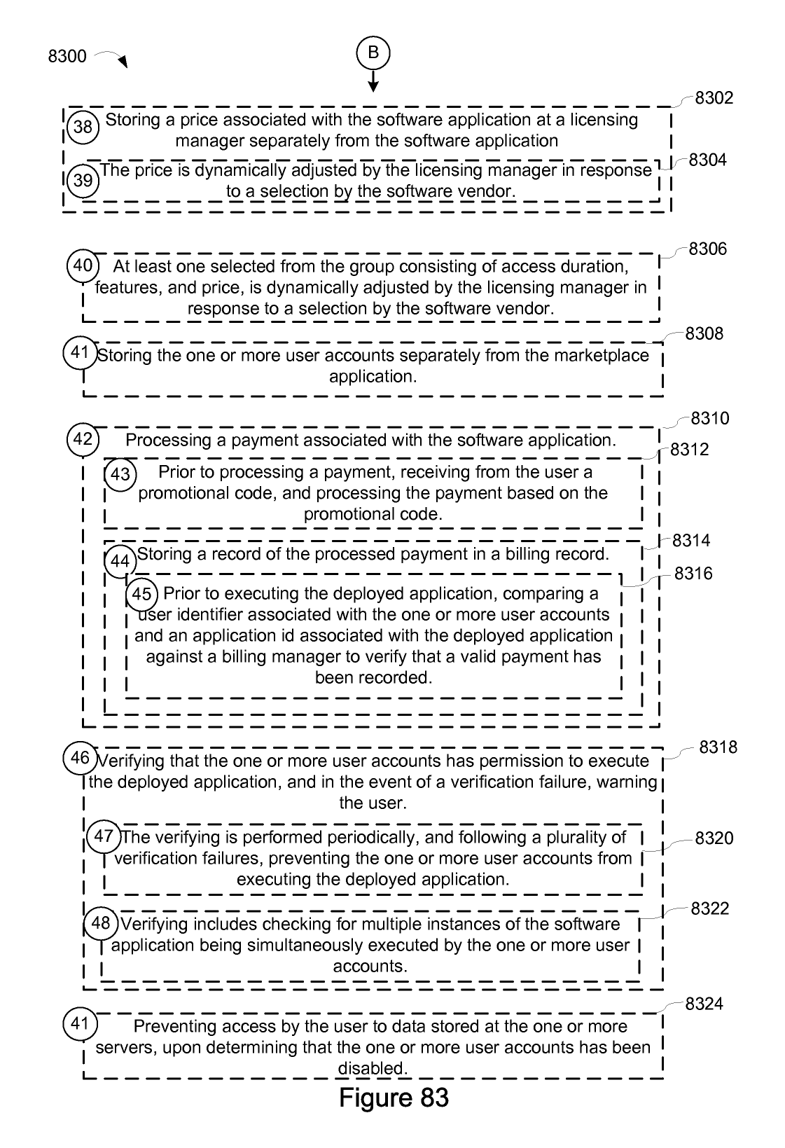

FIG. 83 is a flowchart 8300 continuing the server method 8200 of FIG. 82.

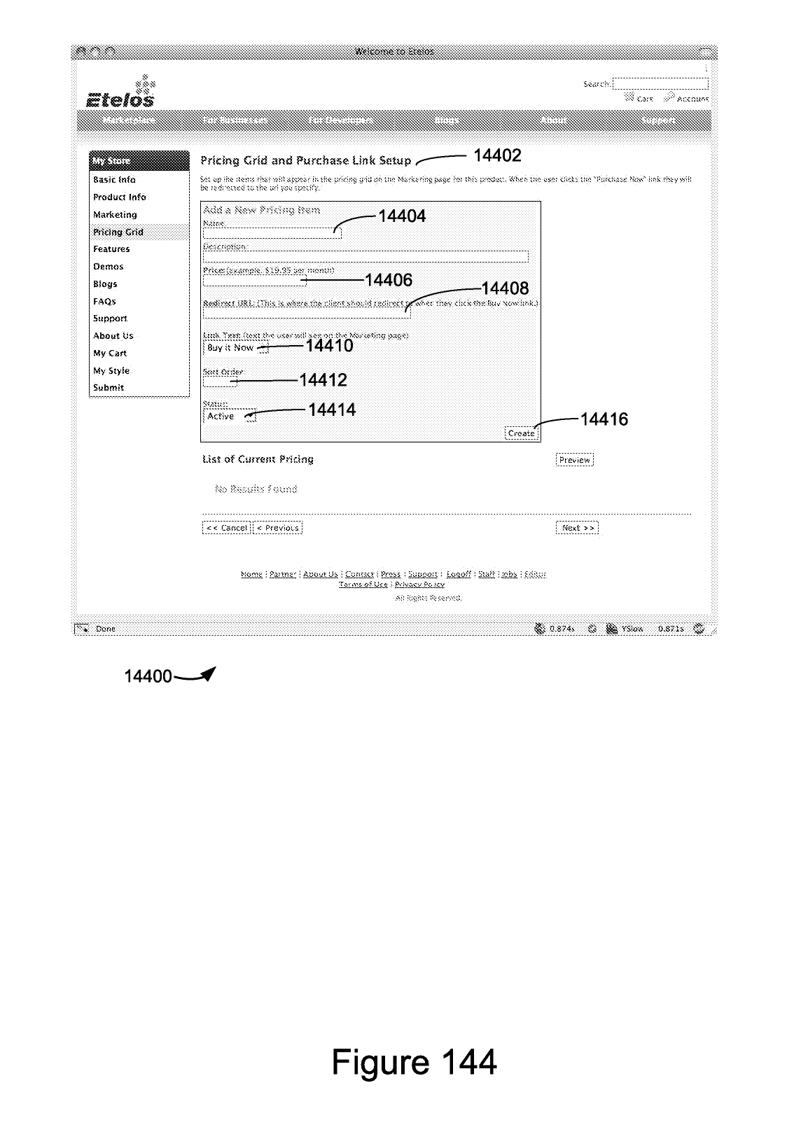

In some embodiments, a price (e.g., FIG. 132, part two; FIG. 144 pricing grid) associated with the software application is stored at a licensing manager separately from the software application (8302). In some embodiments, the price is dynamically adjusted by the licensing manager in response to a selection by the software vendor (8304). In some embodiments the vendor selects a price by entering a price (e.g., price in US dollars, Euros, Yen, or any other currency) in the licensing manager 4930 (FIG. 49) or billing manger 5030 (FIG. 50). In some embodiments, the vendor selects a price by choosing a price from a set of options provided by the marketplace. In some embodiments, at least one selected from the group consisting of access duration, features, and price, is dynamically adjusted by the licensing manager in response to a selection by the software vendor (8306).

In some embodiments, the one or more user accounts are stored separately from the marketplace application (8308).

In some embodiments, a payment (e.g., FIG. 159, billing history) associated with the software application is processed (8310). In some embodiments, prior to processing a payment, a promotional code is received from the user, and the payment is processed based on the promotional code (8312). In some embodiments, a record of the processed payment is stored in a billing record (8314).

In some embodiments, prior to executing the deployed application, a user identifier associated with the one or more user accounts and an application id associated with the deployed application are compared against a billing manager to verify that a valid payment has been recorded (8316). In some embodiments, the system verifies that the one or more user accounts has permission to execute the deployed application, and in the event of a verification failure, warns the user (8318). In some embodiments, the verifying is performed periodically, and following a plurality of verification failures, the one or more user accounts are prevented from executing the deployed application (8320). In some embodiments, the verifying includes checking for multiple instances of the software application being simultaneously executed by the one or more user accounts (8322). In some embodiments, the system prevents access by the user to data stored at the one or more servers, upon determining that the one or more user accounts has been disabled (8324).

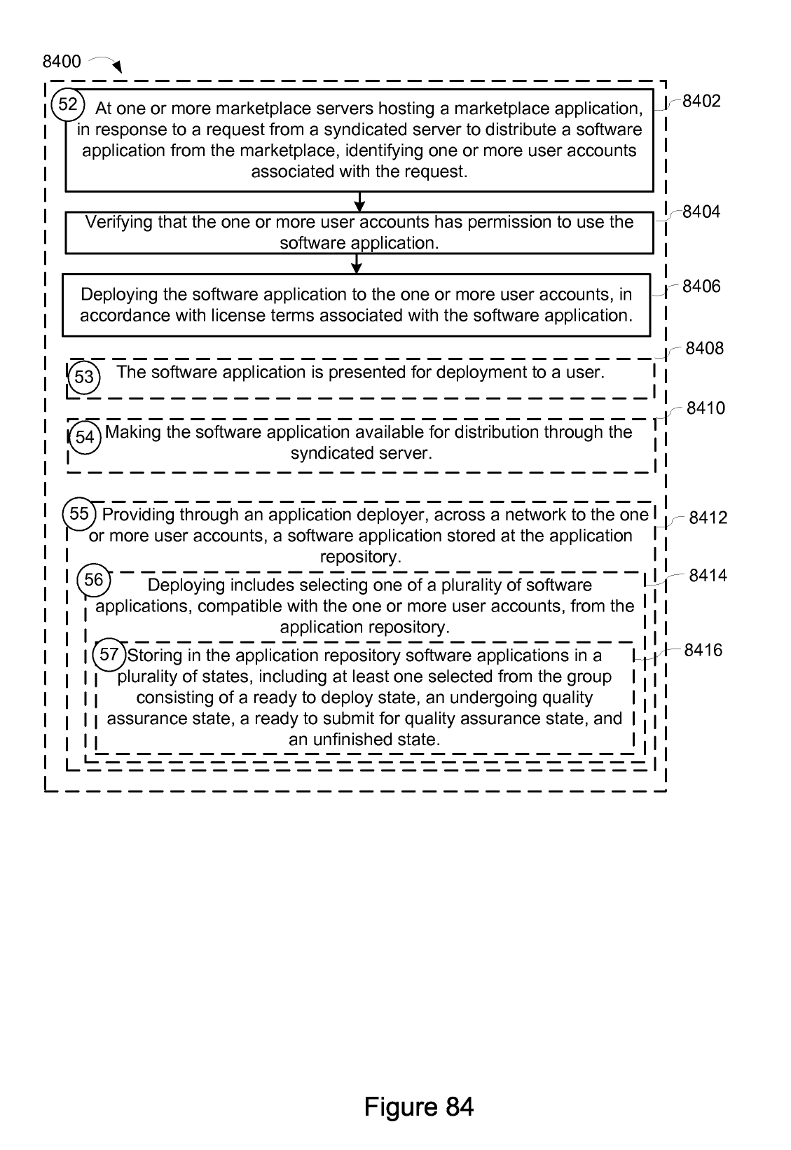

FIG. 84 is a flowchart representing a server method 8400 for syndicated deployment of a software application, according to certain embodiments of the invention. Server method 8400 may be governed by instructions, as described earlier.

At one or more marketplace servers hosting a marketplace application, in response to a request from a syndicated server to distribute a software application from the marketplace, one or more user accounts associated with the request are identified (8402). The system verifies that the one or more user accounts has permission to use the software application (8404). The software application is deployed to the one or more user accounts, in accordance with license terms associated with the software application.

In some embodiments, the software application is presented for deployment to a user (8408). In some embodiments, the software application is made available for distribution through the syndicated server. In some embodiments, deploying includes providing through an application deployer, across a network to the one or more user accounts, a software application stored at the application repository (8412).

In some embodiments, deploying includes selecting one of a plurality of software applications, compatible with the one or more user accounts, from the application repository (8414). In some embodiments, the application repository stores software applications in a plurality of states, including at least one selected from the group consisting of a ready to deploy state, an undergoing quality assurance state, a ready to submit for quality assurance state, and an unfinished state (8416).

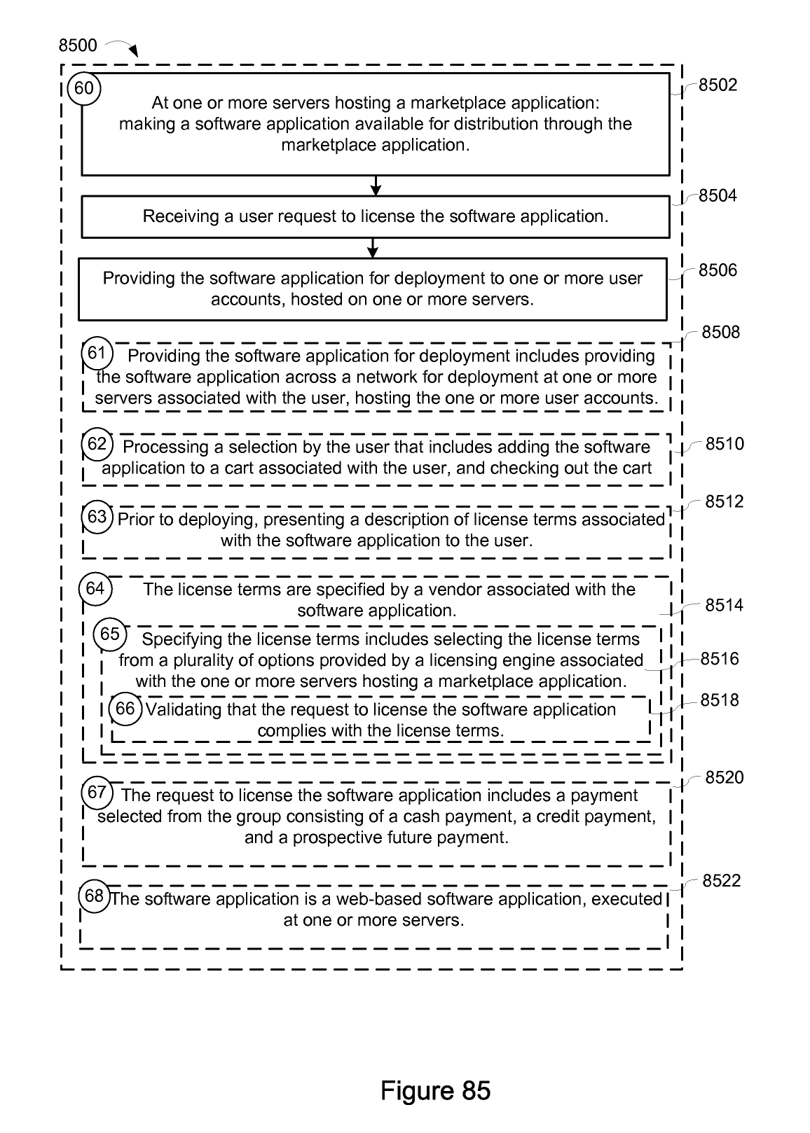

FIG. 85 is a flowchart representing a server method 8500 for licensing and receiving payment for a software application, according to certain embodiments of the invention. Server method 8500 may be governed by instructions, as described earlier.

At one or more servers hosting a marketplace application (e.g., FIGS. 129, 155), a software application is made available for distribution through the marketplace application (8502). A user request to license the software application is received (8504). The software application is provided for deployment to one or more user accounts, hosted on one or more servers (8506). In some embodiments, the software application is provided across a network for deployment at one or more servers associated with the user, hosting the one or more user accounts (8508).

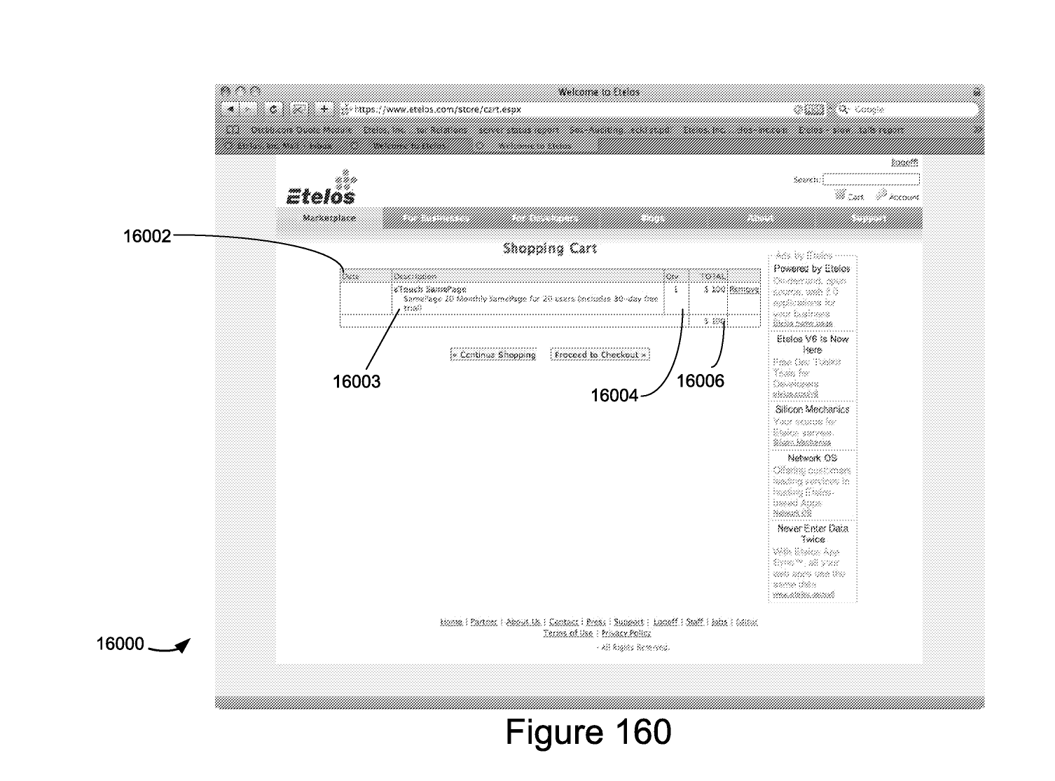

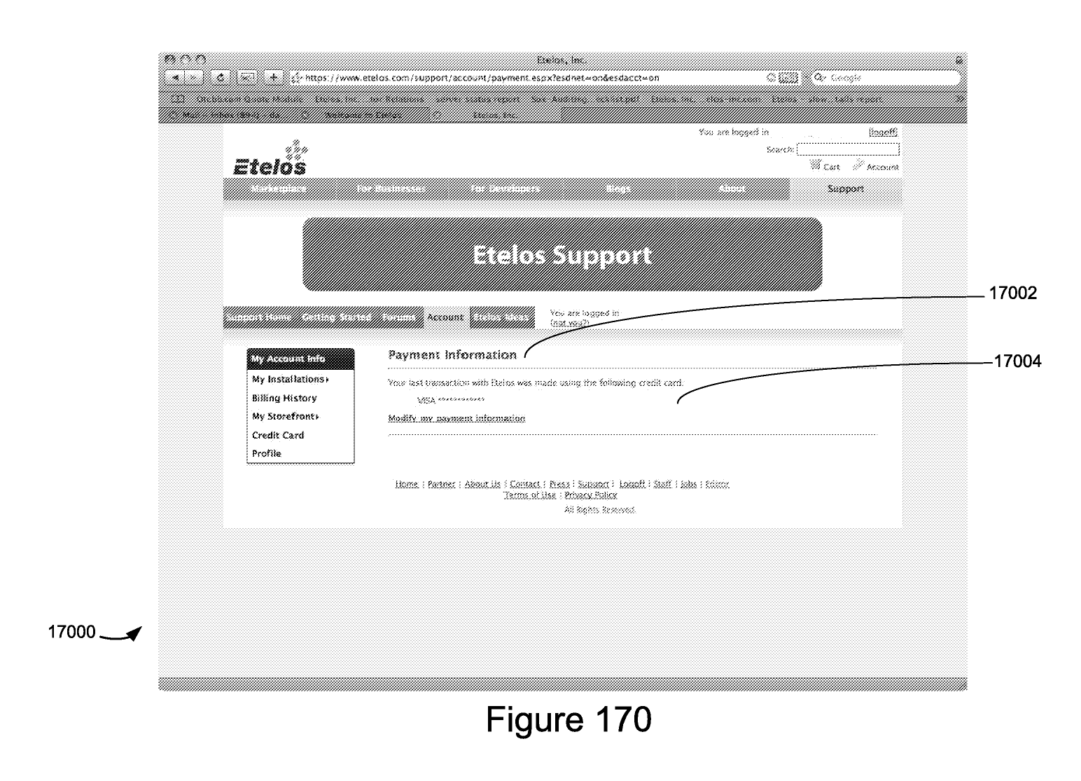

In some embodiments, a selection by the user is processed that includes adding the software application to a cart (e.g., FIG. 160, 172, cart and checkout) associated with the user, and checking out the cart (8510). In some embodiments, prior to deploying, a description of license terms associated with the software application is presented (e.g., FIG. 158, license) to the user (8512). In some embodiments, the license terms are specified by a vendor (e.g., FIG. 132) associated with the software application (8514). In some embodiments, the license terms are selected from a plurality of options provided by a licensing engine associated with the one or more servers hosting a marketplace application (8516). In some embodiments, the system validates that the request to license the software application complies with the license terms (8518). In some embodiments, the request to license the software application includes a payment (e.g., FIG. 170, payment info) selected from the group consisting of a cash payment, a credit payment, and a prospective future payment (8520).

In some embodiments, the software application is a web-based software application, executed at one or more servers (8522).

### Application Framework

Some embodiments provide an application framework that facilitates synchronizing data between applications. The application framework can include data structures and a set of rules for synchronizing data between two applications. For example, consider a customer relationship management (CRM) application and an email application, both of which include tasks for a user. The fields (or columns, etc.) to be synchronized between the CRM application and the email application are first mapped to application framework data structure. For example, the task identifier fields for these two applications can be mapped to the “identifier” field in the application framework data structure. During a synchronization operation between the CRM application and the email application, the CRM application can first synchronize itself with the application framework data structure. The email application can then synchronize itself with the application framework data structure. Synchronization rules can be used to map the fields from the CRM application to the application framework data structure and to map the fields of the application framework data structure to fields for the email application. Note that that the synchronization process can be performed in both directions (e.g., from the CRM application to the email application and from the email application to the CRM application. Also note that in these embodiments, the code and/or the architecture of the applications do not need to be modified in order to synchronize data between the applications. In some embodiments, the data is synchronized between the databases for the applications without using explicit commands executed by the applications. In other words, the synchronization of data occurs at the database level, and not the application level.

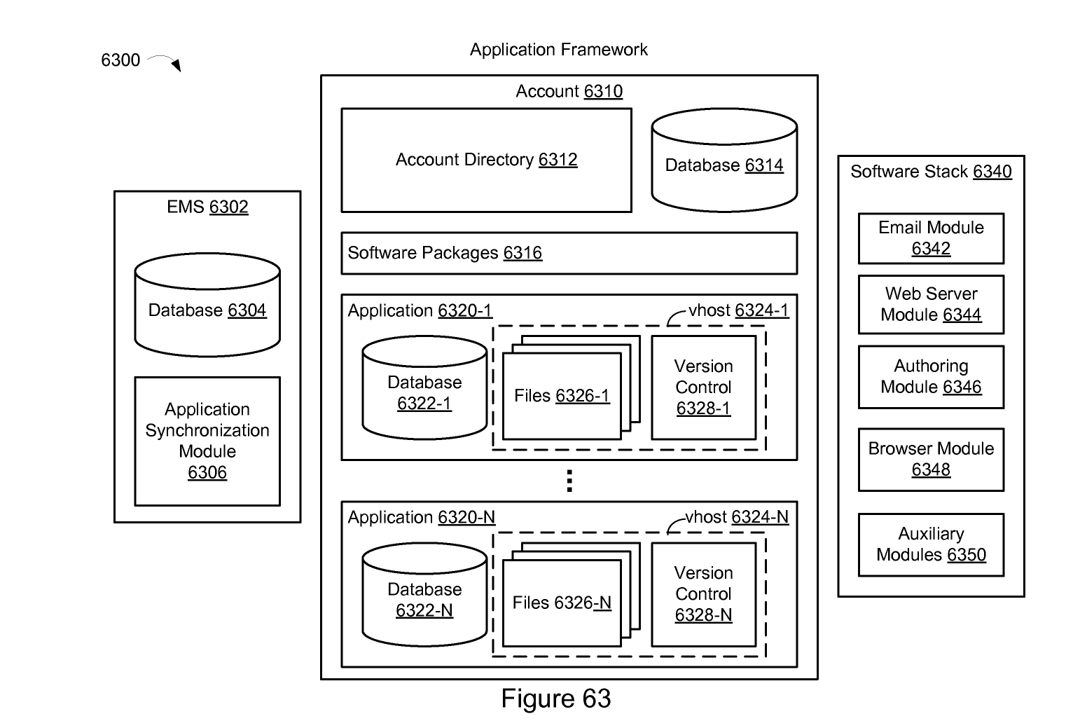

FIG. 63 is a block diagram illustrating an exemplary application framework 6300, according to some embodiments. In some embodiments, the application framework 6300 is located on one or more servers. For example, the application framework 6300 can be located on a server such as the servers 4420-4840 in FIG. 44, any one of the servers 4520-4530 in FIG. 45, the hosting infrastructure 4630 and/or the server 4602 in FIG. 46, any one of the servers 4802 and/or 4830 in FIG. 48, the server 4902 in FIG. 49, the server 5002 in FIG. 50, the server 5102 in FIG. 51, any one of the server 5202 and/or the syndicated server 5230 in FIG. 52, any one of the servers 5350, 5450, and 5550 in FIGS. 53-55, respectively, and/or any one of the servers 5702, 5754, and 5764 in FIG. 57. The one or more servers can include an end user server maintained by an end user (e.g., a customer-provisioned server, etc.) and a hosted server maintained by a service provider (e.g., a software vendor, a web hosting company, etc.). In some embodiments, the application framework 6300 is located on one or more client computer systems. For example, the application framework 6300 can be located on a client computer system such as the client systems 4450-4454 in FIG. 44, and/or any one of the client systems 5820 and 5840 in FIG. 58.

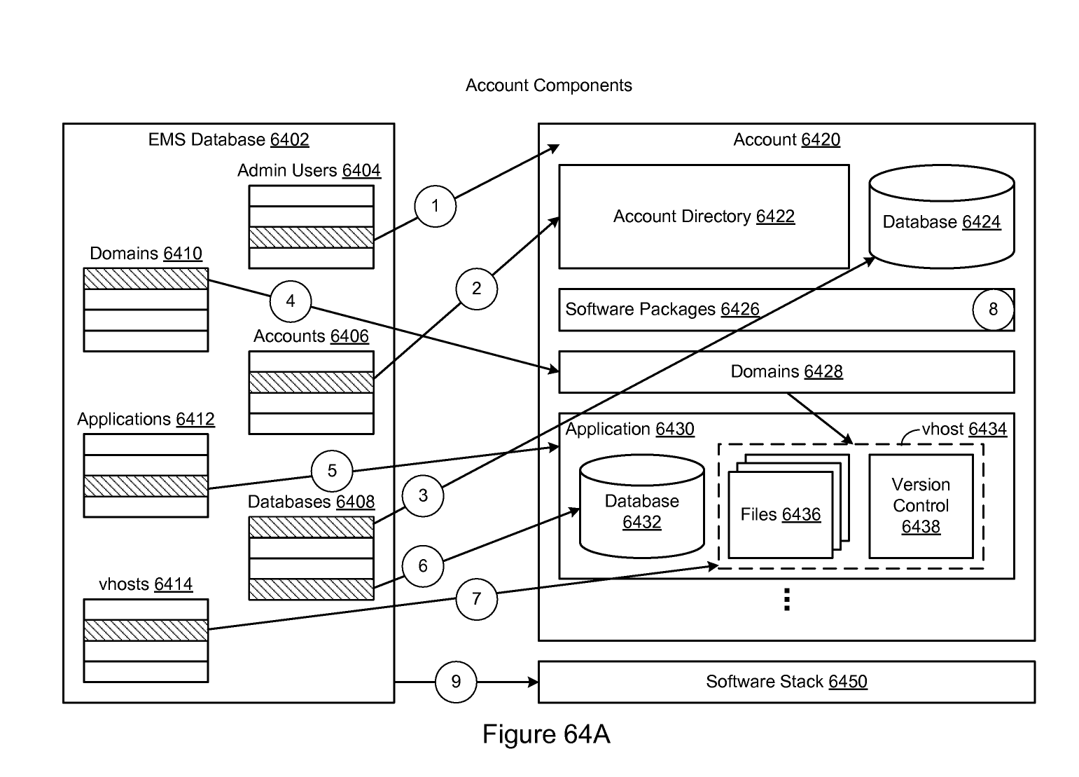

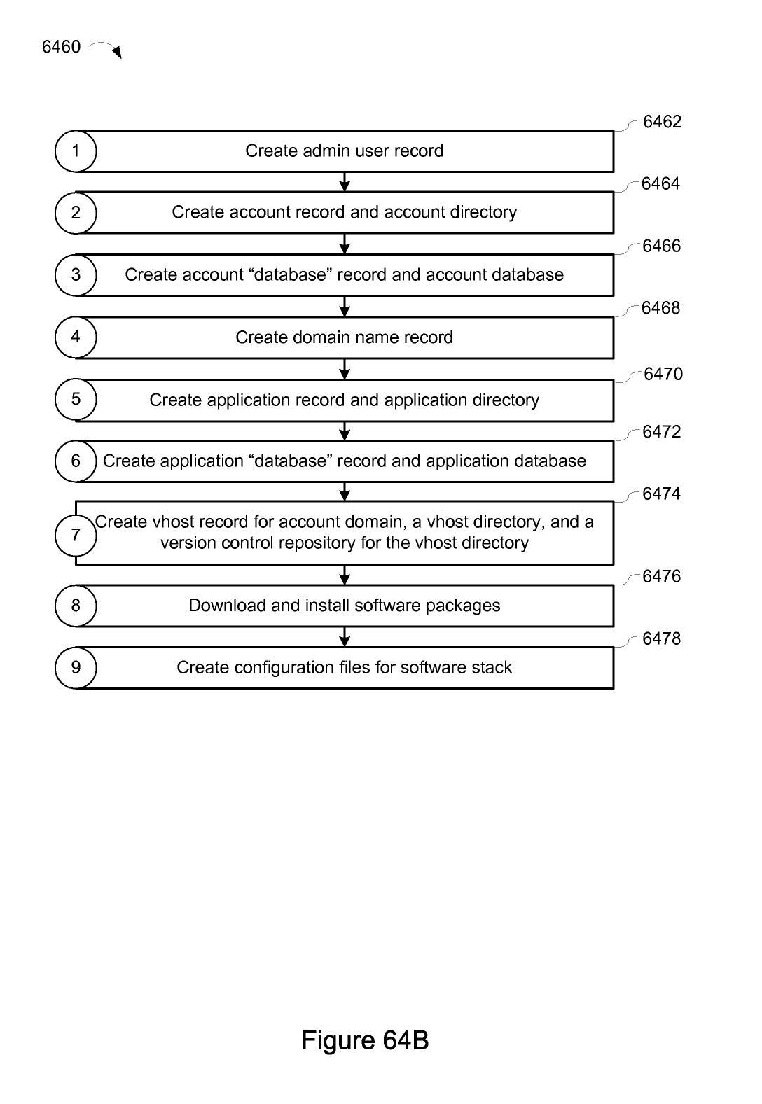

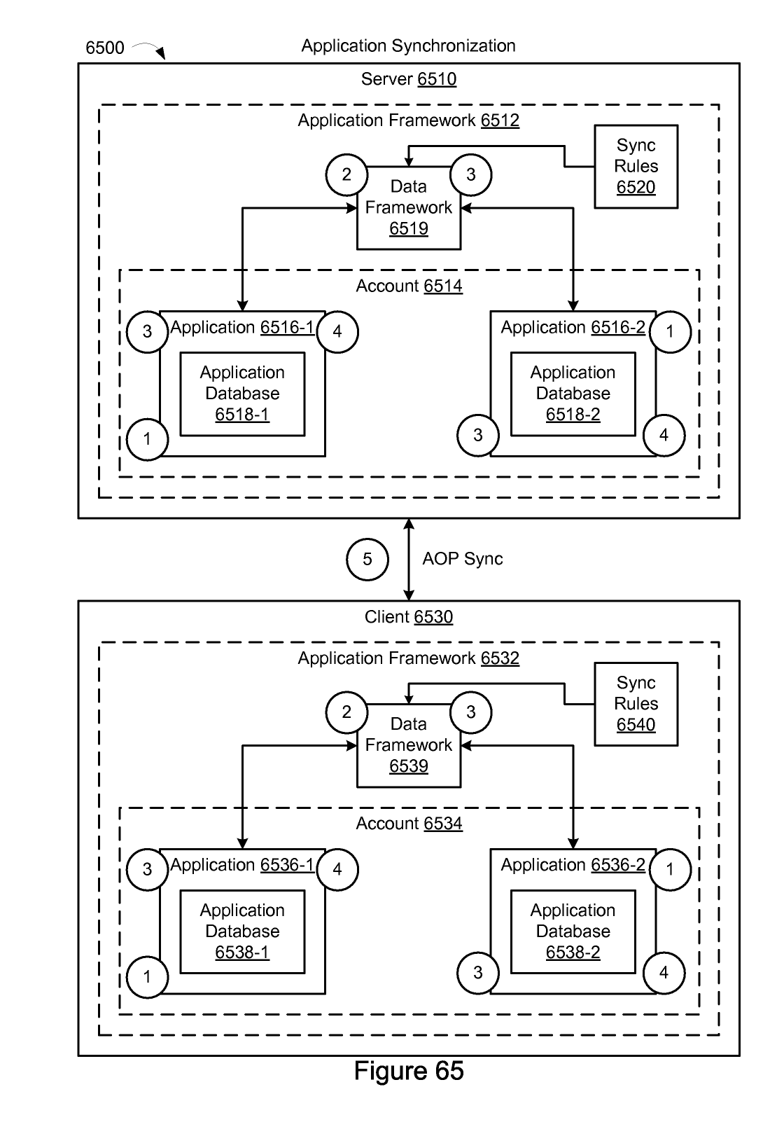

In some embodiments, the application framework 6300 includes one or more of an account management system (EMS) 6302 and/or a software stack 6340. Recall that “EMS” is used to describe a generic account management system. The EMS 6302 can create and manage accounts within the application framework 6300, provide user authentication, and/or synchronize applications within an account and/or between account frameworks. The EMS 6302 can include one or more of a database 6304 and/or an application synchronization module 6306. The database 6304 is described in more detail with reference to FIGS. 64 and 72-73 below and the application synchronization module 6306 is described in more detail below with reference to FIGS. 65-79 below. Note that although the discussion below refers to a single database, multiple databases can be used. The software stack 6340 can include one or more of: an email module 6342, a web server module 6344, an authoring module 6346, a browser module 6348, and/or auxiliary modules 6350. The email module 6342 can include any electronic mail program. For example, the email module 6342 can include email servers (e.g., Sendmail, Postfix, and qmail, etc.), mail filtering programs (e.g., procmail, SpamAssassin, etc.), client email programs (e.g., elm, pine, Microsoft Outlook, etc.), etc. The web server module 6344 can include any application that can respond to client requests for pages, data, graphics, videos, documents, etc, hosted on a server coupled to clients and/or other servers via a network. For example, the web server module 6344 can include Apache HTTP Server, Microsoft Internet Information Server, etc. The authoring module 6346 can include any application that allows a developer or a user to generate web-based applications. For example, the authoring module 6346 can include a text editor, a word processor, a web development environment (e.g., Microsoft Expression Web, Adobe Dreamweaver, etc.), etc. The browser module 6348 can include any application with a rendering engine that can access data and/or services on a local and/or a remote computer system and render the results so that a user can view the data and/or interact with the services. In some embodiments, browser module 6348 is a web browser. The auxiliary modules 6350 can include other applications such as a Lightweight Data Access Protocol (LDAP) interface module and/or database, an Internet Message Access Protocol (IMAP) module, a Post Office Protocol (POP) module, a Dovecot module (e.g., an IMAP and POP server), a web server (e.g., Apache HTTP server, Microsoft IIS Server, etc.), one or more database management systems (e.g., MySQL, PostgreSQL, etc.), logging applications (e.g., Syslog-ng, etc.), authentication services (e.g., saslauthd, etc.). Note that although FIG. 63 illustrates a single module for each type of service, the software stack 6340 can include any number of modules for a given type of service. For example, two different email modules can be included within software stack 6340.

In some embodiments, the application framework 6300 includes one or more accounts. For example, as illustrated in FIG. 63, the application framework 6300 includes an account 6310. The account 6310 can include one or more of: an account directory 6312, and a database 6314. The account directory 6312 can include a directory structure configured to store one or more applications. The account database 6314 can include meta data for the account 6310. The meta data can include descriptions for the software packages 6316, users associated with the account 6310, and/or default synchronization hooks/rules (e.g., for user management, licensing, etc.).

In some embodiments, the account 6310 includes software packages 6316. For example, the software packages 6316 can include utilities (e.g., phpmyadmin, phppgadmin, websvn, EDK, etc.), tools, and/or shared libraries (e.g., Zend, PHPunit, famfamfam, the Etelos Application Server Framework, etc.) used by applications within an account.

In some embodiments, the account 6310 includes one or more applications 6320-1 to 6320-N. For example, the applications 6320 can include applications purchased through the marketplace 4410 in FIG. 44. In some embodiments, one or more of the applications 6320 are web-based applications. In these embodiments, a user can interact with one or more of the applications 6320 using a browser engine (e.g., the browser module 6348). In some embodiments, the applications 6320 are located on a remote server separate and distinct from a computer system and/or a server that includes the browser module 6348. In these embodiments, the browser module 6348 can access the applications 6320 that are executed on the remote server via a network connection. In some embodiments, the applications 6320 are located on the same computer system that includes the browser module 6348. In these embodiments, the browser module 6348 can access the applications 6320 that are executed on the local computer system. In some embodiments, the applications 6320 are located both on a remote server separate and the local computer system. In these embodiments, the browser module 6348 can access the applications 6320 that are executed on the remote server via a network connection. If a connection to the remote server is not available (e.g., the network connection is not available, the remote server is unavailable, etc.), the browser module 6348 can access the applications 6320 on the local computer system. These embodiments are discussed above in reference to the AOP mode of operation. In some embodiments, the browser module 6348 can access the applications 6320 on the local computer system and the remote server.

In some embodiments, a respective application 6320 includes one or more of: a database 6322, files 6326, and/or a version control repository 6328. The databases 6322 can include data for the respective application 6320. The files 6326 can include application files for the respective application 6320. For example, the files 6326 can include static HTML files, scripts, graphics files, video files, XML files, access control files, documents, etc. The version control repository 6328 can include one or more versions of the files 6326. For example, the version control repository 6328 can include repositories managed by version control systems such as Subversion (SVN), Concurrent Version System (CVS), Revision Control System (RCS), etc. In some embodiments, the files 6326 can be modified by developers through a version control interface (e.g., WebDAV). When making changes to the files 6326, the version control system maintains a history of the changes, which can be used to generate patches, updates, and/or new versions of the files 6326 that can be distributed and deployed to other instances of the respective application (e.g., the application can be running on different account on a different server, etc.). In some embodiments, the files 6326 and the version control repository 6328 for a respective application are associated with one or more vhosts 6324. A virtual host is a mechanism that allows a web server to host one or more domains. For example, www.example.com and www.example2.com can both be hosted on the same web server using a virtual host mechanism. Each virtual host may include a separate directory hierarchy within the web server and/or a separate database (e.g., either on the web server or on a separate database server or servers). A virtual host (e.g, vhost) for a respective application can point to a different set of files that are owned and/or used by the respective application.

In some embodiments, one or more of the applications 6320 are configured to use a specified email domain. In these embodiments, the email module 6342 can be configured by the applications 6320 to send and/or receive email on the specified email domain.

Note that a newly-created account may not include any applications. Also note that although FIG. 63 illustrates a single account, the application framework 6300 can support any number of accounts (e.g., 0, 1, 2, . . . , N). Moreover, although components are grouped together in FIG. 63, these groupings can be changed. For example, the software stack 6340 can include all or a subset of the software packages 6316.

FIG. 64A is a block diagram illustrating exemplary components of an account 6420, according to some embodiments. The account 6420 can be the account 6310 in FIG. 63. The account 6420 can include one or more of an account directory 6422, a database 6424, software packages 6426, and applications 6430 (including one or more of databases 6432, files 6436, version control repository 6438, and vhost 6434), which correspond in general to the account components described above with reference to FIG. 63. In some embodiments, the account 6420 includes domains 6428, which include one or more Internet domain names associated with applications within the account 6420.

In some embodiments, an EMS database 6402 includes one or more of: a users table 6404, an accounts table 6406, a databases table 6408, a domains table 6410, an applications table 6412, and/or a vhosts table 6414. Recall that “EMS” is used to describe a generic account management system. The users table 6404 can include user records for one or more users that can be associated with one or more accounts. The accounts table 6406 can include account records that can include information about accounts, locations of account directories, users associated with the accounts, etc. The databases table 6408 can include “database” records that can include information about databases for the account 6420 (e.g., the database 6424, the database 6432, etc.). The domains table 6410 can include domain records for one or more domains associated with the account 6420 and/or the applications 6430. The applications table 6412 can include application records that can include information about the applications 6430, the files 6436 and directories within the account directory 6422, the version control repositories 6438, and/or the vhosts 6434 associated with the account 6420. The vhosts table 6414 can include virtual host records that can include information associated with a vhost directory, an account domain, and/or the version control repository 6438.

FIG. 64A also includes a software stack 6450, which can correspond to the software stack 6340 in FIG. 63.

FIG. 64B is a flow diagram of an exemplary process 6460 for creating an account and installing applications into the account, according to some embodiments. Note that the circled numbers in FIG. 64B correspond to the circled numbers in FIG. 64A. In some embodiments, an EMS (e.g., the EMS 6302) performs these operations. The discussion of FIG. 64B below describes the operations as being performed by the EMS for the sake of clarity. However, it should be noted that other modules can perform all or a subset of these operations. The process 6460 may be governed by instructions that are stored in a computer readable storage medium and that are executed by one or more processors of one or more servers. Each of the operations shown in FIG. 64B may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

The EMS creates an admin user record for an admin user in the admin users table 6404 (6462). In some embodiments, an application synchronization operation and/or an AOP synchronization operation cannot be performed for admin users. Note that non-admin users associated with an account can also be created in a separate process after the account has been created. These non-admin users can be stored in a “users” table (not shown). In some embodiments, an application synchronization operation and/or an AOP synchronization operation can be performed for non-admin users.

Returning to FIG. 64B, the EMS creates an account record in the accounts table 6406 and an account directory that are associated with the admin user record (6464). The EMS then creates an account database and an associated “database” record in the databases table 6408 for the newly created account database (6466). Next, the EMS creates a domain record in the domains table 6410 (6468). The EMS then creates an application directory and an application record in the applications table 6412 associated with the application directory (6470). The EMS then creates an application database and a “database” record in the databases table 6408 associated with the application database (6472). Next, the EMS creates a vhost directory, a version control repository for the vhost directory, and/or a vhosts record in the vhosts table 6414 (6474). Note that a given application (e.g., the application 6430) can have many virtual hosts (e.g., the vhost 6434, etc.) associated with it. Thus, multiple vhost directories, version control repositories, and/or vhosts records can be associated with the given application. In some embodiments, a virtual host (e.g., the vhost 6434) for an application (e.g., the application 6430) can be associated with a database. In these embodiments, a database connection string, which indicates how the virtual host can connect to the database, can be stored in the databases table 6408 and/or the vhosts table 6414. The EMS then downloads and installs the software packages 6426 (6476). The EMS then creates configuration files for the modules in the software stack 6450 (6478).

Although FIG. 64B describes an exemplary process for creating a new account and installing applications into the new account, only a subset of the operations in FIG. 64B may need to be performed. For example, if a user record for a given user and an account record associated with the user already exist in the EMS database 6402, then steps 6462-6466 can be omitted when adding a new application to the existing account.

### Synchronizing Applications

Some embodiments provide techniques for synchronizing data between applications. In these embodiments, the code and/or the architecture of the applications do not need to be modified in order to synchronize data between the applications. In some embodiments, the data is synchronized between the databases for the applications without using explicit commands executed by the applications. In other words, the synchronization of data occurs at the database level, and not the application level. In some embodiments, the application framework described above is used to facilitate synchronizing data between applications. For example, the data that can be synchronized between applications can include tasks, contacts, calendar items, etc. The data is typically stored in tables within a database. The tables in which the data is stored can be different for each application. For example, a first application may store contact data in a “contacts” table in a database for the first application, whereas a second application may store contact data in an “email” table in a database for the second application. In some embodiments, one or more of the applications is a web-based application.

FIG. 65 is a block diagram 6500 of a server 6510 and a client 6530, according to some embodiments. In some embodiments, the server 6510 includes an application framework 6512. The application framework 6512 can include one or more accounts. For example, the application framework 6512 can include an account 6514. The account 6514 can include one or more applications 6516. The applications 6516 can be associated with application databases 6518, which can store, update, delete, retrieve, query, and search for data in application databases 6518. As illustrated in FIG. 65, the account 6514 includes the applications 6516-1 and 6516-2 and the associated application databases 6518-1 and 6518-2, respectively.

In some embodiments, a subset of the data stored in the application databases 6518-1 and 6518-2 can be synchronized with each other. For example, the subset of the data can be data that has changed (e.g., new data, updated data, deleted data, etc.). In some embodiments, the subset of the data stored in the application databases 6518-1 and 6518-2 are first synchronized with a data framework 6519 based on synchronization rules 6520. The synchronization rules 6520 are then applied to the data that was synchronized to the data framework 6519 to synchronize this data with the respective application database. Alternatively, the synchronization rules can be applied directly to synchronize the subset of the data stored in the application databases 6518-1 and 6518-2 without using the data framework 6519. The synchronization rules 6520 are described in more detail below. In some embodiments, the applications 6516-1 and 6516-2 can be applications that do not have any built-in capabilities to synchronize data with each other. These applications can include, but are not limited to, email applications, CRM applications, calendar applications, etc. If these applications are standalone applications, they may not be able to synchronize data with each other. For example, GOOGLE™ calendar may not be able to synchronize tasks with SUGAR CRM. In some embodiments, the application databases 6518-1 and 6518-2 are synchronized with each other directly. For example, a database that includes contact information for GOOGLE™ calendar can synchronize directly with a database that includes contact information for SUGAR CRM. This synchronization can be performed “outside” of the applications. In other words, the applications do not need to be executing or active to perform the synchronization.

In some embodiments, the client 6530 includes an application framework 6532. The application framework 6532 can include one or more accounts. For example, the application framework 6532 can include an account 6534. The account 6534 can include one or more applications 6536. The applications 6536 can be associated with application databases 6538, which can store, update, delete, retrieve, query, and search for data in application databases 6538. As illustrated in FIG. 65, the account 6534 includes the applications 6536-1 and 6536-2 and the associated application databases 6538-1 and 6538-2, respectively. For example, the applications 6536 can be GOOGLE™ calendar and SUGAR CRM, respectively, and the databases 6538 can be databases for GOOGLE™ calendar and SUGAR CRM, respectively.

In some embodiments, a subset of the data stored in the application databases 6538-1 and 6538-2 can be synchronized with each other. For example, the subset of the data can be data that has changed (e.g., new data, updated data, deleted data, etc.). In some embodiments, the subset of the data stored in the application databases 6538-1 and 6538-2 are first synchronized with a data framework 6539 based on synchronization rules 6540. The synchronization rules 6540 are then applied to the data that was synchronized to the data framework 6539 to synchronize this data with the respective application database. For example, if changes have occurred in GOOGLE™ calendar, fields (or columns, etc.) in the database for GOOGLE™ calendar first synchronized with the data framework 6539, then the synchronization rules 6540 are applied to the data framework 6539 to propagate/synchronize the data from the data framework 6539 to the database for SUGAR CRM. Alternatively, the synchronization rules can be applied directly to synchronize the subset of the data stored in the application databases 6538-1 and 6538-2 without using the data framework 6539. The synchronization rules 6530 are described in more detail below. In some embodiments, the applications 6536-1 and 6536-2 can be applications that do not have any built-in capabilities to synchronize data with each other. In some embodiments, the application databases 6538-1 and 6538-2 are synchronized with each other directly.

In some embodiments, the applications 6516 in the account 6514 on the server 6510 can be synchronized with the applications 6536 in the account 6534 on the client 6530. In some embodiments, the data frameworks 6519 and 6539 are first synchronized with each other, and then the synchronization rules 6520 and 6540, respectively, are applied to the synchronized data to synchronize the application databases 6518 and 6538, respectively. In some embodiments, the AOP synchronization process described above is used to synchronize the application databases 6518 on the server 6510 with the application databases 6538 on the client 6530.

Note that although FIG. 65 illustrates a single account in the server 6510 and a single account in the client 6530, more than one account can be included on the server 6510 and/or the client 6530. Furthermore, each account can include any number of applications.

In some embodiments, the data frameworks 6519 and 6539 and the sync rules 6520 and 6540 are included in an application synchronization module (e.g., the application synchronization module 6306 in FIG. 63.

Although FIG. 65 illustrates that both the server 6510 and the client 6530 include application frameworks, in some embodiments, either the server 6510 or the client 6530 may not include an application framework.

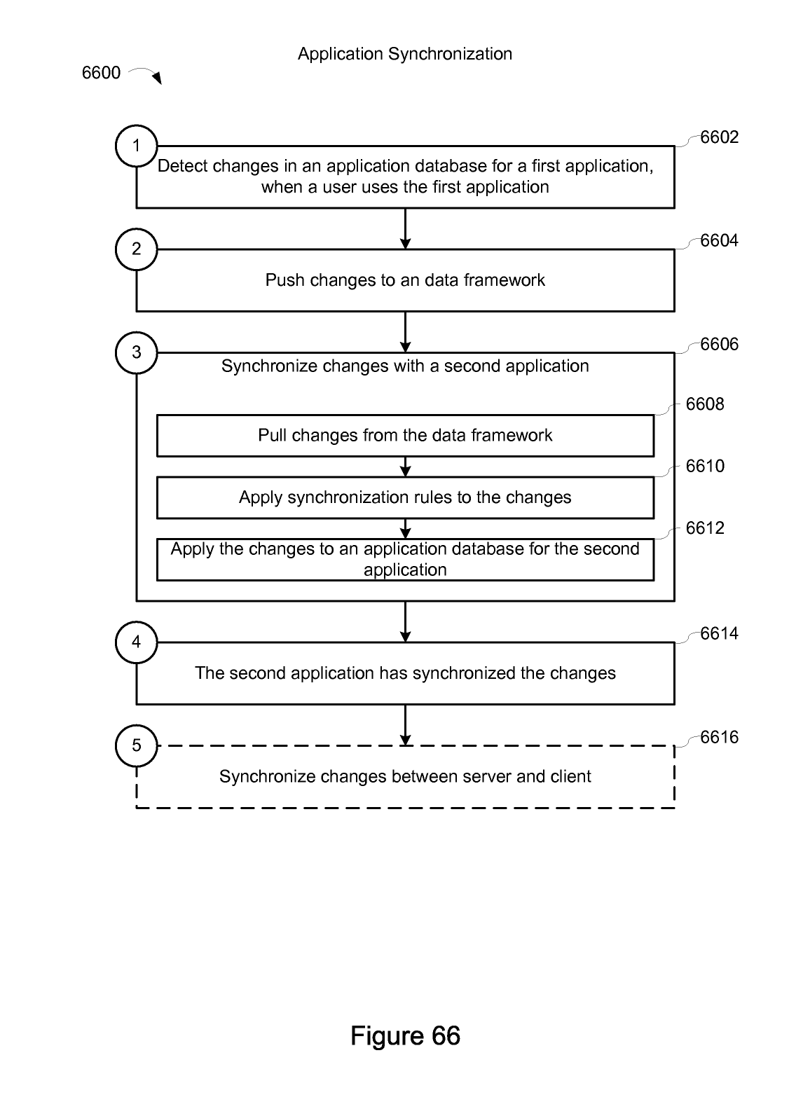

FIG. 66 is a flow diagram of an exemplary process 6600 for synchronizing applications, according to some embodiments. Note that the circled numbers in FIG. 66 correspond to the circled numbers in FIG. 65. The process 6600 may be governed by instructions that are stored in a computer readable storage medium and that are executed by one or more processors of one or more servers. Each of the operations shown in FIG. 66 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

As illustrated in FIG. 66, changes are detected in an application database (e.g., the application database 6518-1 in FIG. 65) for a first application (e.g., the application 6516-1) when a user uses the first application (6602). The changes are then pushed to a data framework (e.g., the data framework 6519 in FIG. 65) (6604) and the changes are then synchronized with a second application (e.g., the application 6516-2 in FIG. 65) (6606). The second application has synchronized the changes (6614). In some embodiments, the changes are synchronized between the server (e.g., the server 6510 in FIG. 65) and the client (e.g., the client 6530 in FIG. 65) (6616). In these embodiments, the AOP synchronization technique described above can be used.

In some embodiments, synchronizing the changes with the second application includes pulling changes from the data framework (6608), applying synchronization rules to the changes (6610), and applying the changes to an application database (e.g., the application database 6518-2 in FIG. 65) for the second application (6612).

Note that the process 6600 can be performed at the client 6530 and/or the server 6510 in FIG. 65. Moreover, changes from any applications within an application framework can be synchronized with other applications within the application framework. For example, changes made in the application 6516-2 can be synchronized with the application 6516-1 and changes made in the application 6516-1 can be synchronized with the application 6516-2. Furthermore, changes made in applications on a server/client can be synchronized with applications on a client/server (e.g., using the AOP synchronization technique described above).

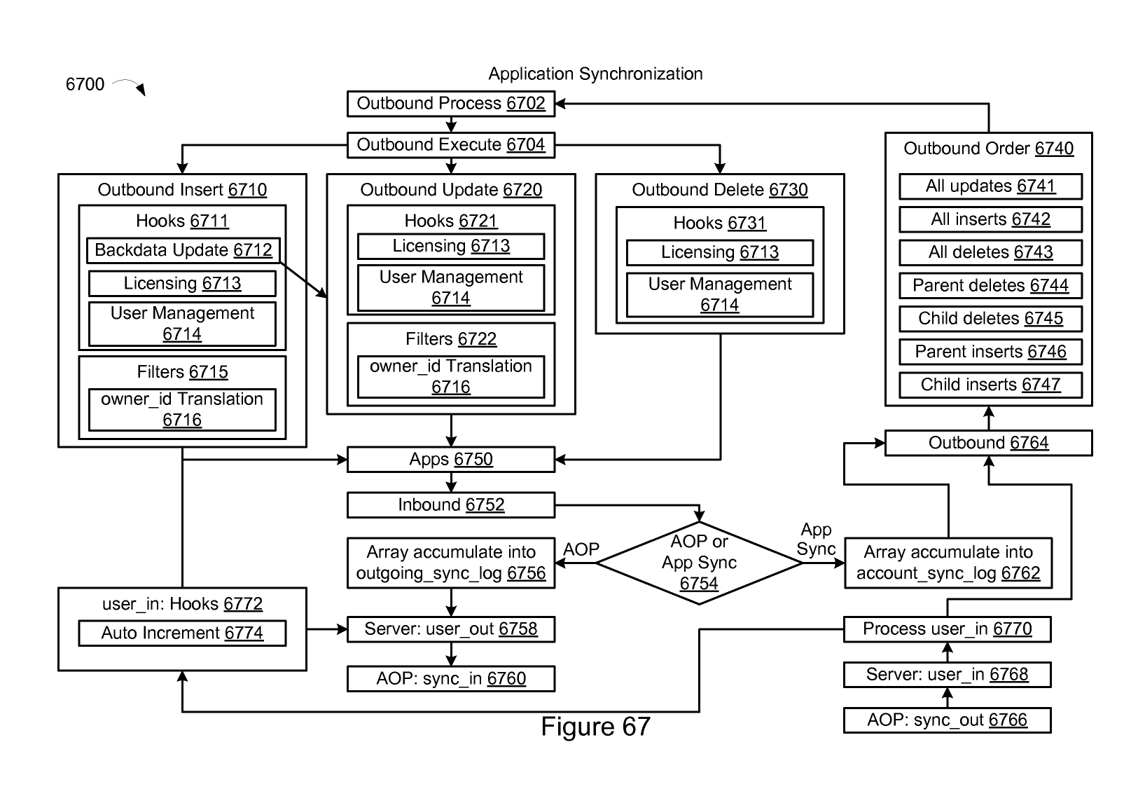

FIG. 67 is a block diagram illustrating an exemplary process 6700 for synchronizing applications, according to some embodiments. The process 6700 may be governed by instructions that are stored in a computer readable storage medium and that are executed by one or more processors of one or more servers. Each of the operations shown in FIG. 67 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. In some embodiments, the process is performed on a computer system that is to be synchronized. For example, the computer system can be a server or a client computer system.

An outbound process module 6702 receives an outbound order 6740, which includes changes to data for one or more applications and an order that changes to data are applied. Note that the changes to the data can be made to one or more databases, one or more structured files, and/or one or more documents. In some embodiments, the ordering of changes to data in the outbound order 6740 can be: all updates 6741, all inserts 6742, all deletes 6743, parent deletes 6744, child deletes 6745, parent inserts 6746, and child inserts 6747. The all updates 6741 includes all updates to existing data. The all inserts 6742 includes all new data records that are to be added. The all deletes 6743 includes all existing data records that are to be deleted. The parent deletes 6744 include parent data records that are to be deleted. The child deletes 6745 include child data records that are to be deleted. The parent inserts 6746 include parent data records that are to be deleted. The child inserts 6747 include child data records that are to be deleted.

In some embodiments, an outbound execute module 6704 receives the changes to the data for one or more applications and executes one or more of: an outbound insert module 6710 that inserts new data records, an outbound update module 6720 that updates existing data records, and an outbound delete module 6730 that deletes existing data records for one or more applications 6750. The one or more applications 6750 can also receive changes to the data from an AOP synchronization process through the user_in: Hooks module 6772. The user_in:Hooks module 6772 can include an auto increment module 6774, which is described in more detail above with reference to FIGS. 27-29 above.

In some embodiments, the outbound insert process 6710 includes hooks 6711 and filters 6715. The hooks 6711 can include one or more of: hooks to a backdata update module 6712 that performs an initial data synchronization (e.g., as described in FIGS. 18 and 19 above), hooks to a licensing module 6713 that verifies that licenses are valid (e.g., as described in FIGS. 44 and 57 above), and/or hooks to a user management module 6714 (e.g., as described in FIG. 57 above). Note that the term “hooks” refers to a mechanism by which a given module can access another module. For example, a hook can include a function, a procedure, and/or a method within a given module that can access functions of another module, an API function, procedure, and/or method, etc. In some embodiments, the backdata update module 6712 requeues new data records (e.g., data records to be added) for an application as updates that are updated in the outbound update process 6720. The filters 6715 can include an owner id translation filter 6716 that translates owner_ids between applications. Note that the term “filter” refers to a mechanism that can perform a specified operation on data. For example, this operation can include a translation operation that translates data values, a selection operation that selects data values based on specified criteria, etc.

In some embodiments, the outbound update process 6720 includes hooks 6721 and filters 6724. The hooks 6721 can include one or more of: hooks to a licensing module 6713 that verifies that licenses are valid and/or hooks to a user management module 6714. The filters 6722 can include an owner_id translation filter 6716 that translates owner_ids between applications.

In some embodiments, the outbound delete process 6730 includes hooks 6731. The hooks 6731 can include one or more of: hooks to a licensing module 6713 that verifies that licenses are valid and/or hooks to a user management module 6714.

Note that if the licensing modules 6713 determine that a license for an application is not valid, the outbound insert process 6710, the outbound update process 6720, and/or the outbound delete process 6730, respectively, are not performed. Similarly, if the user management modules 6714 determine that a user of an application does not have sufficient privileges to change specified data for the one or more applications, the outbound insert process 6710, the outbound update process 6720, and/or the outbound delete process 6730, respectively, are not performed.

In some embodiments, as changes to the data for the one or more applications 6750 are detected by an inbound module 6752, the changes can be accumulated for one or more of an AOP synchronization process and an application synchronization process. If the changes are being accumulated for an application synchronization process (6754, App Sync), the changes are accumulated into an account synchronization log 6762, which is then used by an outbound process 6764. If the changes are being accumulated for an AOP synchronization process (6754, AOP), the changes are accumulated into an outgoing synchronization log 6756. Changes from the outgoing_sync_log and the AOP user_in are then separated into “user out” tables 6758 as described above with reference to FIG. 27 above. The user_out tables are then received by an AOP sync_in process 6760 on a receiving system (e.g., a server if the changes were made on a client, or a client if the changes were made on the server).

In some embodiments, an AOP sync_out process 6766 receives changes to data for applications on a transmitting system made when the applications were operating in an AOP mode (e.g., as described above). These changes can be included in a user_in table 6768. The changes included in the user_in tables are then processed 6770. In some embodiments, the changes included in the user_in tables are received by the outbound process 6764, which incorporates the changes made to applications within a given computer system (e.g., application synchronization) and changes made to applications on different computer systems (e.g., AOP synchronization). In some embodiments, the changes included in the user_in tables are processed by the auto increment module 6774 as described above. After being processed by the auto increment module 6774, the changes included in the user_in tables are incorporated into the user_out tables 6758 and/or the one or more applications 6750. Note that the changes included in the user_in tables can be included in the user_out tables because an application synchronization operation may include changes both to the instance of the application on the server and on the client.

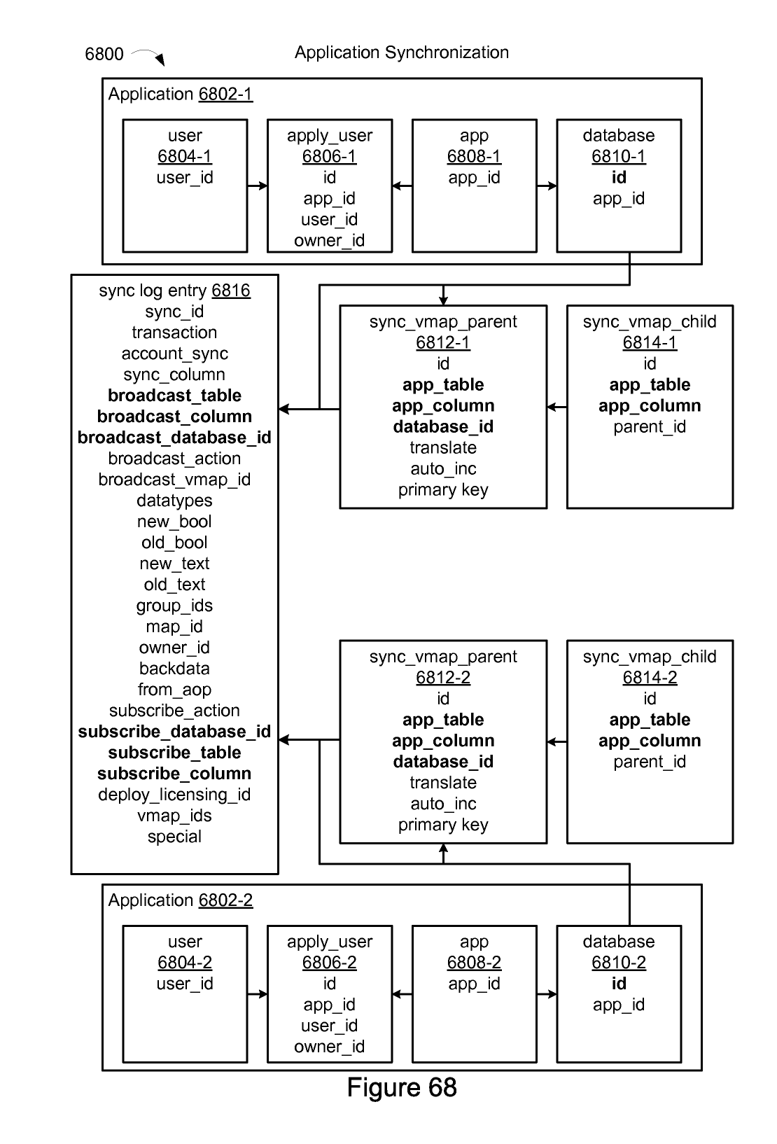

FIG. 68 is a block diagram illustrating an exemplary process 6800 for handling parent-child relationships during a synchronization process, according to some embodiments. The exemplary process 6800 describes exemplary operations performed by the owner_id translation module 6716 in FIG. 67. Parent-child relationships can be unenforced or can be enforced using foreign keys. Parent-child relationships can be used to associate records with each other. These associations can include a one-to-one (e.g., one parent to one child), a one-to-many (e.g., one parent to multiple children), and a many-to-many (e.g., many parents to many children) relationship. As illustrated in FIG. 68, applications 6802 are being synchronized with each other. The applications 6802 can be any of the applications described above (e.g., web-based applications). The applications 6802 include users tables 6804, apply_users tables 6806, applications tables 6808, and databases tables 6810. A user with a given id is associated with an application with an associated id via the apply_users table 6806. For example, the apply_user table 6806-1 can include foreign keys referring to a data record in the users table 6804-1 associated with a given user (e.g., user_id) and a data record in the applications table associated with a given application (e.g., app_id). The apply_user table 6806-1 can also include a unique record id (e.g., “id”) and an owner_id value that corresponds to the given user's instance within an application. The corresponding set of tables also exist for the application 6802-2.

In some embodiments, the parent-child relationships are defined in sync_vmap_parent tables 6812 and sync_vmap_child tables 6814. The sync vmap_parent tables 6812 include an app_table field, an app_column field, a database_id field, a translate field, an auto_inc field, and a primary key field. The app_table and app_column fields specify an application table and column, respectively. The database_id field specifies the database_id in the databases table 6408 corresponding to the database including the app_table and app_column. The translate field specifies whether an owner_id translation is to be performed for a given parent-child relationship defined in the sync_vmap_parent tables 6812. The auto_inc field specifies that the parent value is an auto incrementing value (e.g. used in AOP sync). The primary key field indicates that the parent value is a primary key of a table (e.g., used for AOP synchronization operations and application synchronization operations). For application synchronization operations, the primary key can indicate whether the EMS needs to generate a unique identifier for a given field. For AOP synchronization operations, the primary keys are required to be the same on the server and the client. Thus, the primary key can be used to reinforce the parent/child relationships. The sync_vmap_child tables 6814 include the app_table field, an app_column field, and a parent_id field.

In some embodiments, during a synchronization process, the changes to the data are stored one or more sync log entries. An exemplary sync log entry 6816 is illustrated in FIG. 68. The exemplary sync log entry 6816 includes one or more of: sync_id (e.g., a unique identifier for the sync log entry), transaction (e.g., a unique identifier for a given database transaction), account_sync (e.g., the type of synchronization data—AOP sync, application sync, etc.), sync_column (e.g., the column to be synchronized), broadcast_table (e.g., a table in the source database), broadcast_column (e.g., a column in a table that in the source database includes the changed data), broadcast_database_id (e.g., a database_id in the databases table 6408 corresponding to the source database), broadcast_action (e.g., an action performed by the source database—insert, update, delete, etc.), broadcast_vmap_id (e.g., a unique identifier for a source vmap), datatypes (e.g, the data type of the changed data), new_bool (e.g., if a column is a Boolean value and an Insert or an Update has occurred, this stores the new Boolean value), old_bool (e.g., if a column is a Boolean value and an Update has occurred, this stores the old Boolean value), new_text (e.g., if a column is not a Boolean value and an Insert or an Update has occurred, this stores the new value), old_text (e.g., if a column is not a Boolean value and an Update has occurred, this stores the old value), group_ids (e.g., identifies ownership and record filtering for AOP and/or application synchronization operations when group ownership is declared), map_id (e.g., a unique identifier that is used to identify records across applications), owner_id (e.g., an identifier for the user that corresponds to the user's instance with an application), backdata (e.g., whether a backdata update is to be performed), from_aop (e.g., whether the sync log entry resulted from an AOP synchronization operation), subscribe_action (e.g., an action to be performed by the subscribing database—insert, update, delete, etc.), subscribe_database_id (e.g., a database_id in the databases table 6408 corresponding to the subscribing database), subscribe_table (e.g., a table in the subscribing database), subscribe_column (e.g., a column in a table that in the subscribing database includes the changed data), deploy_licensing_id (e.g., a unique identifier used to identify the licensing model for a given application), vmap_ids (e.g., a unique identifier for a destination/subscribing vmap), and special (e.g., used to mark phrases—updating, complete, etc.—for auto-increment).

In some embodiments, every table in the application used by the synchronizer includes a column “eas_sync_map_id.” During a synchronization operation, the field “map_id” includes the unique identifier that corresponds to the value in eas_sync_map_id column. This column can include a 32 character unique identifier which is used to identify records across applications. For example, when updating or deleting a value during synchronization, the value in the eas_sync_map_id column is used to match to the eas_sync_map_id in the destination app.

In some embodiments, the sync log entry 6816 includes data that allows the lookup of parent/children relationships. This lookup can be performed while the sync log entry is being processed. Note that the fields prefixed with “broadcast_” include data pertaining to the source database and the fields prefixed with “subscribe_” include data pertaining to the destination database.

In some embodiments, if a subscribing database includes a parent/child relationship defined on a subscribe_table and/or a subscribe_column, the sync log entry is treated as a special case and is handled in a different order. (e.g., see the outbound order 6740 in FIG. 67). In some embodiments, a subscribing database is a database that has requested to receive changes to data made in another database. In some embodiments, if a given sync log entry corresponds to a data record that has a parent-child relationship and the data record is marked as “translate” (e.g., via the sync_vmap_parent 6812 tables), the apply_user records for the source database are queried to determine a user associated with the owner_id for the changed data that the sync log entry is referencing. The apply_user records for the subscribing database are also queried to determine the owner_id for the subscribing database associated with the determined user. The owner_id value of the subscribing database can then be used to replace the value of the owner_id in the sync log entry.

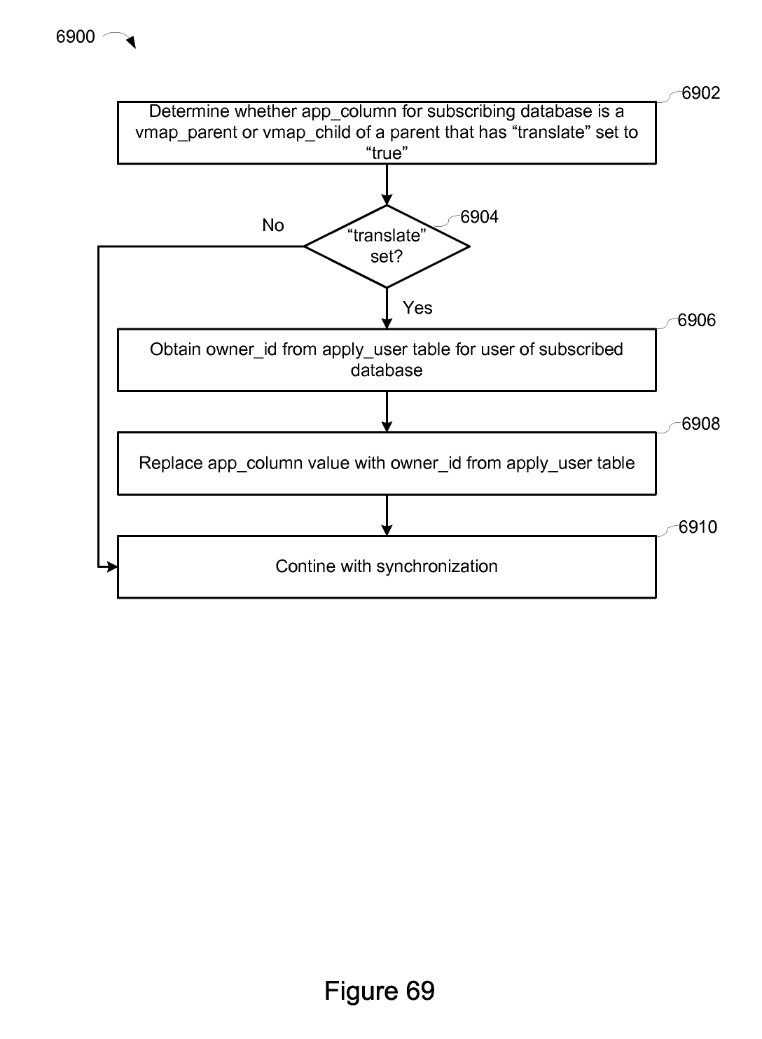

FIG. 69 is a flow diagram of an exemplary process 6900 for translating owner IDs, according to some embodiments. The process 6900 may be governed by instructions that are stored in a computer readable storage medium and that are executed by one or more processors of one or more servers. Each of the operations shown in FIG. 69 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. For example, the process 6900 can be performed by the application synchronization module 6306 (e.g., in a client and/or a server) in FIG. 63. The discussion of FIG. 69 below describes the operations as being performed by the application synchronization module 6306 of a computer system (e.g., a client and/or a server) for the sake of clarity. However, it should be noted that other modules can perform all or a subset of these operations.

In FIG. 69, the application synchronization module 6306 determines whether the app column for a subscribing database is a vmap_parent or a vmap_child of a parent that has the “translate” field set to “true” (6902). If the “translate” field is set to “false” (6904, no), the application synchronization module 6306 continues with the synchronization (6910). If the “translate” field is set to “true” (6904, yes), the application synchronization module 6306 obtains the owner_id corresponding to the user of the subscribed database from the apply_user table (6906). Next, the application synchronization module 6306 replaces the app_column value with the owner_id from the apply_user table (6908). The application synchronization module 6306 then continues with the synchronization (6910).

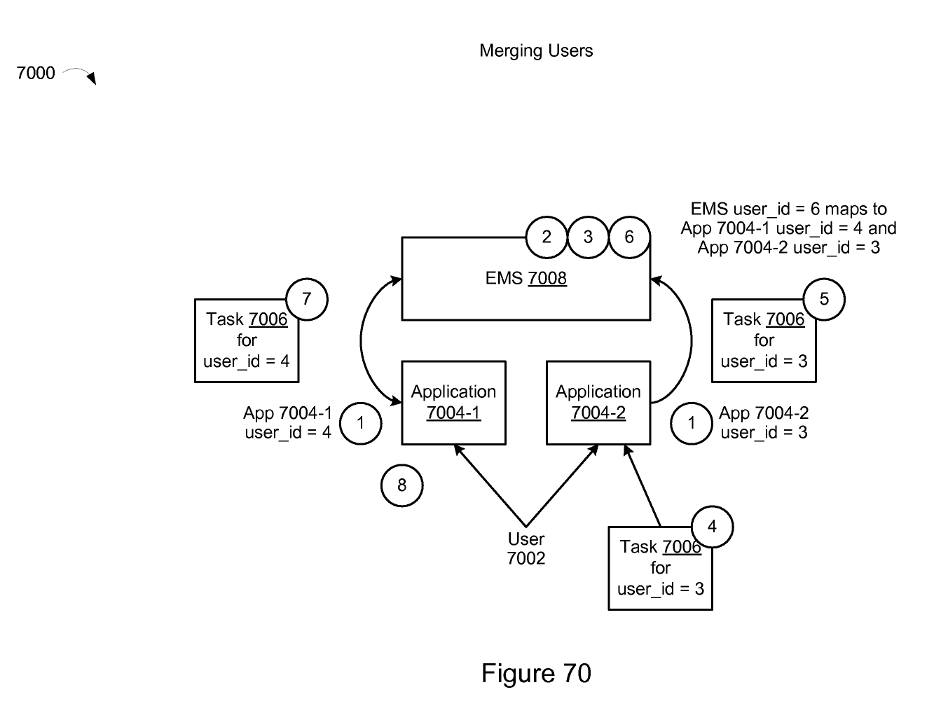

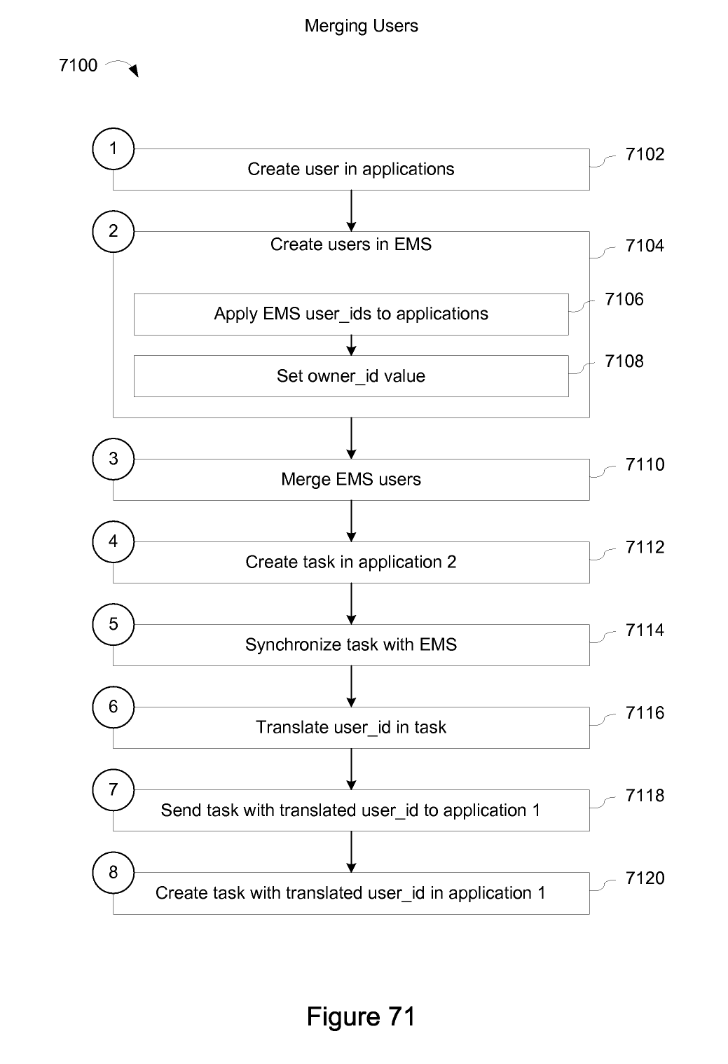

FIG. 70 is a block diagram illustrating an exemplary process 7000 for merging users between applications, according to some embodiments. FIG. 71 is a flow diagram of an exemplary process 7100 for merging users between applications, according to some embodiments. It is desirable to merge users between applications because a single user may have different user identifiers (e.g., user_ids) in different applications. For example, the same user may have a user identifier of 2 in a first application and a user identifier of 6 for a second application. It is therefore desirable to merge these two users into a single user so that the synchronization of user data can be facilitated. The process 7100 corresponds to the process 7000 and are discussed together. Note that the circled numbers in FIG. 70 correspond to the circled numbers in FIG. 71. The process 7100 may be governed by instructions that are stored in a computer readable storage medium and that are executed by one or more processors of one or more servers. Each of the operations shown in FIG. 71 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

FIG. 70 includes applications 7004-1 and 7004-2 and EMS 7008, which can be included in an application framework (e.g., the application framework 6300) on a computer system (not shown). A user is created in the applications 7004-1 and 7004-2 for a user 7002 (7102). For example, the user can have a user_id of 4 in the application 7004-1 and a user_id of 3 in the application 7004-2. A user is also created in the EMS 7008 (7104). For example, the user can have a user_id of 6 in the EMS 7008. In some embodiments, the EMS user_ids are applied to the applications 7004-1 and 7004-1 (7106) and the owner_id values are set (7108). Note that applying users to applications identifies the user's relationship and access to the application. The user's relationship is the “owner_id,” which is the user's unique identifier for the application. Also note that a user cannot access an application using AOP unless the user is applied to that application and the user is allowed to use AOP (e.g., the AOP flag set for the user). Furthermore, applications may use this record to authenticate a user for an application. Thus, the application can query the EMS to determine whether the user has permission to use the application.

Returning to FIGS. 70 and 71, the user_ids are merged in the EMS (7110). Thus, user_id=4 for the application 7004-1 and user_id=3 for the application 7004-2 correspond to the same user_id=6 in the EMS 7008.

At a later time, the user 7002 creates a task 7006 associated with the user_id=3 in the application 7004-2 (7112). Note that although the task 7006 is described in this example, other objects can be created (e.g., calendar items, contacts, documents, etc.). Next, the task 7006 is synchronized with the EMS 7008 (7114). In doing so, the EMS 7008 determines the EMS user_id corresponding to the user_id=3 for the application 7004-2 (e.g., user_id=6). The EMS 7008 then translates the user id in the task 7006 from user_id=3 for the application 7004-2 to user_id=4 for the application 7004-1 (7116). The EMS 7008 then sends the task 7006 with the translated user_id to the application 7004-1 (7118). The application 7004-1 receives the task 7006 with the translated user_id and creates a task in the database for the application 7004-1 corresponding to the task 7006 generated by the application 7004-2 (7120).

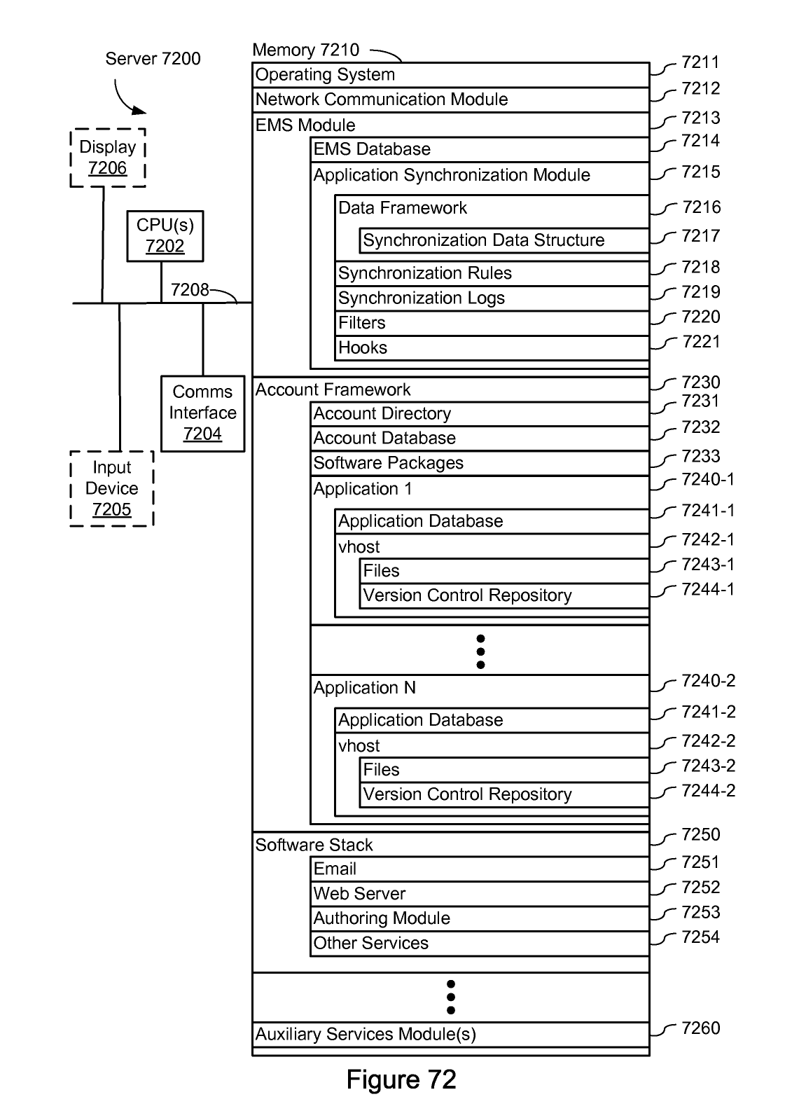

FIG. 72 presents a block diagram of an exemplary server 7200, according to some embodiments. The server 7200 generally includes one or more processing units (CPU's) 7202, one or more network or other communications interfaces 7204, memory 7210, and one or more communication buses 7208 for interconnecting these components. The communication buses 7208 may include circuitry (sometimes called a chipset) that interconnects and controls communications between system components. The server 7200 may optionally include a display 7206 and one or more input devices 7205 (e.g., keyboard, mouse, trackpoint, etc.). The memory 7210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 7210 may optionally include one or more storage devices remotely located from the CPU(s) 7202. The memory 7210, or alternately the non-volatile memory device(s) within the memory 7210, comprises a computer readable storage medium. In some embodiments, the memory 7210 stores the following programs, modules and data structures, or a subset thereof: operating system 7211, network communication module 7212, an EMS module 7213, an account framework 7230, a software stack 7250, and/or auxiliary modules 7260.

The operating system 7211 includes procedures for handling various basic system services and for performing hardware dependent tasks. Network communication module 7212 can be used for connecting the server 7200 to other computers via the one or more communication network interfaces 7204 (wired or wireless) and one or more communication networks, such as the Internet, other wide area networks, local area networks, metropolitan area networks, and so on.

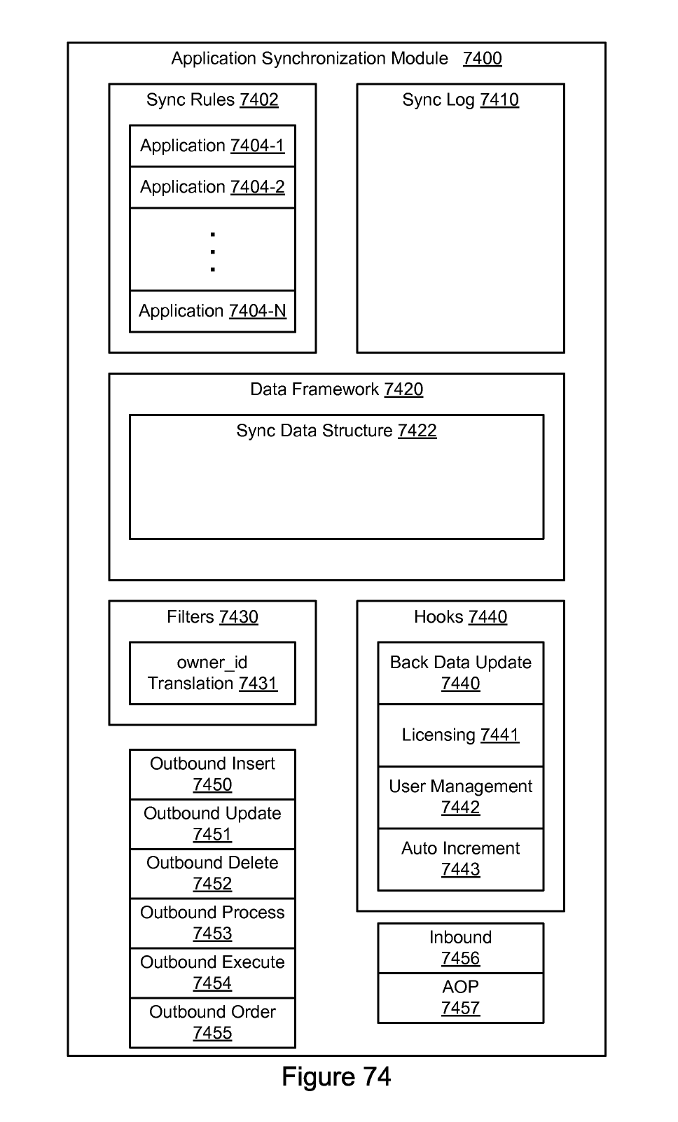

In some embodiments, the EMS module 7213 includes one or more of: an EMS database 7214 and/or an application synchronization module 7215. The application synchronization module can include one or more of: a data framework 7216, synchronization rules 7218, synchronization logs 7219, filters 7220, and hooks 7221. Note that these components and/or modules are described in more detail with reference to FIGS. 63-71, and 74-79. In some embodiments the data framework 7216 includes a synchronization data structure 7217 that can be used to synchronize data between applications. The synchronization data structure 7217 is described in more detail with reference to FIGS. 74-79.

In some embodiments, the account framework 7230 includes one or more of: an account directory 7231, an account database 7232, software packages 7233, and/or one or more applications 7240. The applications 7240 can include one or more of: an application database 7241, files 7243, and version control repository 7244. The files 7243 and the version control repository 7244 can be associated with a vhost 7242. In some embodiments, the software packages 7233 can include utilities (e.g., phpmyadmin, phppgadmin, websvn, EDK, etc.), tools, and/or shared libraries (e.g., Zend, PHPunit, famfamfam, the Etelos Application Server Framework, etc.) used by applications within an account. These components and/or modules are described in more detail with reference to FIGS. 63-71, and 74-79.

In some embodiments, the software stack 7250 includes one or more of: an email module 7251, a web server module 7252, an authoring module 7253, and/or other services 7254. Email module 7251 can include any electronic mail program. For example, the email module 7251 can include email servers (e.g., Sendmail, Postfix, and qmail, etc.), mail filtering programs (e.g., procmail, SpamAssassin, etc.), client email programs (e.g., elm, pine, Microsoft Outlook, etc.), etc. The web server module 7252 can include any application that can respond to client requests for pages, data, graphics, videos, documents, etc, hosted on a server coupled to clients and/or other servers via a network. For example, the web server module 7252 can include Apache HTTP Server, Microsoft Internet Information Server, etc. The authoring module 7253 can include any application that allows a developer or a user to generate web-based applications. For example, the authoring module 7253 can include a text editor, a word processor, a web development environment (e.g., Microsoft Expression Web, Adobe Dreamweaver, etc.), etc. The other services 7254 can include other applications such as a Lightweight Data Access Protocol (LDAP) interface module and/or database, an Internet Message Access Protocol (IMAP) module, a Post Office Protocol (POP) module, a Dovecot module (e.g., an IMAP and POP server), a web server (e.g., Apache HTTP server, Microsoft IIS Server, etc.), one or more database management systems (e.g., MySQL, PostgreSQL, etc.), logging applications (e.g., Syslog-ng, etc.), authentication services (e.g., saslauthd, etc.). Note that although FIG. 72 illustrates a single module for each type of service, the software stack 7250 can include any number of modules for a given type of service. For example, two different email modules can be included within software stack 7250.

In some embodiments, the auxiliary services module 7260 includes one or more of: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and FreeType (font utilities library).

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 7210 may store a subset of the modules and data structures identified above. Furthermore, the memory 7210 may store additional modules and data structures not described above.

Although FIG. 72 shows a “server,” FIG. 72 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 72 could be implemented on single servers and single items could be implemented by one or more servers. The actual number of servers used to implement an application server and how features are allocated among them will vary from one implementation to another, and may depend in part on the amount of data traffic that the system must handle during peak usage periods as well as during average usage periods.

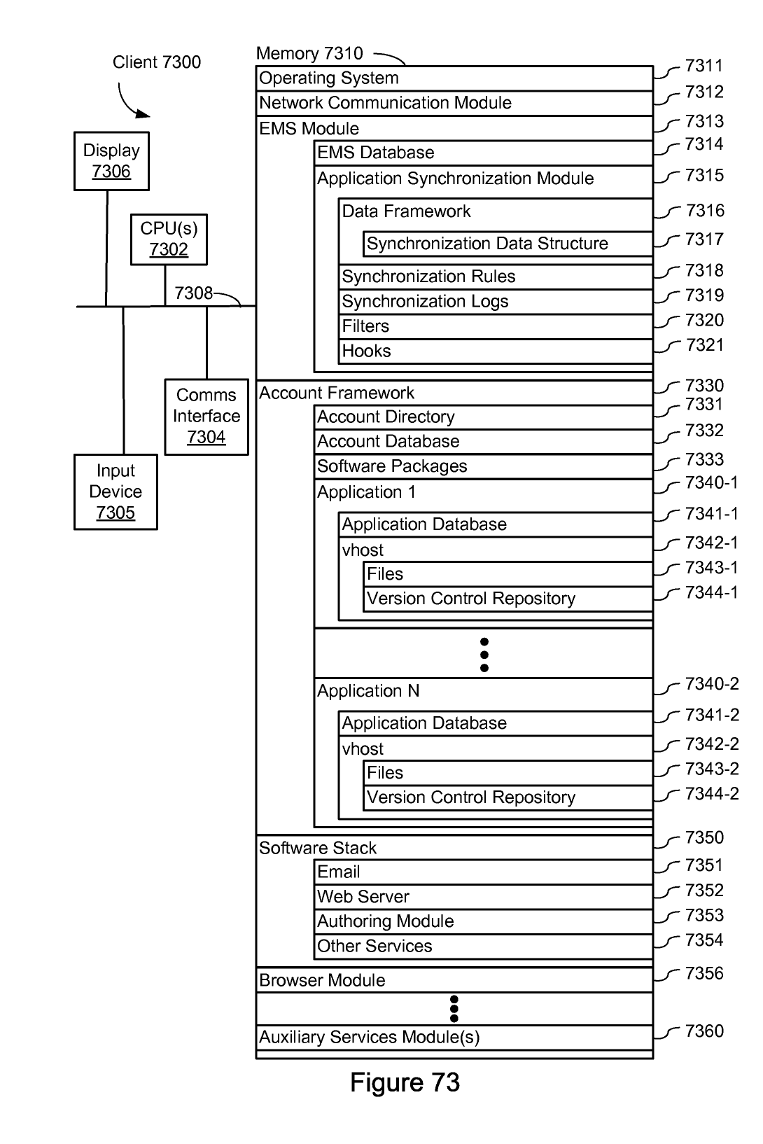

FIG. 73 presents a block diagram of an exemplary client computer system 7300, according to some embodiments. The client computer system 7300 generally includes one or more processing units (CPU's) 7302, one or more network or other communications interfaces 7304, memory 7310, and one or more communication buses 7308 for interconnecting these components. The communication buses 7308 may include circuitry (sometimes called a chipset) that interconnects and controls communications between system components. The client computer system 7300 includes a display 7306 and one or more input devices 7305 (e.g., keyboard, mouse, trackpoint, etc.). The memory 7310 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 7310 may optionally include one or more storage devices remotely located from the CPU(s) 7302. The memory 7310, or alternately the non-volatile memory device(s) within the memory 7310, comprises a computer readable storage medium. In some embodiments, the memory 7310 stores the following programs, modules and data structures, or a subset thereof: operating system 7311, network communication module 7312, an EMS module 7313, an account framework 7330, a software stack 7350, a browser module 7356, and/or auxiliary modules 7360.

The operating system 7311 includes procedures for handling various basic system services and for performing hardware dependent tasks. Network communication module 7312 can be used for connecting the server 7300 to other computers via the one or more communication network interfaces 7304 (wired or wireless) and one or more communication networks, such as the Internet, other wide area networks, local area networks, metropolitan area networks, and so on.

In some embodiments, the EMS module 7313 includes one or more of: an EMS database 7314 and/or an application synchronization module 7315. The application synchronization module can include one or more of: a data framework 7316, synchronization rules 7318, synchronization logs 7319, filters 7320, and hooks 7321. Note that these components and/or modules are described in more detail with reference to FIGS. 63-71 and 74-79. In some embodiments the data framework 7316 includes a synchronization data structure 7317 that can be used to synchronize data between applications. The synchronization data structure 7317 is described in more detail with reference to FIGS. 74-79.

In some embodiments, the account framework 7330 includes one or more of: an account directory 7331, an account database 7332, software packages 7333, and/or one or more applications 7340. The applications 7340 can include one or more of: an application database 7341, files 7343, and version control repository 7344. The files 7343 and the version control repository 7344 can be associated with a vhost 7342. In some embodiments, the software packages 7233 can include utilities (e.g., phpmyadmin, phppgadmin, websvn, EDK, etc.), tools, and/or shared libraries (e.g., Zend, PHPunit, famfamfam, the Etelos Application Server Framework, etc.) used by applications within an account. These components and/or modules are described in more detail with reference to FIGS. 63-71, and 74-79.

In some embodiments, the software stack 7350 includes one or more of: an email module 7351, a web server module 7352, an authoring module 7353, and/or other services 7354. Email module 7351 can include any electronic mail program. For example, the email module 7351 can include email servers (e.g., Sendmail, Postfix, and qmail, etc.), mail filtering programs (e.g., procmail, SpamAssassin, etc.), client email programs (e.g., elm, pine, Microsoft Outlook, etc.), etc. The web server module 7352 can include any application that can respond to client requests for pages, data, graphics, videos, documents, etc, hosted on a server coupled to clients and/or other servers via a network. For example, the web server module 7352 can include Apache HTTP Server, Microsoft Internet Information Server, etc. The authoring module 7353 can include any application that allows a developer or a user to generate web-based applications. For example, the authoring module 7353 can include a text editor, a word processor, a web development environment (e.g., Microsoft Expression Web, Adobe Dreamweaver, etc.), etc. The other services 7354 can include other applications such as a Lightweight Data Access Protocol (LDAP) interface module and/or database, an Internet Message Access Protocol (IMAP) module, a Post Office Protocol (POP) module, a Dovecot module (e.g., an IMAP and POP server), a web server (e.g., Apache HTTP server, Microsoft IIS Server, etc.), one or more database management systems (e.g., MySQL, PostgreSQL, etc.), logging applications (e.g., Syslog-ng, etc.), authentication services (e.g., saslauthd, etc.). Note that although FIG. 73 illustrates a single module for each type of service, the software stack 7350 can include any number of modules for a given type of service. For example, two different email modules can be included within software stack 7350.

In some embodiments, the auxiliary services module 7360 includes one or more of: famfamfam (icon images), phpMyAdmin (php web-based MySQL database management interface), phpPGAdmin (php web-based PostgSQL database management interface), WebSVN (php web-based Subversion interface), ImageMagick (image manipulation library), ZendFramework (php utility framework), IconCube Loaders (encrypted-php decryption library), libpng (PNG manipulation library), libjpeg (JPEG manipulation library), Neon (WebDAV client library), mcrypt (encryption library), and FreeType (font utilities library).

In some embodiments, the browser module 7356 can include any application with a rendering engine that can access data and/or services on a local and/or a remote computer system and render the results so that a user can view the data and/or interact with the services. In some embodiments, browser module 7356 is a web browser.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 7310 may store a subset of the modules and data structures identified above. Furthermore, the memory 7310 may store additional modules and data structures not described above.

FIG. 74 presents a block diagram illustrating an exemplary application synchronization module 7400, according to some embodiments. The application synchronization module 7400 can be the application synchronization module 6304 in FIG. 63. In some embodiments, the cross-application synchronization module 7400 includes one or more of: synchronization rules 7402, sync log 7410, data framework 7420, filters 7430, hooks 7440, an outbound insert module 7450, an outbound update module 7451, an outbound delete module 7452, an outbound process module 7453, an outbound execute module 7454, an outbound order 7455, an inbound module 7456, and/or an AOP module 7457. These components and/or modules are described in more detail with reference to FIGS. 1-42 and 63-79.

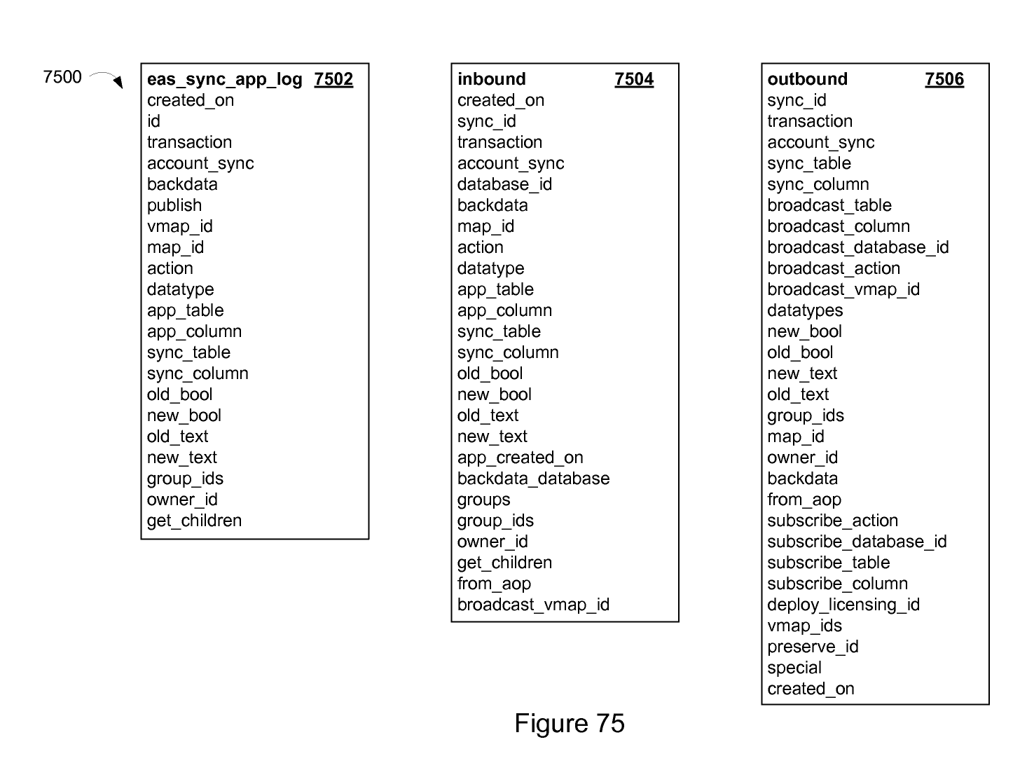

In some embodiments, the synchronization rules 7402 include synchronization rules for one or more applications 7404. In some embodiments, the data framework 7420 includes a synchronization data structure 7422. The synchronization data structure 7422 is described in more detail with reference to FIG. 75. In some embodiments, the filters 7430 include an owner_id translation module 7431 (e.g., as described in FIG. 67). In some embodiments, the hooks 7440 include one or more of: a hook to a back data update module 7440, a hook to a licensing module 7441, a hook to a user management module 7442, and a hook to an auto increment module 7443 (e.g., as described in FIG. 67).

FIG. 75 presents exemplary synchronization data structures 7500, according to some embodiments. The synchronization data structures 7500 include one or more of: an eas_sync_app_log data structure 7502, an inbound data structure 7504, and an outbound data structure 7506. The eas_sync_app_log 7502 is used to store the changes made by the application. These changes can be tracked using database triggers on the tables and/or columns to be synchronized. The inbound data structure 7504 includes data that is to be processed by the application. This inbound data can be first placed in a temporary table prior to being processed. The outbound data structure 7506 includes data that is to be preprossed and grouped together for outbound processing. This processed data can them be placed in an outgoing_sync_log and/or an account_sync_log. If the data is in an account_sync_log, the data is to be outbound processed and sent to the application databases. If the data is in the outgoing sync_log, the data is to be sent to the user_out and/or the sync_out (for AOP) table to wait for an AOP sync. The data can be placed into the user_in or sync_in (for AOP) and processed as if it was in the account_sync_log.

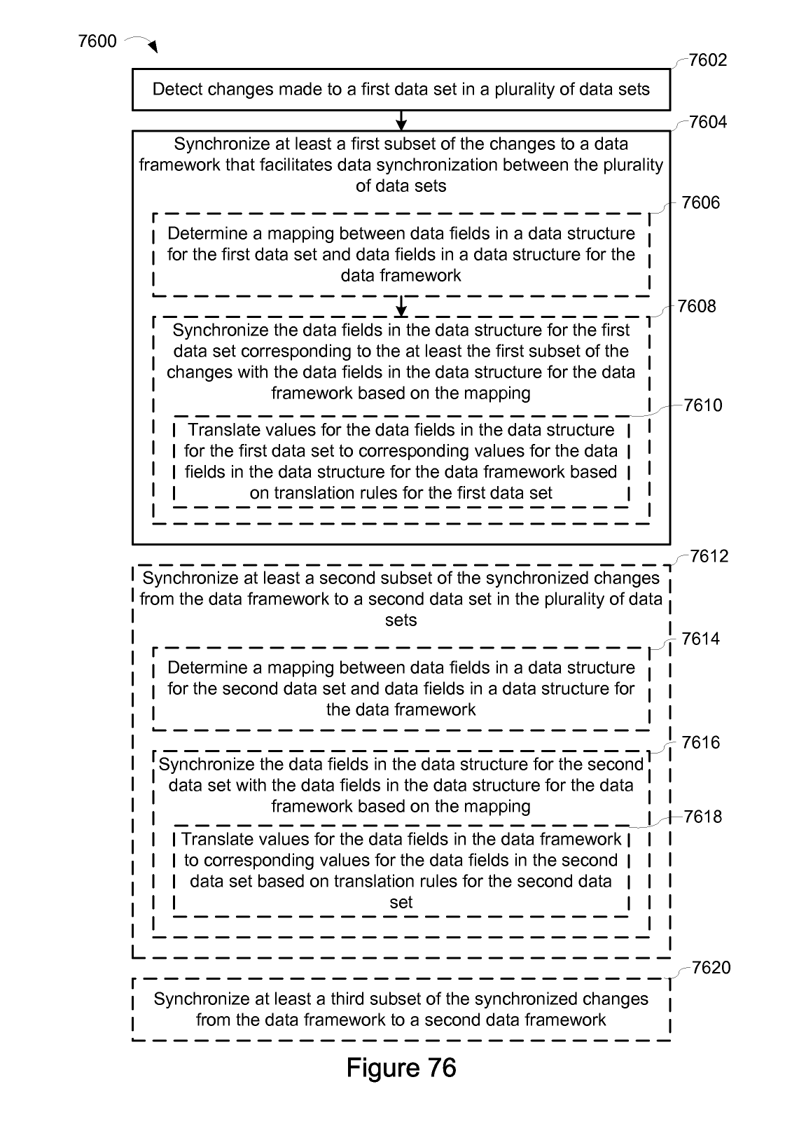

FIG. 76 is a flow diagram of an exemplary process 7600 for synchronizing applications, according to some embodiments. The process 7600 may be governed by instructions that are stored in a computer readable storage medium and that are executed by one or more processors of one or more servers. Each of the operations shown in FIG. 76 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

As FIG. 76 illustrates, changes made to a first data set in a plurality of data sets is detected (7602). At least a first subset of the changes are synchronized to a data framework (e.g., the data framework 7420) that facilitates data synchronization between the plurality of data sets (7204). In some embodiments, a data set and a data framework includes one or more of: one or more databases, one or more structured files, and one or more documents. The structured file can include one of: an extensible markup language (XML) file, a hypertext markup language (HTML) file, and a file including values separated by a delimiter. The delimiter can include one of: a comma, and a tab break. A document can include one of: a web document, a word processor document, a spreadsheet document, a presentation document, and an electronic mail message. In some embodiments, a change to a data set includes one or more of: an update of data in the data set, an addition of data to the data set, and/or a deletion of data from the data set.

In some embodiments, synchronizing the at least the first subset of the changes to the data framework includes determining a mapping between data fields in a data structure for the first data set and data fields in a data structure for the data framework (7606) and synchronizing the data fields in the data structure for the first data set corresponding to the at least the first subset of the changes with the data fields in the data structure for the data framework based on the mapping (7608). In some embodiments, synchronizing the data fields includes translating values for the data fields in the data structure for the first data set to corresponding values for the data fields in the data structure for the data framework based on translation rules for the first data set (7610). In some embodiments, the translation rules and/or the mapping are included in the synchronization rules (e.g., the synchronization rules 6520, 6540 and 7218 in FIGS. 65 and 72, respectively).

In some embodiments, at least a second subset of the synchronized changes are synchronized from the data framework to a second data set in the plurality of data sets (7612). In some embodiments, synchronizing the at least the second subset of the synchronized changes from the data framework to a second data set in the plurality of data sets includes: determining a mapping between data fields in a data structure for the second data set and data fields in a data structure for the data framework (7614) and synchronizing the data fields in the data structure for the second data set with the data fields in the data structure for the data framework based on the mapping (7616). In some embodiments, synchronizing the data fields includes translating values for the data fields in the data framework to corresponding values for the data fields in the second data set based on translation rules for the second data (7618). In some embodiments, the translation rules and/or the mapping are included in the synchronization rules (e.g., the synchronization rules 6520, 6540 and 7218 in FIGS. 65 and 72, respectively).

In some embodiments, at least a third subset of the synchronized changes are synchronized from the data framework to a second data framework (7620).

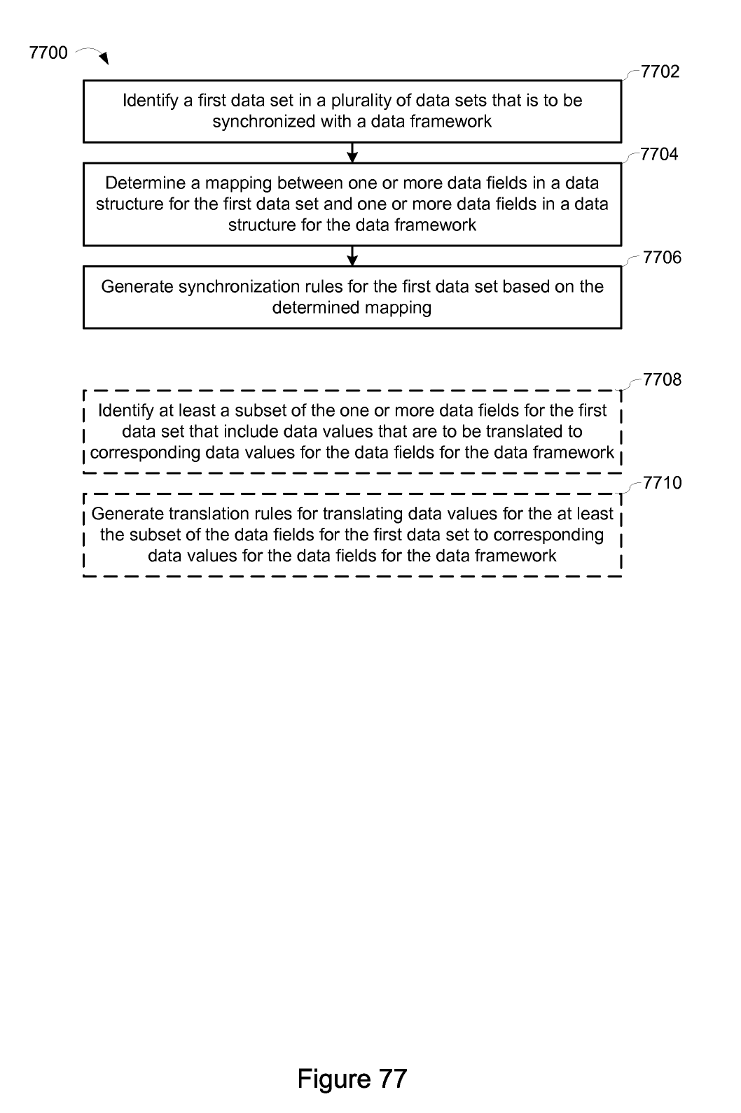

FIG. 77 is a flow diagram of an exemplary process 7700 for generating synchronization rules that are used to synchronize applications, according to some embodiments. The process 7700 may be governed by instructions that are stored in a computer readable storage medium and that are executed by one or more processors of one or more servers. Each of the operations shown in FIG. 77 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

As illustrated in FIG. 77, a first data set in a plurality of data sets that is to be synchronized with a data framework is identified (7702). A mapping between one or more data fields in a data structure for the first data set and one or more data fields in a data structure for the data framework is determined (7704). Synchronization rules for the first data set based on the determined mapping are generated (7706).

In some embodiments, at least a subset of the one or more data fields for the first data set that include data values that are to be translated to corresponding data values for the data fields for the data framework are identified (7708). Translation rules for translating data values for the at least the subset of the data fields for the first data set to corresponding data values for the data fields for the data framework are generated (7710). In some embodiments, the translation rules are included in the synchronization rules (e.g., the synchronization rules 6520, 6540 and 7218 in FIGS. 65 and 72, respectively).

In some embodiments, the first data set and the data framework include one or more of: one or more databases; one or more structured files; and one or more documents. In some embodiments, the first data set and the data framework include one or more databases. The mapping can include a mapping between columns of one or more database tables for the first data set and columns of one or more database tables for the data framework.

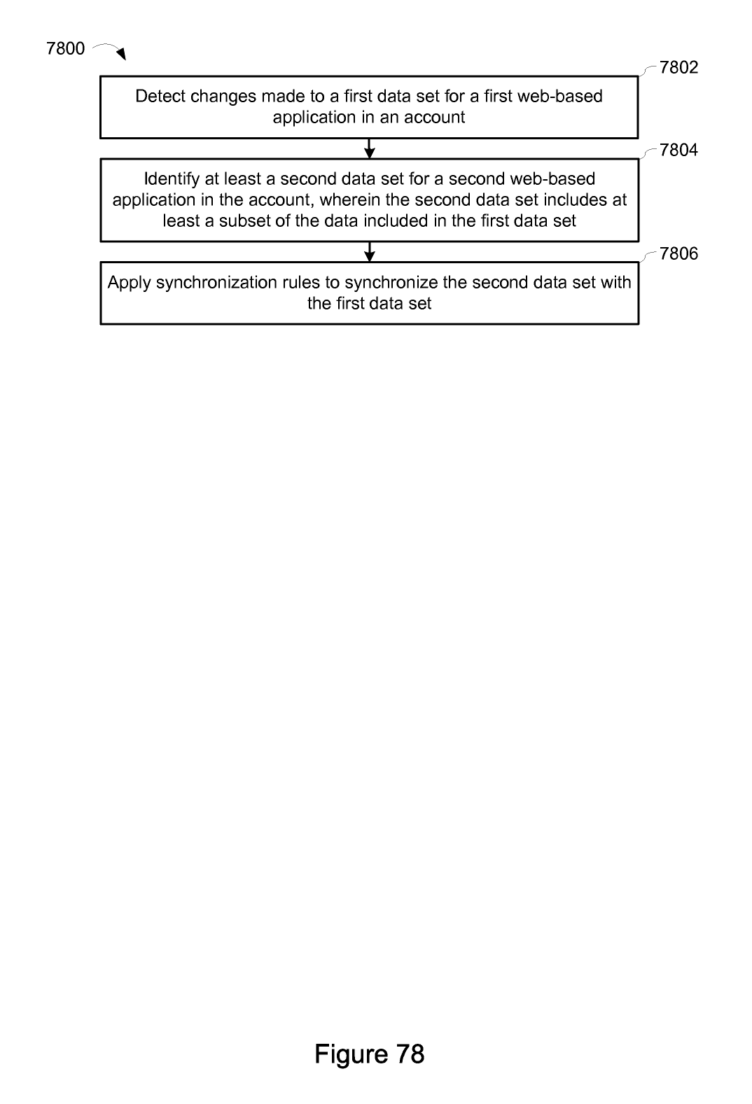

FIG. 78 is a flow diagram of an exemplary process 7800 for synchronizing applications, according to some embodiments. The process 7800 may be governed by instructions that are stored in a computer readable storage medium and that are executed by one or more processors of one or more servers. Each of the operations shown in FIG. 78 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction for mat that is interpreted by one or more processors.

As illustrated in FIG. 78, changes made to a first data set for a first web-based application in an account are detected (7802). At least a second data set for a second web-based application in the account is identified (7804), wherein the second data set includes at least a subset of the data included in the first data set. Synchronization rules to synchronize the second data set with the first data set are applied (7806).

In some embodiments, the synchronization rules include: one or more rules to synchronize at least a subset of data fields in a data structure for the first data set with data fields in a data structure for a data framework, and/or one or more rules to synchronize at least a subset of the data fields in the data structure for the data framework with data fields in a data structure for the second data set.

In some embodiments, the account includes a plurality of data sets and corresponding web-based applications.

In some embodiments, the synchronization rules include one or more of: a mapping between fields in the first data set and fields in the second data set and/or rules for resolving data conflicts between the first data set and the second data set.

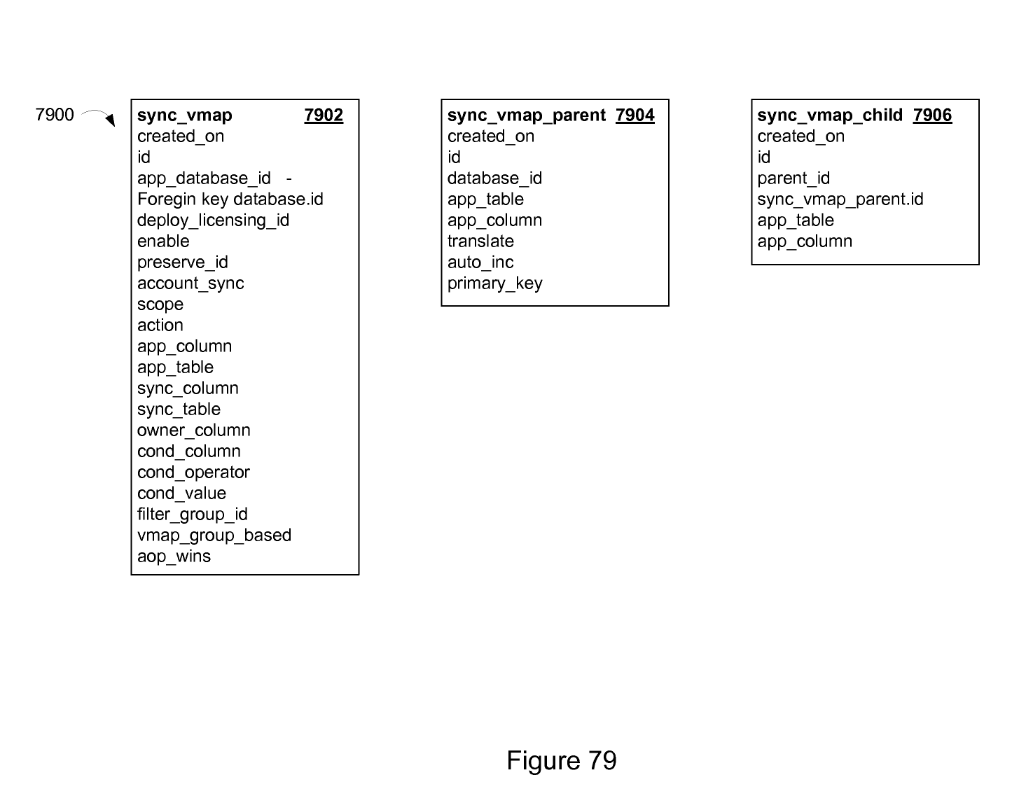

FIG. 79 presents exemplary synchronization rules data structures 7900, according to some embodiments. The synchronization rules data structures include a sync_vmap data structure 7902, a sync_vmap_parent data structure 7904, and a sync_vmap_child data structure 7906.

Screenshots

In the following figures (descriptions of screenshots), all references to modules (e.g., marketplace module 6122, user account access module 6172, deployer module 6152, packager module 6136, and marketplace database management module 6180) relate to modules shown in the system of FIG. 61. These screen shots are exemplary screenshots of user interfaces that display information for, and enable user interaction with, the various applications and components of the application marketplace of the present invention.

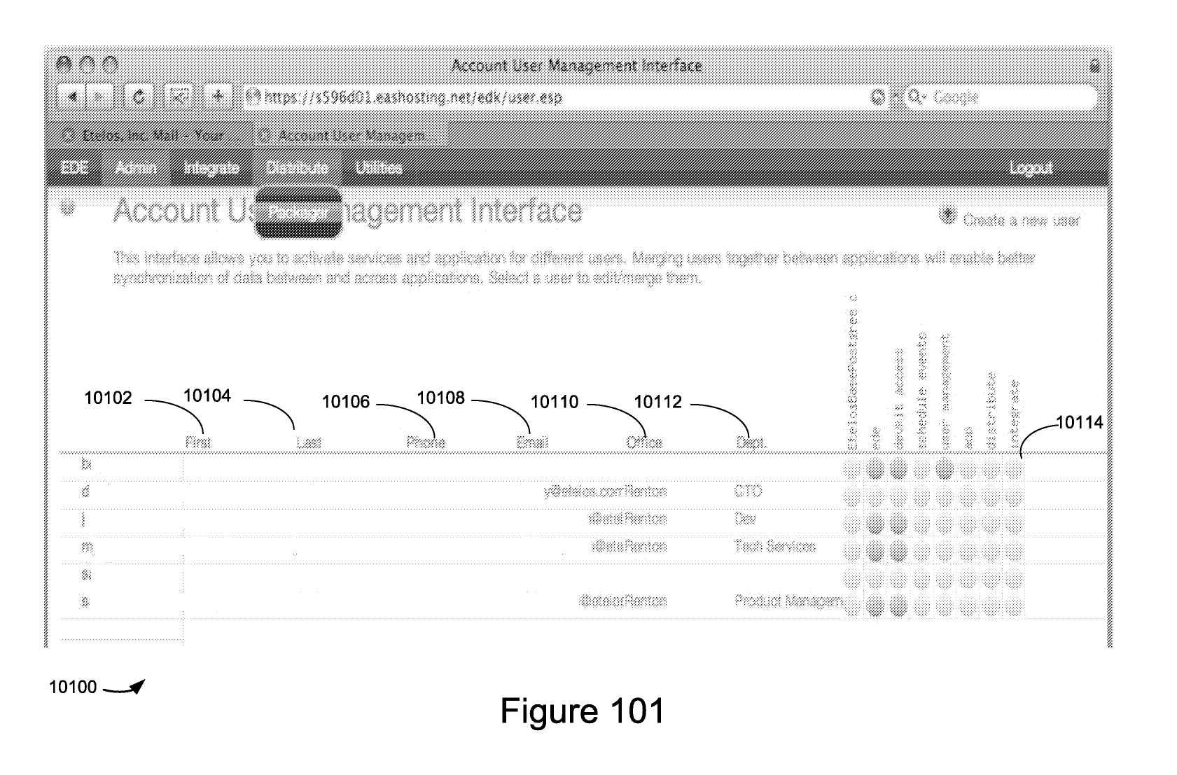

FIG. 101 is an exemplary screenshot 10100 of an Account User Management Interface, generated by User Account Access Module 6172. The information reflected here is stored in a user database accessed by User Account Database Management Module.

An Account User Management Interface allows a user to activate services and application for different users. Merging users together between applications enables better synchronization of data between and across applications. Field 10102 displays a user's first name; field 10104 displays a user's last name; field 10106 displays a user's phone number; field 10108 displays a user's email address; field 10110 displays a user's office; field 10112 displays a user's department; field 10114 is a matrix of user access information. These are exemplary fields; in other embodiments different fields may be created.

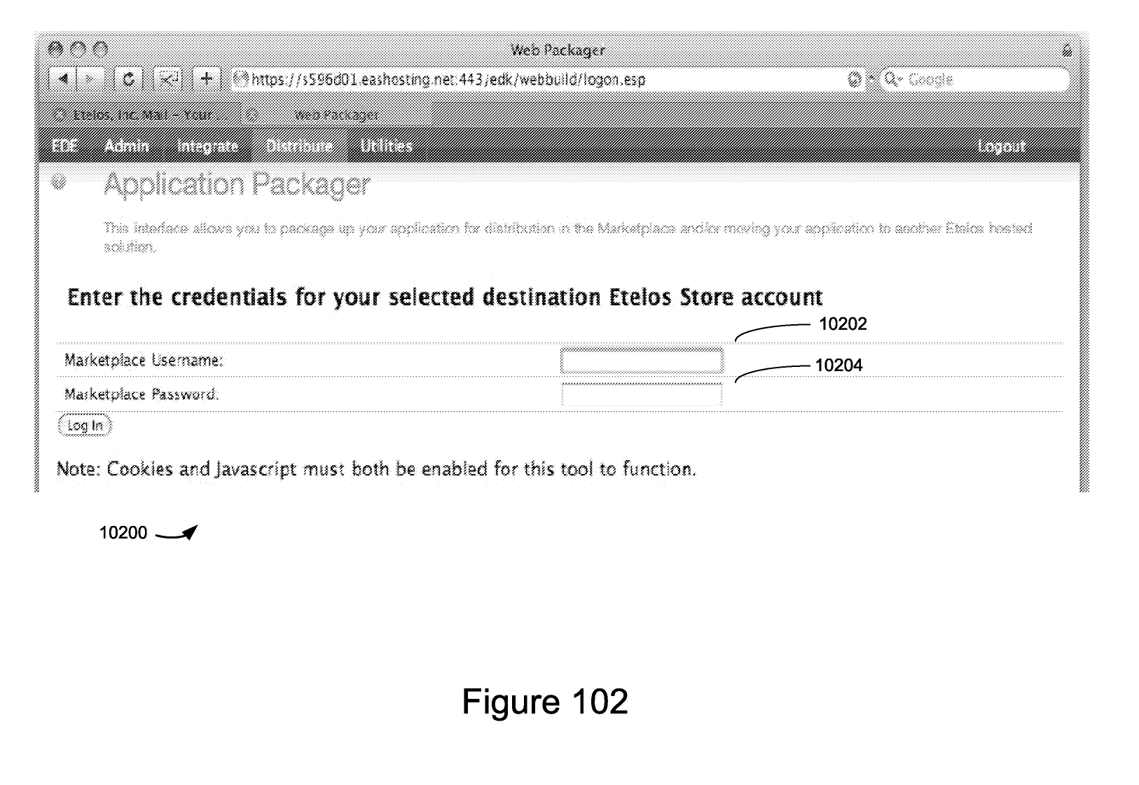

FIG. 102 is an exemplary screenshot 10200 of an application packager, generated by Packager Module 6136. The information reflected here is stored in a user database accessed by User Account Database Management Module 6188.

The Application Packager allows a user to package up the user's application for distribution in the Marketplace or move the application to another hosted solution (e.g. an Etelos hosted solution). Field 10202, and 10204 allow a user to input the user's Marketplace Username, and user's Marketplace password respectively.

FIG. 103 is an exemplary screenshot 10300 of an application packager, generated by Packager Module 6136. The information entered here is stored in a database accessed by Deployment Database Management Module 6184. Package a new full app (with the associated Begin button) 10302 allow a user to begin packaging a new application. Package an update to an app 10304, allows a user to package an update to an application.

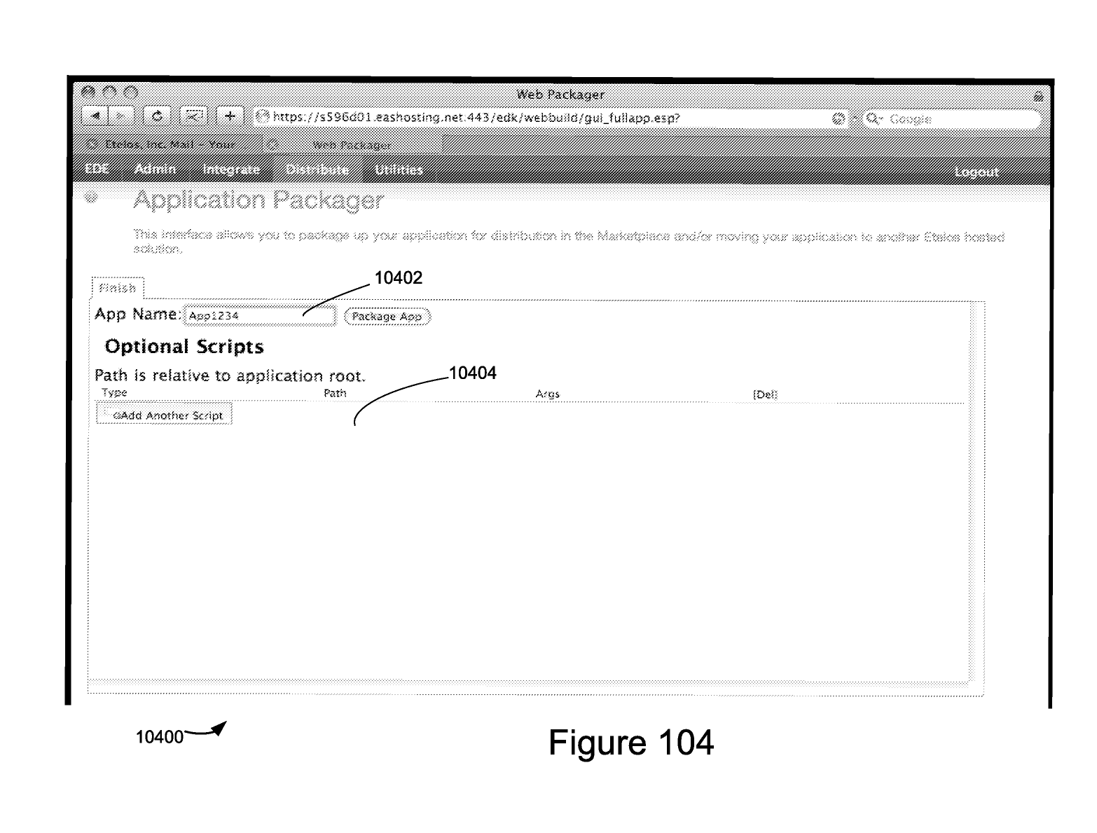

FIG. 104 is an exemplary screenshot 10400 of an application packager, generated by Packager Module. The information entered here is stored in a database accessed by Deployment Database Management Module 6184. Field 10402 allows a user to enter an application name which the user wishes to package. Field 10404 allows a user to specify a script associated with the package.

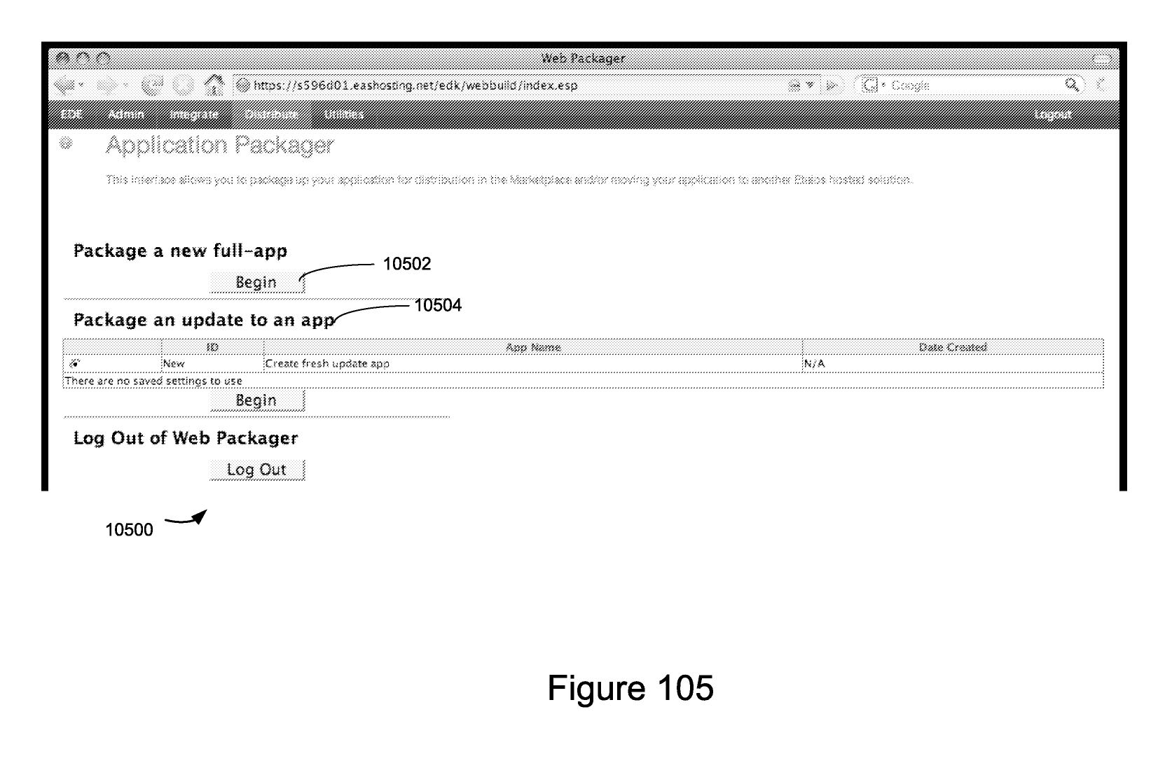

FIG. 105 is an exemplary screenshot 10500 of an application packager, generated by Packager Module 6136. The information entered here is stored in a database accessed by Deployment Database Management Module 6184. Package a new full app (with the associated Begin button) 10502 allow a user to begin packaging a new application. Package an update to an app, 10504, allows a user to package an update to an application.

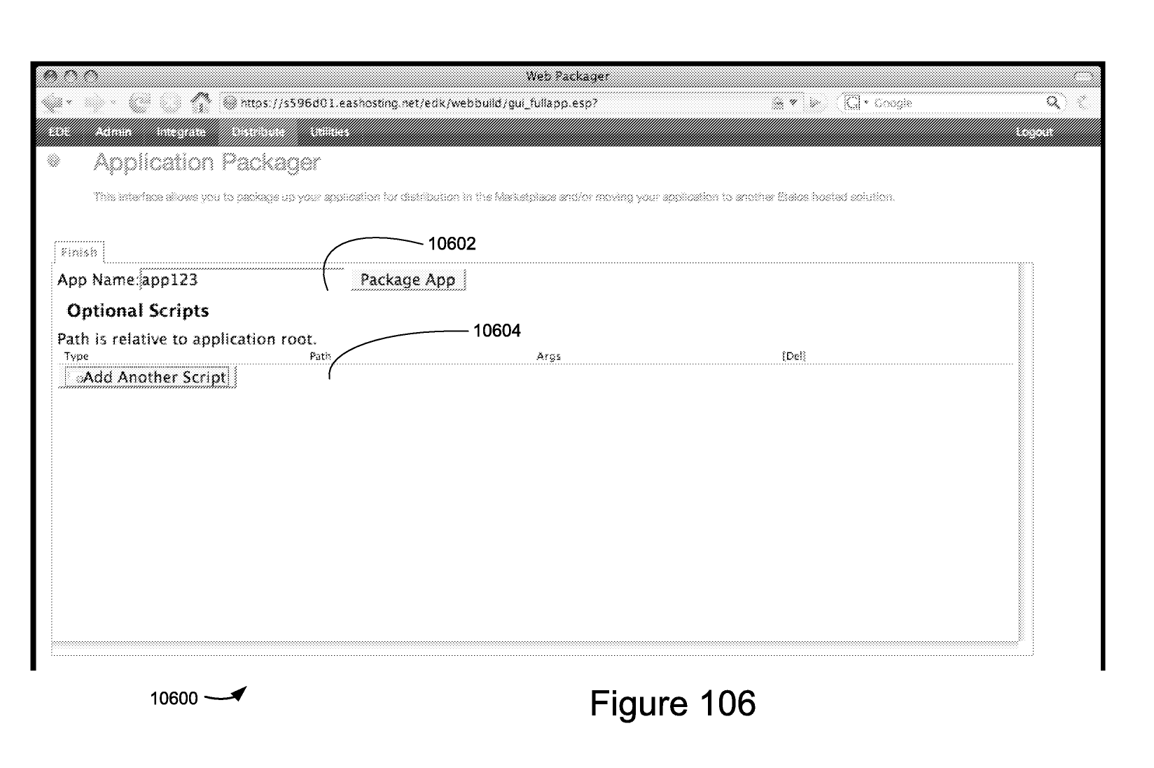

FIG. 106 is an exemplary screenshot 10600 of an application packager, generated by Packager Module 6136. The information entered here is stored in a database accessed by Deployment Database Management Module 6184. Field 10602 allows a user to enter an application name which the user wishes to package. Field 10604 allows a user to specify other data.

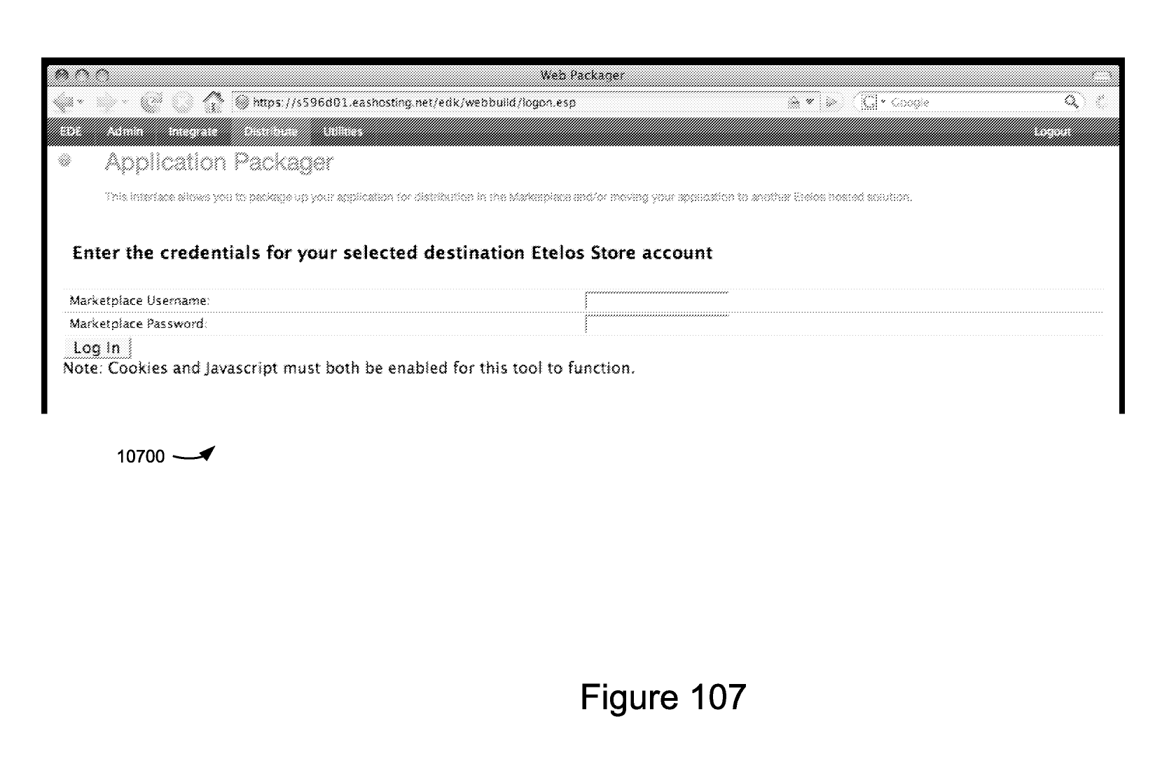

FIG. 107 is an exemplary screenshot 10700 of an application packager, generated by Packager Module 6136. The information entered here is used by Permissions Module 6128 to verify the user's credentials for a selected destination store (e.g. an Etelos store).

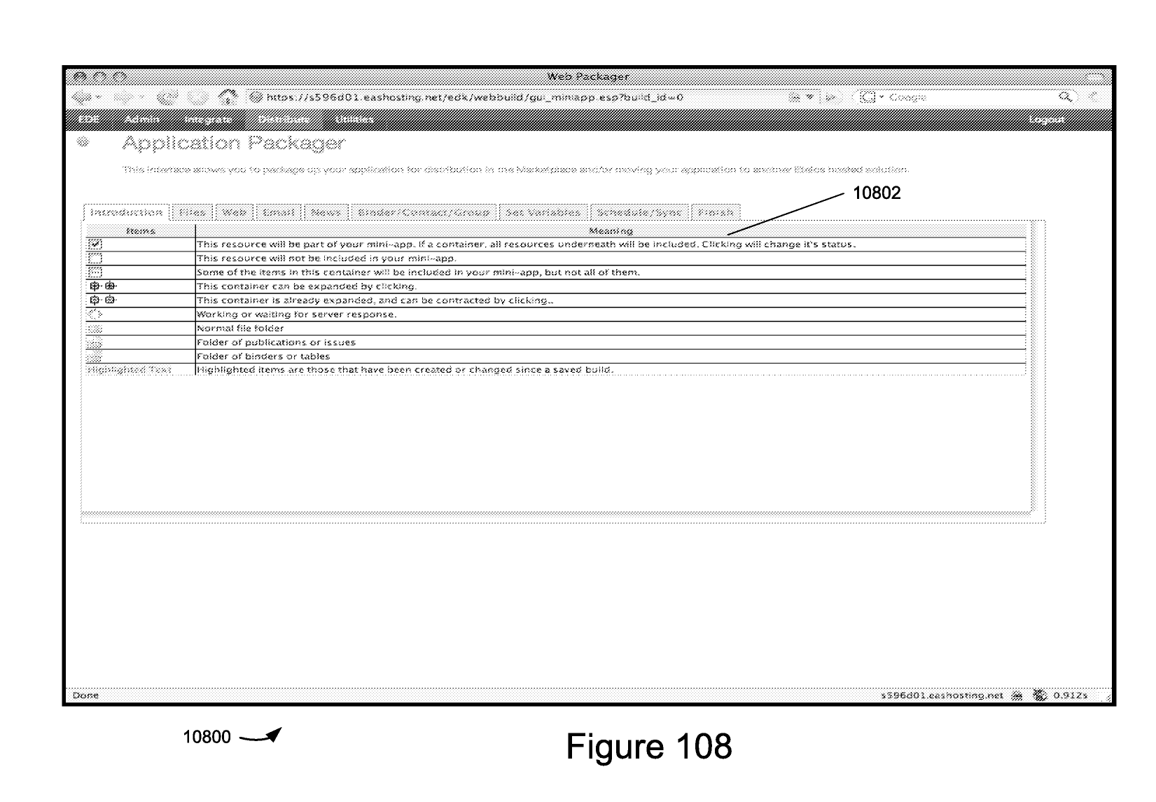

FIG. 108 is an exemplary screenshot 10800 of an application packager, generated by Packager Module 6136. Field 10802 displays a set of icons associated with packaging of a software application for distribution.

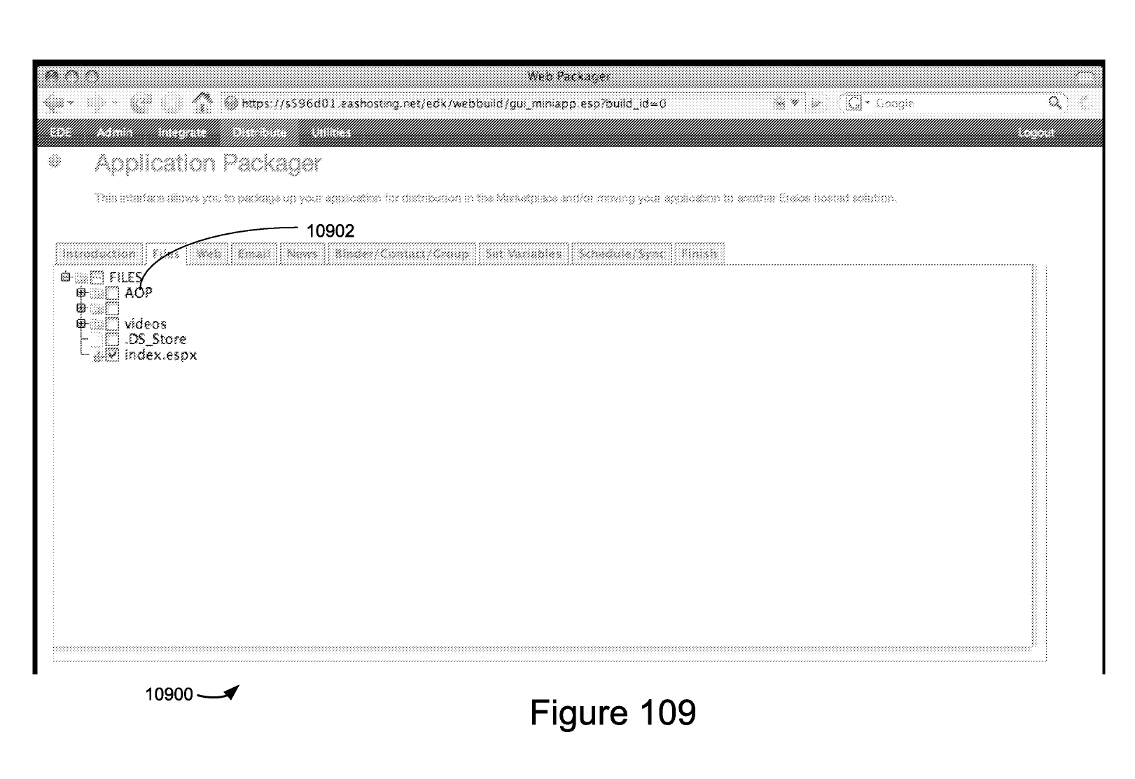

FIG. 109 is an exemplary screenshot 10900 of an application packager, generated by Packager Module 6136. Field 10902 shows a file structure for a packaged application.

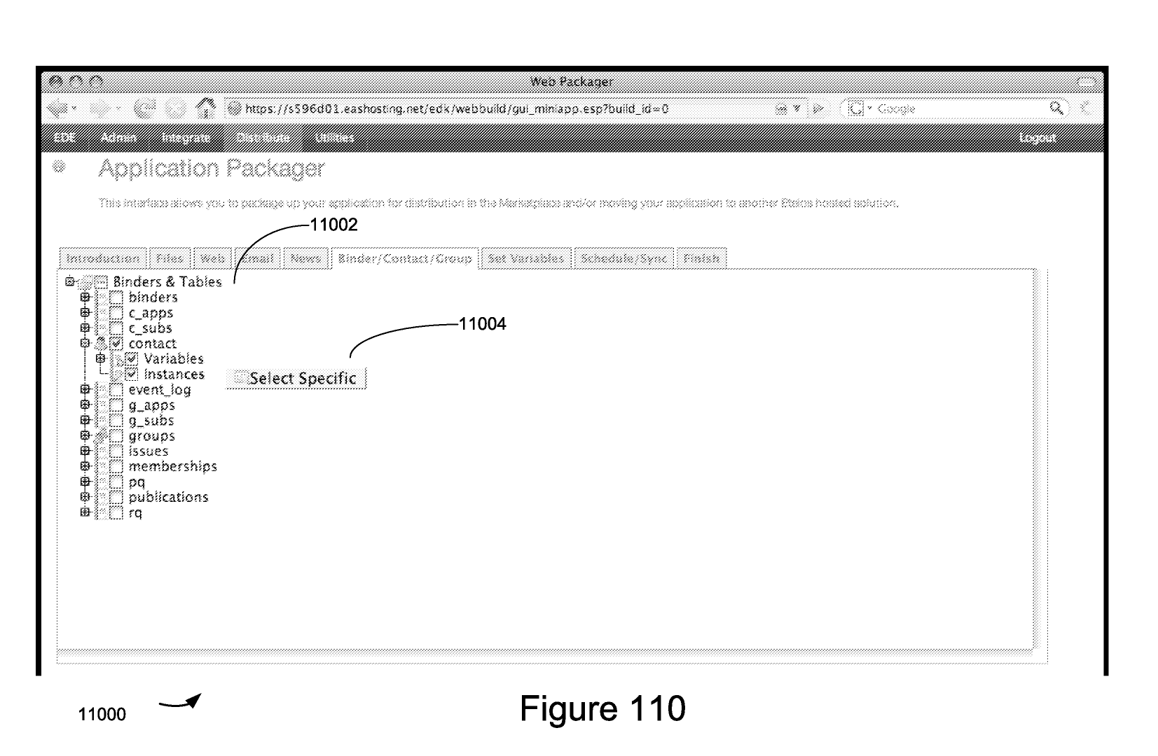

FIG. 110 is an exemplary screenshot 11000 of an application packager, generated by Packager Module 6136. Field 11002 allows a user to view Binders and Tables associated with a packaged application. Field 11004 allows a user to select a specific binder and/or table.

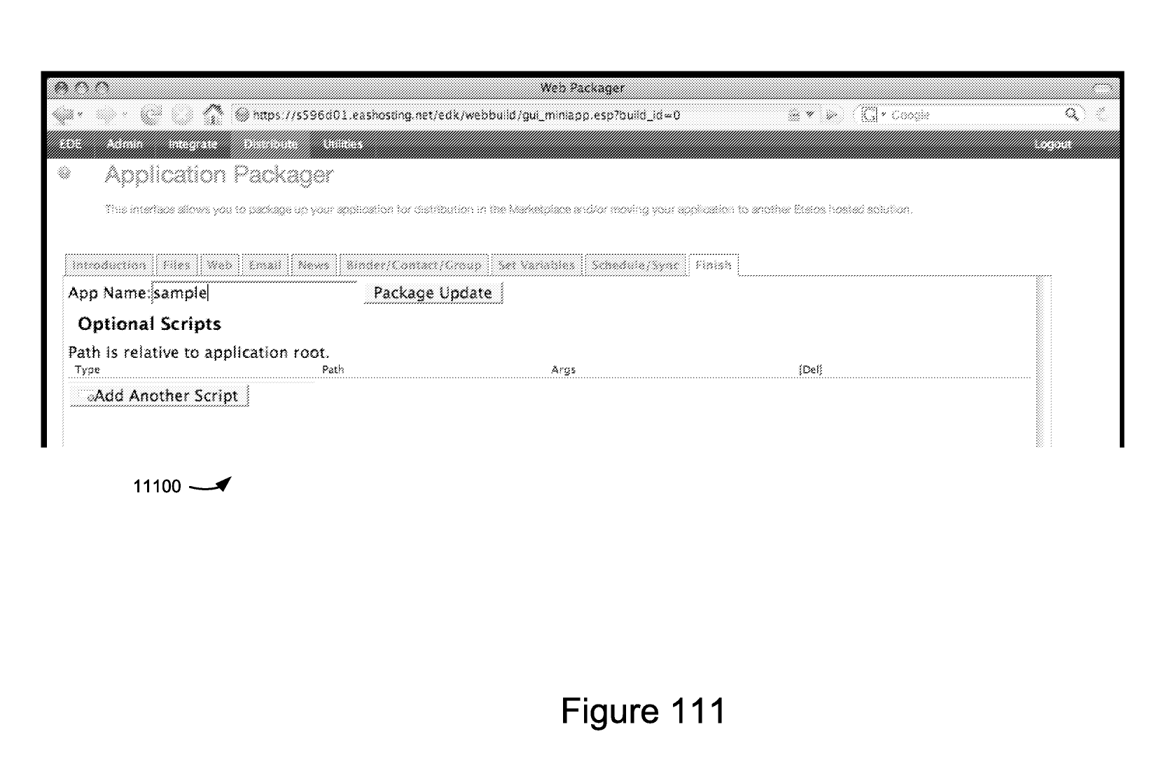

FIG. 111 is an exemplary screenshot 11100 of an application packager, generated by Packager Module 6136 for specifying a script associated with a packaged application.

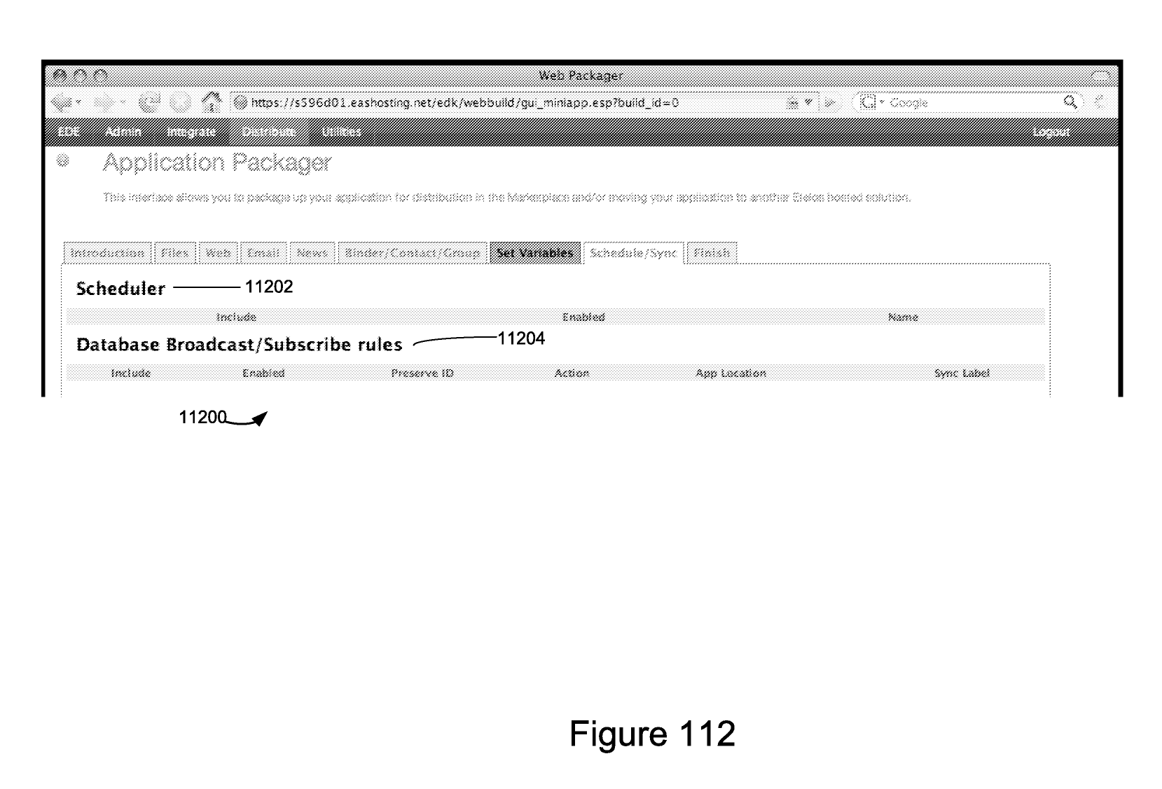

FIG. 112 is an exemplary screenshot 11200 of an application packager, generated by Packager Module 6136. Scheduler, 11202, allows a user to schedule software applications for packaging updates. Database Broadcast/Subscribe rules, 11204, allows an administrator to specify broadcasting and subscription rules for updates based on an application's license as stored in licensing database management module 6182.

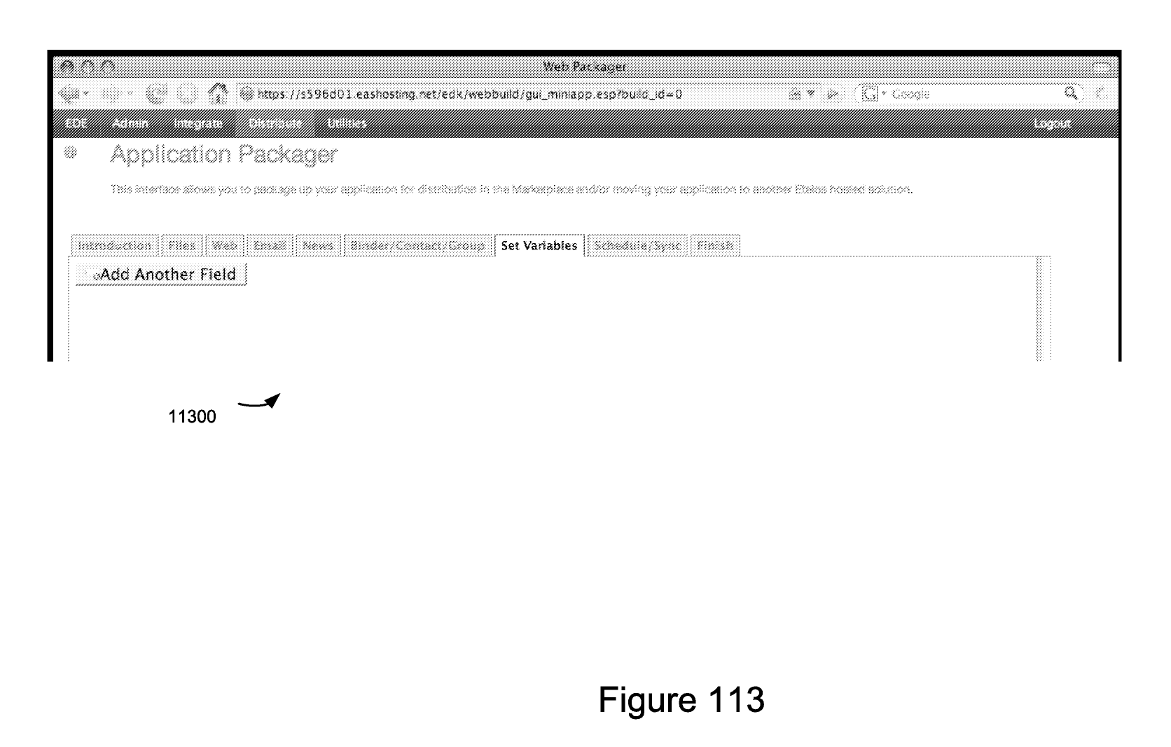

FIG. 113 is an exemplary screenshot 11300 of an application packager, generated by Packager Module 6136.

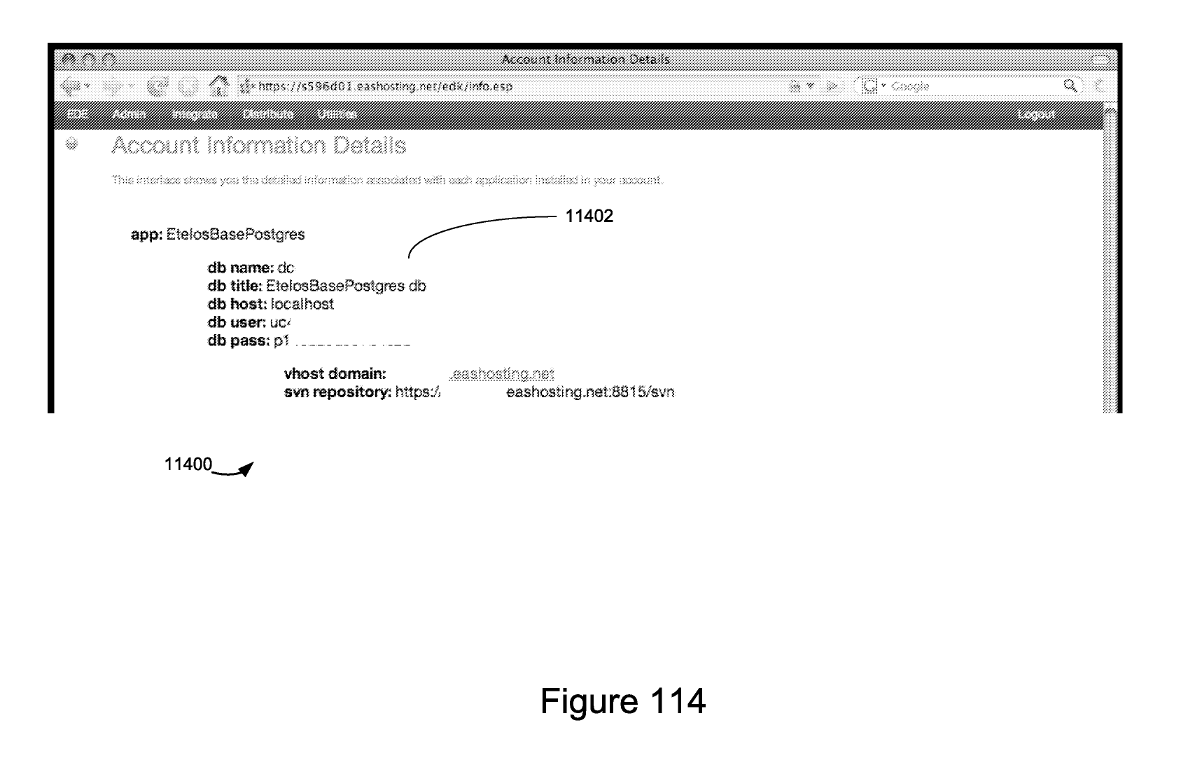

FIG. 114 is an exemplary screenshot 11400 of an Account Information Details, generated by User Accounts Module 6156.

Account Information Details shows the user the detailed information associated with each application installed on the user's account. Field 11402 includes examples of information that may be included in one embodiment.

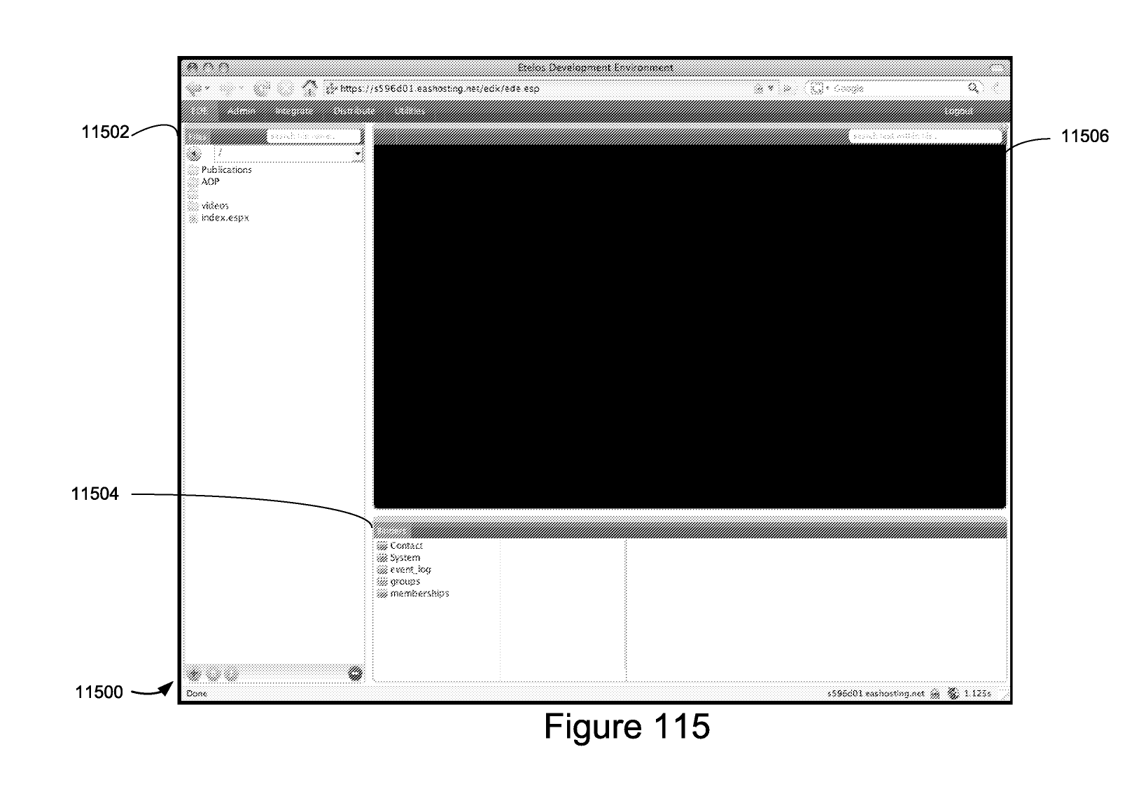

FIG. 115 is an exemplary screenshot 11500 of a Development Environment that can be used to create or modify applications. Files panel 11502 displays the file structure associated with an application. Binders panel 11504 displays Binders associated with the application. Panel 11506 can display the contents of selected files, folders, and/or objects.

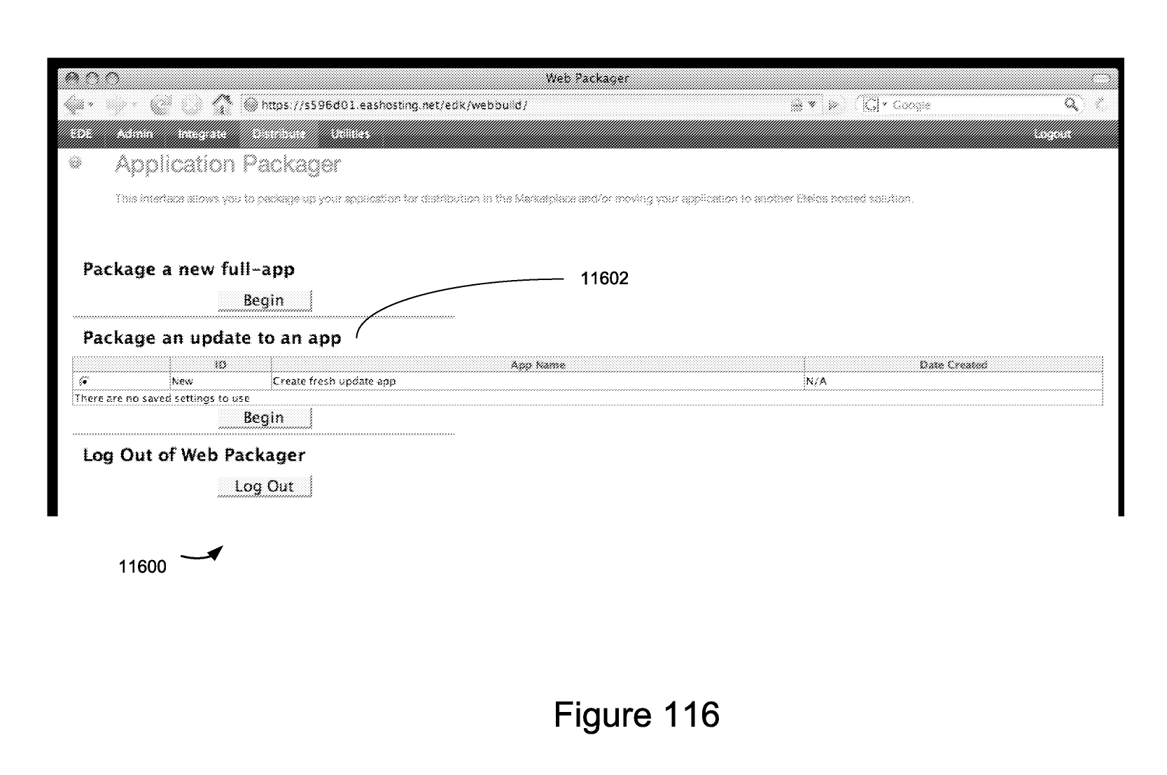

FIG. 116 is an exemplary screenshot 11600 of an application packager, generated by Packager Module 6136 similar to FIG. 103.

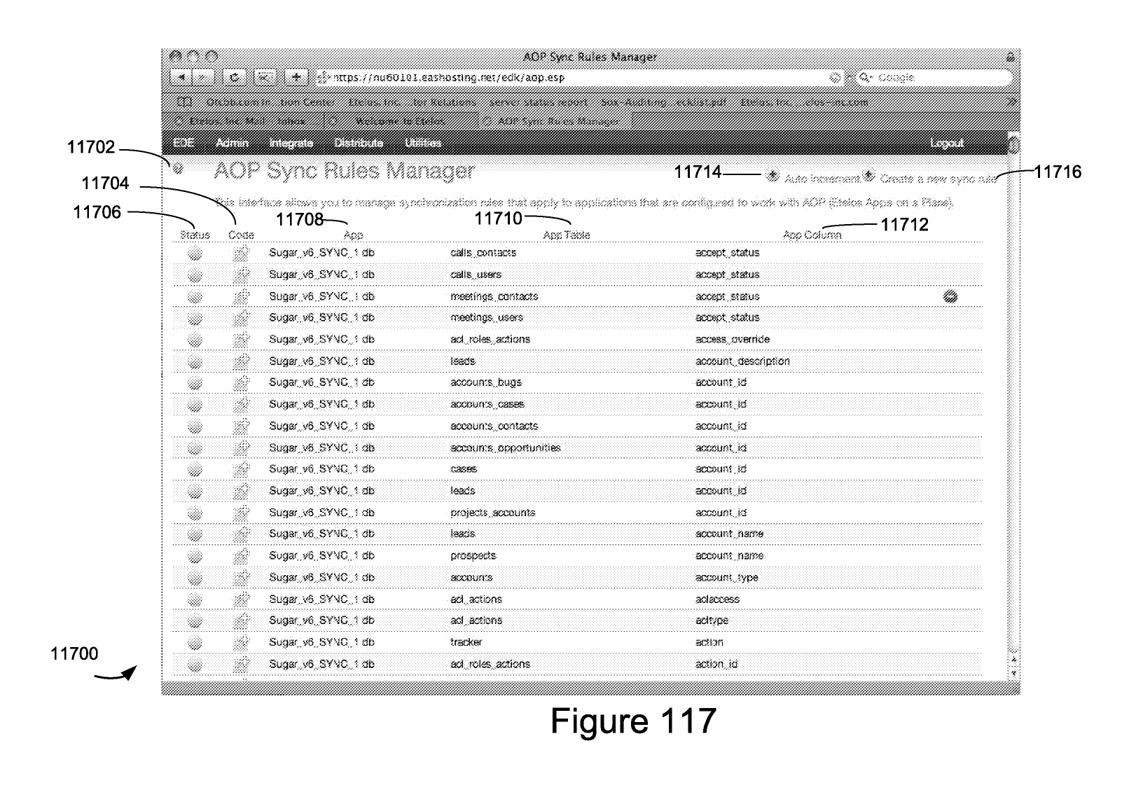

FIG. 117 is an exemplary screenshot 11700 of an AOP sync rules manager, generated by an application synchronization module (e.g., the application synchronization module 6306 in FIG. 63). The AOP sync rules manager 11702 displays current synchronization rules as defined by a user. Column 11704 displays the Code associated with an application. The code column includes the code to execute upon rule execution. Column 11706 displays the status of a rule associated with an application. Column 11708 displays names of applications and/or database for which there is a sync rule defined. Column 11710 and 11712 display a table and a column, respectively, in the application database for which there is a defined sync rule. Button 11714 opens an interface to specify whether a given column in the application database is an autoincrementing column. Button 11716 allows a user to create a new sync rule.

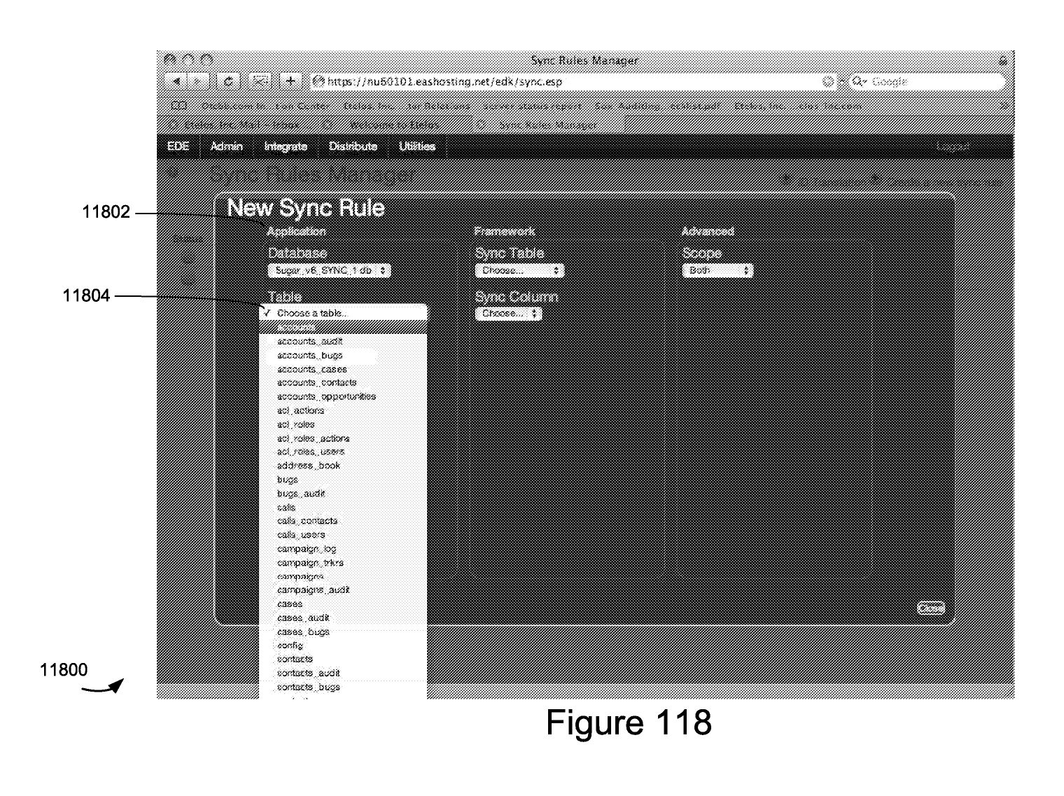

FIGS. 118-121 are exemplary screenshots of an AOP sync rules manager. FIG. 118 is an exemplary screenshot 11800 of an AOP sync rules manager, allowing a user to define a new sync rule. Field 11802 allows a user to specify the application and/or database for which the user wishes to define a new sync rule. Field 11804 allows the user to choose a table associated with the application and/or database for which the user wishes to define a sync rule.

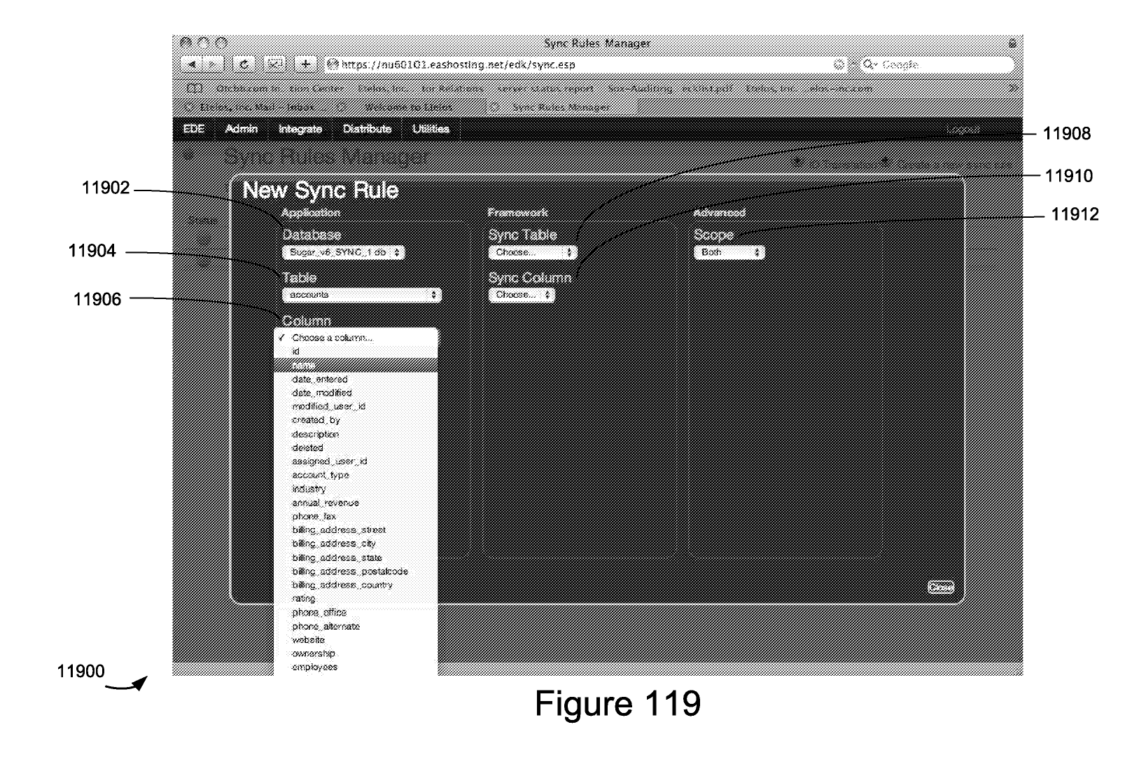

FIG. 119 is an exemplary screenshot 11900 of an AOP sync rules manager, allowing a user to define a new sync rule. Field 11902 allows a user to specify an application and/or a database for which the user wishes to define a new sync rule. Field 11904 allows the user to choose a table associated with the application and/or database for which the user wishes to define a new sync rule. Field 11906 allows the user to specify a Column associated with the application and/or database for which the user is defining a new sync rule. Fields 11908, 11910, and 11912 allow a user to define a table in the application framework (e.g., Framework Sync Table) to which the table defined in field 11904 is synchronized, an associated column (e.g., Framework Sync Column) in the table defined in field 11904 to which the column defined in field 11906 is synchronized, and a scope of the synchronization rule, respectively.

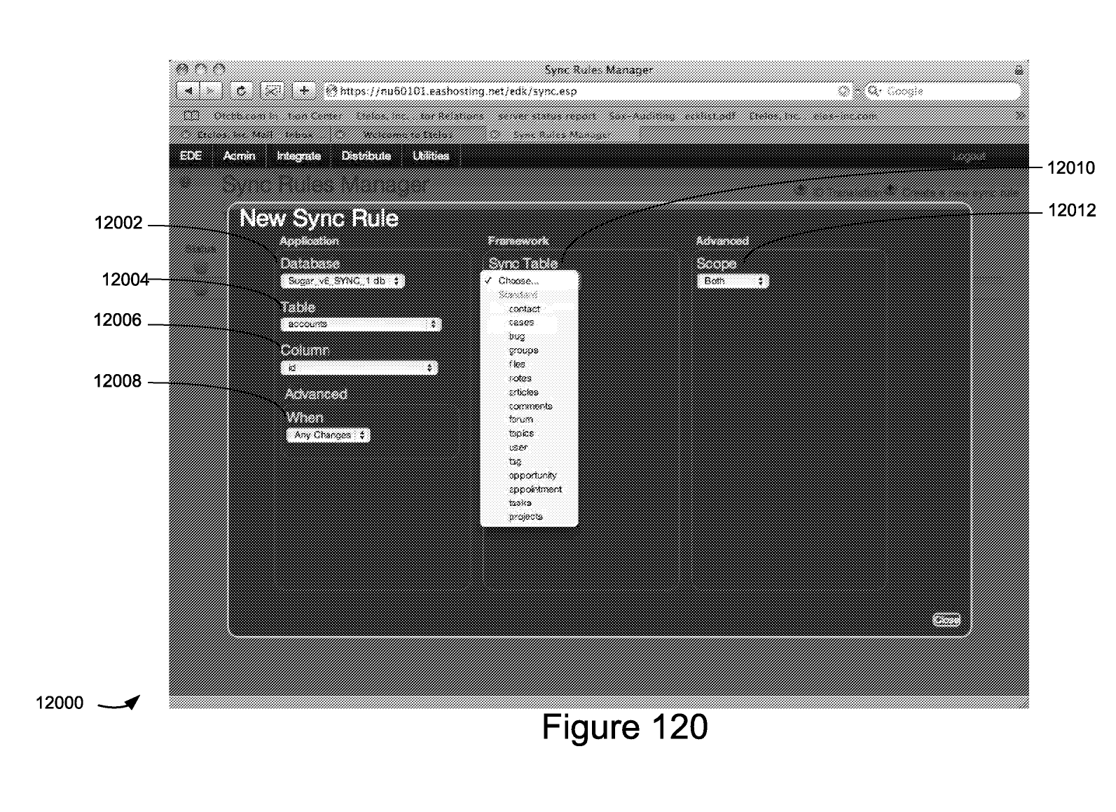

FIG. 120 is an exemplary screenshot 12000 of an AOP sync rules manager, allowing a user to define a new sync rule. Field 12002 allows a user to specify an application and/or a database for which the user wishes to define a new sync rule. Field 12004 allows the user to choose a table associated with the application and/or database for which the user wishes to define a new sync rule. Field 12006 allows the user to specify a Column associated with the application and/or database for which the user is defining a new sync rule. Field 12008 allows a user to select when and what types of changes are synchronized. For example, changes can be synchronized when there are one or more of the following: inserts (e.g., new data added), and updates (e.g., existing data is updated), deletes (e.g., existing data is deleted), etc. Fields 12010 and 12012 allow a user to define a table in the application framework (e.g., Framework Sync Table) to which the table defined in field 12004 is synchronized, and a scope of the synchronization rule, respectively.

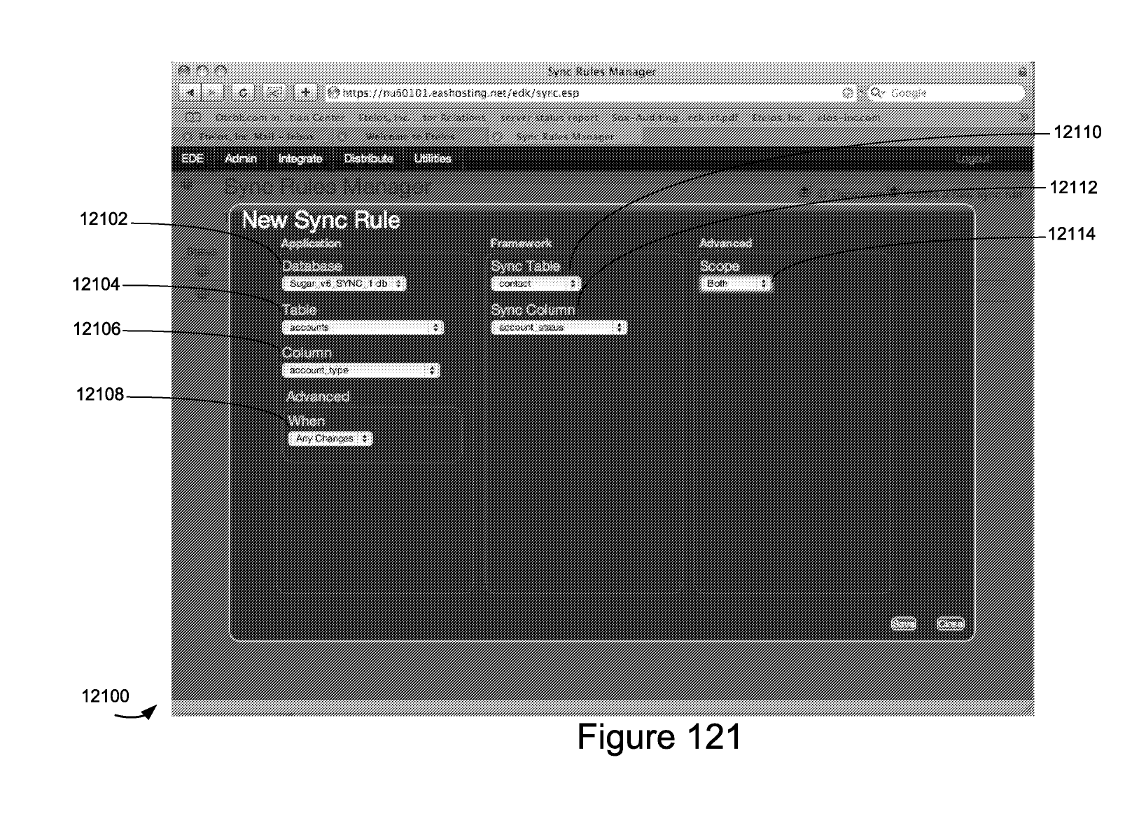

FIG. 121 is an exemplary screenshot 12100 of an AOP sync rules manager, allowing a user to define a new sync rule. Field 12102 allows a user to specify an application and/or a database for which the user wishes to define a new sync rule. Field 12104 allows the user to choose a table associated with the application and/or database for which the user wishes to define a new sync rule. Field 12106 allows the user to specify a Column associated with the application and/or database for which the user is defining a new sync rule. Field 12108 allows a user to select when and what types of changes are synchronized. Fields 12110, 12112, and 12114 allow a user to define a table in the application framework (e.g., Framework Sync Table) to which the table defined in field 12104 is synchronized, an associated column (e.g., Framework Sync Column) in the table defined in field 12104 to which the column defined in field 12106 is synchronized, and a scope of the synchronization rule, respectively.

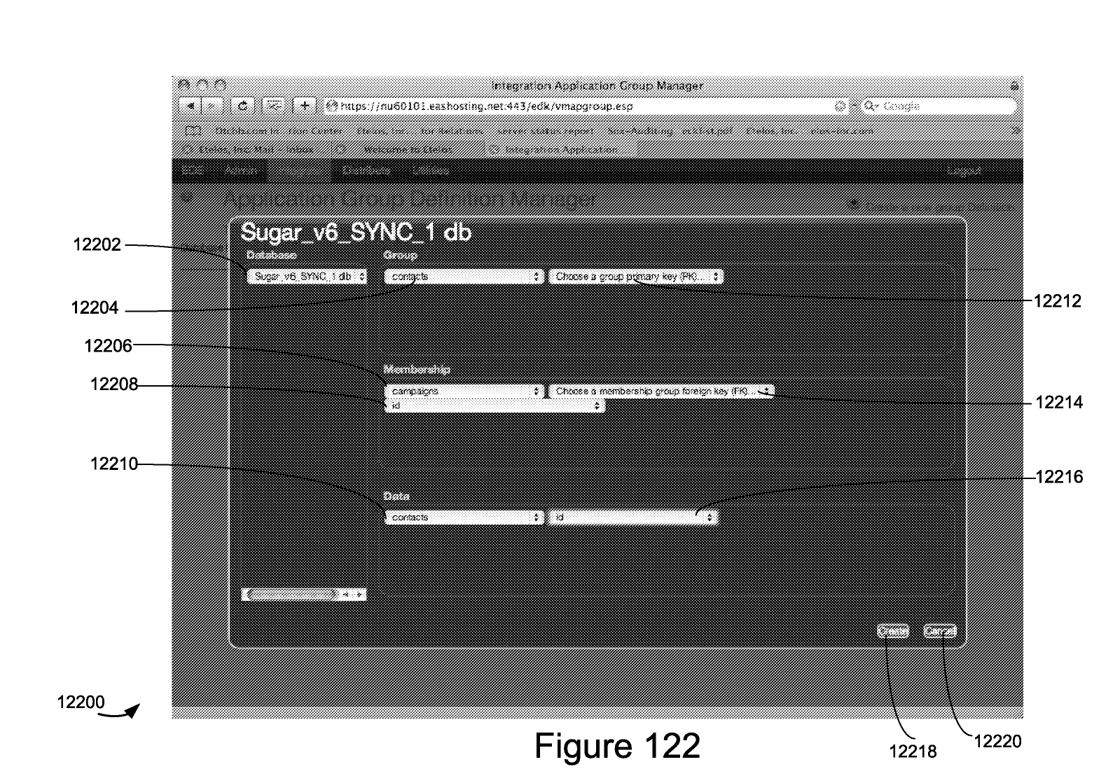

FIG. 122 is an exemplary screenshot 12200 of a Group Manager, generated by an access module (e.g., the access module 6170 in FIG. 61). In some embodiments, a user may define an application and/or database 12202, group 12204, membership 12206, membership id 12208, data type 12210, group primary key 12212, membership group foreign key 12214, and Data id 12216 associated with an application. By clicking the Create button 12218 a user may create a group definition associated with an application. By clicking the Cancel button 12220, a user may cancel the group definition associated with an application.

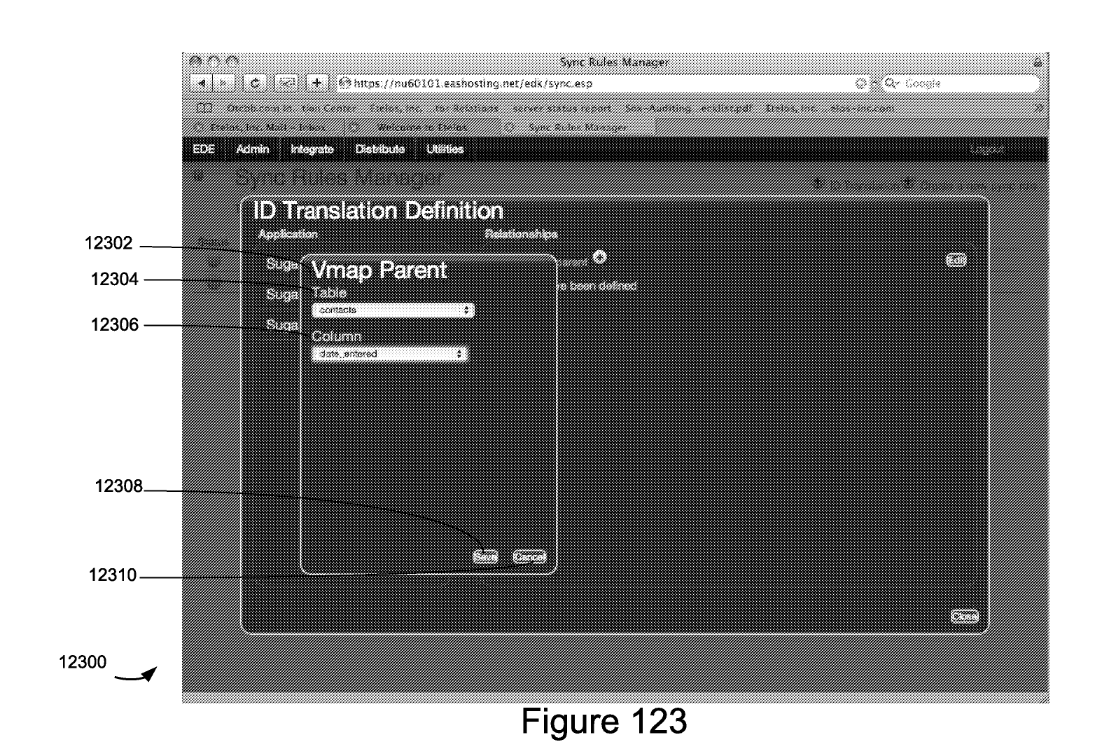

FIG. 123 is an exemplary screenshot 12300 of a sync rules manager wherein a user generates an ID Translation Definition for parent-child relationships. The user may define a Vmap Parent 12302 by defining a table 12304 and a column 12306 for an application and/or a database that is a parent for another column in a table. The user may save changes by clicking the Save button 12308, or cancel changes by clicking the Cancel button 12310.

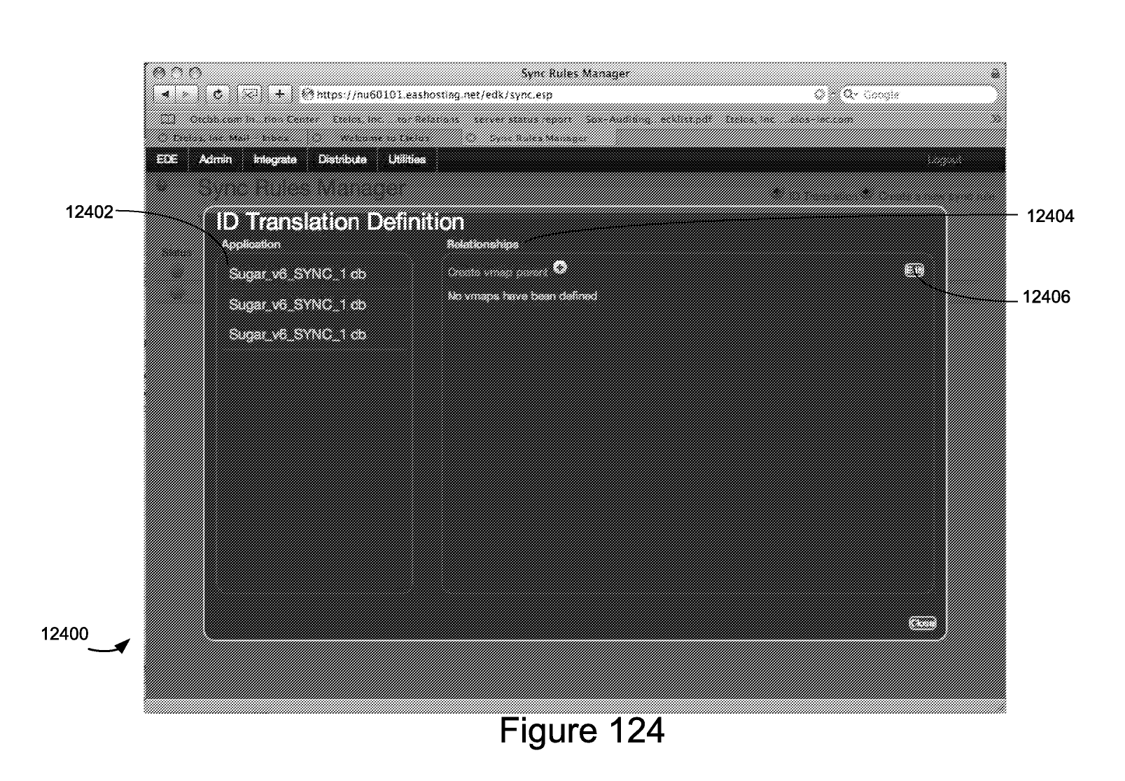

FIG. 124 is an exemplary screenshot 12400 of a sync rules manager wherein a user generates an ID Translation Definition. Field 12402 includes applications for which there is an ID Translation Definition. Field 12404 can display the Vmap parent relationships described in FIG. 123. The button Edit 12406 allows a user to edit the relationships information associated with an application.

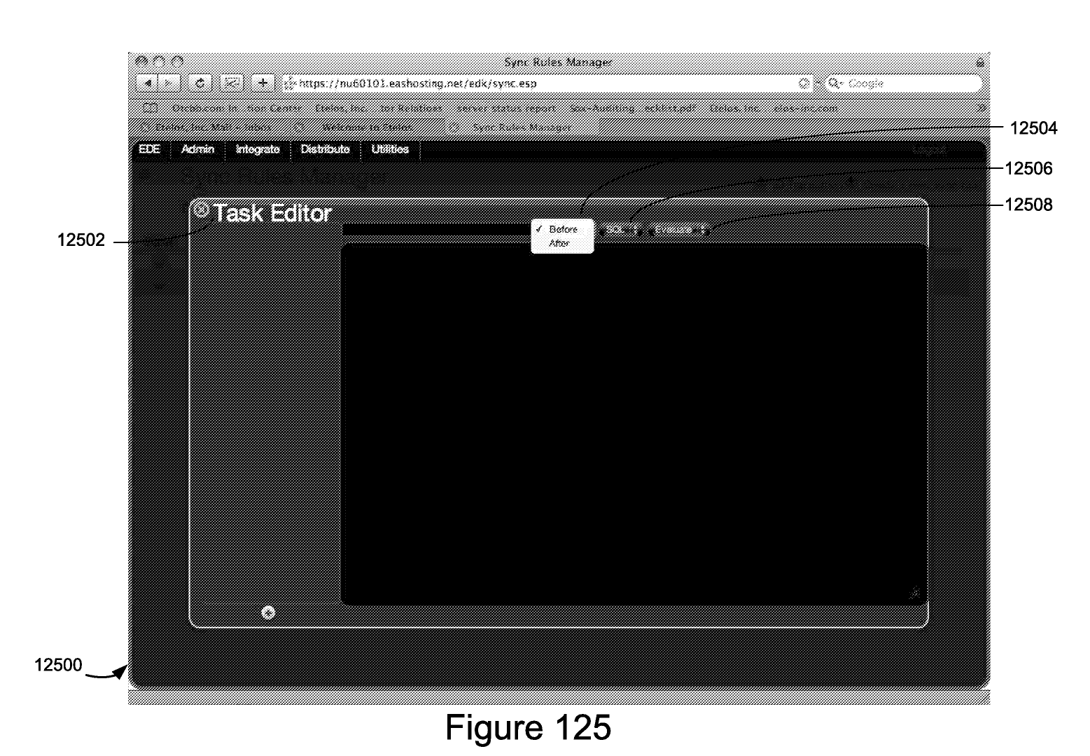

FIG. 125 is an exemplary screenshot 12500 of a sync rules manager wherein a user may use Task Editor 12502 to add scripts to a sync rule. The user may specify whether the task is to be performed before or after syncing using field 12504. The user may also specify the type of scripts using the field 12506 (e.g., SQL). The user may further specify in field 12508 whether the script is to evaluate or to execute.

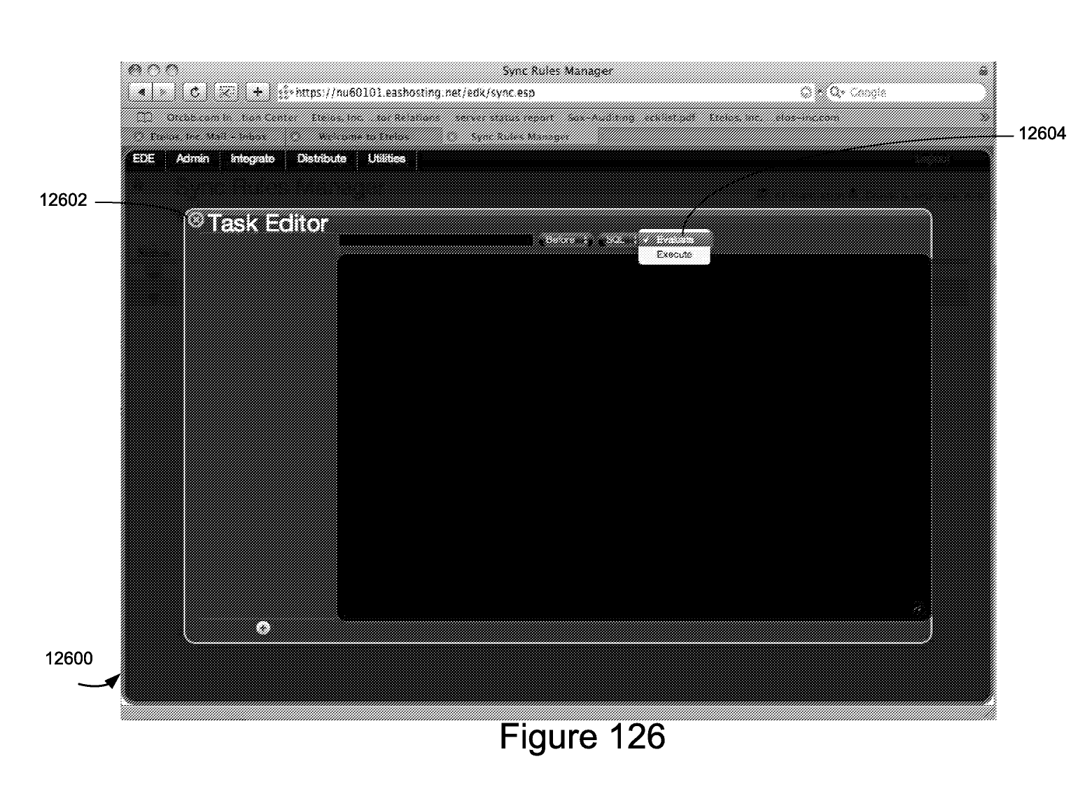

FIG. 126 is an exemplary screenshot 12600 of a sync rules manager wherein a user may use Task Editor 12602 to add script details to a sync rule similar to FIG. 125.

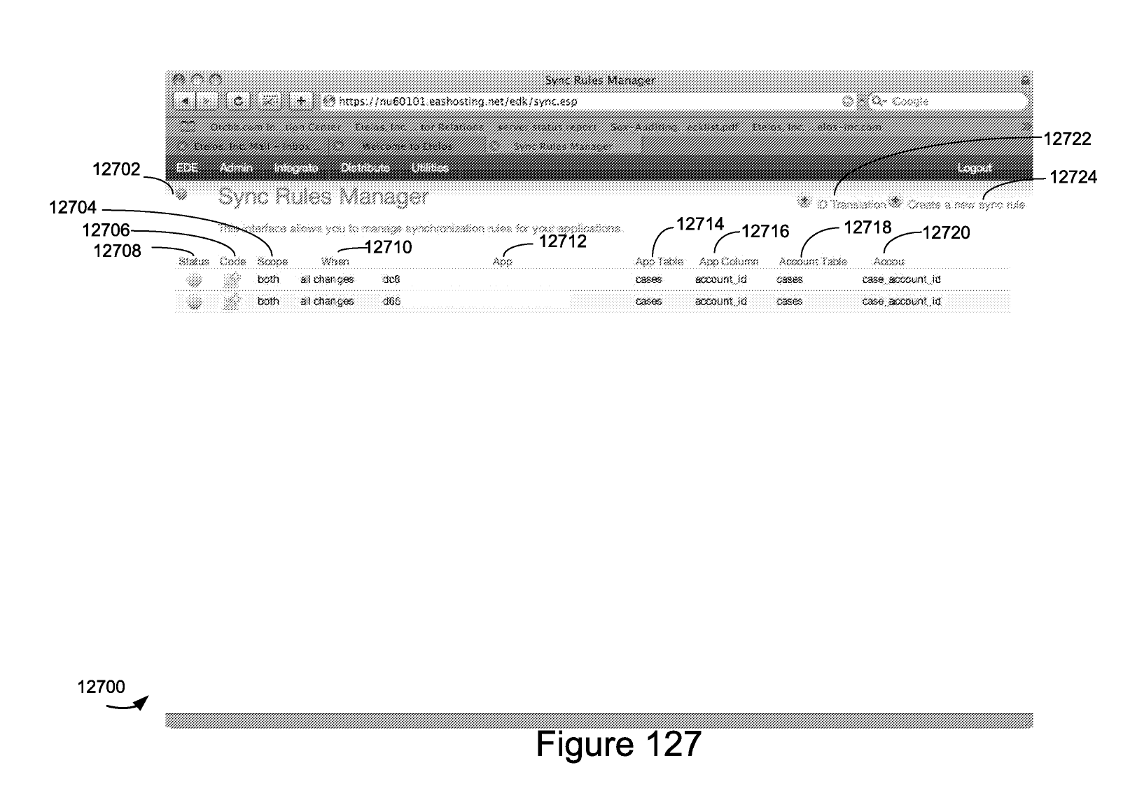

FIG. 127 is an exemplary screenshot 12700 of a sync rules manager wherein a user can manage synchronization rules associated with an application. The user may access help information by clicking the question mark button 12702. The user may view a scope of a rule in field 12704, a code in field 12706, a status of a rule in field 12708, when a rule is applied in field 12710, an application and/or a database in field 12712, an application table in field 12714, an application column in filed 12716, an account table in field 12718, application account in field 12720. The user may specify an ID Translation by clicking on the plus button 12722, or create a new sync rule by clicking on the plus button 12724.

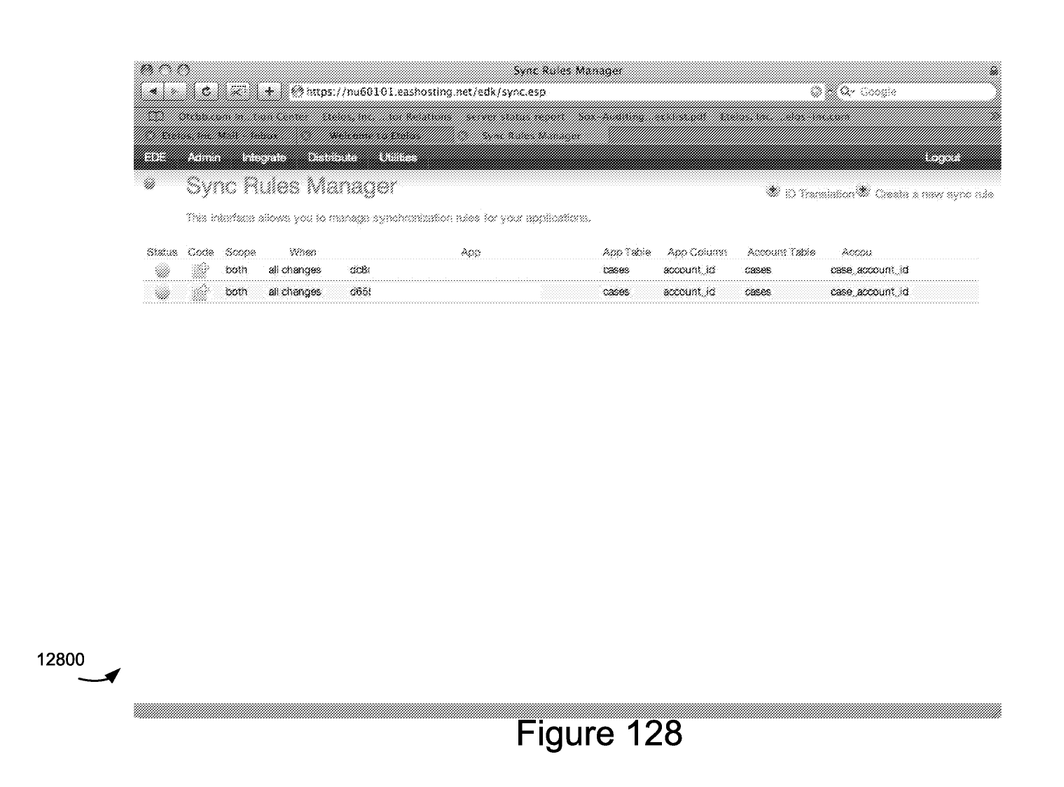

FIG. 128 is an exemplary screenshot 12800 of a sync rules manager wherein a user can manage synchronization rules associated with an application similar to FIG. 127.

FIG. 129 is an exemplary screenshot 12900 of a support page (e.g. an Etelos Support page) wherein a user may use a Storefront 12902 (e.g. Etelos “My Storefront”) to add product or services to a marketplace (e.g. an Etelos marketplace) generated by marketplace module 6122. Field 12904 displays a store listing; field 12906 displays a status of an application; field 12908 displays a type of an application.

FIG. 130 is an exemplary screenshot 13000 of a Product/Service Basic Information Page generated by listing module 6124. A user may specify a product name in field 13002, short description in field 13004, product type in field 13006, and item status in field 13008. Store Item Details appears in the field 13010. The user may create a Product/Service Basic Information page by clicking on the button Create A Copy 13012.

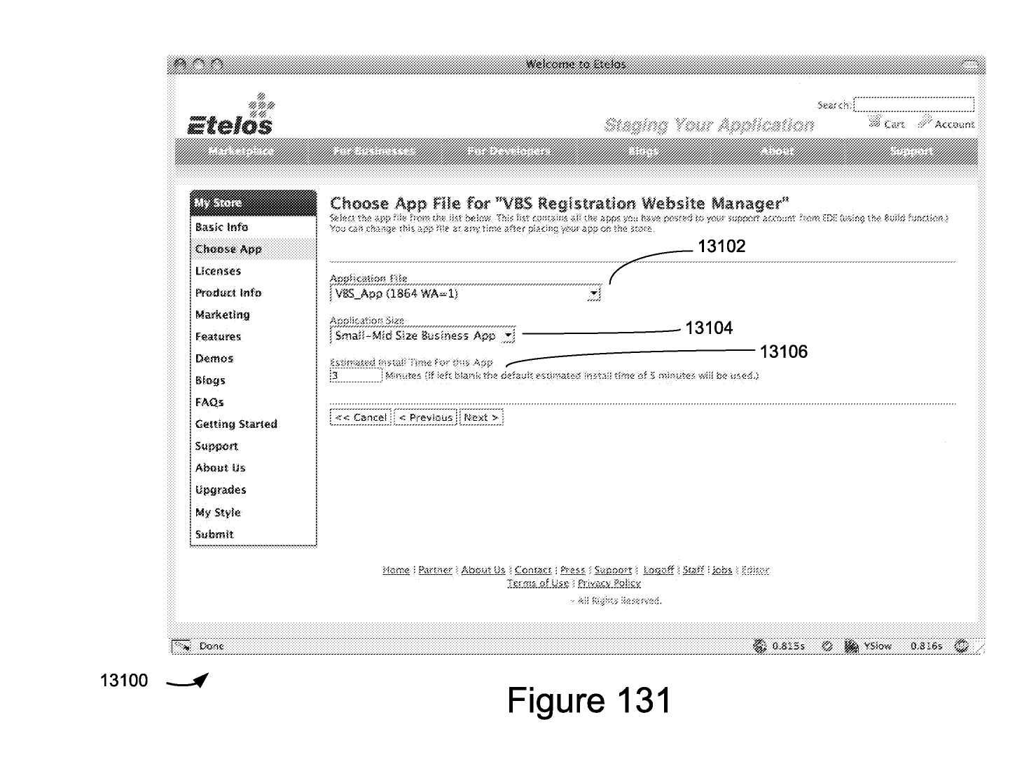

FIG. 131 is an exemplary screenshot 13100 of a staging application page. In application file field 13102, a user can specify an application file for e.g. the VBS registration website manager (in one embodiment, VBS is an example software application listed in the marketplace). In application size field 13104, a user can specify the application size. In install time field 13106, a user can specify the estimated install time for the application.

FIG. 132 is an exemplary screenshot 13200 of an edit licensing page wherein a user may edit licensing for “a registration website manager” 13202. The edit licensing for “registration website” is generated by the licensing module 6126. The information entered on this page is stored by licensing database management module 6182.

Field 13204 displays the name, description, or billing, retail, wholesale, and type (per account or per user) information associated with a packaged application for which the user may wish to edit licensing information. In field 13206, the user may select an install type for an application. In field 13208, the user may type a description of the application. In field 13210, the user may specify a license version. In field 13212, the user may specify a type of license associated with the application. In field 13214, the user may specify a quantity of licenses associated with the application (allowance of application features like user groups, max records on quantifiable items like tasks, documents, projects, sales reps, etc. . . . ). In field 13216, the user may specify whether the license is a trial version. In field 13218, the user may specify a billing type associated with a license associated with the application. In field 13220, the user may specify whether the application is hosted using bundled hosting. In field 13222, the user may specify a hosting provider associated with the application. In field 13224, the user may specify a retail pricing associated with the application. In field 13226, the user may specify a resale term to be associated with a license associated with the application. In field 13228, the user may specify a wholesale pricing associated with the application. In field 13230, the user may specify a license type associated with a source code associated with the application (e.g. whether source code is licensed as an open source license, etc.). In field 13232, the user may specify whether the source code associated with the application is downloadable. In field 13234, the user may specify whether application synchronization (syncing) is enabled. In field 13236, the user may specify whether the application is Application on Plane (AOP) enabled. In field 13238, the user may specify whether multiple instances of the application are allowed. In field 13240, the user may specify an external product ID associated with the application. In field 13242, the user may specify whether there is an ad server associated with the application. In field 13244, the user may specify the status of a license associated with the application (e.g. whether the license is on or off). These fields are exemplary, other embodiments may incorporate different fields and editing options concerning licensing associated with an application.

FIG. 133 is an exemplary screenshot 13300 of a setup marketing information page generated by the listing module 6124. A product review and store categories page 13302 includes information used to display an application in a catalog and search result. In field 13304, a user may upload a product image to be displayed with an application. In field 13306, a user may specify a desired turnkey rating associated with an application. In field 13308, a user may specify an internet address associated with a provider of an application. In field 13310, a user may specify different categories associated with an application. In field 13312, a user may specify store items related to an application. In field 13314, a user may specify keywords for which an application may appear in a search result. In field 13316, a user may specify a type of hosting associated with an application.

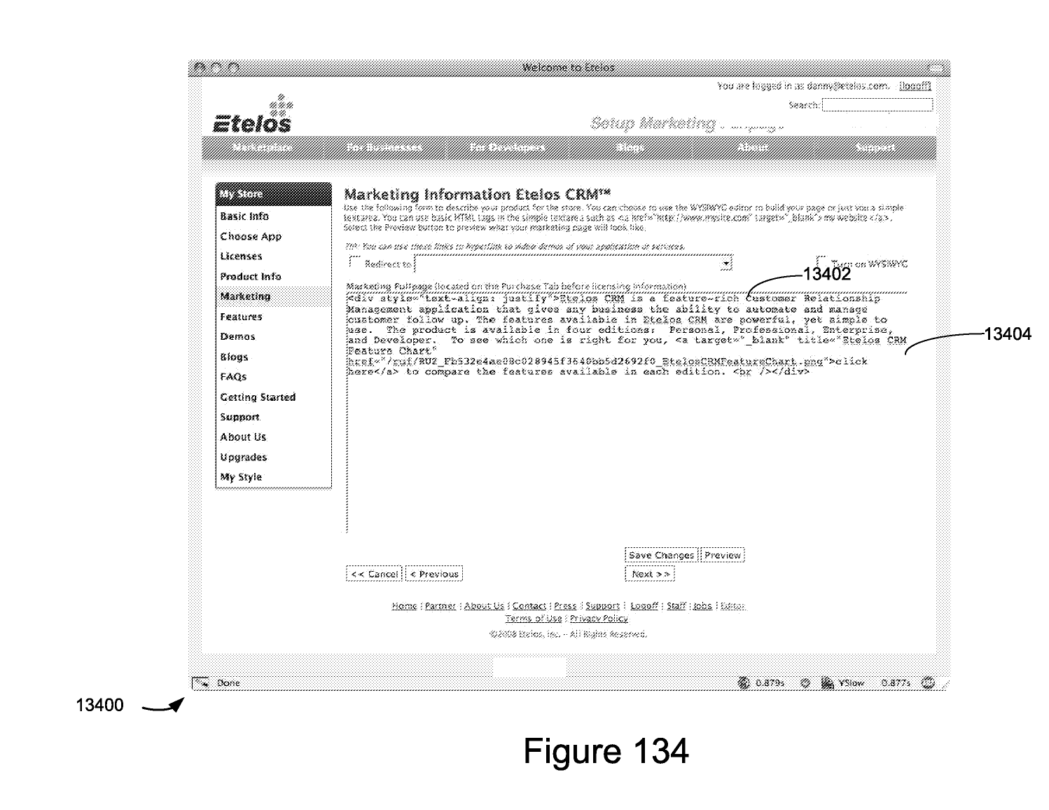

FIG. 134 is an exemplary screenshot 13400 of a setup marketing full page generated by the listing module 6124 whereby a user may describe his applications. In field 13402, a user may specify a web address to redirect a purchaser to the user's marketing material. In field 13404, a user may write a description of an application which the user is selling through marketplace module 6122.

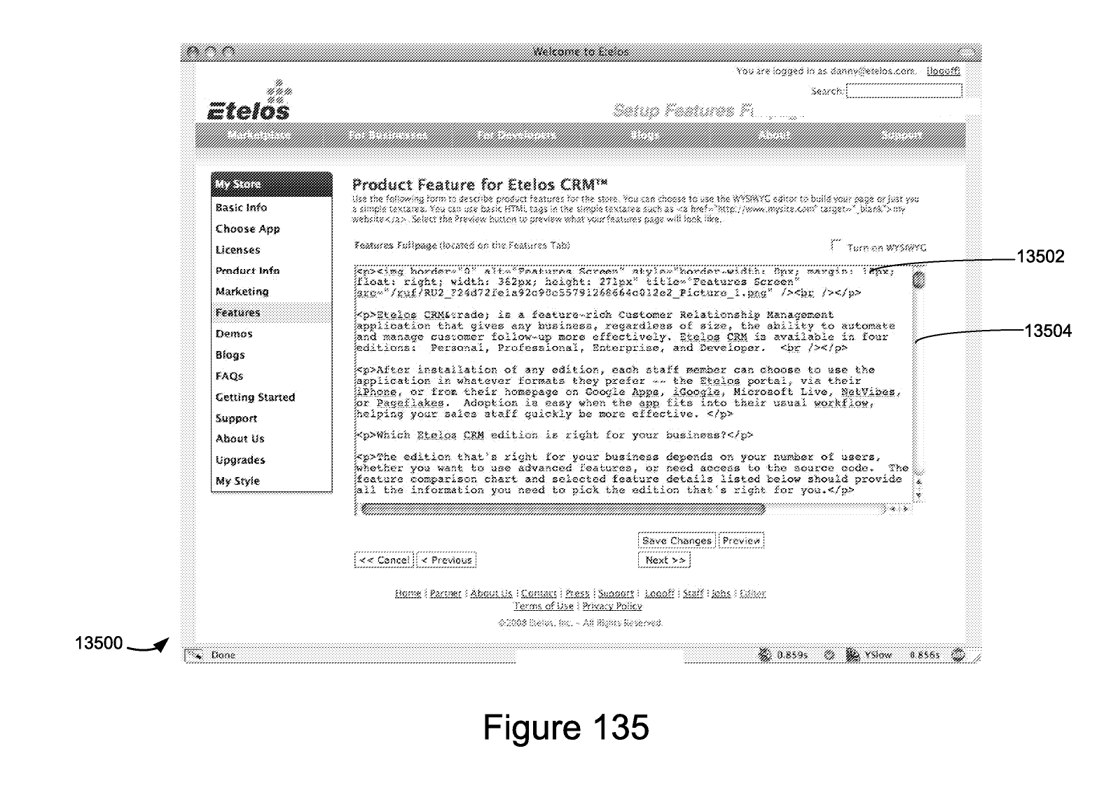

FIG. 135 is an exemplary screenshot of a setup product features full page 13500 generated by the listing module 6124. In field 13502, a user may turn on WYSIWYG. In field 13504, a user may write a description of features in the user's application. The user's application is available for sale through marketplace module 6122.

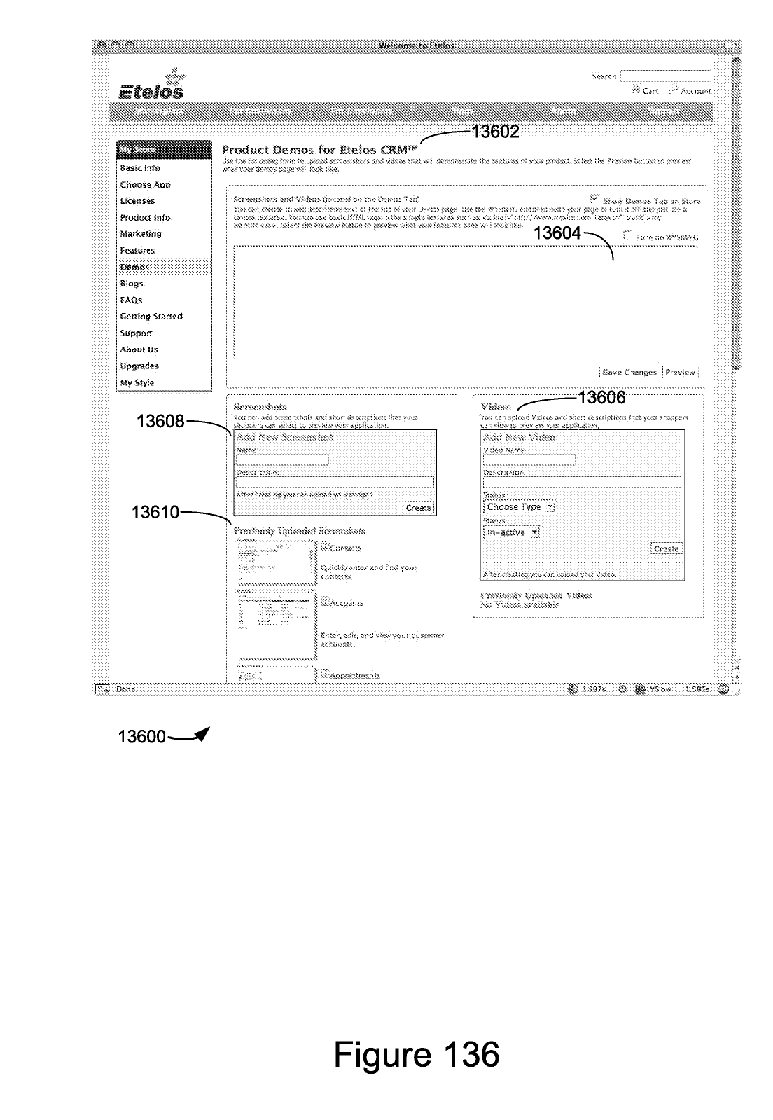

FIG. 136 is an exemplary screenshot of a product demo page 13600 generated by the listing module 6124. The information entered here is stored by marketplace database management module 6180. A user may access this product demos page 13602 to upload screenshots, and videos associated with the user's applications available through Marketplace module 6122. In field 13604, a user may add a descriptive text describing the features of the user's application. In field 13606, a user may upload videos to be used as a demo associated with an application. In field 13608, a user may upload screenshots to be used as a demo associated with an application. In field 13610, a user may view previously uploaded screenshots associated with an application.

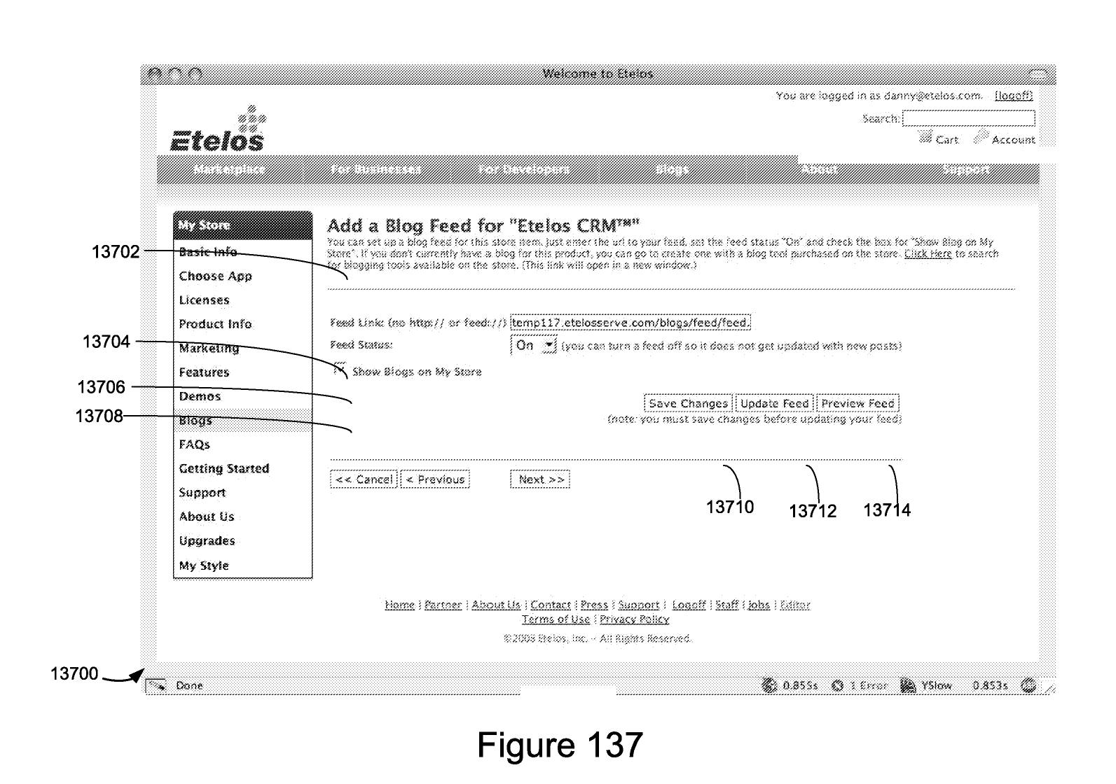

FIG. 137 is an exemplary screenshot 13700 of an “Add a Blog” feed page, executed by marketplace module 6122. A user can set up a blog feed for a store item using add a Blog feed page 13702 (e.g. “add a Blog feed for Etelos CRM”). In field 13704, a user may provide a feed link. In field 13708, a user may specify a feed status (e.g. on or off). In field 13708, a user may specify whether blogs should be displayed on the user's store. Using buttons 13710, 13712, and 13714, a user may save changes, update feed, or review feed respectively.

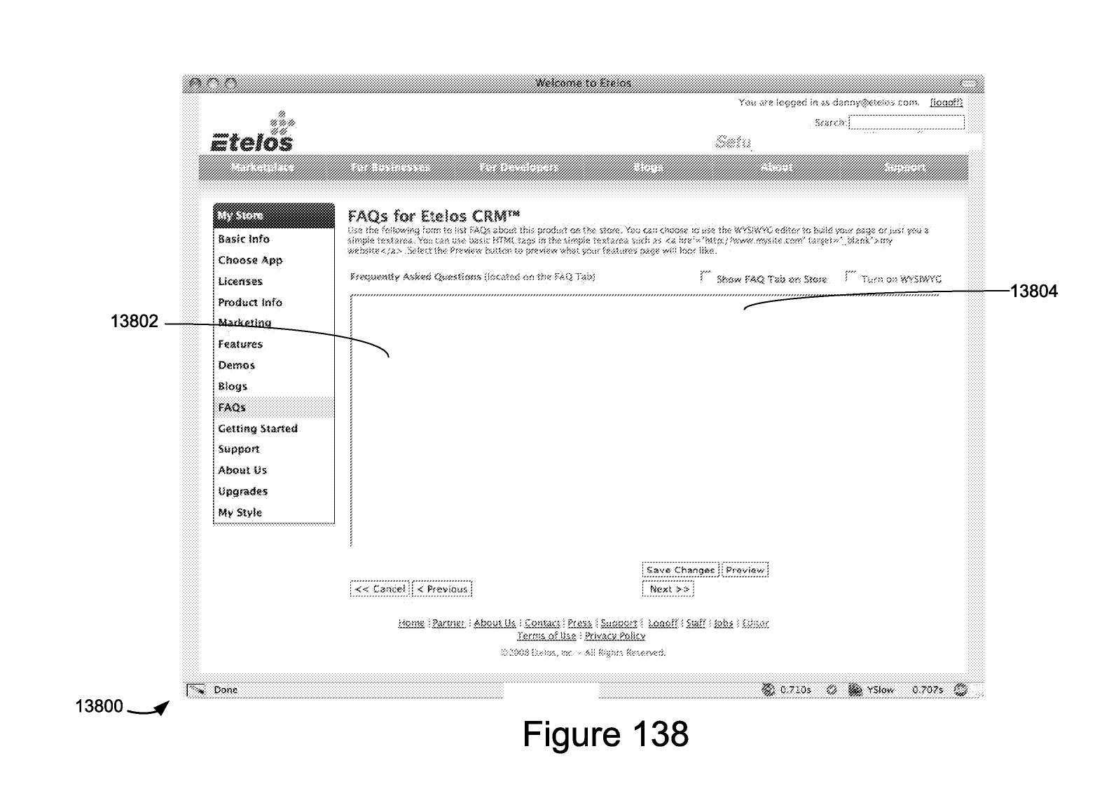

FIG. 138 is an exemplary screenshot 13800 of a setup frequently asked questions (FAQs) page generated by the listing module 6124. Information entered here is stored in the Marketplace database management module 6180. In field 13802, a user may enter FAQs about the user's application. Using the checkbox 13804, a user can display the FAQ tab on the user's store in Marketplace module 6122.

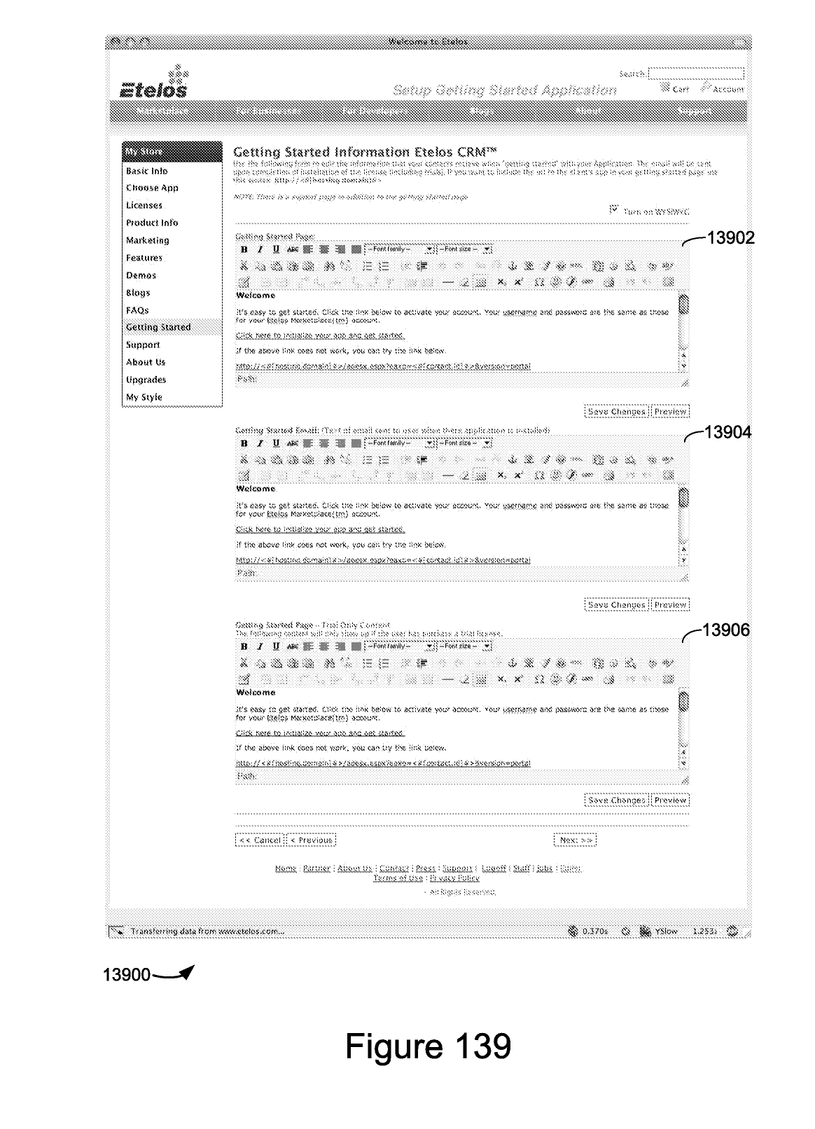

FIG. 139 is an exemplary screenshot 13900 of a setup getting started information page generated by the listing module 6124. The information entered here is stored by marketplace database management module 6180. In field 13902, an administrator may write a getting started page associated with an application which a user will see when starting the application. In field 13904, an administrator may write a getting started email associated with an application which a user will receive when the application is installed. In field 13906, an administrator may write a text associated with an application. The text would only appear if a user has purchased a trial version of the application.

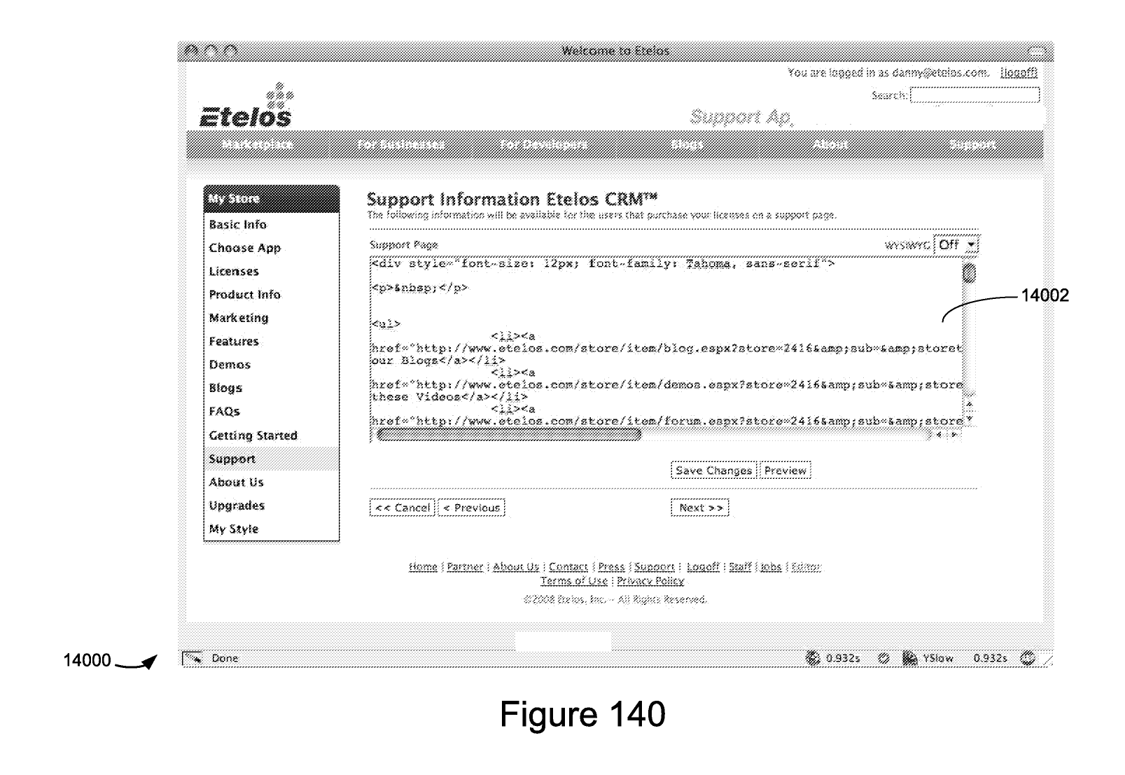

FIG. 140 is an exemplary screenshot 14000 of a support information page generated by marketplace database management module 6180. In field 14002, an administrator may write a support page to be displayed to the licensees of the administrator's application in Marketplace module 6122.

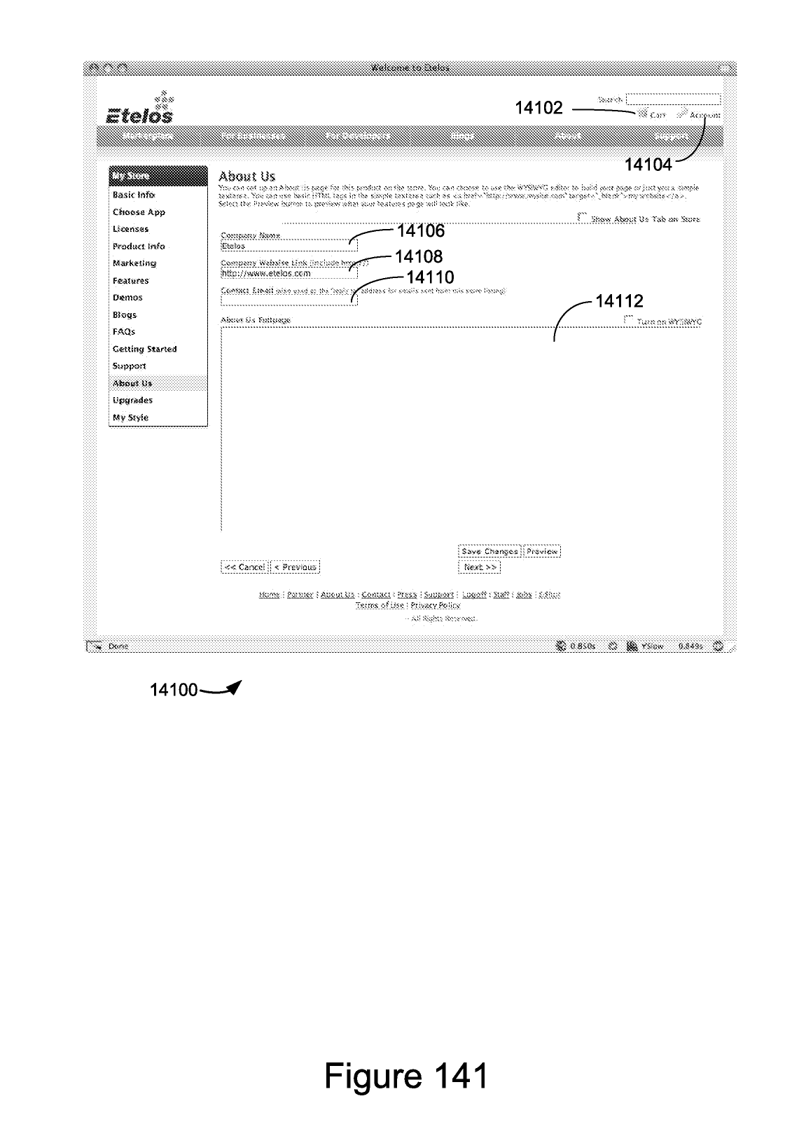

FIG. 141 is an exemplary screenshot 14100 of an about us page generated by the listing module 6124. The information entered here is stored by marketplace database management module 6180. Icon 14102, Cart, enables a user to access items in the user's shopping cart. Icon 14104, Account, enables a user to access the users account information. In field 14106, an administrator may specify the administrator's company name. In field 14108, an administrator may specify the administrator's company website link. In field 14110, an administrator can specify a contact email associated with the administrator's application. In field 14112, an administrator may write an “about us” section to be included with the administrator's application by Marketplace module 6122.

FIG. 142 is an exemplary screenshot 14200 of a product upgrade page generated in some embodiments by the listing module 6124, or in some embodiments by the licensing module. The information entered here is stored by marketplace database management module 6180. Icon 14202, Cart, enables an administrator to access items in the user's shopping cart. Cart icon 14204, and account icon 15204 operate as previously described. Using checkbox 14206, an administrator may specify whether an upgrade tab should be displayed in the administrator's store by marketplace module 6122. In field 14208, an administrator can enter a name for an upgrade. In field 14210, an administrator can write a description of an upgrade. In field 14212, an administrator may specify upgrade licensing information, e.g., the version or features of a license to upgrade to. In field 14214, an administrator may specify the status of an upgrade (e.g. if the upgrade is active). Using button 14216, an administrator may create the upgrade. Field 14218, displays upgrade information for an application an administrator is currently viewing.

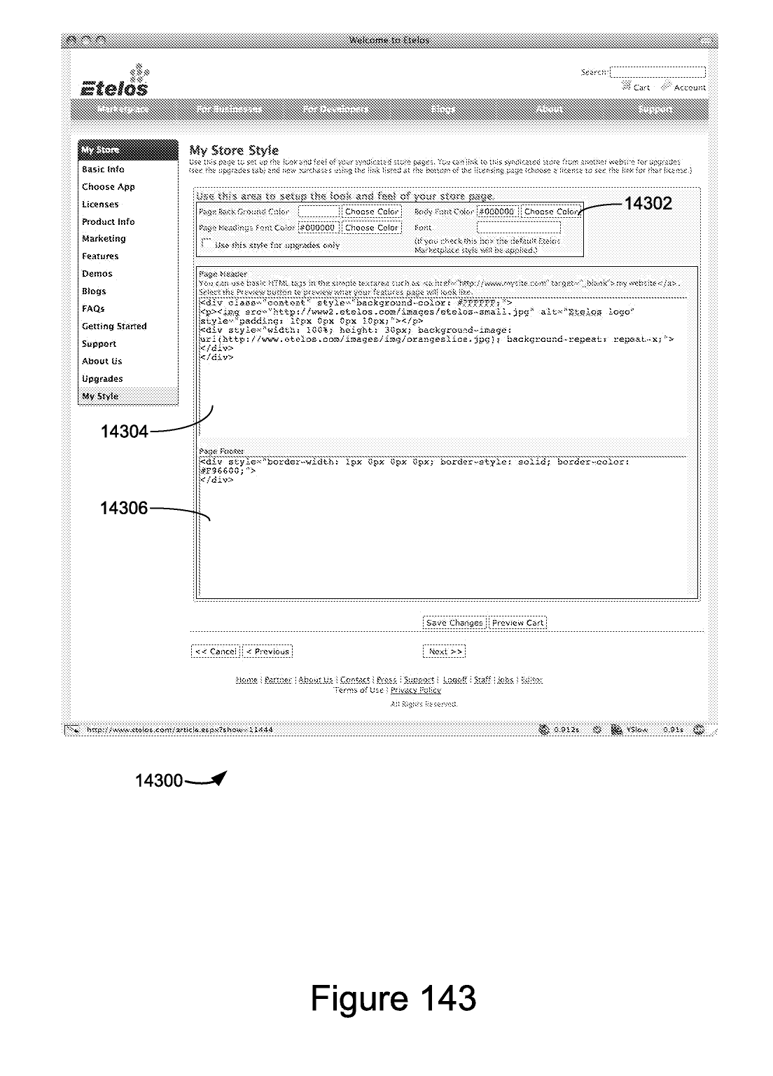

FIG. 143 is an exemplary screenshot 14300 of a “My Store Style” page generated by the listing module 6124. The information entered here is stored by marketplace database management module 6180. An administrator can use the “My store style” page to setup the look and feel of his regular and/or syndicated store pages. For example, in one embodiment, in field 14302, an administrator can specify page background color, page headings font color, body font color, and general font. In field 14304, an administrator may write or define a page header to be displayed in the administrator's store. In field 14306, an administrator may write or define a page footer to be displayed in the administrator's store in Marketplace module 6122.

FIG. 144 is an exemplary screenshot 14400 of a pricing grid and purchase/license link setup page generated by the listing module 6124. The information entered here is stored by marketplace database management module 6180. Pricing grid and purchase/license link setup page 14402 enables an administrator to set up items that will appear in the pricing grid on the Marketing page for a product in Marketplace module 6122. In field 14404, an administrator may enter the name of an application for which the administrator is setting up a pricing grid. In field 14406, an administrator may enter a price associated with an application. In field 14408, an administrator may provide a web address to redirect a prospective purchaser once the purchaser clicks a buy now link. In field 14410, an administrator may choose the link text. In field 14412, the administrator may enter sorting order information. In field 14414, the administrator may specify a status of a pricing grid (e.g. active). Using the create button 14416, an administrator can create the pricing grid the administrator has specified.

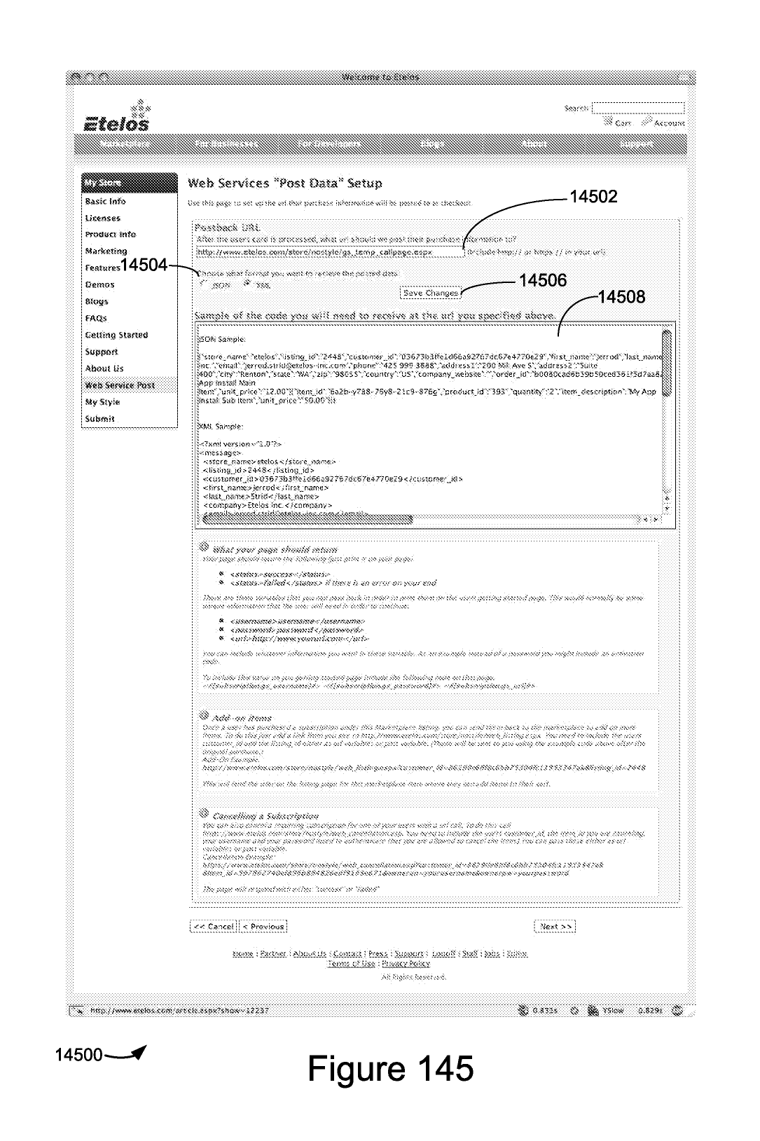

FIG. 145 is an exemplary screenshot 14500 of a web services “Post Data” setup page generated by the listing module 6124. The information entered here is stored by Marketplace database management module 6180. In field 14502, an administrator may specify a web address for a purchaser's purchase/license information to be posted to. Using radio buttons 14504, an administrator may specify in what format he prefers to receive a user's purchase/license information. Using the save changes button 14506, an administrator may save the changes the administrator has created. In field 14508, an administrator may provide a sample of the format in which he prefers to receive a purchase/license information.

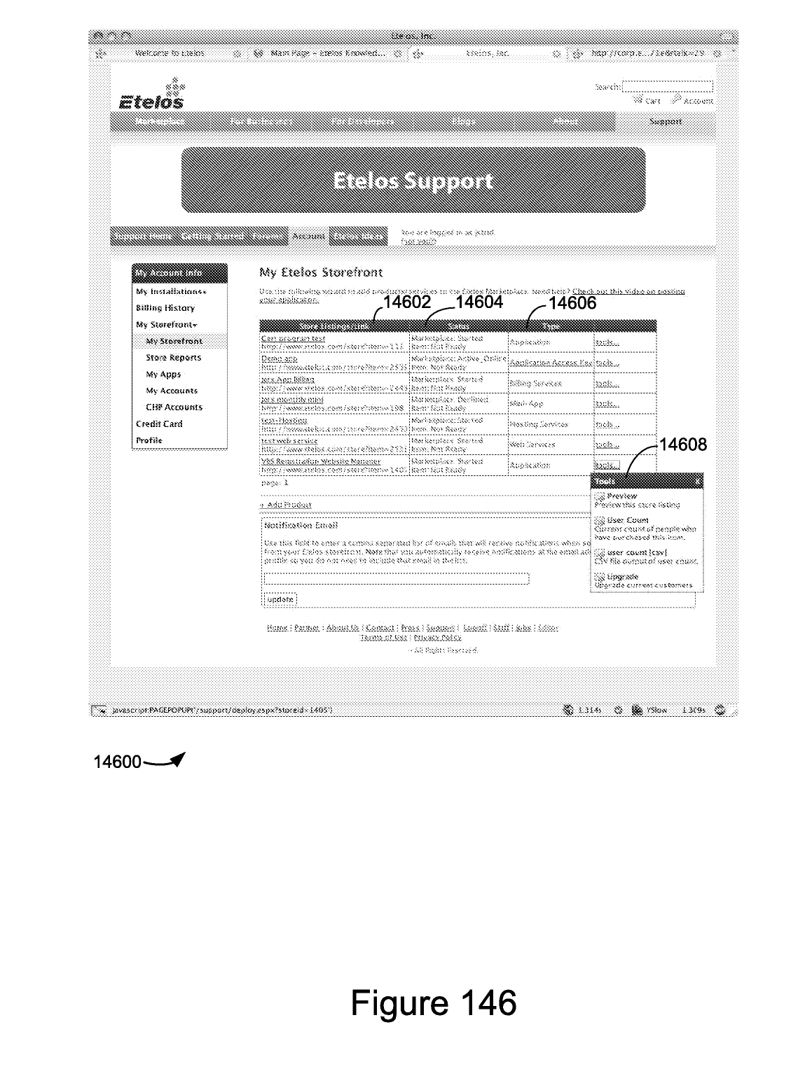

FIG. 146 is an exemplary screenshot 14600 of a support page (e.g. an Etelos support page) wherein a user may use a Storefront (e.g. Etelos “My Storefront”) to add product or services to a marketplace (e.g. an Etelos marketplace) generated by marketplace module 6122. Field 14602 displays a store listing and link; field 14604 displays a status of an application; field 14606 displays a type of an application; field 14608 displays tools available to a user. For example a user administrator can preview a store listing, number of people who have purchased from the store, and other information related to an application.

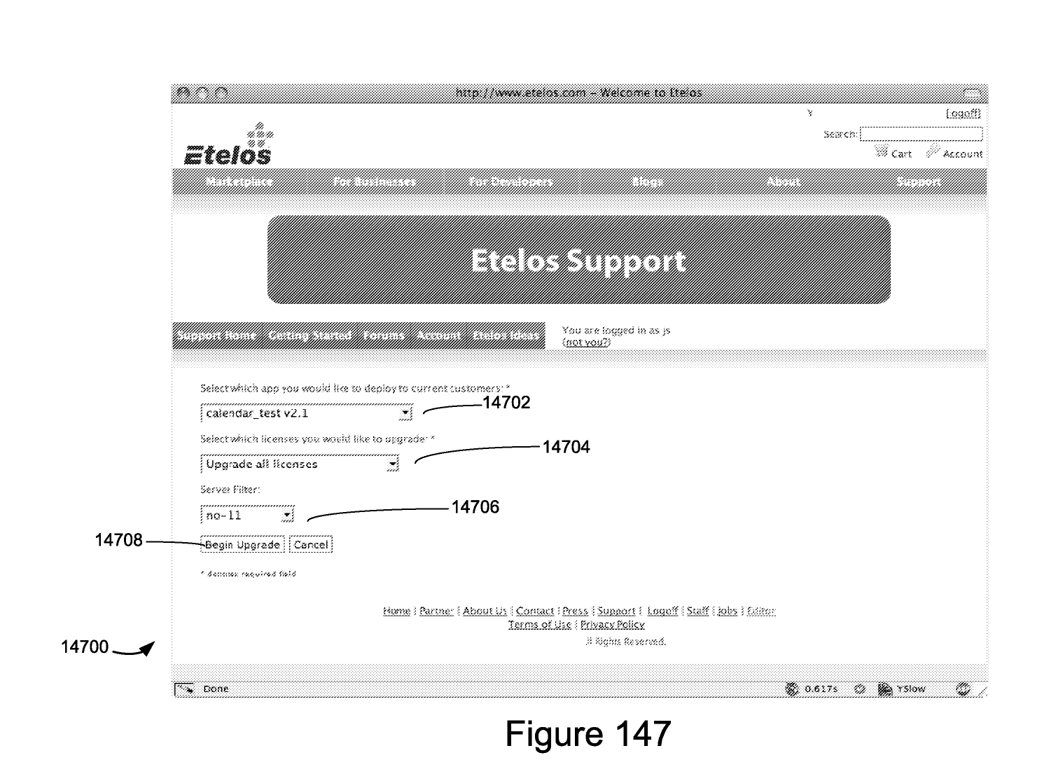

FIG. 147 is an exemplary screenshot 14700 of a support page (e.g. an Etelos support page) generated by marketplace module 6122. Using drop down menu 14702, a user may select which application the user would like to deploy to the user's customers. Using drop down menu 14704, a user may select which licenses the user would like to upgrade. Using drop down menu 14706, a user may specify a server filter. Using the begin upgrade button 14708, a user may start an upgrade process.

FIG. 148 is an exemplary screenshot 14800 of a support page (e.g. an Etelos support page) generated by marketplace module 6122. In field 14802, a user may add new domains to the user's account. A user may view an account name in field 14804, its associated default domain name in field 14806, and its status in field 14808. A user may add a domain to an account by clicking on the button Add Domain 14810.

FIG. 149 is an exemplary screenshot 14900 of a support page (e.g. an Etelos support page) generated by marketplace module 6122. A user may use the page “create a sub domain for” 14902 to create a subdomain associated with an account. In field 14904, a user may type a domain the user would like to associate with the user's account.

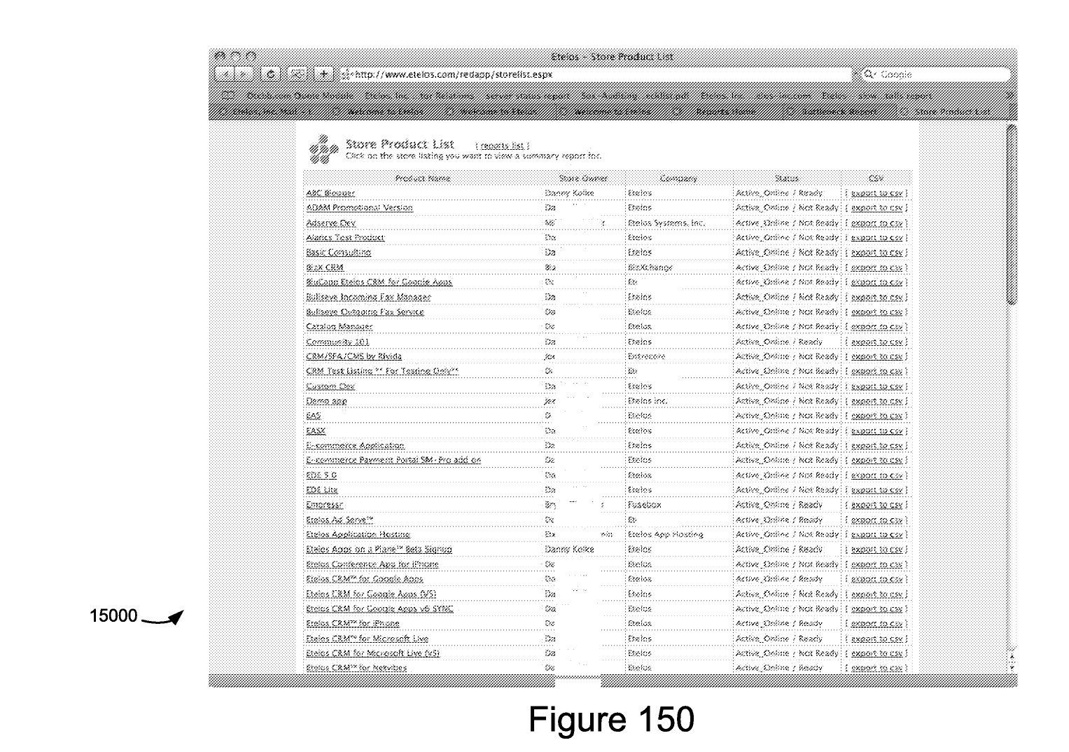

FIG. 150 is an exemplary screenshot 15000 of a store product list generated by the marketplace module 6122. The information reflected here is stored in marketplace database management module 6180, including product name column 15002, store owner column 15004, company column 15006, status column 15008, and export option 15010.

FIG. 151 is an exemplary screenshot 15100 of a store listing report (e.g. a store listing 15110, “Store listing report for Etelos CRM”) generated by transactions report module 6132. In one embodiment, the store listing report 15110 utilizes a table including the following rows and columns. Column 15102 displays a running total for every row; column 15104 displays a total year to date for every row; columns in the field 15106 displays a total for a month; column 15108 displays a total for financial quarter 1. Rows 15112 display various totals for store listings. Row 15114 displays accounts that are later cancelled or deactivated. Rows in 15116 provide a break down between unused, dormant, dry accounts, and active accounts. Rows in 15118 provide a number of registered users and accounts registered without a registered user. Rows in 15120 provide a number of billable users, free users, and a total number of users. These columns and rows are exemplary, and in other embodiments different information might be provided in a store listing table.

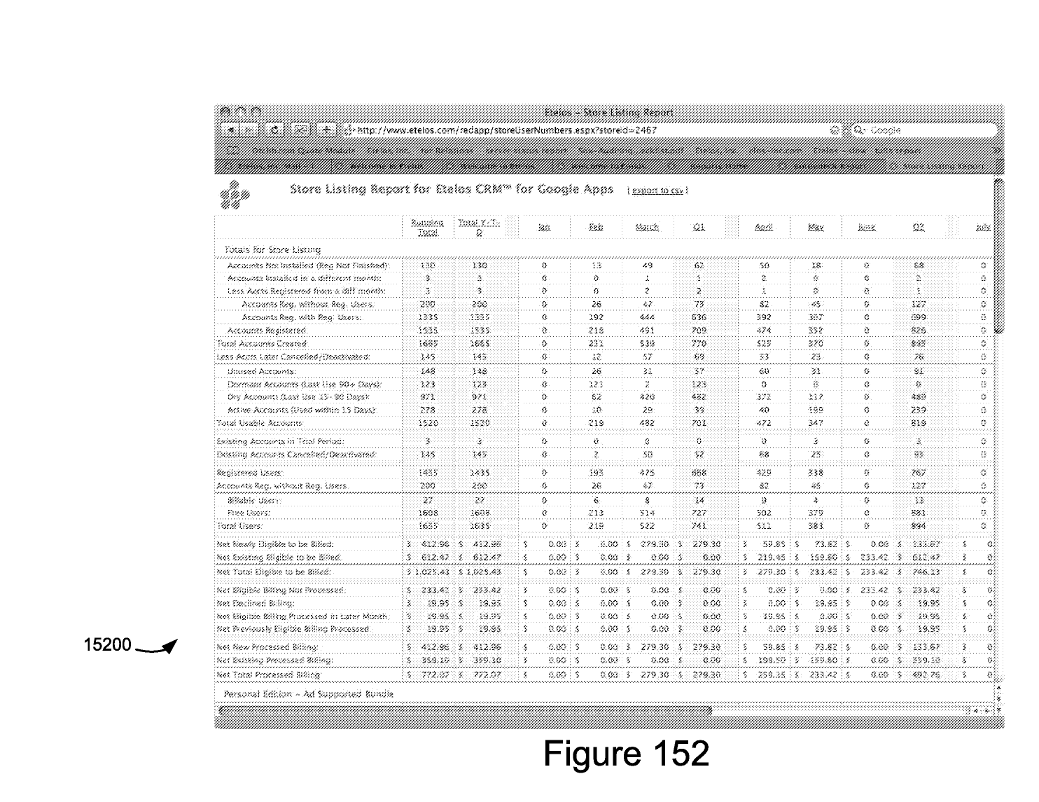

FIG. 152 is an exemplary screenshot 15200 of a store listing report (e.g. a store listing 15110, “Store listing report for Etelos CRM”) generated by marketplace module 6122 similar to FIG. 151.

FIG. 153 is an exemplary screenshot 15300 of a licensing transaction report (also known as a bottleneck report) generated by transactions report module 6132. This report includes all non-hosting services, non-cancelled, non-automated billing items. In one embodiment, the report includes the following information: field 15302, displays when an item was created, field 15304 displays the name-email, and company associated with an item; field 15306 displays a check mark if an item is store registered; field 15308 displays a check mark if an item is associated with a credit card; field 15310 displays an item's billing detail and associated domain; field 15312 displays a check mark if an item is checked out; field 15314 displays a check mark if an item is processed; field 15316 displays a check mark and a time stamp to indicate whether licensing terms associated with an item are accepted; field 15318 displays a check mark to indicate whether an item is downloaded; field 15320 displays a check mark if an installation for an item has started; field 15322 displays a check mark to indicate whether an item is licensed; field 15324 displays a check mark to indicate whether an installation of an item is complete; and field 15326 displays a check mark to indicate whether a user associated with an item is registered.

FIG. 154 is an exemplary screenshot 15400 of a support page (e.g. an Etelos support page) generated by Marketplace module 6122 wherein a vendor or administrator may edit an application information using the field 15402. Using the field 15404, the vendor may view or select the vendor's packaged applications available for editing. Field 15406 displays the names of a vendor's applications available for editing. Field 15408 indicates whether an application has been deployed in Marketplace module 6122. Field 15410 indicates an application type; field 15412 indicates a date where an application was created; field 15414 indicates the grouping information associated with an application; field 15416 indicates an application's version; field 15418 enables a user to archive an application using a check box.

FIG. 155 is an exemplary screenshot of a Marketplace 15500 (e.g. an Etelos Marketplace) generated by Marketplace module 6122. Tab 15502 displays the available storefronts stored by Marketplace database management module 6180. Tab 15504 displays the categories of available applications. Tab 15506 displays the most recent available applications. Tab 15508 displays a list of featured applications. Box 15510 indicates the steps a user takes to install and use the user's applications in a Marketplace.

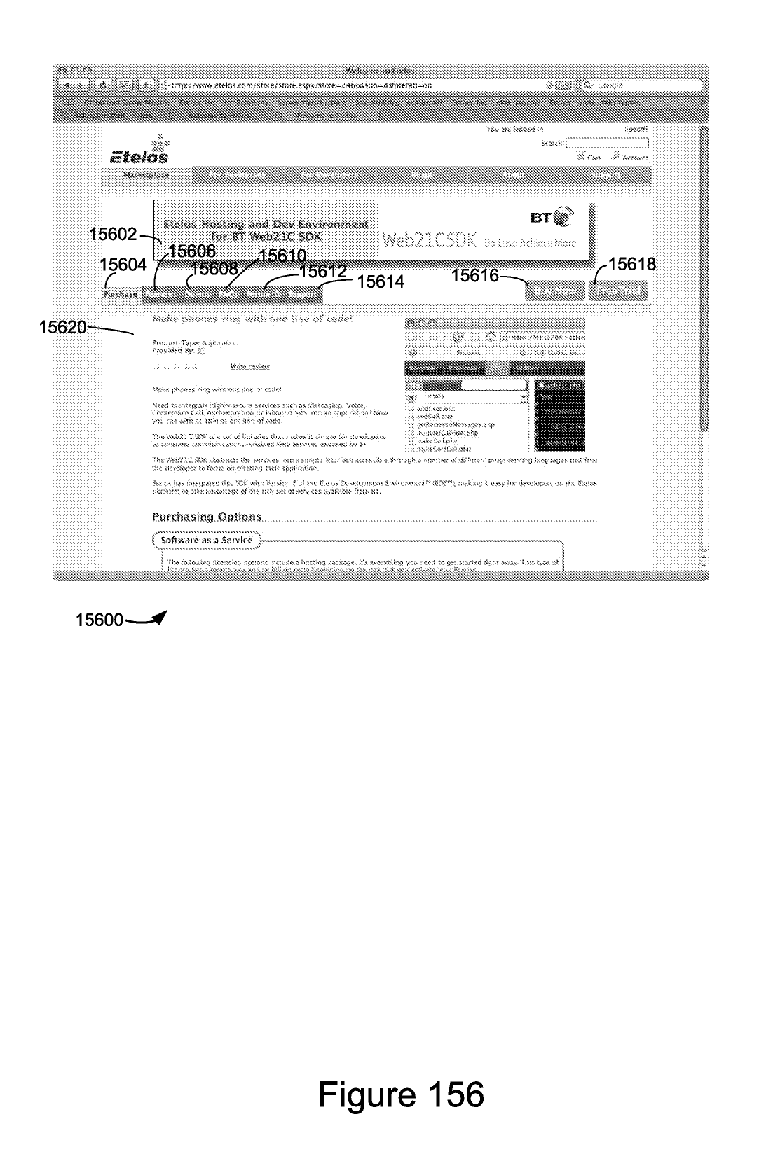

FIG. 156 is an exemplary screenshot 15600 of a hosting and development environment (e.g. an Etelos Hosting and Dev Environment for BT Web21C SDK 15602) wherein a user may purchase/license an application available through Marketplace module 6122. Tab 15604 displays a purchasing information 15620 including purchasing options; tab 15606 displays available features of an application; tab 15608 displays available demos associated with an application; tab 15610 displays FAQs associated with an application; tab 15612 displays available forums associated with an application; tab 15614 displays a support page associated with an application. A user may purchase/license an application by clicking the Buy Now button 15616. A user may obtain a free trial of an application by clicking on a Free Trial button 15618.

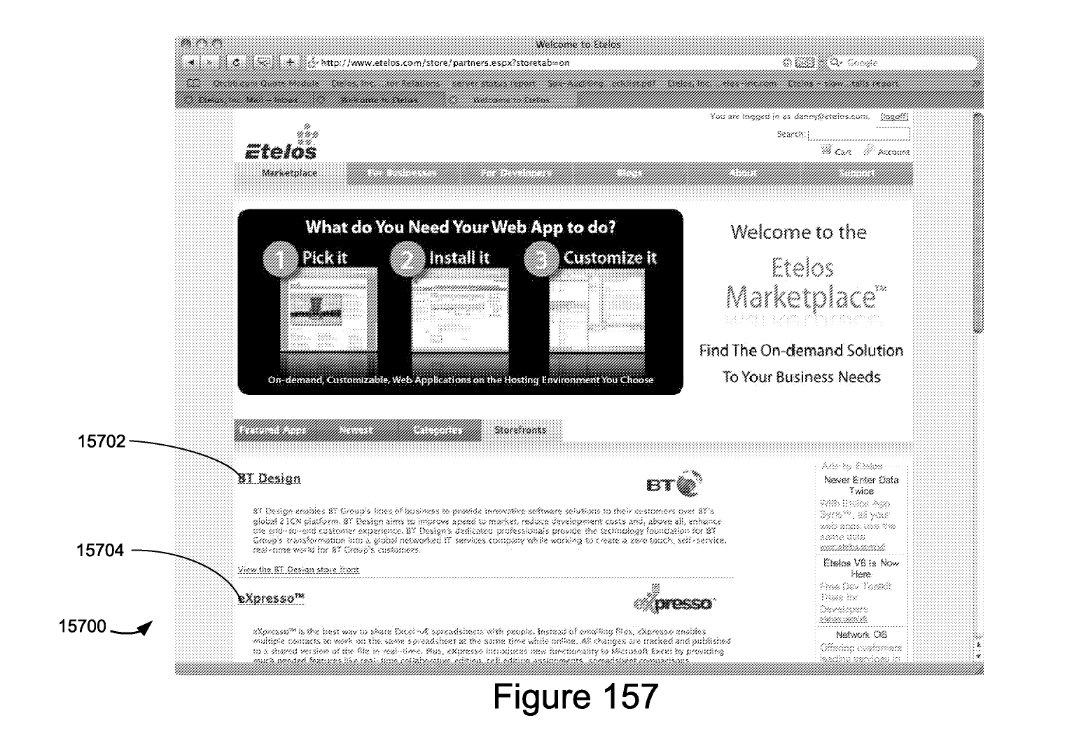

FIG. 157 is an exemplary screenshot of a Marketplace 15700 (e.g. an Etelos Marketplace) generated by Marketplace module 6122. 15702 and 15704 are examples of storefronts available through Marketplace database management module 6180.

FIG. 158 is an exemplary screenshot 15800 of a licensing page. Field 15802 includes licensing terms which a user may accept by clicking the Accept button 15804, or decline by clicking the decline button 15806.

FIG. 159 is an exemplary screenshot 15900 of a support page (e.g. an Etelos support page) generated by Marketplace module 6122 including a user's billing 15902 and transaction 15904 history, including date 15906, order ID 15908, name 15910, description 15912, and price 15914.

FIG. 160 is an exemplary screenshot 16000 of a shopping cart page. Field 16002 displays a date when a purchase/license is occurring; field 16003 provides a description; field 16004 displays a quantity of applications a user is purchasing; field 16006 displays a total cost of items in a user's shopping cart.

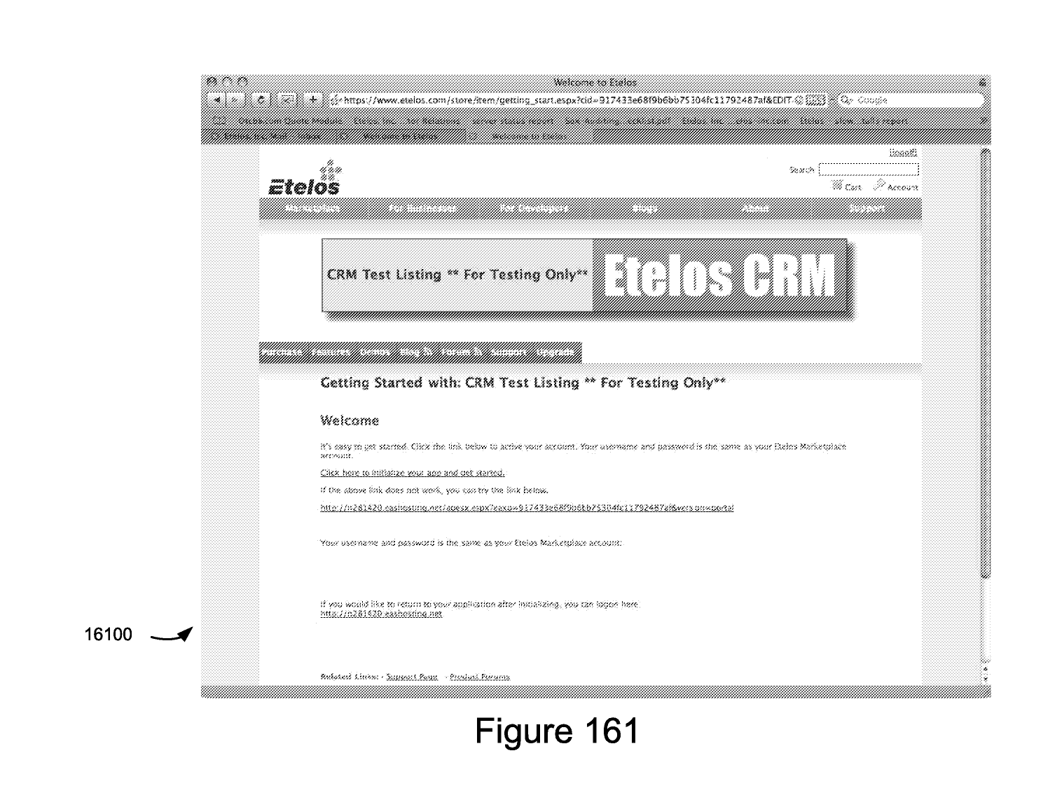

FIG. 161 is an exemplary screenshot 16100 of a Getting Started page for a CRM application listing (e.g. an Etelos CRM test listing page) where a user can initialize an application.

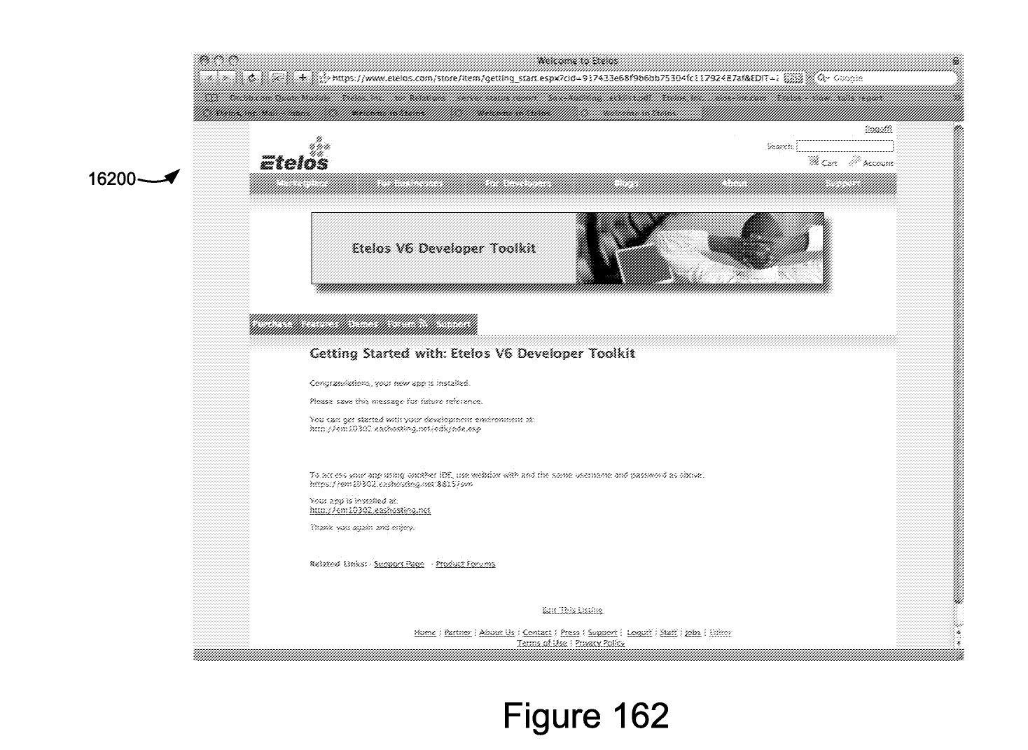

FIG. 162 is an exemplary screenshot 16200 of a Getting Started page for a developer toolkit app (e.g. an Etelos V6 developer toolkit page) where a user can initialize a development environment generated by listing module 6124 to define an application.

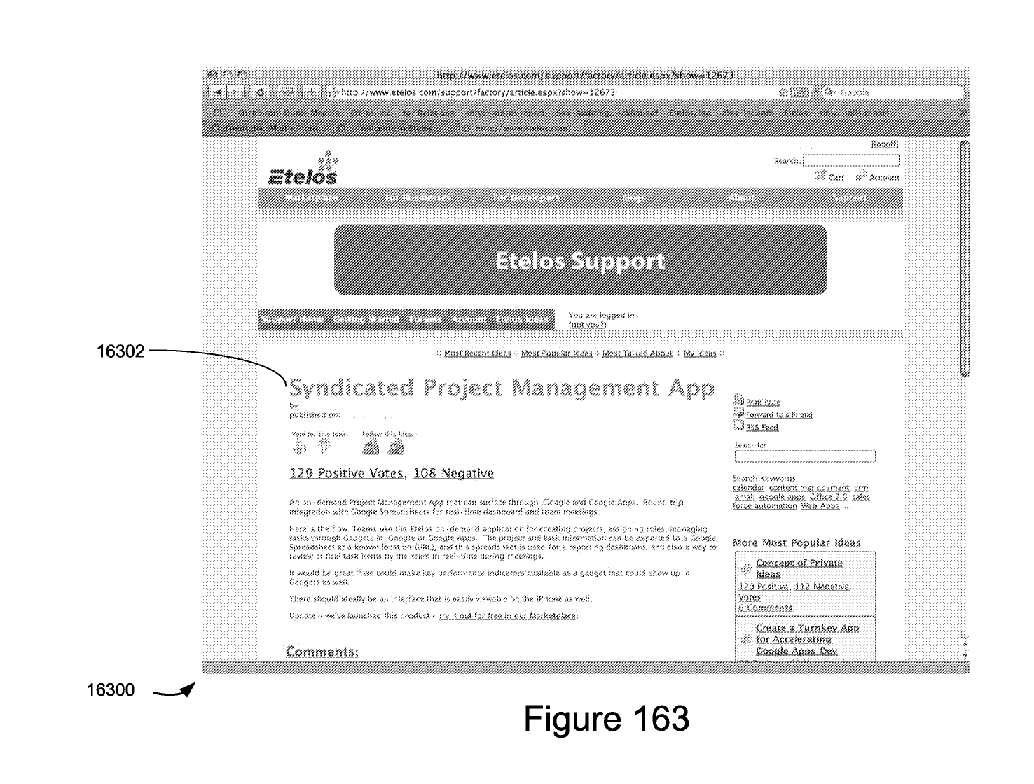

FIG. 163 is an exemplary screenshot 16300 of a support page (e.g. an Etelos support page) generated by marketplace module 6122. Field 16302 describes an exemplary user idea called “Syndicated project management app”. This description is stored by the marketplace database management module 6180.

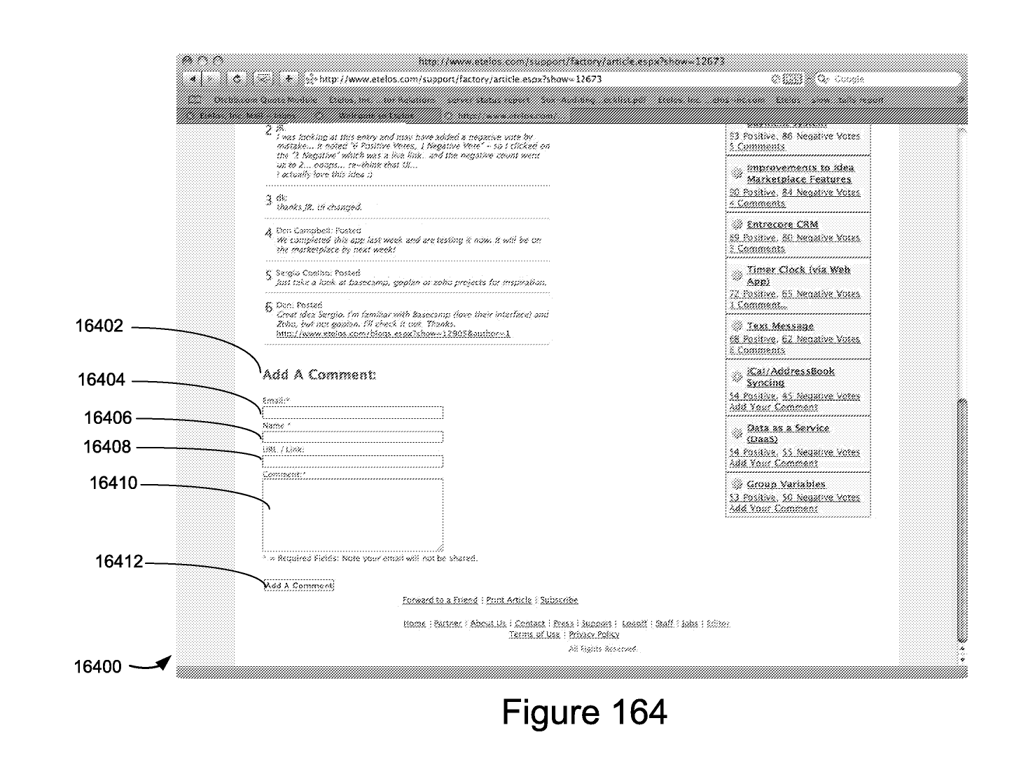

FIG. 164 is an exemplary screen shot 16400 from the bottom portion of the screenshot 16300 in FIG. 163. In field 16402, Add a Comment, a user may add a comment to a user idea reflected in FIG. 163. To add a comment a user enters the user's email address in the field 16404, and the user's name in the field 16406. The user may include a web address in the field 16408. The user can type a comment in the field 16410. The user can add a comment by clicking on the button Add A Comment 16412. These comments are stored by the marketplace database management module 6180.

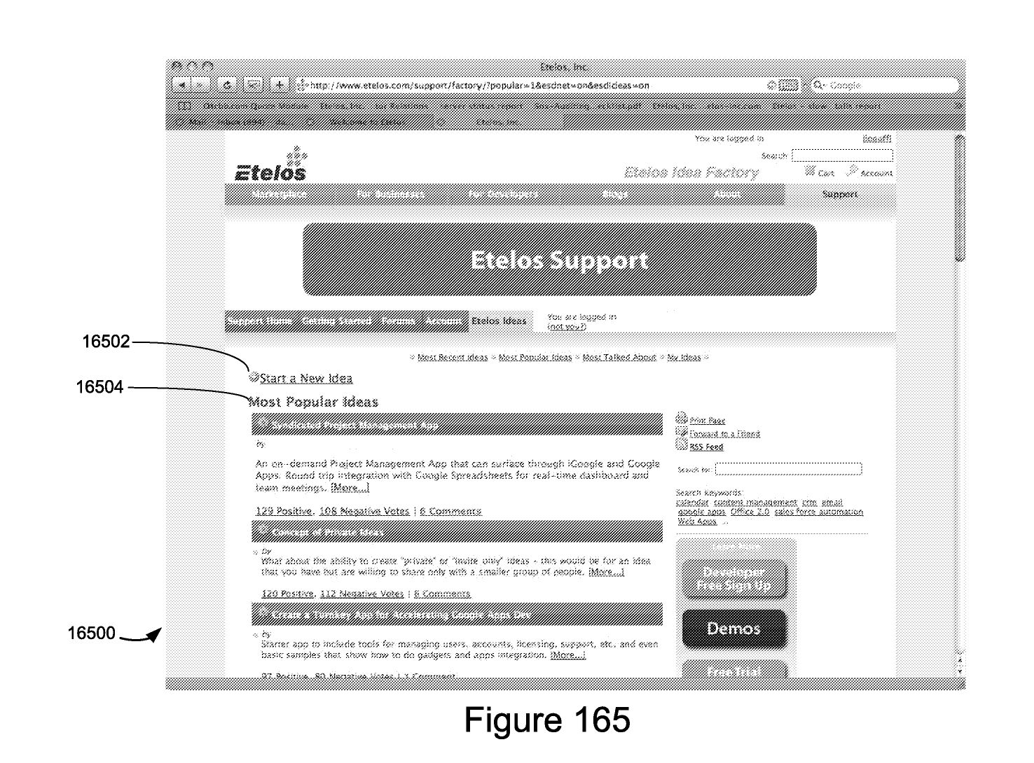

FIG. 165 is an exemplary screenshot 16500 of a support page (e.g. an Etelos support page) generated by marketplace module 6122. Using button 16502, a user may start a new idea. In field 16504, a user may view most popular ideas as voted by other users.

FIG. 166 is an exemplary screenshot 16600 of an installation page generated by application deployer module 1650. Installation in progress page 16602 displays which applications are being installed, estimated install times, status, and progress for each application installation. Field 16604 displays a name of an application being installed; field 16606 displays an estimated time for an application installation; field 16608 displays an installation status; field 16610 displays a progress bar associated with an application installation.

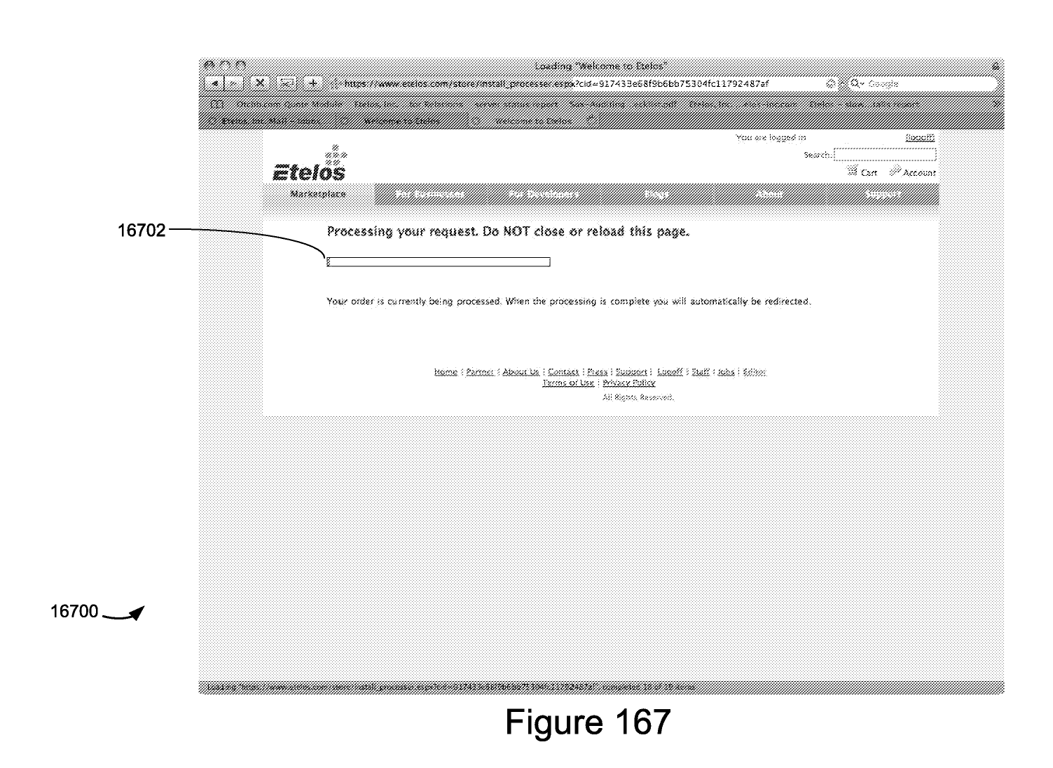

FIG. 167 is an exemplary screenshot 16700 of an installation processing page generated by application deployment module 6150. A progress bar 16702 displays a progress of a user's request for installation. This page is displayed to a user during installation of a software application.

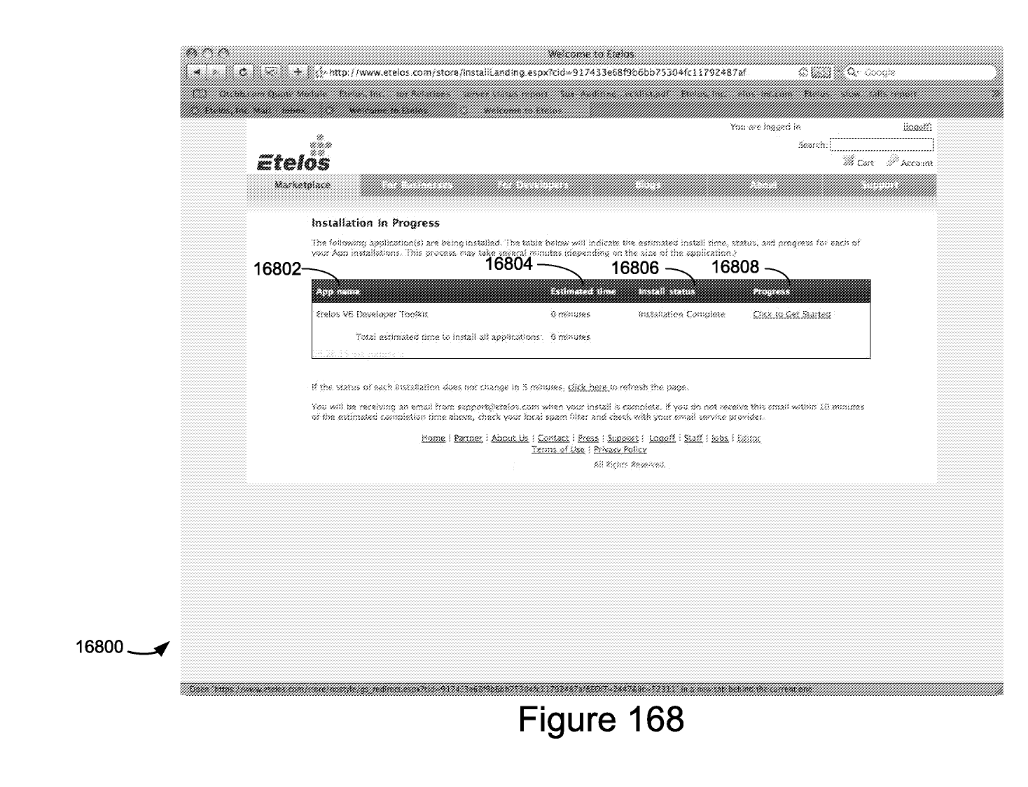

FIG. 168 is an exemplary screenshot 16800 of an installation processing page similar to FIG. 166. This page shows that the installation has completed (16806) and gives a link to get started (16808) with the deployed application.

FIG. 169 is an exemplary screenshot 16900 of a support page (e.g. an Etelos support page) generated by marketplace module 6122. This page is presented to a user when configuring accounts and applications. My developer accounts 16902 enables a user to select an account name to edit its properties, or add an account manually. Drop down menu 16904 enables a user to choose the type of account to generate. Button “Build an App” 16906 enables a user to build an application for a particular account in the list of developer accounts 16902. Button “Add Domain” 16908 enables a user to add a domain associated with an application.

FIG. 170 is an exemplary screenshot 17000 of a support page (e.g. an Etelos support page) generated by marketplace module 6122. This page is displayed to a user when configuring their account to run software apps. Payment information 17002 displays an account payment information. In one embodiment payment information field 17004 includes the last four digits of a credit card number associated with an account.

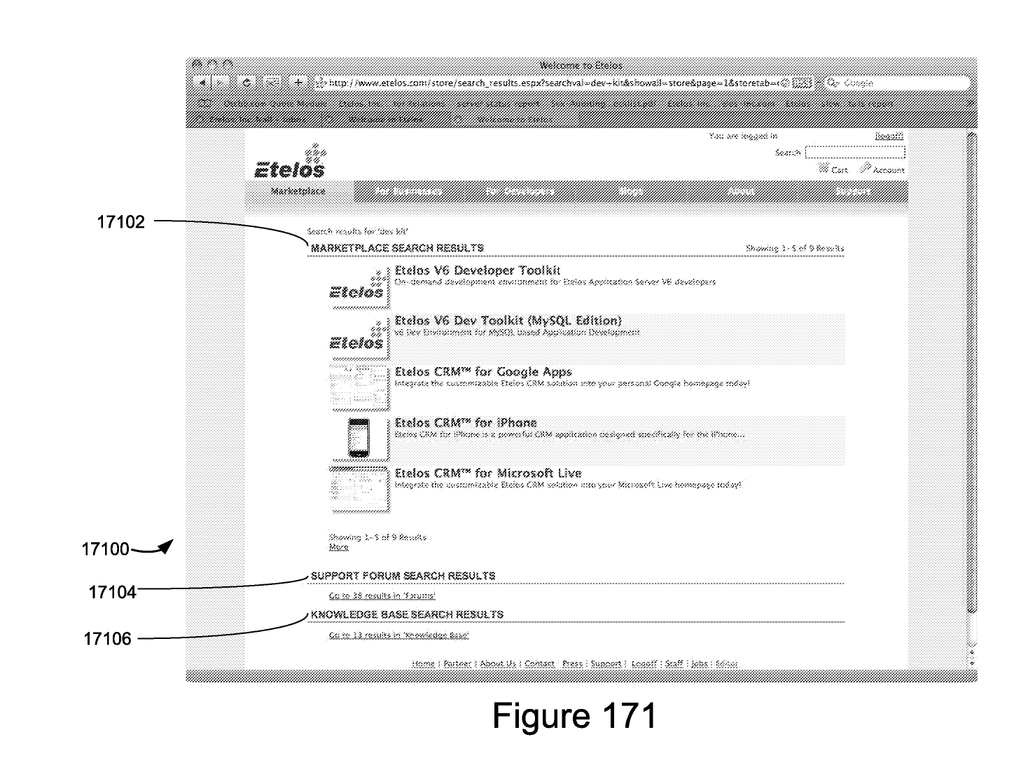

FIG. 171 is an exemplary screenshot 17100 of a marketplace page, generated by marketplace module 6122. This page is presented to a user searching for software applications in the marketplace. Marketplace search result 17102 displays the results for an exemplary search. Support forum search results 17104 provides a link to search results in Marketplace forum stored in Marketplace database management module 6180. Knowledge base search result 17106 provides a link to search results in Marketplace knowledge base stored in Marketplace database management module 6180.

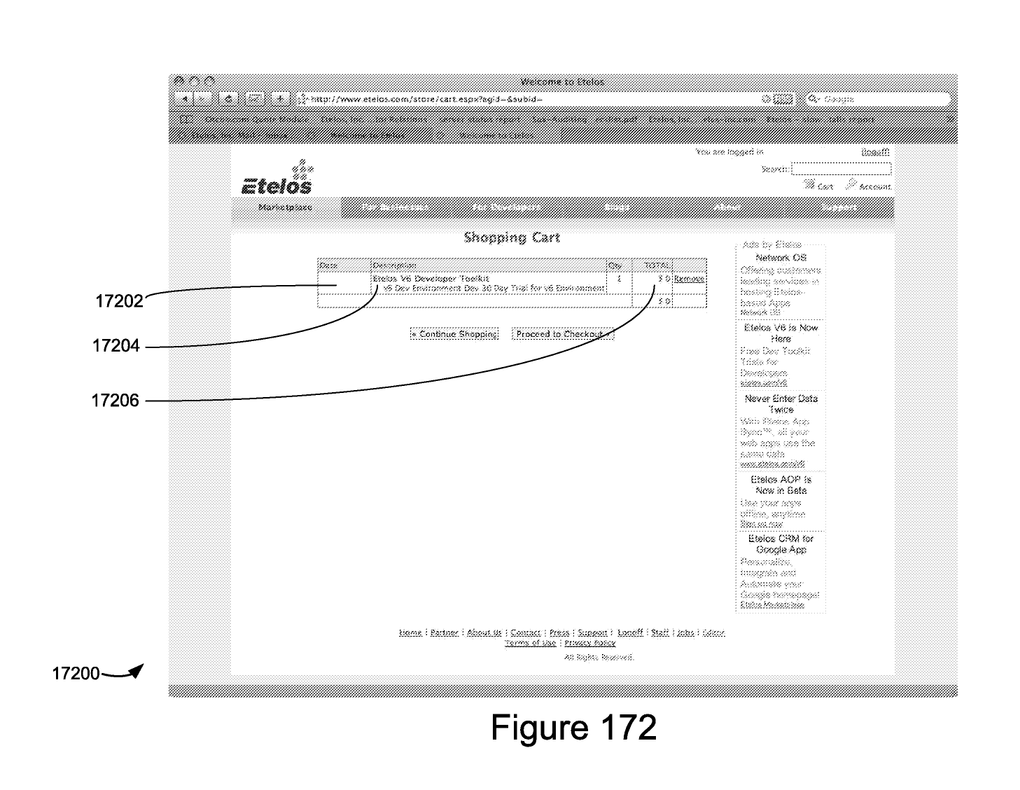

FIG. 172 is an exemplary screenshot 17200 of a marketplace shopping cart page, generated by marketplace module 6122, similar to FIG. 141. This screen shows a shopping cart with a software application for licensing, displayed to a prospective licensee.

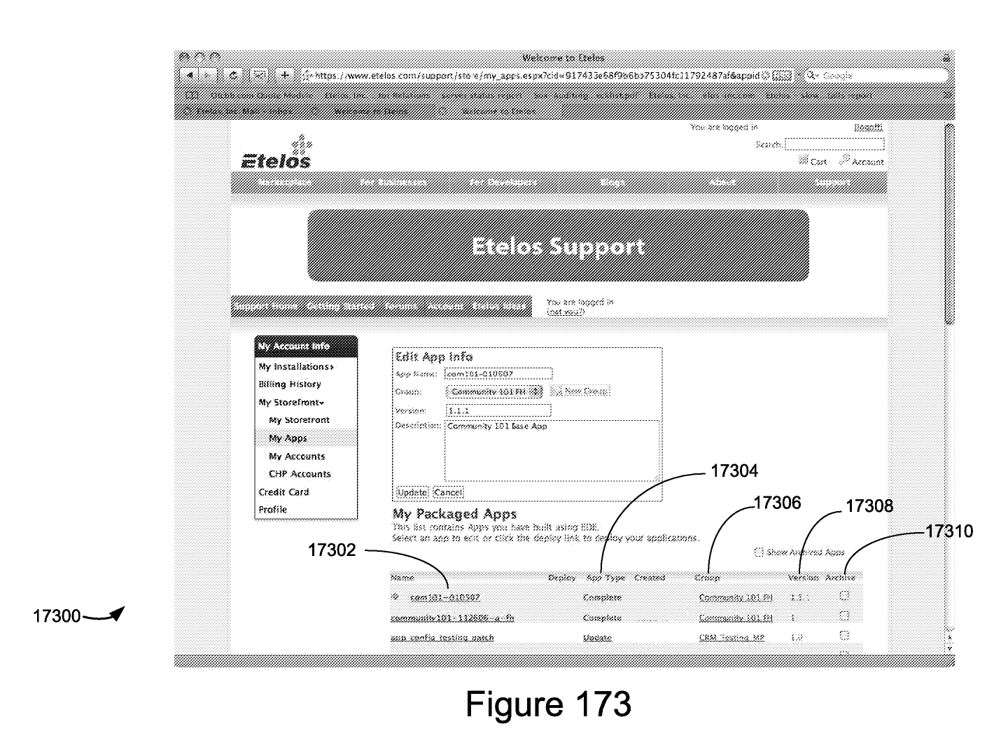

FIG. 173 is an exemplary screenshot 17300 of a support page (e.g. an Etelos Support page) generated by Marketplace module 6122 displayed to a user, so the user can edit an application or deploy an application. Field 17302 displays names of available applications; field 17304 displays the application type associated with an application; field 17306 displays the grouping information associated with an application; field 17308 displays an application version managed by the packager module 6136. A user may archive an application by checking the checkboxes in field 17310.

FIG. 174 is an exemplary screenshot 17400 of a support page (e.g. an Etelos Support page) generated by Marketplace module 6122, wherein a user can learn about an application by reviewing the information in a knowledge base (e.g. an Etelos knowledge base). This knowledge base information is managed by marketplace database management module 6180.

FIG. 175 is an exemplary screenshot 17500 of a support page (e.g. an Etelos Support page) generated by Marketplace module 6122 wherein installation of software application information associated with a user's account is displayed. Field 17502 displays install dates; field 17504 displays product information; field 17506 displays licensing information; field 17508 provides links to more installation information; field 17510 includes buttons for a user to cancel an installation or reinstall an installation.

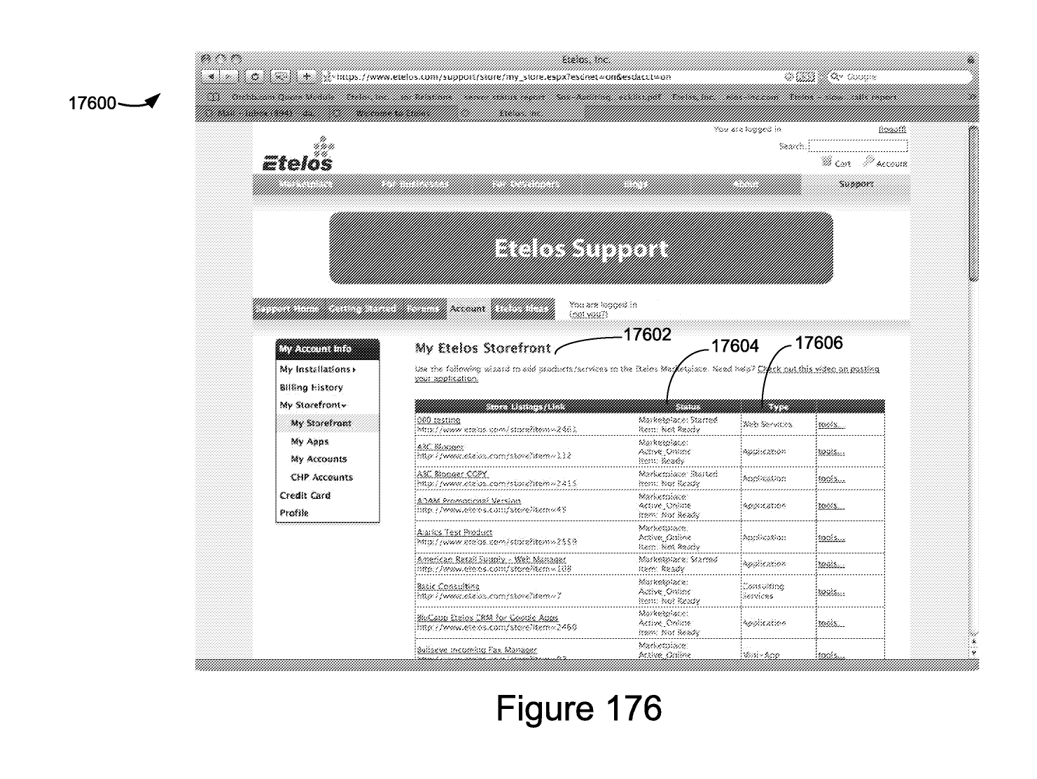

FIG. 176 is an exemplary screenshot 17600 of a support page (e.g. an Etelos Support page) similar to FIG. 129 generated by marketplace module 6122.

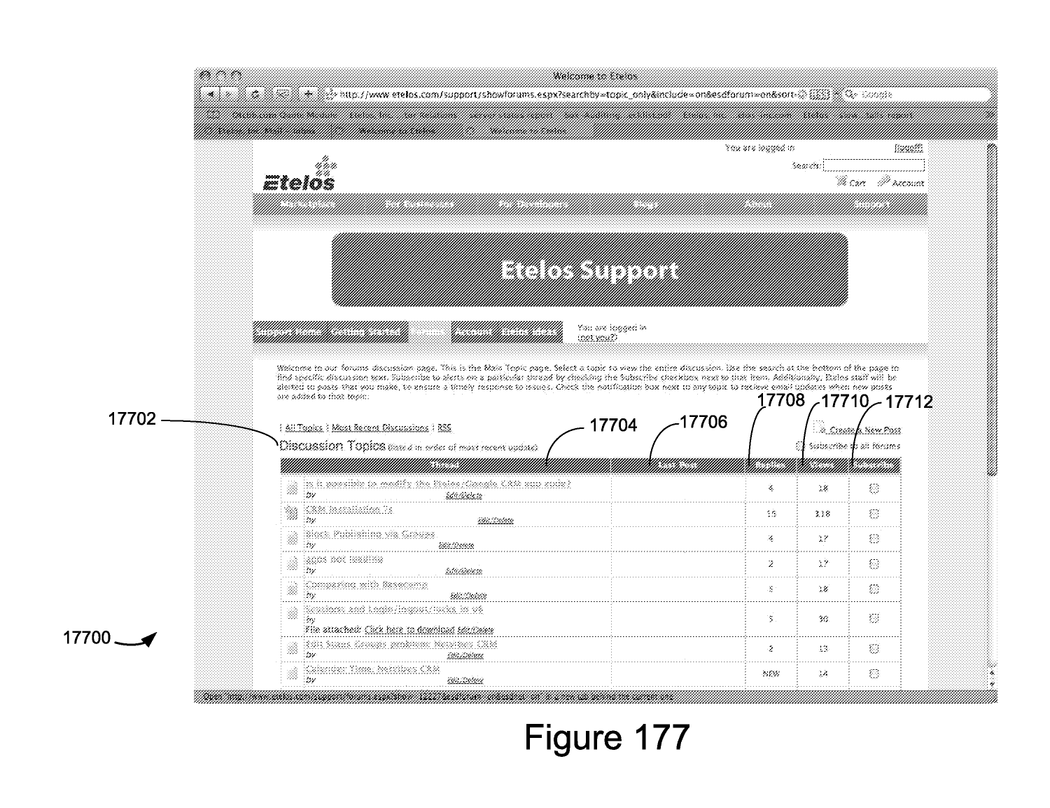

FIG. 177 is an exemplary screenshot 17700 of a support page (e.g. an Etelos Support page) generated by marketplace module 6122. Discussion topics 17702 includes topics available in a forum page stored by marketplace database management module 6180. Column 17704 includes discussion topics threads; column 17706 displays a date on which a forum thread was last posted; column 17708 displays number of replies to a forum thread; column 17710 displays number of times a forum thread has been viewed; column 17712 enables a user to subscribe to a forum thread by checking a checkbox.

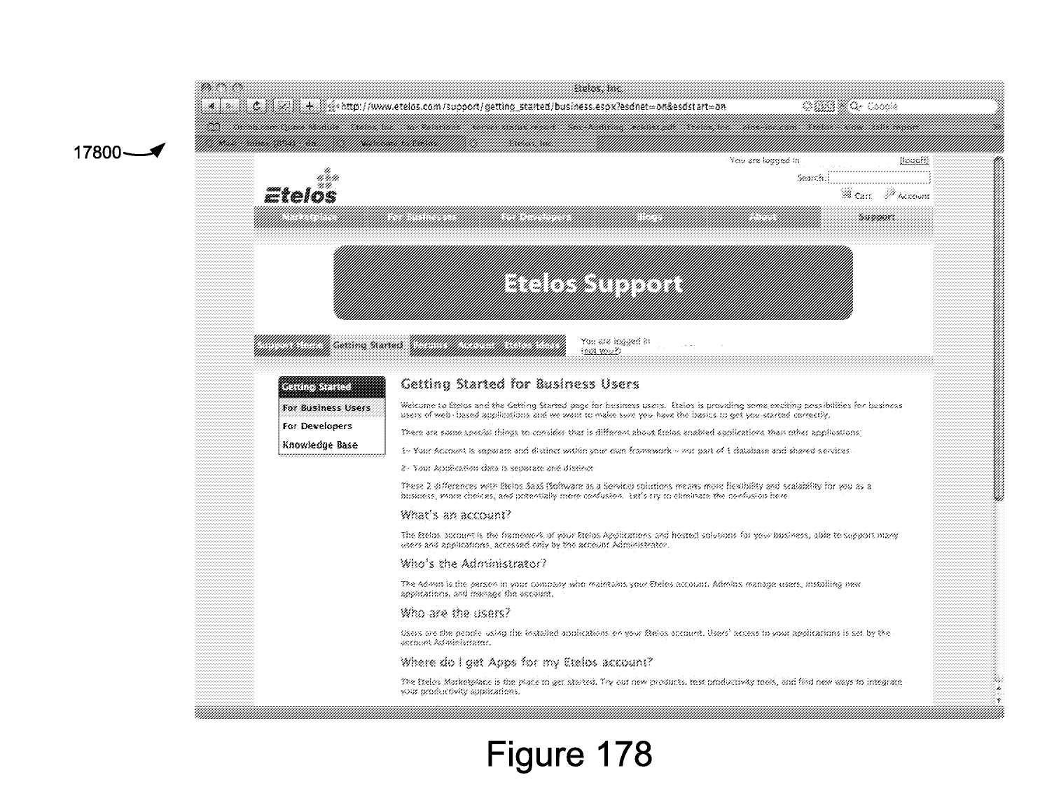

FIG. 178 is an exemplary screenshot 17800 of a support page (e.g. an Etelos Support page) generated by Marketplace module 6122 that includes information on getting started for business users. This page is displayed to a user seeking support information regarding an application.

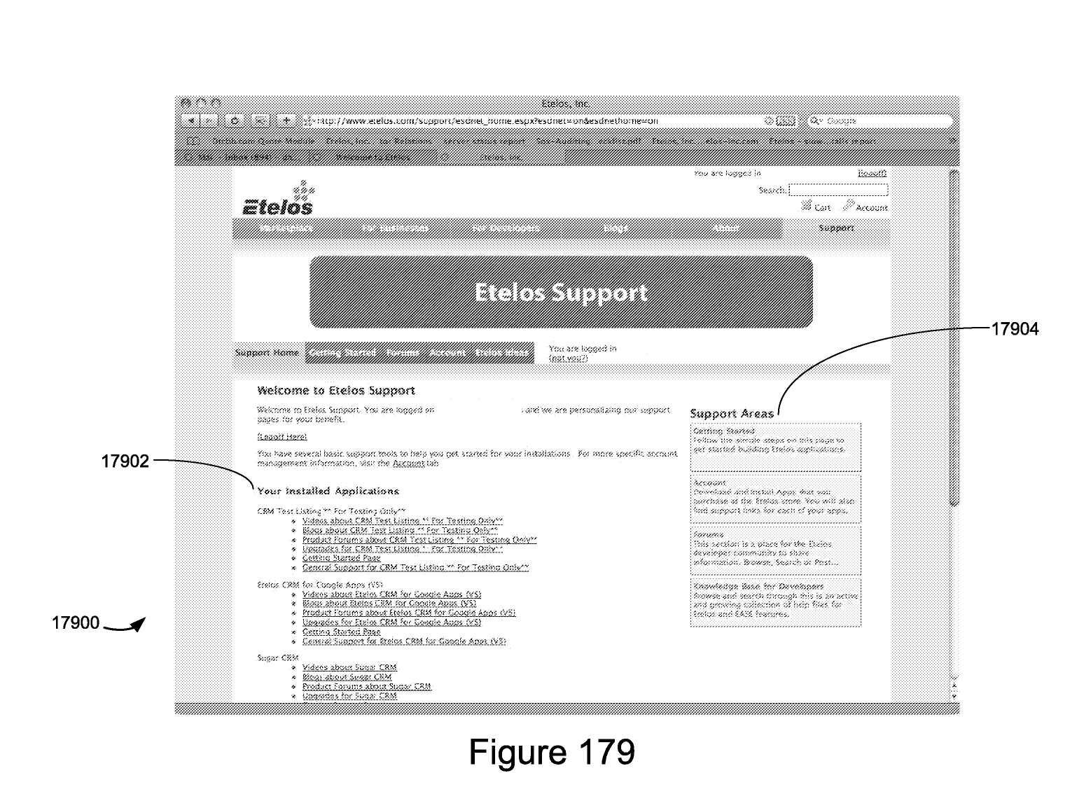

FIG. 179 is an exemplary screenshot 17900 of a support page (e.g. an Etelos Support page) generated by Marketplace module 6122. Your installed applications 17902 enables a user to view the user's installed applications. Field 17904 includes links to other support areas e.g. getting started, account, forums, or knowledge base.

FIG. 180 is an exemplary screenshot 18000 of a support page (e.g. an Etelos Support page) generated by Marketplace module 6122. Field 18002 includes information on an exemplary web developing application called EASE made available through Marketplace module 6122. This page is accessed by an application developer/vendor using the marketplace (e.g. Etelos system).

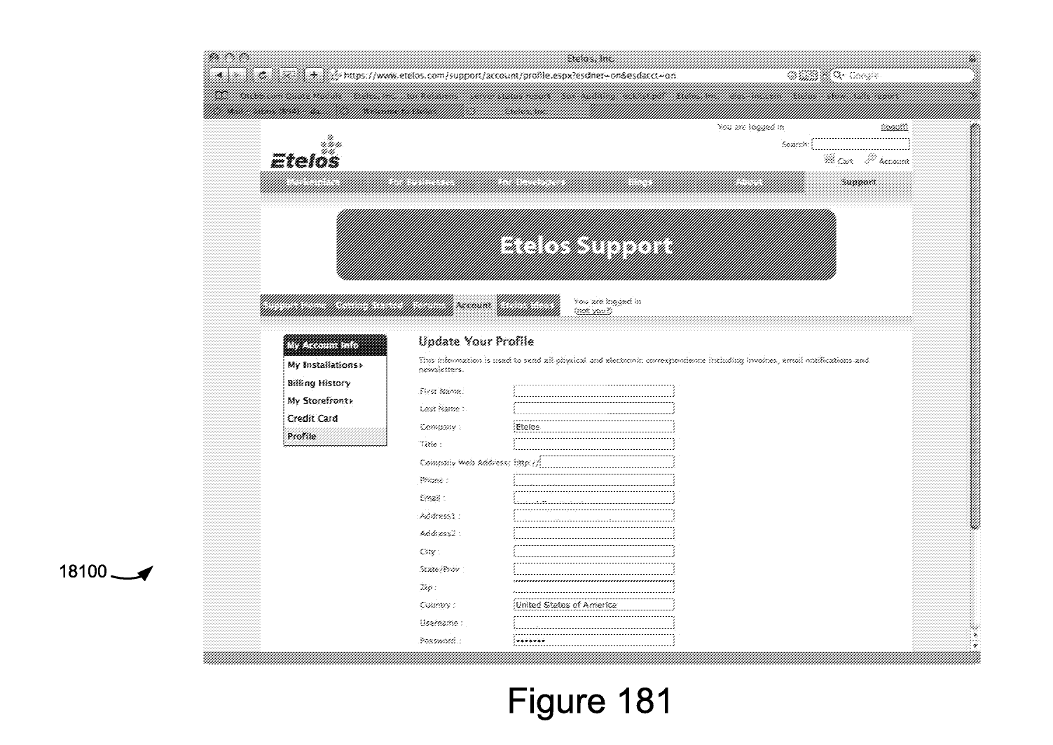

FIG. 181 is an exemplary screenshot 18100 of a support page (e.g. an Etelos Support page) generated by Marketplace module 6122 wherein a user can modify the user's profile information. The information entered here is stored by user account access module 6172.

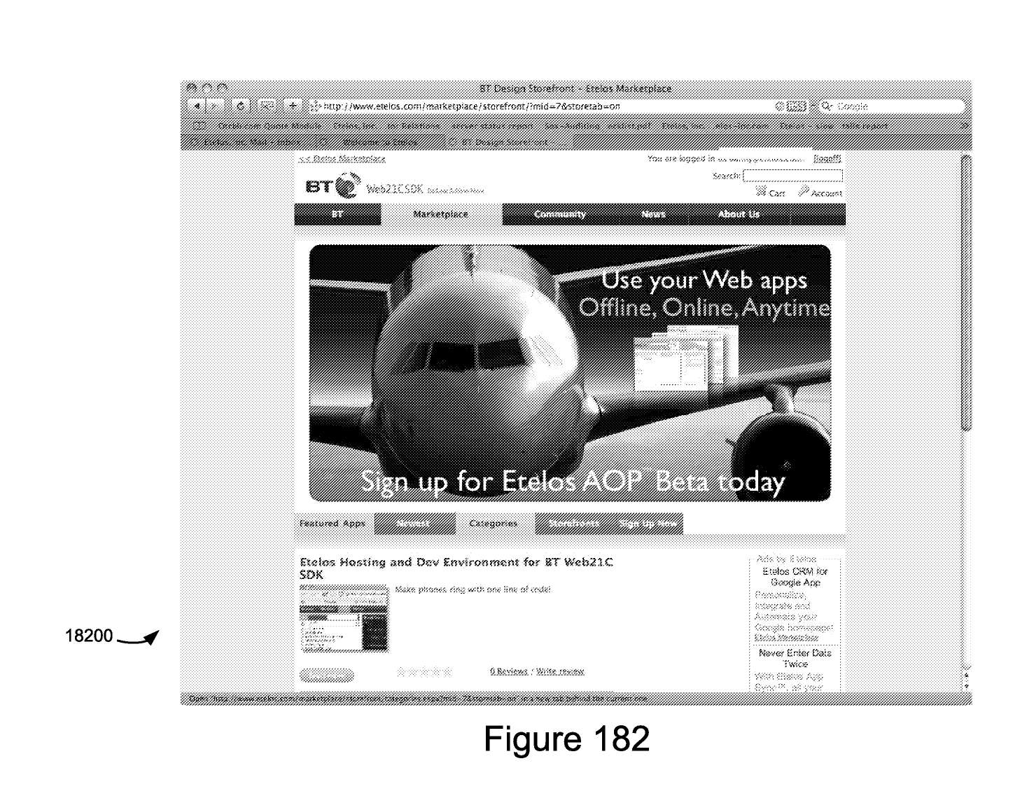

FIG. 182 is an exemplary screenshot 18200 of a Marketplace homepage, generated by marketplace module 6122.

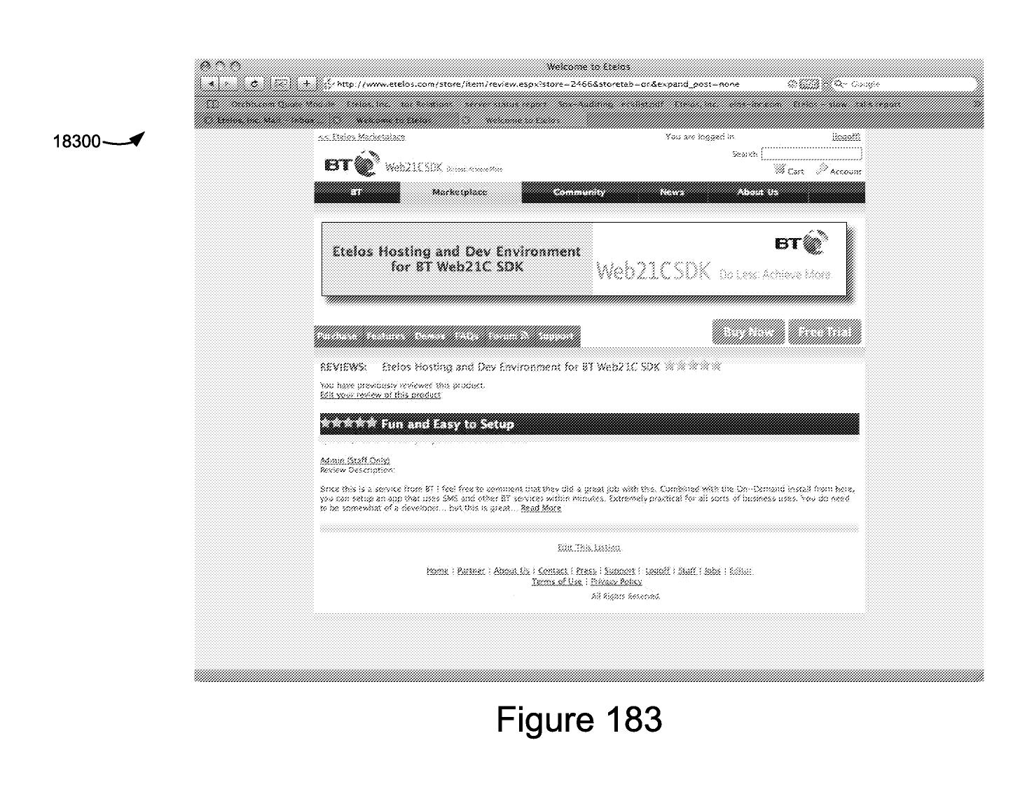

FIG. 183 is an exemplary screenshot 18300 of a Marketplace page, generated by marketplace module 6122, where an application is displayed for sale (e.g. Etelos Hosting and Dev Environment for BT Web21C SDK). This page shows reviews by users and a description of software applications.

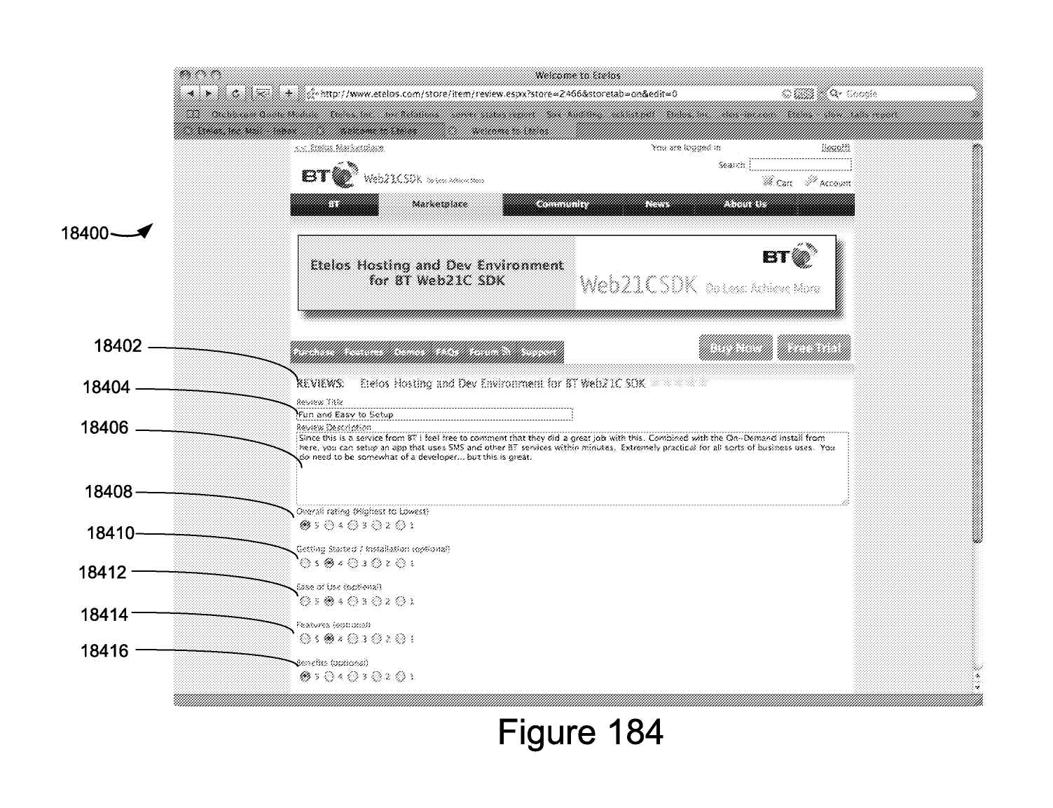

FIG. 184 is an exemplary screenshot 18400 of a Marketplace page, generated by marketplace module 6122, where an application is displayed for sale (e.g. Etelos Hosting and Dev Environment for BT Web21C SDK). In field Reviews 18402, a user may post a review associated with an application. In field 18404 the user may type a title for the user's review; in field 18406 the user may type the text of the user's review. Radio buttons 18408-18416 enable the user to rate the user's satisfaction with different aspects of Marketplace services.

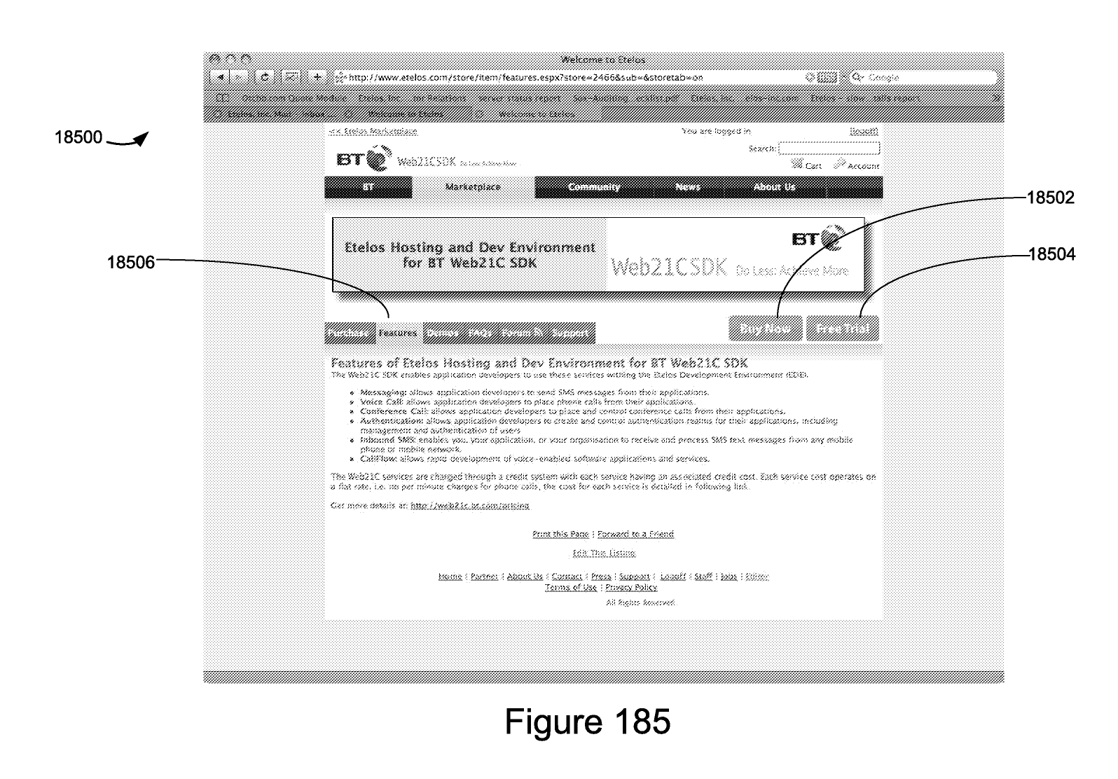

FIG. 185 is an exemplary screenshot 18500 of a Marketplace page, generated by marketplace module 6122, where an application is displayed for sale (e.g. Etelos Hosting and Dev Environment for BT Web21C SDK). A user may purchase/license an application by clicking the button 18502 labeled Buy Now. A user may purchase/license a free trial of an application by clicking the button 18504 labeled Free Trial. The features tab 18506 is activated wherein information about features of the application are displayed.

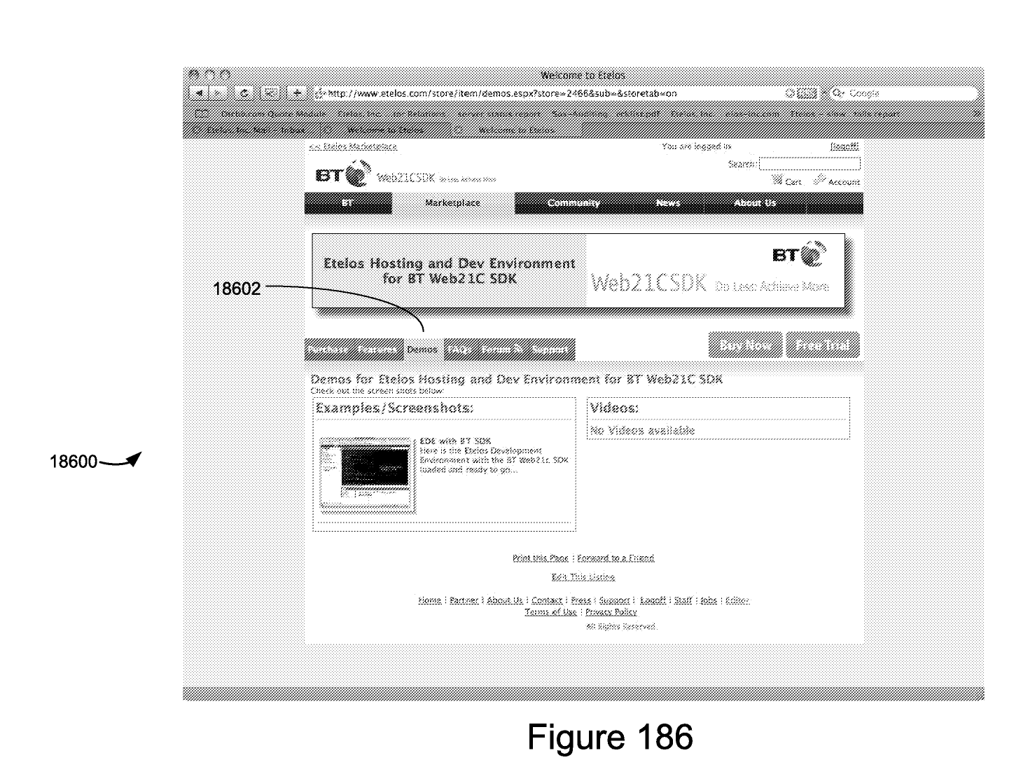

FIG. 186 is an exemplary screenshot 18600 of a Marketplace page, generated by marketplace module 6122, where an application is displayed for sale (e.g. Etelos Hosting and Dev Environment for BT Web21C SDK). A demos tab 18602 shows videos or screenshots of the application. This screen is displayed to a user looking for information about a software application.

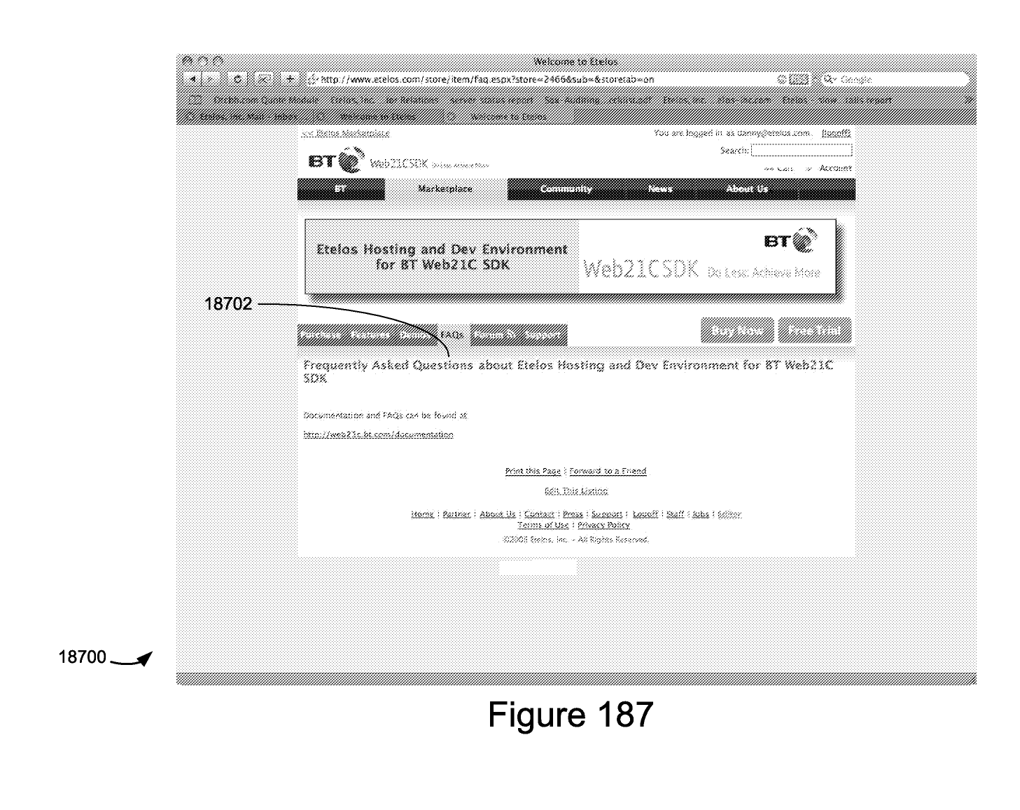

FIG. 187 is an exemplary screenshot 18700 of a Marketplace page, generated by marketplace module 6122, where an application is displayed for sale (e.g. Etelos Hosting and Dev Environment for BT Web21C SDK) and the FAQs tab 18702 is activated wherein user's frequently asked questions associated with the application are displayed.

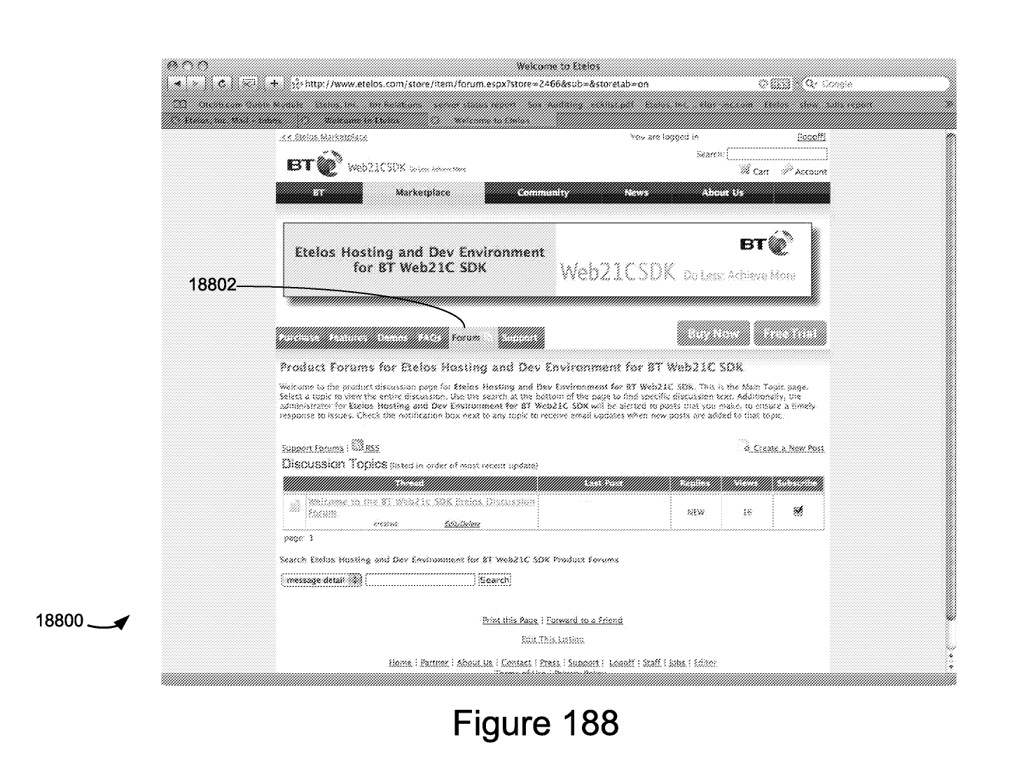

FIG. 188 is an exemplary screenshot 18800 of a Marketplace page, generated by marketplace module 6122, where an application is displayed for sale (e.g. Etelos Hosting and Dev Environment for BT Web21C SDK) and the forum tab 18802 is activated wherein forum discussions associated with the application are displayed.

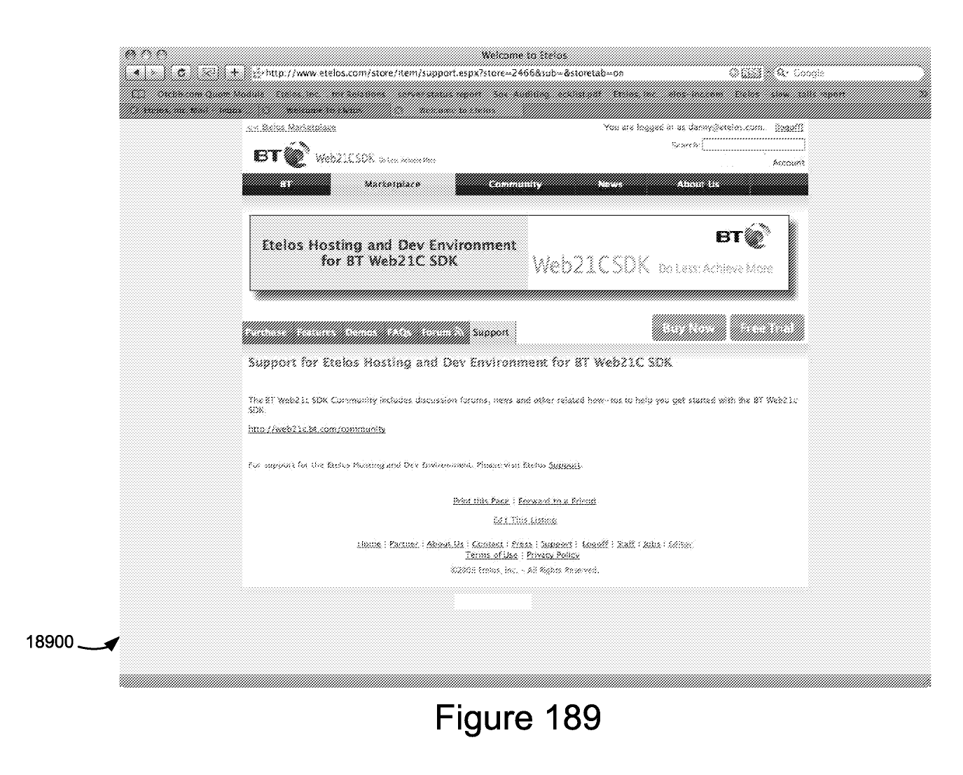

FIG. 189 is an exemplary screenshot 18900 of a Marketplace page, generated by marketplace module 6122, where an application is displayed for sale (e.g. Etelos Hosting and Dev Environment for BT Web21C SDK) and the support tab 18902 is activated wherein the support information associated with the application is displayed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Start of 5006: Software Marketplace and Distribution System Support for Foreign Prosecution.

1. A computer implemented method, comprising:

at one or more servers, hosting a marketplace application:

receiving from a vendor a software application for distribution;

associating license terms with the software application;

making the software application available for distribution through the marketplace application; and

deploying the software application to one or more user accounts on one or more hosting servers, in accordance with the license terms.

2. The computer-implemented method of claim 1, further comprising presenting a description of the license terms to a user.

3. The computer-implemented method of claim 1, wherein the on one or more hosting servers are physically separate from the one or more servers hosting the marketplace application.

4. The computer-implemented method of claim 1, wherein the deploying is performed after a user request to deploy the software application.

5. The computer-implemented method of claim 1, wherein the deploying includes downloading the software to the one or more user accounts.

6. The computer-implemented method of claim 1, wherein the deploying includes activating a flag associated with the software application in the one or more user accounts.

7. The computer-implemented method of claim 6, where the flag enables for user the software application.

8. The computer-implemented method of claim 1, wherein the deploying includes activating a license for the software application in the one or more user accounts.

9. The computer-implemented method of claim 1, wherein the deploying includes providing the software application for hosting by a user on hosting servers associated with the user.

10. The computer-implemented method of claim 1, wherein distribution to a user through the marketplace application includes through a website associated with the marketplace application.

11. The computer-implemented method of claim 1, wherein distribution to a user through the marketplace application includes through a client associated with the marketplace application.

12. The computer-implemented method of claim 1, comprising packaging the software application for distribution via the marketplace application hosted by the one or more servers.

13. The computer-implemented method of claim 12, comprising storing a packaged software application in an application repository.

14. The computer implemented method of claim 12 wherein packaging includes preparing an update to a previously deployed software application, where the update requires the previously deployed software application to function.

15. The computer implemented method of claim 12 wherein packaging includes preparing a standalone distribution for a software application.

16. The computer implemented method of claim 15 wherein the standalone distribution includes a software application and one or more updates to the application.

17. The computer implemented method of claims 14, 15, 16 wherein the update is deployed to the one or more user accounts selected from the group consisting of a push method, a subscription (pull) method, and a hybrid method, in accordance with the license terms.

18. The computer-implemented method of claim 1, wherein the making available is performed by a listing manager.

19. The computer implemented method of claim 18 wherein the listing manager includes a store listing for licensing the software application.

20. The computer-implemented method of claim 1, wherein the deploying is performed by an application deployer.

21. The computer-implemented method of claim 1, comprising hosting the deployed software application for the one or more user accounts.

22. The computer implemented method of claims 1 or 19 wherein the marketplace application includes technical support for the software application.

23. The computer implemented method of claims 1, 19 or 22, wherein making the software application available for distribution includes at least one selected from the group consisting of: determining a user account type, and based on the user account type, preparing to deploy a software application to the user account, or generating a new user account compatible with the software application and preparing to deploying the software application to the new user account.

24. A server system, comprising:

one or more processors;

memory; and

one or more programs stored in the memory, the one or more programs comprising instructions for at one or more servers, host a marketplace application:

receiving from a vendor a software application for distribution;

associate license terms with the software application;

make the software application available for distribution through the marketplace application; and

deploy the software application to one or more user accounts on one or more hosting servers, in accordance with the license terms.

25. The server system of claim 24, further comprising instructions to present a description of the license terms to a user.

26. The server system of claim 24, wherein the on one or more hosting servers are physically separate from the one or more servers hosting the marketplace application.

27. The server system of claim 24, wherein the instructions to deploy include instructions to deploy the software application after a user request.

28. The server system of claim 24, wherein the instructions to deploy include instructions to download the software to the one or more user accounts.

29. The server system of claim 24, wherein the instructions to deploy include instructions to activate a flag associated with the software application in the one or more user accounts.

30. The server system of claim 29, where the flag enables for user the software application.

31. The server system of claim 24, wherein the instructions to deploy include instructions to activate a license for the software application in the one or more user accounts.

32. The server system of claim 24, wherein the instructions to deploy include instructions to provide the software application for hosting by a user on hosting servers associated with the user.

33. The server system of claim 24, wherein the instructions to distribute to a user through the marketplace application includes instructions to distribute through a website associated with the marketplace application.

34. The server system of claim 24, wherein the instructions to distribute to a user through the marketplace application includes instructions to distribute through a client associated with the marketplace application.

35. The server system of claim 24, comprising instructions to package the software application for distribution via the marketplace application hosted by the one or more servers.

36. The server system of claim 35, comprising instructions to store a packaged software application in an application repository.

37. The server system of claim 35 wherein instructions to package include instructions to prepare an update to a previously deployed software application, where the update requires the previously deployed software application to function.

38. The server system of claim 35 wherein instructions to package include instructions to preparing a standalone distribution for a software application.

39. The server system of claim 38 wherein the standalone distribution includes a software application and one or more updates to the application.

40. The server system of claims 37, 38 or 39 where the update is deployed to the one or more user accounts selected from the group consisting of a push method, a subscription (pull) method, and a hybrid method, in accordance with the license terms.

41. The server system of claim 24, wherein the instructions to make available includes instructions for a listing manager.

42. The server system of claim 41 wherein the listing manager includes a store listing for licensing the software application.

43. The server system of claim 24, wherein the instructions to deploy include instructions for an application deployer.

44. The server system of claim 24, comprising instructions to host the deployed software application for the one or more user accounts.

45. The server system of claim 24 or 42 wherein the marketplace application includes technical support for the software application.

46. The server system of claim 24, 42, or 45, wherein instructions to make the software application available for distribution includes instructions for at least one selected from the group consisting of: determining a user account type, and based on the user account type, preparing to deploy a software application to the user account, or generating a new user account compatible with the software application and preparing to deploying the software application to the new user account.

47. A computer readable storage medium storing one or more programs configured for execution by a computer, the one or more programs comprising instructions to at one or more servers, hosting a marketplace application:

receive from a vendor a software application for distribution;

associate license terms with the software application;

make the software application available for distribution through the marketplace application; and

deploy the software application to one or more user accounts on one or more hosting servers, in accordance with the license terms.

48. A computer implemented method, comprising:

at one or more marketplace servers hosting a marketplace application, in response to a request from a syndicated server to distribute a software application from the marketplace:

identifying one or more user accounts associated with the request;

verifying that the one or more user accounts has permission to use the software application; and

deploying the software application to the one or more user accounts, in accordance with license terms associated with the software application.

49. The computer-implemented method of claim 48, wherein deploying includes presenting for deployment to a user.

50. The computer-implemented method of claim 48, comprising making the software application available for distribution through the syndicated server.

51. The computer-implemented method of claim 48 or 49, wherein deploying includes providing through an application deployer, across a network to the one or more user accounts, a software application stored at the application repository.

52. The computer-implemented method of claim 51, wherein deploying includes selecting one of a plurality of software applications, compatible with the one or more user accounts, from the application repository.

53. The computer-implemented method of claim 51 or 52, wherein the application repository stores software applications in a plurality of states, including at least one selected from the group consisting of a ready to deploy state, an undergoing quality assurance state, a ready to submit for quality assurance state, and an unfinished state.

54. A server system, comprising:

one or more processors;

memory; and

one or more programs stored in the memory, the one or more programs comprising instructions to at one or more marketplace servers hosting a marketplace application, in response to a request from a syndicated server to distribute a software application from the marketplace:

identify one or more user accounts associated with the request;

verify that the one or more user accounts has permission to use the software application; and

deploy the software application to the one or more user accounts, in accordance with license terms associated with the software application.

55. The server system of claim 54, wherein instructions to deploy include instructions to present for deployment to a user.

56. The server system of claim 54, further comprising instructions to make the software application available for distribution through the syndicated server.

57. The server system of claim 54 or 55, wherein instructions to deploy include instructions to provide through an application deployer, across a network to the one or more user accounts, a software application stored at the application repository.

58. The server system of claim 57, wherein instructions to deploy include instructions to select one of a plurality of software applications, compatible with the one or more user accounts, from the application repository.

59. The server system of claim 57 or 58, wherein the application repository stores software applications in a plurality of states, including at least one selected from the group consisting of a ready to deploy state, an undergoing quality assurance state, a ready to submit for quality assurance state, and an unfinished state.

60. A computer readable storage medium storing one or more programs configured for execution by a computer, the one or more programs comprising instructions for at one or more marketplace servers hosting a marketplace application, in response to a request from a syndicated server to distribute a software application from the marketplace:

identifying one or more user accounts associated with the request;

verifying that the one or more user accounts has permission to use the software application; and

deploying the software application to the one or more user accounts, in accordance with license terms associated with the software application.

Data Structure for purchasing, deploying, hosting programs:

61. A computer system, comprising:

one or more processors;

memory; and

one or more programs stored in the memory, the one or more programs comprising instructions for implementing:
a program module configured to provide a software application for distribution in response to an access request from a user;
a program module configured to receive and deploy the software application from the marketplace module to an account on one or more servers; and
a program module configured to provide at least one or more user accounts, from which the user accesses the software application.

62. The system of claim 61, wherein the one or more user accounts receives a link to the deployed software application, wherein the link permits the one or more user accounts to access the deployed software application.

63. The system of claim 61, wherein the program module configured to provide a software application for distribution is a marketplace module.

64. The system of claim 61, wherein the program module configured to provide at least one or more user accounts is a one or more user accounts module

65. The system of claim 61, wherein the program module configured to receive and deploy a software application to the one or more user accounts module is a deployment module.

66. The system of claim 61, comprising an application repository storing software applications ready for distribution.

67. The system of claim 61, comprising a licensing module configured to provide a license associated with the software application, and to ensure that the deploying is performed in accordance with the license.

68. The system of claim 64, wherein the licensing module is configured to verify user permission to access a deployed software application prior to executing the application.

69. The system of claim 61, comprising a billing module configured to receive payment associated with the one or more user accounts for deployment of the selected software application.

70. The system of claim 69, wherein the billing module is configured to receive subscription payments associated with the one or more user accounts.

71. The system of claim 69, wherein an amount of the payment varies in accordance with license terms associated with the software application.

72. The system of claim 69, wherein the billing module is configured to receive from the user a promotional code prior to processing a payment, and the billing module is configured to process the payment based on the promotional code.

73. The system of claim 61, comprising a listing manager module for managing marketplace content related to the software application.

74. The system of claim 61, comprising a deployer module for accessing the software application from the application repository and deploying the software application in the hosting infrastructure module.

75. The system of claim 61, wherein the access request comprises a selection instruction for a software application compatible with a framework associated with the one or more user accounts.

76. The system of claim 61, wherein the user accesses the software application through a one or more user accounts registered with the hosting infrastructure module.

77. The system of claim 61, wherein following installation, the hosting infrastructure module sends an installation confirmation to the marketplace module.

78. The computer implemented method of any one of claims 61 to 77, wherein the software application is a web-based software application, executed at one or more servers.

End of 5006: Software Marketplace and Distribution System Support for Foreign Prosecution.

Start of 5007: Software Licensing and Enforcement System support for Foreign Prosecution.

1. A computer implemented method, comprising:

at one or more servers, hosting a marketplace application:

receiving from a vendor a software application for distribution;

generating license terms in response to a selection by the vendor from options provided by the marketplace application;

associating the license terms with the software application, and

making the software application available for distribution through the marketplace application, in accordance with the license terms.

2. The computer implemented method of claim 1, further comprising deploying the software application to one or more user accounts on one or more hosting servers, in accordance with the license terms.

3. The computer implemented method of claim 2, where the deploying is in response to a payment associated with the one or more user accounts.

4. The computer implemented method of claim 1, wherein the license terms include at least one of an open source license, a closed license, a source code license, an executable license, and a repacking license.

5. The computer implemented method of claim 4, wherein the repacking license determines whether a user of the software application is permitted to repackage and redistribute the software application.

6. The computer implemented method of claim 5, wherein the repacking license has an associated royalty.

7. The computer implemented method of claim 6, wherein the associated royalty is one selected from the group consisting of a wholesale royalty, a retail royalty, and a flat fee.

8. The computer implemented method of claims 1, 4, or 5, wherein a license manager determines user permissions for installation, activation, and access to features of applications.

9. The computer implemented method of claim 1 wherein the options provided by the marketplace application includes an option to use license terms supplied by the vendor.

10. The computer implemented method of claims 1, 4, 5, 8, or 9 including displaying licensing events for a respective software application made available for distribution through the marketplace application.

11. The computer-implemented method of claim 10, wherein displaying includes displaying the licensing events to a respective vendor associated with the respective software application.

12. The computer-implemented method of claim 1, comprising storing the license terms in a licensing manager.

13. The computer implemented method of claim 1, wherein a price associated with the software application is stored at a licensing manager separately from the software application.

14. The computer implemented method of claim 13, wherein the price is dynamically adjusted by the licensing manager in response to a selection by the software vendor.

15. The computer implemented method of claim 1, wherein at least one selected from the group consisting of access duration, features, and price, is dynamically adjusted by a licensing manager in response to a selection by the software vendor.

16. The computer implemented method of claim 1, 2, wherein the one or more user accounts are stored separately from the marketplace application.

17. The computer implemented method of claims 1 or 16 further comprising processing a payment associated with the software application.

18. The computer implemented method of claim 17, further comprising, prior to processing a payment, receiving from the user a promotional code, and processing the payment based on the promotional code.

19. The computer implemented method of claim 17, comprising storing a record of the processed payment in a billing record.

20. The computer implemented method of claim 19, comprising prior to executing the deployed application, comparing a user identifier associated with the one or more user accounts and an application id associated with the deployed application against a billing manager to verify that a valid payment has been recorded.

21. The computer implemented methods of claims 1, 16, 17, or 20, comprising verifying that the one or more user accounts has permission to execute the deployed application, and in the event of a verification failure, warning the user.

22. The computer implemented method of claim 21, wherein the verifying is performed periodically, and following a plurality of verification failures, preventing the one or more user accounts from executing the deployed application.

23. The computer implemented method of claims 21 or 22, wherein the verifying includes checking for multiple instances of the software application being simultaneously executed by the one or more user accounts.

24. The computer implemented method of claim 16, comprising preventing access by the user to data stored at the one or more servers, upon determining that the one or more user accounts has been disabled.

25. The computer implemented method of claim 16, further comprising deploys a license key associated with the software application to a user account associated with a licensee of the software application.

26. The computer implemented method of claim 25, further comprising communicating to the software vendor that the software application has been licensed by the user.

27. The computer implemented method of claim 26, wherein the communicating is performed via an application programming interface call.

28. A server system, comprising:

one or more processors;

memory; and

one or more programs stored in the memory, the one or more programs comprising instructions for, at one or more servers hosting a marketplace application:

receiving from a vendor a software application for distribution;

generating license terms in response to a selection by the vendor from options provided by the marketplace application;

associating the license terms with the software application, and

making the software application available for distribution through the marketplace application, in accordance with the license terms.

29. The computer implemented method of claim 28, further comprising deploying the software application to one or more user accounts on one or more hosting servers, in accordance with the license terms.

30. The computer implemented method of claim 29, where the deploying is in response to a payment associated with the one or more user accounts.

31. The computer implemented method of claim 28, wherein the license terms include at least one of an open source license, a closed license, a source code license, an executable license, and a repacking license.

32. The computer implemented method of claim 28, wherein the repacking license determines whether a user of the software application is permitted to repackage and redistribute the software application.

33. The computer implemented method of claim 32, wherein the repacking license has an associated royalty.

34. The computer implemented method of claim 33, wherein the associated royalty is one selected from the group consisting of a wholesale royalty, a retail royalty, and a flat fee.

35. The computer implemented method of claims 28, 32, or 33, wherein a license manager determines user permissions for installation, activation, and access to features of applications.

36. The computer implemented method of claim 28 wherein the options provided by the marketplace application includes an option to use license terms supplied by the vendor.

37. The computer implemented method of claims 28, 32, 33, 35, or 36 including displaying licensing events for a respective software application made available for distribution through the marketplace application.

38. The computer-implemented method of claim 37, wherein displaying includes displaying the licensing events to a respective vendor associated with the respective software application.

39. The computer-implemented method of claim 28, comprising storing the license terms in a licensing manager.

40. The computer implemented method of claim 28, wherein a price associated with the software application is stored at a licensing manager separately from the software application.

41. The computer implemented method of claim 40, wherein the price is dynamically adjusted by the licensing manager in response to a selection by the software vendor.

42. The computer implemented method of claim 28, wherein at least one selected from the group consisting of access duration, features, and price, is dynamically adjusted by a licensing manager in response to a selection by the software vendor.

43. The computer implemented method of claim 29, wherein the one or more user accounts are stored separately from the marketplace application.

44. The computer implemented method of claims 28 or 43 further comprising processing a payment associated with the software application.

45. The computer implemented method of claim 44, further comprising, prior to processing a payment, receiving from the user a promotional code, and processing the payment based on the promotional code.

46. The computer implemented method of claim 44, comprising storing a record of the processed payment in a billing record.

47. The computer implemented method of claim 44, comprising prior to executing the deployed application, comparing a user identifier associated with the one or more user accounts and an application id associated with the deployed application against a billing manager to verify that a valid payment has been recorded.

48. The computer implemented methods of claims 28, 43, 44, and 47 comprising verifying that the one or more user accounts has permission to execute the deployed application, and in the event of a verification failure, warning the user.

49. The computer implemented method of claim 48, wherein the verifying is performed periodically, and following a plurality of verification failures, preventing the one or more user accounts from executing the deployed application.

50. The computer implemented method of claims 48 or 49, wherein the verifying includes checking for multiple instances of the software application being simultaneously executed by the one or more user accounts.

51. The computer implemented method of claim 43, comprising preventing access by the user to data stored at the one or more servers, upon determining that the one or more user accounts has been disabled.

52. The computer implemented method of claim 43, further comprising deploys a license key associated with the software application to a user account associated with a licensee of the software application.

53. The computer implemented method of claim 52, further comprising communicating to the software vendor that the software application has been licensed by the user.

54. The computer implemented method of claim 53, wherein the communicating is performed via an application programming interface call.

55. A computer readable storage medium storing one or more programs configured for execution by a computer, the one or more programs comprising instructions for

at one or more servers, hosting a marketplace application:

receiving from a vendor a software application for distribution;

generating license terms in response to a selection by the vendor from options provided by the marketplace application;

associating the license terms with the software application, and

making the software application available for distribution through the marketplace application, in accordance with the license terms.

56. A computer implemented method, comprising:

at one or more servers hosting a marketplace application:

making a software application available for distribution through the marketplace application;

receiving a user request to license the software application; and

providing the software application for deployment to one or more user accounts, hosted on one or more servers.

57. The computer implemented method of claim 56, where providing the software application for deployment includes providing the software application across a network for deployment at one or more servers associated with the user, hosting the one or more user accounts.

58. The computer implemented method of claim 56, further comprising processing a selection by the user that includes adding the software application to a cart associated with the user, and checking out the cart.

59. The computer implemented method of claim 56, comprising prior to deploying, presenting a description of license terms associated with the software application to the user.

60. The computer implemented method of claim 57, wherein the license terms are specified by a vendor associated with the software application.

61. The computer implemented method of claim 60, wherein specifying the license terms includes selecting the license terms from a plurality of options provided by a licensing engine associated with the one or more servers hosting a marketplace application.

62. The computer implemented method of claim 57, 60, or 61 comprising validating that the request to license the software application complies with the license terms.

63. The computer implemented method of claim 56, 57, 60, 61 or 62 wherein the request to license the software application includes a payment selected from the group consisting of a cash payment, a credit payment, and a prospective future payment.

64. The computer implemented method of claim 56, 57, 60, 61, 62 or 63 wherein the software application is a web-based software application, executed at one or more servers.

65. A server system, comprising:

one or more processors;

memory; and

one or more programs stored in the memory, the one or more programs comprising instructions to at one or more servers hosting a marketplace application:

make a software application available for distribution through the marketplace application;

receive a user request to license the software application; and

provide the software application for deployment to one or more user accounts, hosted on one or more servers.

66. The server system of claim 65, wherein the instructions to provide the software application for deployment includes instructions to provide the software application across a network for deployment at one or more servers associated with the user, hosting the one or more user accounts.

67. The server system of claim 65, further comprising instructions to process a selection by the user that includes adding the software application to a cart associated with the user, and checking out the cart.

68. The server system of claim 65, further comprising instructions for prior to deploying, presenting a description of license terms associated with the software application to the user.

69. The server system of claim 68, further comprising instructions to receive license terms specified by a vendor associated with the software application.

70. The server system of claim 69, wherein receiving license terms specified by a vendor include receiving a selection of license terms from a plurality of options provided by a licensing engine associated with the one or more servers hosting a marketplace application.

71. The server system of claim 66, 69, or 70 further comprising instructions to validate that the request to license the software application complies with the license terms.

72. The server system of claims 65, 66, 69, 70, or 71 wherein the request to license the software application includes a payment selected from the group consisting of a cash payment, a credit payment, and a prospective future payment.

73. The server system of claims 65, 66, 69, 70, 71, or 72 wherein the software application is a web-based software application, executed at one or more servers.

74. A computer readable storage medium storing one or more programs configured for execution by a computer, the one or more programs comprising instructions for at one or more servers hosting a marketplace application:

making a software application available for distribution through the marketplace application;

receiving a user request to license the software application; and

providing the software application for deployment to one or more user accounts, hosted on one or more servers.

End of 5007: Software Licensing and Enforcement System Support for Foreign Prosecution.

What is claimed is:

1. A computer implemented method, comprising:
at one or more servers, hosting a marketplace application:
receiving from a vendor a software application for distribution;
generating license terms in response to a selection by the vendor from options provided by the marketplace application;
associating the license terms with the software application, and
making the software application available for distribution through the marketplace application, in accordance with the license terms.

2. The computer implemented method of claim 1, further comprising deploying the software application to one or more user accounts on one or more hosting servers, in accordance with the license terms.

3. The computer implemented method of claim 2, where the deploying is in response to a payment associated with the one or more user accounts.

4. The computer implemented method of claim 1, wherein the license terms include at least one of an open source license, a closed license, a source code license, an executable license, and a repacking license.

5. The computer implemented method of claim 4, wherein the repacking license determines whether a user of the software application is permitted to repackage and redistribute the software application.

6. The computer implemented method of claim 5, wherein the repacking license has an associated royalty.

7. The computer implemented method of claim 6, wherein the associated royalty is one selected from the group consisting of a wholesale royalty, a retail royalty, and a flat fee.

8. The computer implemented method of claim 1, wherein a license manager determines user permissions for installation, activation, and access to features of applications.

9. The computer implemented method of claim 1 wherein the options provided by the marketplace application includes an option to use license terms supplied by the vendor.

10. The computer implemented method of claim 1, including displaying licensing events for a respective software application made available for distribution through the marketplace application.

11. The computer-implemented method of claim 10, wherein displaying includes sending for display the licensing events to a respective vendor associated with the respective software application.

12. The computer-implemented method of claim 1, further comprising storing the license terms in a licensing manager.

13. The computer implemented method of claim 1, wherein a price associated with the software application is stored at a licensing manager separately from the software application.

14. The computer implemented method of claim 13, wherein the price is dynamically adjusted by the licensing manager in response to a selection by the software vendor.

15. The computer implemented method of claim 1, wherein at least one selected from the group consisting of access duration, features, and price, is dynamically adjusted by a licensing manager in response to a selection by the software vendor.

16. The computer implemented method of claim 1, wherein the one or more user accounts are stored separately from the marketplace application.

17. The computer implemented method of claim 1 further comprising processing a payment associated with the software application.

18. The computer implemented method of claim 17, further comprising, prior to processing a payment, receiving from the user a promotional code, and processing the payment based on the promotional code.

19. The computer implemented method of claim 17, further comprising storing a record of the processed payment in a billing record.

20. The computer implemented method of claim 19, further comprising prior to executing the deployed application, comparing a user identifier associated with the one or more user accounts and an application id associated with the deployed application against a billing manager to verify that a valid payment has been recorded.

21. The computer implemented methods of claim 1, further comprising verifying that the one or more user accounts has permission to execute the deployed application, and in the event of a verification failure, warning the user.

22. The computer implemented method of claim 21, wherein the verifying is performed periodically, and following a plurality of verification failures, preventing the one or more user accounts from executing the deployed application.

23. The computer implemented method of claims 21, wherein the verifying includes checking for multiple instances of the software application being simultaneously executed by the one or more user accounts.

24. The computer implemented method of claim 16, further comprising preventing access by the user to data stored at the one or more servers, upon determining that the one or more user accounts has been disabled.

25. The computer implemented method of claim 16, further comprising deploying a license key associated with the software application to a user account associated with a licensee of the software application.

26. The computer implemented method of claim 25, further comprising communicating to the software vendor that the software application has been licensed by the user.

27. The computer implemented method of claim 26, wherein the communicating is performed via an application programming interface call.

28. A server system, comprising:
one or more processors;
memory; and
one or more programs stored in the memory, the one or more programs comprising instructions for, at one or more servers hosting a marketplace application:
receiving from a vendor a software application for distribution;
generating license terms in response to a selection by the vendor from options provided by the marketplace application;
associating the license terms with the software application, and
making the software application available for distribution through the marketplace application, in accordance with the license terms.

29. The server system of claim 28, further comprising instructions for deploying the software application to one or more user accounts on one or more hosting servers, in accordance with the license terms.

30. The server system of claim 29, where the deploying is in response to a payment associated with the one or more user accounts.

31. The server system of claim 28, wherein the license terms include at least one of an open source license, a closed license, a source code license, an executable license, and a repacking license.

32. The server system of claim 28, wherein the repacking license determines whether a user of the software application is permitted to repackage and redistribute the software application.

33. The server system of claim 32, wherein the repacking license has an associated royalty.

34. The server system of claim 33, wherein the associated royalty is one selected from the group consisting of a wholesale royalty, a retail royalty, and a flat fee.

35. The server system of claim 28, further comprising instructions for license manager to determines user permissions for installation, activation, and access to features of applications.

36. The server system of claim 28 wherein the options provided by the marketplace application includes an option to use license terms supplied by the vendor.

37. The server system of claim 28, including instructions to display licensing events for a respective software application made available for distribution through the marketplace application.

38. The server system of claim 37, wherein displaying includes sending for display the licensing events to a respective vendor associated with the respective software application.

39. The server system of claim 28, further comprising instructions to store the license terms in a licensing manager.

40. The server system of claim 28, wherein a price associated with the software application is stored at a licensing manager separately from the software application.

41. The server system of claim 40, wherein the price is dynamically adjusted by the licensing manager in response to a selection by the software vendor.

42. The server system of claim 28, wherein at least one selected from the group consisting of access duration, features, and price, is dynamically adjusted by a licensing manager in response to a selection by the software vendor.

43. The server system of claim 29, wherein the one or more user accounts are stored separately from the marketplace application.

44. The server system of claim 28 further comprising instructions to process a payment associated with the software application.

45. The server system of claim 44, further comprising instructions for, prior to processing a payment, receiving from the user a promotional code, and processing the payment based on the promotional code.

46. The server system of claim 44, further comprising instructions for storing a record of the processed payment in a billing record.

47. The server system of claim 44, further comprising instructions for prior to executing the deployed application, comparing a user identifier associated with the one or more user accounts and an application id associated with the deployed application against a billing manager to verify that a valid payment has been recorded.

48. The server system of claim 28, further comprising instructions for verifying that the one or more user accounts has permission to execute the deployed application, and in the event of a verification failure, warning the user.

49. The server system of claim 48, wherein the verifying is performed periodically, and following a plurality of verification failures, preventing the one or more user accounts from executing the deployed application.

50. The server system of claim 48, wherein the verifying includes checking for multiple instances of the software application being simultaneously executed by the one or more user accounts.

51. The server system of claim 43, further comprising instructions for preventing access by the user to data stored at the one or more servers, upon determining that the one or more user accounts has been disabled.

52. The server system of claim 43, further comprising instructions for deploying a license key associated with the software application to a user account associated with a licensee of the software application.

53. The server system of claim 52, further comprising instructions for communicating to the software vendor that the software application has been licensed by the user.

54. The server system of claim 53, wherein the communicating is performed via an application programming interface call.

55. A computer readable storage medium storing one or more programs configured for execution by a computer, the one or more programs comprising instructions for
at one or more servers, hosting a marketplace application:
receiving from a vendor a software application for distribution;
generating license terms in response to a selection by the vendor from options provided by the marketplace application;
associating the license terms with the software application, and
making the software application available for distribution through the marketplace application, in accordance with the license terms.

56. A computer implemented method, comprising:
at one or more servers hosting a marketplace application:
making a software application available for distribution through the marketplace application;
receiving a user request to license the software application; and
providing the software application for deployment to one or more user accounts, hosted on one or more servers.

57. The computer implemented method of claim 56, where providing the software application for deployment includes providing the software application across a network for deployment at one or more servers associated with the user, hosting the one or more user accounts.

58. The computer implemented method of claim 56, further comprising processing a selection by the user that includes adding the software application to a cart associated with the user, and checking out the cart.

59. The computer implemented method of claim 56, further comprising prior to deploying, presenting a description of license terms associated with the software application to the user.

60. The computer implemented method of claim 57, wherein the license terms are specified by a vendor associated with the software application.

61. The computer implemented method of claim 60, wherein specifying the license terms includes selecting the license terms from a plurality of options provided by a licensing engine associated with the one or more servers hosting a marketplace application.

62. The computer implemented method of claim 57, further comprising validating that the request to license the software application complies with the license terms.

63. The computer implemented method of claim 56, wherein the request to license the software application includes a payment selected from the group consisting of a cash payment, a credit payment, and a prospective future payment.

64. The computer implemented method of claim 56, wherein the software application is a web-based software application, executed at one or more servers.

65. A server system, comprising:
one or more processors;
memory; and
one or more programs stored in the memory, the one or more programs comprising instructions to at one or more servers hosting a marketplace application:
make a software application available for distribution through the marketplace application;
receive a user request to license the software application; and
provide the software application for deployment to one or more user accounts, hosted on one or more servers.

66. The server system of claim 65, wherein the instructions to provide the software application for deployment includes instructions to provide the software application across a network for deployment at one or more servers associated with the user, hosting the one or more user accounts.

67. The server system of claim 65, further comprising instructions to process a selection by the user that includes adding the software application to a cart associated with the user, and checking out the cart.

68. The server system of claim 65, further comprising instructions for prior to deploying, presenting a description of license terms associated with the software application to the user.

69. The server system of claim 68, further comprising instructions to receive license terms specified by a vendor associated with the software application.

70. The server system of claim 69, wherein instructions to receive license terms specified by a vendor include instructions to receive a selection of license terms from a plurality of options provided by a licensing engine associated with the one or more servers hosting a marketplace application.

71. The server system of claim 66, further comprising instructions to validate that the request to license the software application complies with the license terms.

72. The server system of claim 65, wherein the request to license the software application includes a payment selected from the group consisting of a cash payment, a credit payment, and a prospective future payment.

73. The server system of claim 65, wherein the software application is a web-based software application, executed at one or more servers.

74. A computer readable storage medium storing one or more programs configured for execution by a computer, the one or more programs comprising instructions for at one or more servers hosting a marketplace application:
making a software application available for distribution through the marketplace application;
receiving a user request to license the software application; and
providing the software application for deployment to one or more user accounts, hosted on one or more servers.
